(19) United States
(12) Patent Application Publication
(10) Pub. No.: US 2024/0046814 A1
(43) Pub. Date: Feb. 8, 2024

(54) SYSTEM AND METHOD FOR TEACHING MUSIC COMPREHENSION

(71) Applicant: Robert C. Dawson, New York, NY (US)

(72) Inventor: Robert C. Dawson, New York, NY (US)

(21) Appl. No.: 18/362,790

(22) Filed: Jul. 31, 2023

Related U.S. Application Data
(60) Provisional application No. 63/395,585, filed on Aug. 5, 2022.

(51) Int. Cl. G09B 15/02; G10G 1/02

(52) U.S. Cl. CPC G09B 15/023; G09B 15/026; G10G 1/02

(57) ABSTRACT

A teaching system for increasing understanding of music through expansion of a compositional technique known as contrary motion and methods for creating and utilizing the same contrary motion and/or understanding. Contrary motion can comprise two or more lines of music that proceed in opposite directions from each other. As a first line of music ascends in pitch, for example, a second line of music descends in pitch. In selected embodiments, the teaching system can employ one or more senses, such as an auditory sense, a visual sense, a tactile sense and a kinesthetic sense, of a listener to enable the listener to further understand and enjoy the music. Accordingly, the teaching system advantageously can enhance understanding of music with a focus on contrary motion by incorporating the use of the other senses of the listener in addition to use of the auditory sense.

### CROSS-REFERENCE TO RELATED APPLICATIONS

This application claims the benefit of, and priority to, U.S. Provisional Application Ser. No. 63/395,585, filed on Aug. 5, 2022, the disclosure of which is hereby incorporated herein by reference in its entirety and for all purposes.

### FIELD

The disclosed embodiments relate generally to the field of music, and more particularly, but not exclusively, to teaching systems and methods for increasing the understanding of music through expansion of a technique in composing known as “contrary motion.” The understanding of contrary motion using the auditory sense can be expanded through the use of other senses, such as visual, tactual, and kinesthetic, in addition to the auditory sense. Employing these senses provides palpability to the music.

### BACKGROUND

Traditionally, music is taught to contain three components: melody; harmony and rhythm.

The teaching method disclosed herein provides another component or dimension that is not only separate from the three basic (or traditional) components of melody, harmony and rhythm, but can also be combined with the traditional components.

Music often contains two or more lines moving or playing at the same time, for example, a melody line and a bass line. In classical and most other styles of music, multiple lines play simultaneously. Contrary motion in music is a term that describes a first line of music moving in one direction, while simultaneously, another line of music moves in the opposite direction or in “contrary motion” to the first line. Traditionally, contrary motion occurs when the last note of one measure is followed by the first note of a new measure or bar; known as “over the bar line.” Frequently, multiple examples of contrary motion also occur at other points within each measure on different beats, secondary beats, and offbeats. While some pieces exhibit contrary motion on every note.

Classical composers intentionally and consistently designed their music to incorporate contrary motion, making it inherent to the classical music genre. Contrary motion can also include mirror image, or the musical terms diminution (shorter duration of notes) and augmentation (longer duration of notes), consonance and dissonance. In some cases, composers, such as Johann Sebastian Bach, are able to create contrary motion by having a line of music played forwards and backwards at the same time or by playing a line of music immediately followed by its inversion. Further displays of opposites might include hands crossing over each other, as in the Bach Goldberg Variations. Contrary motion is considered one of the main rules of composing of classical music by scholars and composers.

Current music teaching methods offer few recognizable auditory or other reference points to keep a listener's attention. Basic thematic material—the “melody”—and “structure”—the beginning of a new section—are often difficult for the listener to recognize or enjoy. Many music listeners, even astute music listeners, relate to music by focusing on its lyrics or beat rather than on the notes of the music. Classical music with contrary motion, however, has a complex musical architecture that frequently does not include lyrics. Therefore, classical music becomes obscure to many listeners, thereby losing audience interest. The use of other senses may help overcome this audible deficiency.

The issue with regard to the listener's difficulty with classical music stems from a problem inherent in the melody. Melodies or thematic material are comprised of “musical cells.” A musical cell is a group of consecutive notes, frequently four, five or six notes. A musical cell may contain as few as two notes, and as many as ten or more notes. Although rare, a one-note musical cell is possible. The notes contained within a musical cell may be repeated, as in the nursery song Are You Sleep-ing? This simple four-note cell consists of the following notes: F up to G up to A and back down to F. While it uses three different notes, the cell is described herein as a four-note cell due to the repetition of a note (F). Following the four-note cell of this simple song, is a three-note cell with the lyrics: Broth-er John. The notes are A, up to B flat up to C. In this case none of the three notes is repeated.

Throughout the evolution of music, a large percentage of all styles uses common musical cells. The three notes in the above example, Are You Sleep-ing?, and the three notes of the Broth-er John cell are two of the more commonly used. Either cell of Are You Sleep-ing? or Broth-er John might be arranged in a different order or permutation, or a change of note order. For example, A down to G down to F creates the nursery song Three Blind Mice and many twentieth century songs, including Pretty Woman or Strangers in the Night. A frequently performed movement of Tchaikovsky's Nutcracker Suite employs the same three notes as its identifying feature.

The cells of one melody in a piece are used in many pieces with different variations throughout all styles of music. This is also true of harmony and rhythm, the other two traditional components of music.

The familiar intervallic sound between F up to A, also known as a third, can also be heard in common everyday sounds such as bird songs, a mother's call to her child, car horns, cell phone rings and other sources, such as within the three notes of Are You Sleeping, F up to G up to A and back down to F.

A permutation—changing the order of the three notes—or using two of the three notes of Broth-er John: A, up to B flat, up to C, is found in hundreds of songs. Another example is the immediately recognizable song by The Beatles, Hey Jude: C down to A.

Repeating a note within a cell, or by changing the rhythm of the notes in the cell, can change how the cell is heard. Certain cells in popular music are so common that only the lyrics differentiate between songs. Similar cell configurations are prevalent in masterpieces of classical composers.

Both cells in Are You Sleep-ing? and Broth-er John appear in most of Bach's 48 Preludes and Fugues of Well-Tempered Clavier, and in symphonies, sonatas and string quartets, and piano music by Mozart and Beethoven. Composers of all styles of music use these cells in compositions up to the present time.

Because the same notes are used over and over in various songs and/or pieces, the music becomes difficult for listeners to discern one composition from the other. Even the permutations between four or five different notes eventually begin to sound similar.

The following exercise using an English language example illustrates how the notes in musical cells can be rearranged.

The four parts of the following sentence model are interchangeable and are labeled 1, 2, 3, 4.

Sentence model: This evening, we are going to walk to the store around the corner to buy some butter.

The order of the model: 1, 2, 3, 4
(1) This evening,
(2) we are going to walk
(3) to the store around the corner
(4) to buy some butter.

Each numbered phrase represents a note of a musical cell.

Permutation:
(1) We are going to walk
(2) to the store around the corner
(3) to buy some butter
(4) this evening.

We are going to walk to the store around the corner to buy some butter this evening.

Paradoxically, rock music and classical music relate closely to each as far as musical cells. Modern classical music uses the same components of melody, harmony and rhythm.

Performing artists and arts institutions have tried innumerable ways of attracting an audience. Questionable methods of attracting an audience can include having a conductor jumping and waving an arm vigorously, a performer wearing a provocative dress, a string quartet playing Beatles songs, making stars out of players so that the stars attract the audience, having someone playing while covered in dripping chocolate, or antics such as two people playing one cello, or switching instruments, having seven pianists all playing at once, or a violinist doing the hula hoop while playing. An orchestra of seventy-five players produces a huge volume of sound but it boils down to the hearing, yet again, the same or similar musical cells. No matter the musical situation, melody, harmony and rhythm constitute the basic components of music.

However, as stated previously, the use of no lyrics may be a main reason that most classical cannot claim popularity.

Since musical cells are derived from a twelve-tone western system, how does classical music differentiate itself from other styles of music?

One solution is contrary motion.

The teaching method disclosed herein posits that contrary motion is the one consistent component in classical music that differentiates classical music from other styles of music. This teaching method demonstrates the technique of understanding contrary motion of expansion and contraction through the auditory sense, which can be combined with, and enhanced by, the visual and/or tactile senses. Furthermore, contrary motion is a pivotal point that connects music to various other scientific disciplines such as architecture, engineering or physics. One might say that contrary motion demonstrated in this fashion is a fourth component of music in addition to three traditional components melody, harmony and rhythm. Also, contrary motion is utilized in almost every measure of classical music. However, this oppositional quality of contrary motion inherent in classical music has virtually gone unnoticed by listeners of classical music.

Learning and fully understanding music, particularly classical music, can present many challenges even for professional musicians. There are not enough guideposts or markers within the music itself, especially when the notice of contrary motion (or CM) is omitted. Listening to classical music can be analogous to hiking without a compass or markers on the trees: the music can be largely unintelligible.

In his book, Multiple Intelligences, Howard Gardner proposes that there are several types of intelligence and learning styles that range from musical intelligence to the intelligence of self-understanding. Some educators, such as Karen Hume in her article titled “Teaching through Metaphor and Analogy,” further suggest that all learning happens through connection. These educators opine that students often make sense of new information by forging connections to other information already known by the students.

To date, no conventional teaching method has been successfully applied to teach listeners how to fully understand or otherwise appreciate music. Since contrary motion is the main and consistent difference between classical and other styles of music, the performers, listeners and audiences can benefit from this teaching and understand contrary motion. Classical music thereby can become more accessible to the listeners by using contrary motion as a guidepost or, to use a modern metaphor, a global positioning system (or GPS).

In view of the foregoing, a need exists for a new and improved system and method for increasing understanding of music that overcome the aforementioned obstacles and deficiencies of currently-available teaching methods. Contrary motion as described herein can be taught through use of multi-sensory cues, such as visual, tactile and kinesthetic. When employing contrary motion, music advantageously can become accessible and understandable.

### SUMMARY

The present disclosure relates to a teaching system for increasing the understanding of music and methods for making and using the teaching system. The teaching system and method advantageously can increase the understanding of music through expansion of a technique in composing known as “contrary motion.” The understanding of contrary motion using the auditory sense can be expanded through the use of other senses, such as visual, tactual, and kinesthetic, in addition to the auditory sense. Employing these senses provides palpability to the music.

In accordance with a first aspect disclosed herein, there is set forth a method for teaching music appreciation through use of multi-sensory cues to highlight a musical technique known as contrary motion that can comprise:
instructing a student to place each digit of a right hand on a keyboard, or other surface of some kind, the right-hand digits being respectively positioned on a first group of keys of the keyboard associated with a first line of music with a first sequence of musical notes that ascend in pitch;
instructing the student to place each digit of a left hand on the keyboard, the left-hand digits being respectively positioned on a second group of keys of the keyboard associated with a second line of music with a second sequence of musical notes that descend in pitch, the first and second lines of music moving in the contrary motion; and/or
interactively presenting the first and second lines of music to the student with instruction to the student to use the right hand to press a relevant key in the first group as each corresponding musical note in the first line of music is presented and instruction to the student to use the left hand to press a relevant key in the second group as each corresponding musical note in the second line of music is presented.

In selected embodiments of the teaching method of the first aspect, the interactively presenting the first and second lines of music to the student can include audibly presenting the first and second lines of music to the student and/or interactively presenting the first and second lines of music simultaneously to the student. The interactively presenting the first and second lines of music to the student optionally can include instruction to the student to use the right hand and left hand to tactually press the relevant keys in the first and second groups simultaneously as each corresponding musical note in the first and second lines of music is presented. Additionally and/or alternatively, the interactively presenting the first and second lines of music to the student can comprise interactively serially (or sequentially) presenting the first and second lines of music to the student one line of music at a time. The first line of music, in other words, can be presented to the student before and/or after the second line of music is presented to the student.

In accordance with a second aspect disclosed herein, there is set forth a system for teaching music appreciation through use of multi-sensory cues that can comprise documents, circuitry or other tangible media for performing the method of the first aspect.

In accordance with a third aspect disclosed herein, there is set forth a computer program product for teaching music appreciation through use of multi-sensory cues that can comprise means for performing the method of the first aspect, the computer program product being encoded on one or more non-transitory machine-readable storage media and comprising instruction for performing the method of the first aspect.

In accordance with a fourth aspect disclosed herein, a method is presented for teaching music understanding through use of multi-sensory cues that can comprise:
annotating a first staff with a first line of music having a first sequence of musical notes that ascend in pitch with first indicia for visually illustrating the ascension of the musical notes;
annotating a second staff with a second line of music having a second sequence of musical notes that descend in pitch with second indicia for visually illustrating the descent of the musical notes, the first and second lines of music moving in contrary motion;
interactively presenting the first and second lines of music to a student with instruction to the student to visually observe the first indicia as each musical note in the first line of music is presented and instruction to the student to visually observe the second indicia as each musical note in the second line of music is presented.

In selected embodiments of the teaching method of the fourth aspect, the annotating the first staff can include annotating the first staff with the first line of music being visually presented during a concert attended by the student, wherein said annotating the second staff includes annotating the second staff with the second line of music being visually presented during the concert, and wherein said interactively presenting the first and second lines of music includes instructing the student to trace the annotated first and second staffs. The first and second lines of music, for example, can be visually presented via printed literature, can be visually presented via a computer display circuit and/or can be visually presented via an interior of a concert program (or other handout materials) for the concert.

The student optionally can be a reader of the first and second lines of music. Additionally and/or alternatively, the instructing the student to trace the annotated first and second staffs can include instructing the student to trace the annotated first and second staffs. The student optionally can be instructed to trace the annotated first and second staffs with an implement. The implement, for example, can include a pen.

In selected embodiments of the teaching method of the fourth aspect, the first and second lines of music optionally can comprise first and second lines from a selected passage of classical music. The first and second lines of music, for example, can be configured for performance or other use by an orchestra, chamber or music group to demonstrate contrary motion. Additionally and/or alternatively, the first and second lines of music can be configured to demonstrate contrary motion to musicians and/or to an audience.

In selected embodiments of the teaching method of the fourth aspect, the interactively presenting the first and second lines of music can further comprise interactively presenting the first and second lines of music to the student with instruction to the student to visually observe a first movement of a first singer who audibly sings the first line of music and a second movement of a second singer who audibly sings the second line of music, wherein the first movement and the second movement demonstrate the contrary motion in the first and second lines of music. The first movement of the first singer can include a first physical movement in a first direction, and/or the second movement of the second singer can include a second physical movement in a second direction. The first direction optionally can comprise an opposite direction relative to the second direction. For example, the first physical movement of the first singer can comprise the first singer sidestepping in a leftward direction relative to the first singer, and/or the second physical movement of the second singer can comprise the second singer sidestepping in a rightward direction relative to the second singer.

In selected embodiments, the teaching method of the fourth aspect can further comprise extracting the first and second lines of music from a written music score. Extracting the first and second lines of music can include extracting the first and second lines of music while singers and musicians are performing the first and second lines of music.

In selected embodiments, the teaching method of the fourth aspect can further comprise distilling the first and second lines of music from a written music score. The distilling the first and second lines of music, for example, can comprise distilling the first and second lines of music while singers and musicians are performing the first and second lines of music.

In accordance with a fifth aspect disclosed herein, there is set forth a system for teaching music appreciation through use of multi-sensory cues that carry out the method of the fourth aspect. The system, for example, can comprise documents, circuitry or other tangible media for performing the method of the fourth aspect.

In selected embodiments of the teaching system of the fifth aspect, the multi-sensory cues can include one or more auditory cues. The multi-sensory cues, for example, can include at least one auditory cue, at least one visual cue, at least one tactual cues and/or at least one kinesthetic cue.

In accordance with a sixth aspect disclosed herein, there is set forth a computer program product for teaching music appreciation through use of multi-sensory cues that can comprise instruction for performing the method of the fourth aspect. In selected embodiments, the computer program product of the sixth aspect can be encoded on one or more non-transitory machine-readable storage media.

In accordance with a seventh aspect disclosed herein, a method is presented for teaching music understanding through use of multi-sensory cues that can comprise:
annotating a first staff with a first line of music having a first sequence of musical notes that ascend in pitch with first indicia for kinesthetically illustrating the ascension of the musical notes;
annotating a second staff with a second line of music having a second sequence of musical notes that descend in pitch with second indicia for kinesthetically illustrating the descent of the musical notes, the first and second lines of music moving in contrary motion;
interactively presenting the first and second lines of music to a student with instruction to the student to kinesthetically observe the first indicia as each musical note in the first line of music is presented and instruction to the student to kinesthetically observe the second indicia as each musical note in the second line of music is presented.

In selected embodiments of the teaching method of the seventh aspect, the annotating the first staff can include annotating the first staff with the first line of music being presented in an interior of a concert program (or other handout materials) for a concert attended by the student, wherein the annotating the second staff can include annotating the second staff with the second line of music being presented in the interior of the concert program, and wherein the interactively presenting the first and second lines of music can include instructing the student to trace the annotated first and second staffs. The first and second lines of music, for example, can be visually presented via printed literature, can be visually presented via a computer display circuit and/or visually presented via an interior of a concert program (or other handout materials) for the concert.

The student optionally can be a reader of the first and second lines of music. Additionally and/or alternatively, the instructing the student to trace the annotated first and second staffs can comprise instructing the student to trace the annotated first and second staffs with an implement. The implement, for example, can include a pen.

In selected embodiments of the teaching method of the seventh aspect, the first and second lines of music optionally can comprise first and second lines from a selected passage of classical music. The first and second lines of music, for example, can be configured for performance or other use by an orchestra, chamber or music group to demonstrate contrary motion. Additionally and/or alternatively, the first and second lines of music can be configured to demonstrate contrary motion to musicians and/or to an audience.

In selected embodiments of the teaching method of the seventh aspect, the interactively presenting the first and second lines of music can further comprise interactively presenting the first and second lines of music to the student with instruction to the student to visually observe a first movement of a first singer who audibly sings the first line of music and a second movement of a second singer who audibly sings the second line of music, wherein the first movement and the second movement demonstrate the contrary motion in the first and second lines of music. The first movement of the first singer can include a first physical movement in a first direction, and/or the second movement of the second singer can include a second physical movement in a second direction. The first direction optionally can comprise an opposite direction relative to the second direction. For example, the first physical movement of the first singer can comprise the first singer sidestepping in a leftward direction relative to the first singer, and/or the second physical movement of the second singer can comprise the second singer sidestepping in a rightward direction relative to the second singer.

In selected embodiments, the teaching method of the seventh aspect can further comprise extracting the first and second lines of music from a written music score. Extracting the first and second lines of music can include extracting the first and second lines of music while singers and musicians are performing the first and second lines of music.

In selected embodiments, the teaching method of the seventh aspect can further comprise distilling the first and second lines of music from a written music score. The distilling the first and second lines of music, for example, can comprise distilling the first and second lines of music while singers and musicians are performing the first and second lines of music.

In accordance with an eighth aspect disclosed herein, there is set forth a system for teaching music appreciation through use of multi-sensory cues that carry out the method of the seventh aspect. The system, for example, can comprise documents, circuitry or other tangible media for performing the method of the seventh aspect.

In selected embodiments of the teaching system of the eighth aspect, the multi-sensory cues can include one or more auditory cues. The multi-sensory cues, for example, can include at least one auditory cue, at least one visual cue, at least one tactual cues and/or at least one kinesthetic cue.

In accordance with a ninth aspect disclosed herein, there is set forth a computer program product for teaching music appreciation through use of multi-sensory cues that can comprise instruction for performing the method of the seventh aspect. In selected embodiments, the computer program product of the ninth aspect can be encoded on one or more non-transitory machine-readable storage media.

### BRIEF DESCRIPTION OF THE DRAWINGS

FIG. 1 is a top-level flow chart illustrating an exemplary embodiment of a teaching method for increasing understanding of music.

FIG. 2A is a detail diagram illustrating an exemplary alternative embodiment of the teaching method of FIG. 1, wherein the teaching method includes presenting a first line of music that ascends in pitch.

FIG. 2B is a detail diagram illustrating an exemplary alternative embodiment of the teaching method of FIG. 1, wherein the teaching method includes presenting a second line of music that descends in pitch.

FIG. 2C is a detail diagram illustrating another exemplary alternative embodiment of the teaching method of FIG. 1, wherein the teaching method includes presenting the first ascending line of music of FIG. 2A and the second descending line of music of FIG. 2B.

FIG. 3A is a detail diagram illustrating an exemplary alternative embodiment of the teaching method of FIG. 2A, wherein the teaching method includes a first visual image for visually presenting the first line of music.

FIG. 3B is a detail diagram illustrating an exemplary alternative embodiment of the teaching method of FIG. 2B, wherein the teaching method includes a second visual image for visually presenting the second line of music.

FIG. 3C is a detail diagram illustrating an exemplary alternative embodiment of the teaching method of FIG. 2C, wherein the teaching method includes a third visual image for visually presenting the first and second lines of music.

FIG. 4A is a detail diagram illustrating still another exemplary alternative embodiment of the teaching method of FIG. 1, wherein the teaching method includes use of a surface for presenting one or more of the lines of music via a tactile sense of touch.

FIG. 4B is a detail diagram illustrating an exemplary alternative embodiment of the teaching method of FIG. 4A, wherein the surface comprises a musical keyboard of a musical instrument.

FIG. 4C is a detail diagram illustrating another exemplary alternative embodiment of the teaching method of FIG. 4A, wherein the surface comprises a typing keyboard.

FIG. 5 is a top-level flow chart illustrating an exemplary alternative embodiment of the teaching method of FIGS. 4A-B, wherein the teaching method includes instruction for touching the surface in accordance with the one or more of the lines of music.

FIG. 6A is a detail diagram illustrating still another exemplary alternative embodiment of the teaching method of FIG. 1, wherein the teaching method includes audibly presenting a first line of music that first ascends in pitch and then descends in pitch.

FIG. 6B is a detail diagram illustrating an exemplary alternative embodiment of the teaching method of FIG. 6A, wherein the teaching method includes visually presenting the first line of music.

FIG. 6C is a detail diagram illustrating another exemplary alternative embodiment of the teaching method of FIG. 6A, wherein the teaching method includes tactilely presenting the first line of music.

FIG. 6D is a detail diagram illustrating yet another exemplary alternative embodiment of the teaching method of FIG. 6A, wherein the teaching method includes audibly, visually and tactilely presenting the first line of music.

FIG. 7A is a detail diagram illustrating still another exemplary alternative embodiment of the teaching method of FIG. 1, wherein the teaching method includes audibly presenting a second line of music that first descends in pitch and then ascends in pitch.

FIG. 7B is a detail diagram illustrating an exemplary alternative embodiment of the teaching method of FIG. 7A, wherein the teaching method includes visually presenting the second line of music.

FIG. 7C is a detail diagram illustrating another exemplary alternative embodiment of the teaching method of FIG. 7A, wherein the teaching method includes tactilely presenting the second line of music.

FIG. 7D is a detail diagram illustrating yet another exemplary alternative embodiment of the teaching method of FIG. 7A, wherein the teaching method includes audibly, visually and tactilely presenting the second line of music.

FIG. 8A is a detail diagram illustrating still another exemplary alternative embodiment of the teaching method of FIG. 1, wherein the teaching method includes audibly presenting the first line of music of FIGS. 6A-D and the second line of music of FIGS. 7A-D.

FIG. 8B is a detail diagram illustrating an exemplary alternative embodiment of the teaching method of FIG. 8A, wherein the teaching method includes visually presenting the first and second lines of music.

FIG. 8C is a detail diagram illustrating another exemplary alternative embodiment of the teaching method of FIG. 8A, wherein the teaching method includes tactilely presenting the first and second lines of music.

FIG. 8D is a detail diagram illustrating yet another exemplary alternative embodiment of the teaching method of FIG. 8A, wherein the teaching method includes audibly, visually and tactilely presenting the first and second lines of music.

FIG. 9A is a detail diagram illustrating still another exemplary alternative embodiment of the teaching method of FIG. 1, wherein the teaching method includes audibly presenting a first line of music that is excerpted from main beats of a top line from a Beethoven Sonata Number 8 Opus 13 and that ascends in pitch.

FIG. 9B is a detail diagram illustrating an exemplary alternative embodiment of the teaching method of FIG. 9A, wherein the teaching method includes visually presenting the first line of music.

FIG. 9C is a detail diagram illustrating another exemplary alternative embodiment of the teaching method of FIG. 9A, wherein the teaching method includes tactilely presenting the first line of music.

FIG. 9D is a detail diagram illustrating yet another exemplary alternative embodiment of the teaching method of FIG. 9A, wherein the teaching method includes audibly, visually and tactilely presenting the first line of music.

FIG. 10A is a detail diagram illustrating still another exemplary alternative embodiment of the teaching method of FIG. 1, wherein the teaching method includes audibly presenting a first line of music that is excerpted from main beats of a bottom line from a Beethoven sonata and that descends in pitch.

FIG. 10B is a detail diagram illustrating an exemplary alternative embodiment of the teaching method of FIG. 10A, wherein the teaching method includes visually presenting the second line of music.

FIG. 10C is a detail diagram illustrating another exemplary alternative embodiment of the teaching method of FIG. 10A, wherein the teaching method includes tactilely presenting the second line of music.

FIG. 10D is a detail diagram illustrating yet another exemplary alternative embodiment of the teaching method of FIG. 10A, wherein the teaching method includes audibly, visually and tactilely presenting the second line of music.

FIG. 11A is a detail diagram illustrating still another exemplary alternative embodiment of the teaching method of FIG. 1, wherein the teaching method includes audibly presenting the first line of music of FIGS. 9A-D and the second line of music of FIGS. 10A-D.

FIG. 11B is a detail diagram illustrating an exemplary alternative embodiment of the teaching method of FIG. 11A, wherein the teaching method includes visually presenting the first and second lines of music.

FIG. 11C is a detail diagram illustrating another exemplary alternative embodiment of the teaching method of FIG. 11A, wherein the teaching method includes tactilely presenting the first and second lines of music.

FIG. 11D is a detail diagram illustrating yet another exemplary alternative embodiment of the teaching method of FIG. 11A, wherein the teaching method includes audibly, visually and tactilely presenting the first and second lines of music.

FIG. 12A is a detail diagram illustrating yet another exemplary alternative embodiment of the teaching method of FIG. 1, wherein at least one of the first and second lines of music provides one or more nested, or double, levels of contrary motion.

FIG. 12B is a detail diagram illustrating an exemplary alternative embodiment of the teaching method of FIG. 12A, wherein the teaching method includes visually presenting the first and second lines of music for each nested level of contrary motion.

FIG. 13A is a detail diagram illustrating a section of a Mozart Fantasia Number 1 Kochel 394 in full form.

FIG. 13B is a detail diagram illustrating yet another exemplary alternative embodiment of the teaching method of FIGS. 12A-B, wherein the teaching method includes presenting the section of the Mozart Fantasia of FIG. 13A.

FIG. 14A is a detail diagram illustrating an exemplary alternative embodiment of the teaching method of FIG. 1, wherein the teaching method includes audibly presenting a first line of music that is excerpted from main and secondary beats of a top line from the section of the Mozart Fantasia of FIGS. 13A-B.

FIG. 14B is a detail diagram illustrating an exemplary alternative embodiment of the teaching method of FIG. 14A, wherein the teaching method includes visually presenting the first line of music.

FIG. 14C is a detail diagram illustrating another exemplary alternative embodiment of the teaching method of FIG. 14A, wherein the teaching method includes tactilely presenting the first line of music.

FIG. 14D is a detail diagram illustrating yet another exemplary alternative embodiment of the teaching method of FIG. 14A, wherein the teaching method includes audibly, visually and tactilely presenting the first line of music.

FIG. 15A is a detail diagram illustrating another exemplary alternative embodiment of the teaching method of FIG. 1, wherein the teaching method includes audibly presenting a second line of music that is excerpted from main and secondary beats of a bottom line from the section of the Mozart Fantasia of FIGS. 13A-B.

FIG. 15B is a detail diagram illustrating an exemplary alternative embodiment of the teaching method of FIG. 15A, wherein the teaching method includes visually presenting the second line of music.

FIG. 15C is a detail diagram illustrating another exemplary alternative embodiment of the teaching method of FIG. 15A, wherein the teaching method includes tactilely presenting the second line of music.

FIG. 15D is a detail diagram illustrating yet another exemplary alternative embodiment of the teaching method of FIG. 15A, wherein the teaching method includes audibly, visually and tactilely presenting the second line of music.

FIG. 16A is a detail diagram illustrating still another exemplary alternative embodiment of the teaching method of FIG. 1, wherein the teaching method includes audibly presenting the first line of music of FIGS. 14A-D and the second line of music of FIGS. 15A-D.

FIG. 16B is a detail diagram illustrating an exemplary alternative embodiment of the teaching method of FIG. 16A, wherein the teaching method includes visually presenting the first and second lines of music.

FIG. 16C is a detail diagram illustrating another exemplary alternative embodiment of the teaching method of FIG. 16A, wherein the teaching method includes tactilely presenting the first and second lines of music.

FIG. 16D is a detail diagram illustrating yet another exemplary alternative embodiment of the teaching method of FIG. 16A, wherein the teaching method includes audibly, visually and tactilely presenting the first and second lines of music.

FIG. 17 is a detail diagram illustrating yet another exemplary alternative embodiment of the teaching method, wherein the teaching method includes demonstrating contrary motion by switching from a first instrument to a second instrument in an excerpt of the Mozart Requiem.

FIG. 18 is a detail diagram illustrating yet another exemplary alternative embodiment of the teaching method, wherein the teaching method includes demonstrating contrary motion by switching rhythms, and displaying eighth notes to be followed by whole notes, using a Beethoven String Quartet.

FIG. 19A is a detail diagram illustrating yet another exemplary alternative embodiment of the teaching method, wherein the teaching method includes demonstrating contrary motion from a first chord to a second chord on a first beat and how, on a fourth beat, held-notes played by a left hand of a musician are against notes played by a right hand of the musician and then proceed in contrary motion from the crossover style song of Will You Marry Me a composition of my own.

FIG. 19B is a detail diagram illustrating yet another exemplary alternative embodiment of the teaching method, wherein the teaching method includes demonstrating contrary motion via a line of parallel motion shown in two parallel lines marked with an asterisk.

FIG. 20A is a detail diagram illustrating yet another exemplary alternative embodiment of the teaching method, wherein the teaching method includes demonstrating contrary motion via a first exception to writing in contrary motion being displayed via rests in a Beethoven String Quartet, with rests providing time for an ear of a listener to adjust to a start of a new musical phrase.

FIG. 20B is a detail diagram illustrating yet another exemplary alternative embodiment of the teaching method, wherein the teaching method includes demonstrating contrary motion via a second exception to writing in contrary motion being displayed via rests in a Chopin Prelude.

FIG. 20C is a detail diagram illustrating yet another exemplary alternative embodiment of the teaching method, wherein the teaching method includes demonstrating contrary motion via a second exception line of contrary motion using “oblique motion” using a Bach Chorale from a Cantata.

FIG. 21 is a detail diagram illustrating yet another exemplary alternative embodiment of the teaching method, wherein the teaching method includes demonstrating contrary motion via a line moving in contrary motion and completing itself on the same note, two octaves apart, from “Searching” a composition of my own.

FIG. 22A is a detail diagram illustrating yet another exemplary alternative embodiment of the teaching method, wherein the teaching method includes a seven-note series for at least one alto singer member of a choir.

FIG. 22B is a detail diagram illustrating yet another exemplary alternative embodiment of the teaching method, wherein the teaching method includes a seven-note series for at least one tenor singer member of the choir.

FIG. 22C is a detail diagram illustrating yet another exemplary alternative embodiment of the teaching method, wherein the teaching method includes demonstrating contrary motion via the seven-note series for the alto singer choir member of FIG. 22A and the seven-note series for the tenor singer choir member of FIG. 22B.

FIG. 23A is a detail diagram illustrating yet another exemplary alternative embodiment of the teaching method, wherein the teaching method includes the seven-note series for the alto singer choir member of FIG. 22A with ascending and descending notes, starting and finishing notes and an alto retrace point.

FIG. 23B is a detail diagram illustrating yet another exemplary alternative embodiment of the teaching method, wherein the teaching method includes the seven-note series for the tenor singer choir member of FIG. 22B with ascending and descending notes, starting and finishing notes and a tenor retrace point.

FIG. 23C is a detail diagram illustrating yet another exemplary alternative embodiment of the teaching method, wherein the teaching method includes demonstrating contrary motion via the seven-note series for the alto singer choir member of FIG. 23A and the seven-note series for the tenor singer choir member of FIG. 23B.

FIG. 24A1 is a detail diagram illustrating yet another exemplary alternative embodiment of the teaching method, wherein the teaching method includes the seven-note series for the alto singer choir member of FIG. 22A with first diagonal lines connecting three of the same notes to three other notes via a “retrace point” where the notes are shown as being repeated in a reverse sequence.

FIG. 24A2 is a detail diagram illustrating yet another exemplary alternative embodiment of the teaching method, wherein the teaching method includes the seven-note series of FIG. 24A1 with ascending notes being shown in green and descending notes being shown in red.

FIG. 24B1 is a detail diagram illustrating yet another exemplary alternative embodiment of the teaching method, wherein the teaching method includes the seven-note series for the tenor singer choir member of FIG. 22B with second diagonal lines connecting three of the same notes to three other notes via a “retrace point” where the notes are shown as being repeated in a reverse sequence.

FIG. 24B2 is a detail diagram illustrating yet another exemplary alternative embodiment of the teaching method, wherein the teaching method includes the seven-note series of FIG. 24B1 with ascending notes being shown in green and descending notes being shown in red.

FIG. 24C1 is a detail diagram illustrating yet another exemplary alternative embodiment of the teaching method, wherein the teaching method includes demonstrating contrary motion via the seven-note series for the alto singer choir member of FIG. 24A1 and the seven-note series for the tenor singer choir member of FIG. 24B1 via a “retrace point” where the notes are shown as being repeated in a reverse sequence.

FIG. 24C2 is a detail diagram illustrating yet another exemplary alternative embodiment of the teaching method, wherein the teaching method includes demonstrating contrary motion via the seven-note series for the alto singer choir member of FIG. 24A2 and the seven-note series for the tenor singer choir member of FIG. 24B2 with ascending notes being shown in green and descending notes being shown in red and with a “retrace point” where the notes are shown as being repeated in a reverse sequence.

FIG. 25A is a detail diagram illustrating yet another exemplary alternative embodiment of the teaching method, wherein the teaching method includes the seven-note series for the alto singer choir member of FIG. 22A with green lines above the ascending notes, red lines above the descending notes and an alto retrace point above an intersection at which the ascending notes end and descending notes begin with no separation for the retrace point, which would not normally encounter in printed music.

FIG. 25B is a detail diagram illustrating yet another exemplary alternative embodiment of the teaching method, wherein the teaching method includes the seven-note series for the tenor singer choir member of FIG. 22B with red lines below the descending notes, and green lines below the ascending notes and a tenor retrace point below an intersection at which the descending notes end and ascending notes begin.

FIG. 25C is a detail diagram illustrating yet another exemplary alternative embodiment of the teaching method, wherein the teaching method includes demonstrating contrary motion via the seven-note series for the alto singer choir member of FIG. 25A and the seven-note series for the tenor singer choir member of FIG. 25B.

FIG. 26A is a detail diagram illustrating yet another exemplary alternative embodiment of the teaching method, wherein the teaching method includes introducing a kinesthetic sense to the seven-note series for the alto singer choir member of FIG. 22A with the alto singer choir member stepping right on the ascending notes and stepping left on the descending notes within the seven-note series.

FIG. 26B is a detail diagram illustrating yet another exemplary alternative embodiment of the teaching method, wherein the teaching method includes introducing a kinesthetic sense to the seven-note series for the tenor singer choir member of FIG. 22B with the tenor singer choir member stepping left on the descending notes and stepping right on the ascending notes within the seven-note series.

FIG. 26C is a detail diagram illustrating yet another exemplary alternative embodiment of the teaching method, wherein the teaching method includes demonstrating the kinesthetic sense via the seven-note series for the alto singer choir member of FIG. 26A and the seven-note series for the tenor singer choir member of FIG. 26B.

FIG. 27A is a detail diagram illustrating yet another exemplary alternative embodiment of the teaching method, wherein the teaching method includes a first group of first stick figures for the alto choir member as seen from the back, holding green flags for signifying ascending notes while the first stick figures step to the right and red flags for signifying descending notes while the first stick figures step to the left.

FIG. 27B is a detail diagram illustrating yet another exemplary alternative embodiment of the teaching method, wherein the teaching method includes a second group of second stick figures for the tenor choir member as seen from the back, holding red flags for signifying descending notes while the second stick figures step to the left and red flags for signifying ascending notes while the second stick figures step to the right.

FIG. 27C is a detail diagram illustrating yet another exemplary alternative embodiment of the teaching method, wherein the teaching method includes demonstrating contrary motion via the seven-note series for the alto choir member of FIG. 27A and the seven-note series for the tenor choir member of FIG. 27B. FIG. 27C comprises a combination of FIGS. 27A and 27B with FIG. 27A placed on the right side of FIG. 27B and being separated by a Center Line.

FIG. 28 is a detail diagram illustrating yet another exemplary alternative embodiment of the teaching method, wherein the teaching method includes an elaboration on the kinesthetic sense for demonstrating relative movement between the alto choir member and the tenor choir member of FIG. 27C.

FIG. 29 is a detail diagram illustrating yet another exemplary alternative embodiment of the teaching method, wherein the teaching method includes demonstrating contrary motion audibly, visually and tactually (or kinesthetically) relative to the alto choir member and the tenor choir member of FIG. 27C.

FIG. 30A is a detail diagram illustrating yet another exemplary alternative embodiment of the teaching method, wherein the teaching method includes a first line of music sung by at least one soprano member of the choir as shown in FIGS. 25A-C.

FIG. 30B is a detail diagram illustrating yet another exemplary alternative embodiment of the teaching method, wherein the teaching method includes a second line of music sung by at least one bass member of the choir as shown in FIGS. 25A-C.

FIG. 30C is a detail diagram illustrating yet another exemplary alternative embodiment of the teaching method, wherein the teaching method includes demonstrating contrary motion via the first line of music sung by the soprano choir member as shown in FIG. 30A and the second line of music sung by the bass choir member as shown in FIG. 30B.

FIG. 31A is a detail diagram illustrating yet another exemplary alternative embodiment of the teaching method, wherein the teaching method includes a third group of third stick figures of the soprano choir member of FIG. 30A as seen from the back, holding red flags for signifying descending notes, within a first seven-note series while the third stick figures step to the left and green flags for signifying ascending notes within a first seven-note series while the third stick figures step to the right.

FIG. 31B is a detail diagram illustrating yet another exemplary alternative embodiment of the teaching method, wherein the teaching method includes a fourth group of fourth stick figures of the bass choir member of FIG. 30B as seen from the back, holding green flags for signifying ascending notes within a second seven-note series while the fourth stick figures step to the right and holding red flags for signifying descending notes within the second seven-note series while the fourth stick figures step to the left.

FIG. 31C is a detail diagram illustrating yet another exemplary alternative embodiment of the teaching method, wherein the teaching method includes demonstrating contrary motion via the first seven-note series for the soprano choir member of FIG. 31A and the second seven-note series for the bass choir member of FIG. 31B being separated by a Center Line.

FIG. 32 is a detail diagram illustrating yet another exemplary alternative embodiment of the teaching method, wherein the teaching method includes an elaboration on the kinesthetic sense for demonstrating relative movement between the soprano choir member and the bass choir member of FIG. 31C.

FIG. 33 is a detail diagram illustrating yet another exemplary alternative embodiment of the teaching method, wherein the teaching method includes demonstrating contrary motion audibly, visually and tactually (or kinesthetically) relative to the soprano choir member and the bass choir member of FIG. 30C.

FIG. 34 is a detail diagram illustrating yet another exemplary alternative embodiment of the teaching method, wherein the teaching method includes demonstrating contrary motion by combining the alto singer choir member and the tenor singer choir member of FIG. 25C with the soprano choir member and the bass choir member of FIG. 30C arranged as a four-part traditional score.

FIG. 35A-C are a detail diagrams illustrating an exemplary alternative embodiment of the teaching method of FIG. 34, wherein the teaching method includes demonstrating contrary motion by coupling the alto singer choir member and the tenor singer choir member of FIG. 25C disposed on a first horizontal plane with the soprano choir member and the bass choir member of FIG. 30C disposed on a second horizontal plane offset from the first horizontal plane by a predetermined distance.

FIG. 36 is a detail diagram illustrating another exemplary alternative embodiment of the teaching method of FIG. 34, wherein the teaching method includes demonstrating contrary motion via four-measures of a four-part score instrumentalists and the soprano, alto singer, tenor singer and bass choir members.

FIG. 37 is a detail diagram illustrating an exemplary alternative embodiment of the teaching method of FIG. 36, wherein the teaching method includes the tenor singer choir member and the bass choir member switching parts.

FIG. 38 is a detail diagram illustrating still another exemplary alternative embodiment of the teaching method of FIG. 1, wherein the teaching method includes presenting contrary motion via a crossword puzzle grid.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

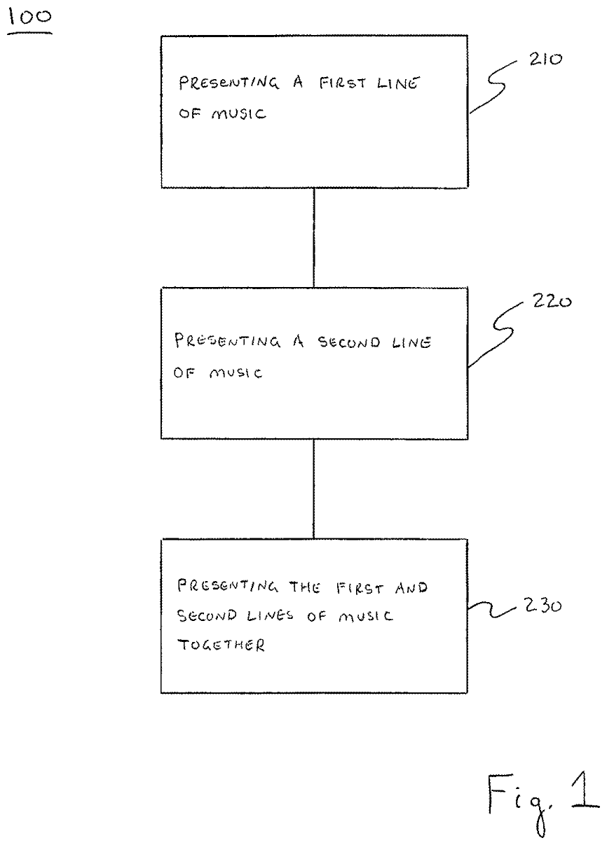

Since currently-available teaching methods fall short in teaching listeners how to fully understand or otherwise appreciate music, a system and method for increasing understanding of music through expansion of contrary motion can prove desirable and provide a basis for a wide range of applications, such as teaching classical music appreciation and enabling a listener to better hear and make sense of the music through use of multi-sensory cues, such as auditory, visual and/or tactile senses, which offer assistance in understanding of contrary motion. This result can be achieved, according to one embodiment disclosed herein, by a teaching method 100 as illustrated in FIG. 1.

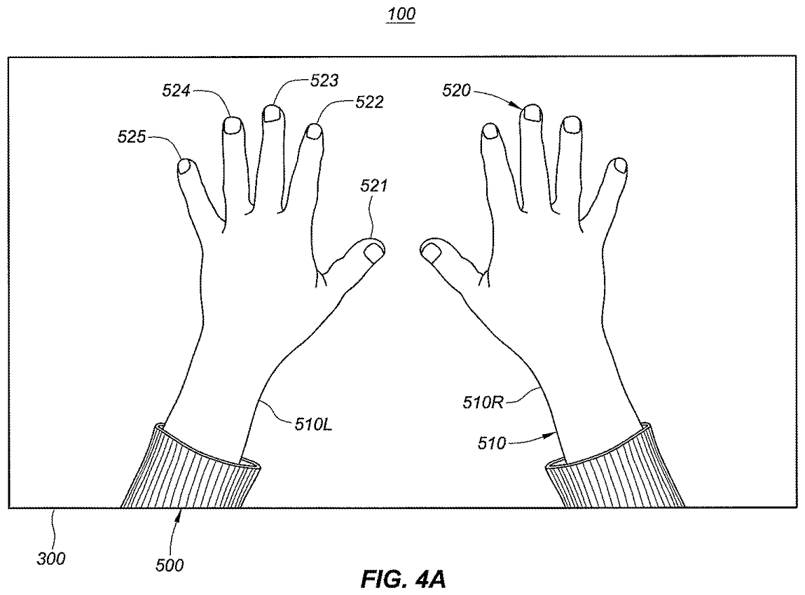

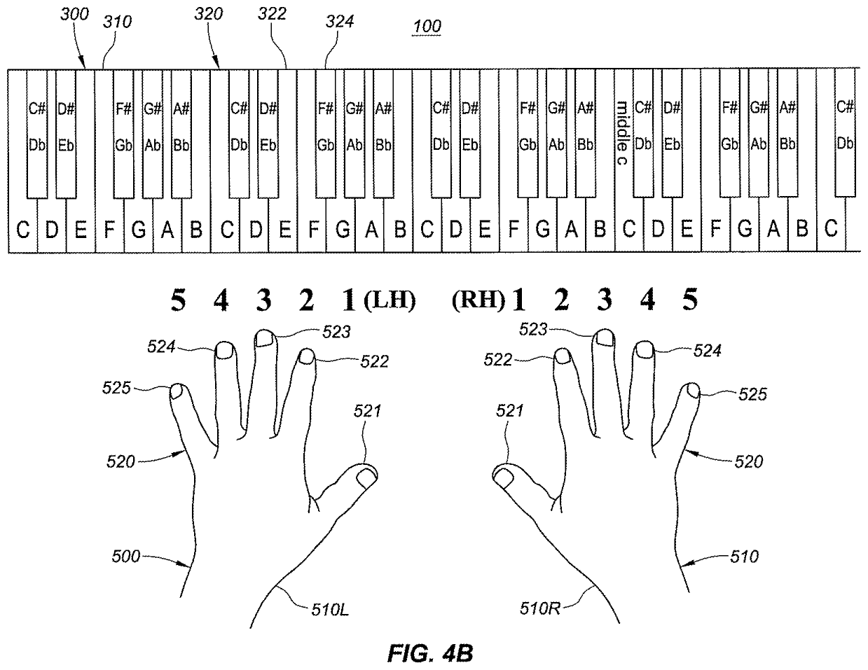

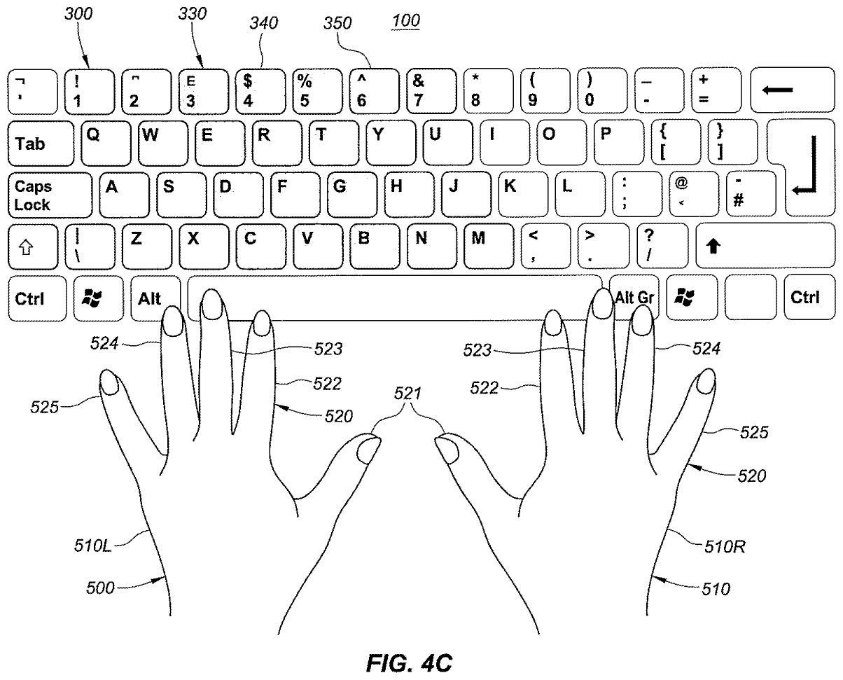

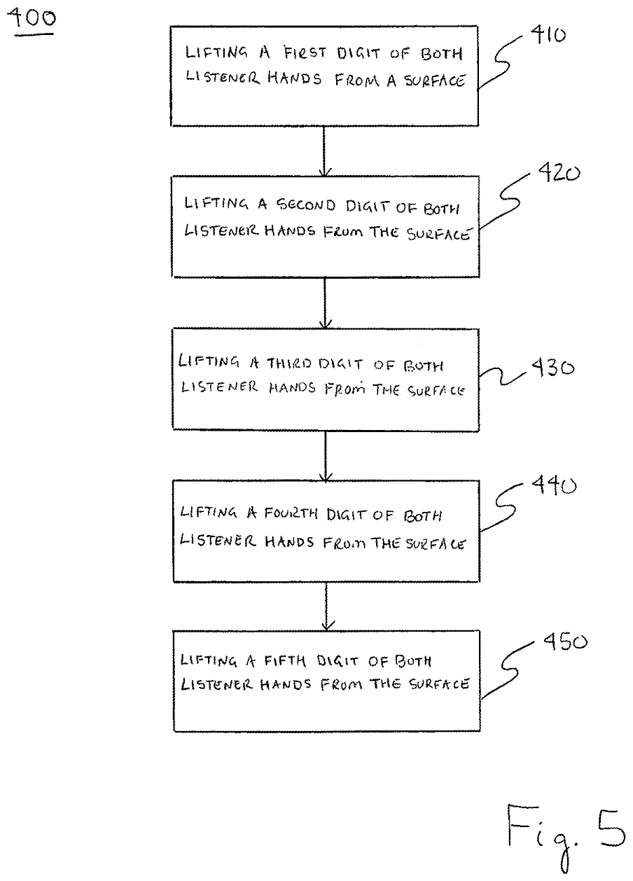

Turning to FIG. 1, the teaching method 100 can be applied to any music composition that includes two or more lines of music and can include presenting a first line 110 of music, at 210, by a demonstrator (not shown), such as a teacher or musician, to a student, a musician, a conductor, a musicologist, an audience member or other listener 500 (shown in FIG. 4A). The first line 110 of music can be presented, at 210, to the listener 500 in any suitable manner. The teaching method 100, for example, can include audibly, visually, tactilely and/or textually presenting the first line 110 of music to the listener 500, without limitation. In selected embodiments, a teacher (not shown) may present the first line 110 of music to a student or other listener 500.

A second line 120 of music likewise can be presented, at 220, to the listener 500. As with the first line 110 of music, the second line 120 of music can be presented, at 220, by the demonstrator to the listener 500 in any suitable manner. The teaching method 100, for example, can include audibly, visually, tactilely and/or textually presenting the second line 120 of music to the listener 500, without limitation. The second line 120 of music can be presented in the same (or similar) manner as the first line 110 of music is presented and/or in a different manner from the manner by which the first line 110 of music is presented. In selected embodiments, a teacher (not shown) may present the second line 120 of music to a student or other listener 500.

At 230, the first line 110 of music and the second line 120 of music both can be presented together (or simultaneously) to the listener 500. The first line 110 of music and the second line 120 of music can be presented, at 230, by the demonstrator to the listener 500 in any suitable manner as set forth herein. The teaching method 100, for example, can include audibly, visually and/or textually presenting the first and second lines of music to the listener 500, without limitation.

In the manner set forth above, the second line 120 of music can be presented in the same (or similar) manner as the first line 110 of music is presented and/or in a different manner from the manner by which the first line 110 of music is presented. In selected embodiments, the first line 110 of music can be presented, at 230, in the same manner by which the first line 110 of music is presented, at 210, and/or the second line 120 of music can be presented, at 230, in the same manner by which the second line 120 of music is presented, at 220. As desired, however, a manner by which the first line 110 of music is presented, at 230, can differ from a manner by which the first line 110 of music is presented, at 210, and/or a manner by which the second line 120 of music is presented, at 230, can differ from a manner by which the second line 120 of music is presented, at 220, as long as the first and second lines 110, 120 move (or proceed) in contrary motion. A teacher (not shown), for example, may present the first and second lines 110, 120 of music to a student or other listener 500.

Although shown and described a setting forth the first and second lines of music in an exemplary sequence for purposes of illustration only, the first and second lines of music can be presented in any suitable sequence, such as with the second line 120 of music being presented, at 220, before the first line 110 of music is presented, at 210. In selected embodiments, the teaching method 100 can include presenting one or more additional lines of music individually and/or together with at least one other line of music. The teaching method 100 advantageously can accustom an ear of the listener 500 to hearing and/or to being able to recognize each line of music individually.

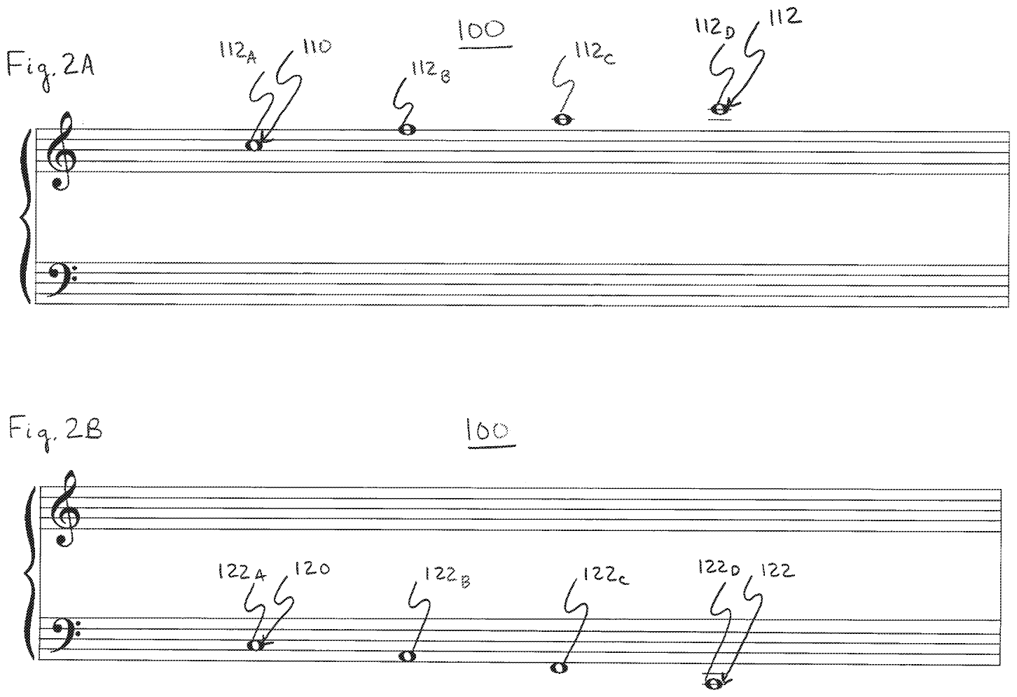

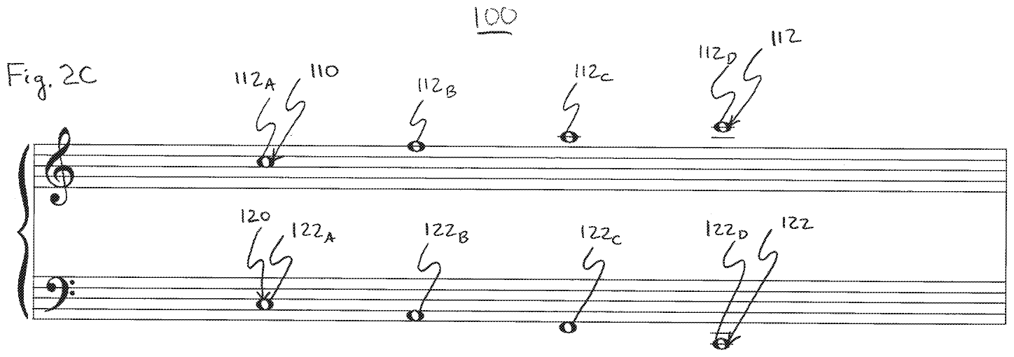

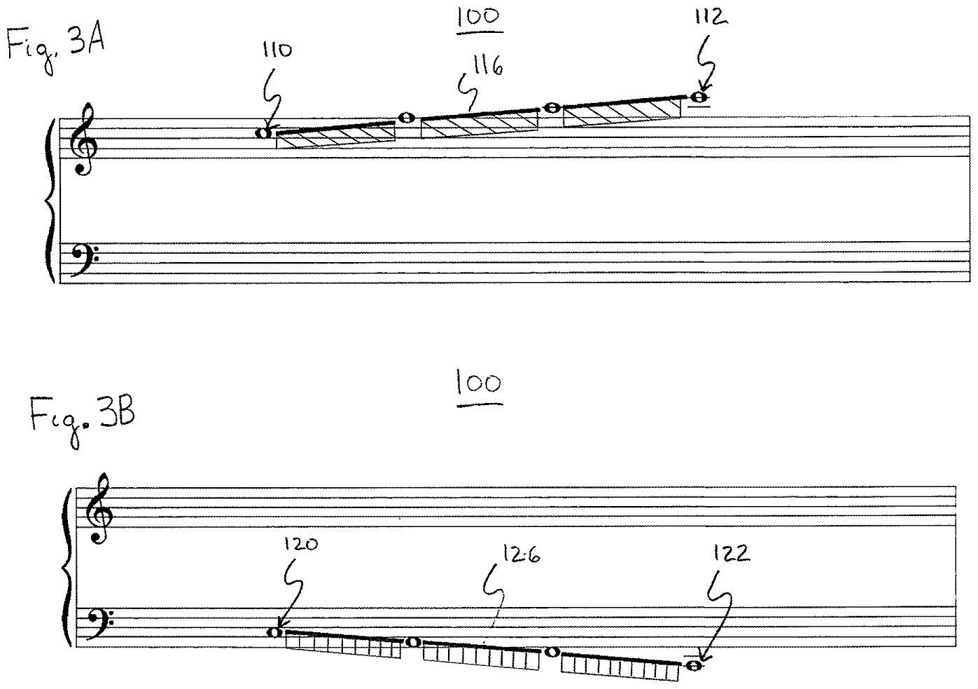

To facilitate a better understanding of the teaching method, exemplary embodiments of the teaching method 100 are shown and described with reference to FIGS. 2A-C. Turning to FIG. 2A, for example, the teaching method 100, at 210 (shown in FIG. 1), can include presentation of a first line 110 of music, such as a melodic line of classical music, with two or more musical notes 112 that ascends in pitch over time. The first ascending line 110 of the music can be presented to a student, a musician, a conductor, a musicologist, an audience member or other listener 500 (shown in FIG. 4A) and/or, as illustrated in FIG. 2A, can include a first series (or sequence) with a first predetermined number of musical notes 112_{A}, 112_{B}, 112_{C}, 112_{D} that ascend in pitch as the first ascending line 110 of the music proceeds. In other words, a first musical note 112_{A} can have a pitch that is lower than a pitch of a second musical note 112_{B}, the second musical note 112_{B}, in turn, can have a pitch that is lower than a pitch of a third musical note 112_{C} and so on.

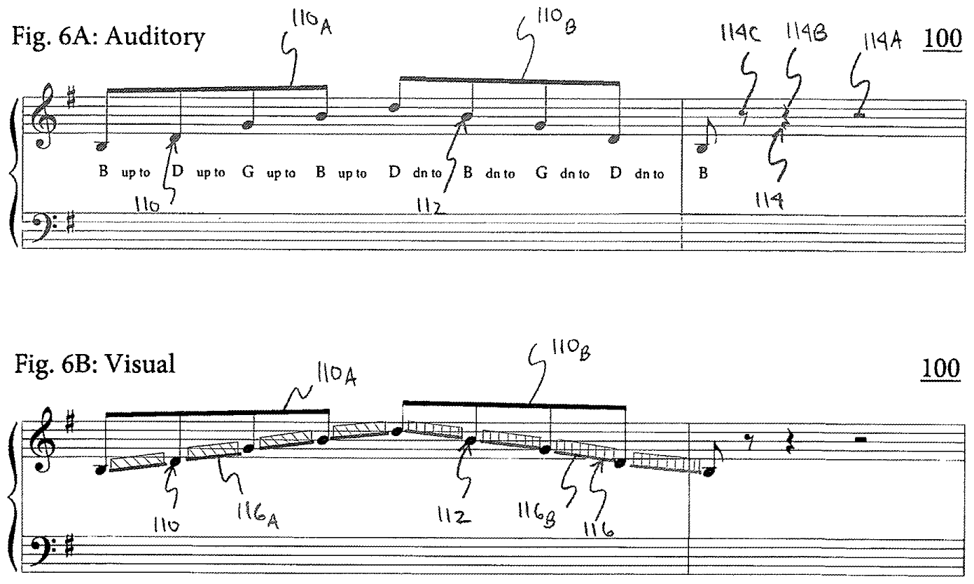

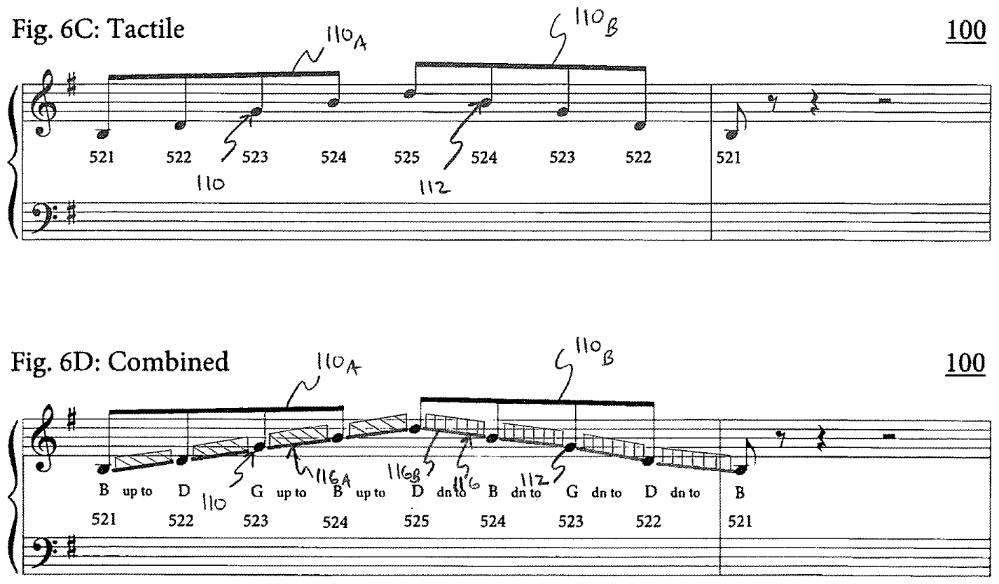

Although shown and described with reference to FIG. 2A as including a first sequence of four uniform musical whole notes 112_{A}, 112_{B}, 112_{C}, 112_{D} in the treble clef for purposes of illustration only, it will be appreciated that the first ascending line 110 of the music can include any first predetermined number of ascending musical notes with any suitable uniform and/or non-uniform duration, can include one or more rests 114 (shown in FIG. 6A) of any suitable duration between adjacent musical notes 112, and/or be associated with the treble or bass clef, without limitation. For example, the musical notes 112 can include, but are not limited to, one or more whole notes, one or more half notes, one or more quarter notes and/or one or more eighth notes; whereas, the rests 114 can include, but are not limited to, one or more whole rests, one or more half rests 114_{A} (shown in FIG. 6A), one or more quarter rests 114_{B} (shown in FIG. 6A) and/or one or more eighth rests 114_{C} (shown in FIG. 6A).

The first line 110 of music, in some embodiments, can include one or more ascending line portions 110_{A} (shown in FIG. 6A), wherein a selected ascending line portion 110_{A} can be adjacent to an intermediate line portion, such as a descending line portion 110_{B} (shown in FIG. 6A) or an unchanging (or steady) line portion (not shown). Additionally and/or alternatively, a selected pair of adjacent ascending line portions 110_{A} can be separated by an intermediate line portion, such as a descending line portion 110_{B} or an unchanging line portion.

The teacher or other demonstrator, for example, may repeatedly play the musical notes 112_{A}, 112_{B}, 112_{C}, 112_{D} in sequence on a keyboard of a musical instrument (shown in FIG. 4B) in an effort to help the student or other listener 500 hear the tones ascending in pitch. The teacher then may play the musical notes 112_{A}, 112_{B}, 112_{C}, 112_{D} on the keyboard backward. By repeatedly playing the musical notes 112_{D}, 112_{C}, 112_{B}, 112_{A} in sequence on the keyboard, the teacher can help the student hear the tones descending in pitch.

The teaching method 100, additionally and/or alternatively, can include presentation of a second line 120 of the music that descends in pitch over time as illustrated in FIG. 2B. In other words, the second line 120 of the music can move in a direction that is that opposite of a direction of the first line 110 of music (shown in FIG. 2A). Like the first line 110 of music, the second line 120, for example, can comprise a melodic line of music such as a melodic line of classical music.

Turning to FIG. 2B, the second descending line 120 of the music can be presented, at 220 (shown in FIG. 1), to the listener 500 (shown in FIG. 4A) and/or can include a second series (or sequence) with a second predetermined number of musical notes 122_{A}, 122_{B}, 122_{C}, 122_{D} that descend in pitch as the second descending line 120 of the music proceeds. Stated somewhat differently, a first musical note 122_{A} can have a pitch that is higher than a pitch of a second musical note 122_{B}, the second musical note 122_{B}, in turn, can have a pitch that is higher than a pitch of a third musical note 122_{C} and so on.

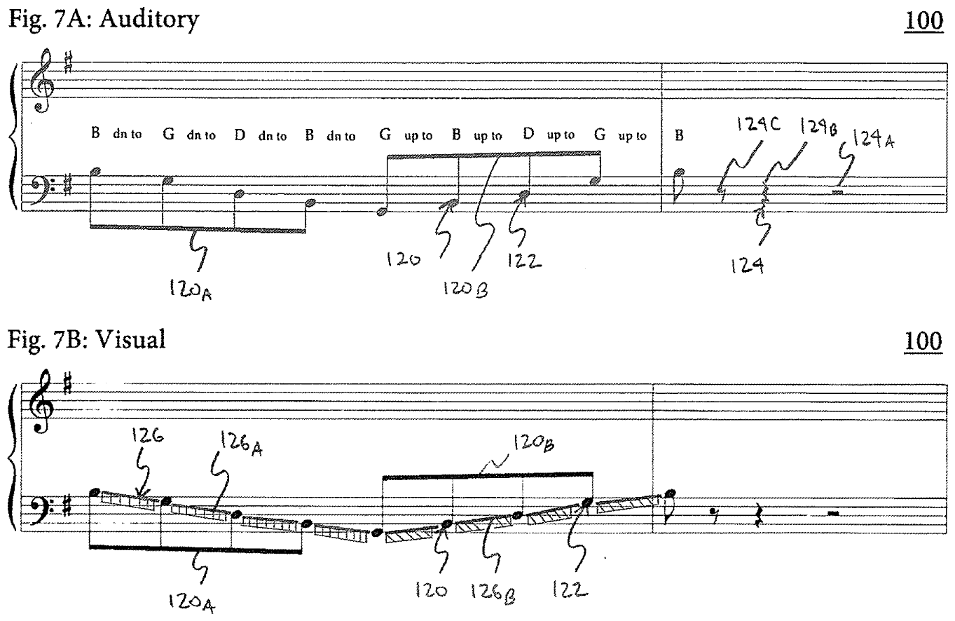

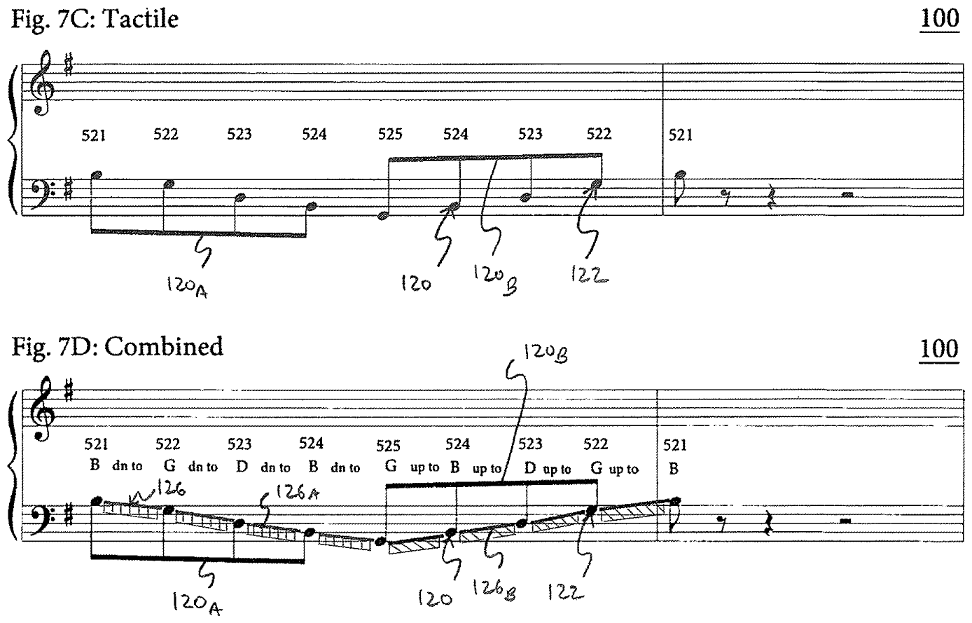

Although shown and described with reference to FIG. 2B as including a second sequence of four uniform musical whole musical notes 122_{A}, 122_{B}, 122_{C}, 122_{D} in the bass clef for purposes of illustration only, it will be appreciated that the second descending line 120 of the music can include any second predetermined number of descending musical notes with any suitable uniform and/or non-uniform duration, can include one or more rests 124 (shown in FIG. 7A) of any suitable duration between adjacent musical notes 122, and/or be associated with the treble or bass clef, without limitation. For example, the musical notes 122 can include, but are not limited to, one or more whole notes, one or more half notes, one or more quarter notes and/or one or more eighth notes; whereas, the rests 124 can include, but are not limited to, one or more whole rests, one or more half rests 124_{A} (shown in FIG. 7A), one or more quarter rests 124_{B} (shown in FIG. 7A) and/or one or more eighth rests 124_{C} (shown in FIG. 7A).

The second line 120 of music, in some embodiments, can include one or more descending line portions 120_{A} (shown in FIG. 7A), wherein a selected descending line portion 120_{A} can be adjacent to an intermediate line portion, such as an ascending line portion 120_{B} (shown in FIG. 7A) or an unchanging line portion. Additionally and/or alternatively, a selected pair of adjacent descending line portions 120_{A} can be separated by an intermediate line portion, such as an ascending line portion 120_{B} (shown in FIG. 7A) or an unchanging line portion.

The teacher or other demonstrator, for example, may repeatedly play the musical notes 122_{A}, 122_{B}, 122_{C}, 122_{D} in sequence on a keyboard of a musical instrument (shown in FIG. 4B) in an effort to help the student or other listener 500 hear the tones descending in pitch. The teacher then may play the musical notes 122_{A}, 122_{B}, 122_{C}, 122_{D} on the keyboard backward. By repeatedly playing the musical notes 122_{D}, 122_{C}, 122_{B}, 122_{A} in sequence on the keyboard, the teacher can help the student hear the tones ascending in pitch.

In selected embodiments, the teaching method 100 can include presentation of the first line 110 of the music that ascends in pitch over time and the second line 120 of the music that descends in pitch over time as shown in FIG. 2C. Stated somewhat differently, the teaching method 100 can simultaneously present the first line 110 of the music and the second line 120 of the music in a manner that advantageously can facilitate understanding of the music through expansion of a compositional technique referred to herein as contrary motion. Contrary motion refers to two or more lines of music that proceed in opposite directions from each other. As the first line 110 of the music moves up (or ascends) in pitch, the second line 120 of the music can move down (or descend) in pitch. In some embodiments, for example, the first line 110 of the music can include a melody line; whereas, the second line 120 of the music can include a bass line.

Turning to FIG. 2C, the first ascending line 110 of the music and the second descending line 120 of the music can be presented, at 230 (shown in FIG. 1), to the listener 500 (shown in FIG. 4A). The first ascending line 110 of the music and the second descending line 120 of the music preferably are simultaneously presented to the listener 500. The first ascending line 110 of the music can include the first sequence of the first predetermined number of the musical notes 112_{A}, 112_{B}, 112_{C}, 112_{D} that ascend in pitch as the first ascending line 110 of the music proceeds in the manner set forth in more detail above with reference to FIG. 2A, and/or the second descending line 120 of the music can include the second sequence of the second predetermined number of the musical notes 122_{A}, 122_{B}, 122_{C}, 122_{D} that descend in pitch as the second descending line 120 of the music proceeds in the manner set forth in more detail above with reference to FIG. 2B.

Although the first ascending line 110 of the music and the second descending line 120 of the music can be provided in any desired manner, the first predetermined number of the musical notes 112_{A}, 112_{B}, 112_{C}, 112_{D} preferably at least partially corresponds with the second sequence of the second predetermined number of the musical notes 122_{A}, 122_{B}, 122_{C}, 122_{D}. FIG. 2C illustrates an exemplary type of correspondence between the musical notes 112_{A}, 112_{B}, 112_{C}, 112_{D} and the musical notes 122_{A}, 122_{B}, 122_{C}, 122_{D}. For example, the first musical note 112_{A} of the first ascending line 110 of the music can correspond with the first musical note 122_{A} of the second descending line 120 of the music.

Additionally and/or alternatively, the second musical note 112_{B} of the first ascending line 110 of the music can correspond with the second musical note 122_{B} of the second descending line 120 of the music, and/or the third musical note 112_{C} of the first ascending line 110 of the music can correspond with the third musical note 122_{C} of the second descending line 120 of the music, and so on. In selected embodiments, a selected musical note of the first ascending line 110 of the music can correspond with two or more musical notes of the second descending line 120 of the music; whereas, a selected musical note of the second descending line 120 of the music can correspond with two or more musical notes of the first ascending line 110 of the music. It is at this challenging juncture of the listener 500 simultaneously hearing of two lines 110, 120 of music that the employing other senses of the listener 500 advantageously can help in the recognizing contrary motion.

The Senses—Use of Multiple Sensory Cues

Hearing and understanding music in contrary motion using the Auditory Sense of hearing is presented in more detail herein with reference to FIGS. 2A and 2B. Although the teaching method 100 can facilitate understanding of the music through the auditory sense of hearing contrary motion, contrary motion itself can be quite complicated and difficult for the listener 500 to recognize. Presenting the first and second lines of music in an audible manner alone may fall short of educating and/or enticing the listener 500. Contrary motion, which occurs when the first ascending line 110 of the music and the second descending line 120 of the music are played or otherwise presented at the same time as illustrated in FIG. 2C, can elude understanding even by musicians who play the music. To help facilitate the understanding of the music by the listener 500, in being able to recognize contrary motion can be augmented and/or otherwise enhanced by incorporating use of one or more other senses of the listener 500. The use of the other senses can provide additional support to the auditory sense and offer one or more reference points to guide the listener 500.

Consider hearing the sound of a warning whistle with our auditory sense that indicates an approaching train. Additionally and/or alternatively, the listener 500 can feel a vibration of the train through the ground, adding depth to the sound of the whistle and/or can see the approaching train. Thereby, auditory, tactile and/or visual cues work together to confirm the knowledge of the approaching train. A phenomenon known as McGurk Effect is described in a paper, entitled “Hearing Lips and Seeing Voices” by Harry McGurk and John MacDonald, published in Nature, pages 264, 746-748, on Dec. 23, 1976. The McGurk Effect states that seeing the mouth movements of another person speaking can influence what you are hearing. The teaching method 100 set forth herein advantageously can support a variety of learning styles that incorporate various sensory stimuli.

Senses to Enhance the Auditory

In selected embodiments, the teaching method 100 can enhance the auditory sense of hearing music via the use of a visual sense of sight, tactile sense of touch and/or the kinesthetic sense of the listener 500. Comprehension of contrary motion in the music may become highlighted, using various cognition skills-pattern recognition, for example. The teaching method 100, in other words, can utilize one or more other sensory cues, such as the visual sense of sight, the tactile sense of touch and/or the kinesthetic sense of movement, to advantageously enable the listener 500 to understand and hear the contrary motion in the music, such as in the often-complex classical genre of music. The teaching method 100 thereby may offer clarification and/or increased enjoyment of the music of the listener 500 by incorporating the use of the other senses in addition to the use of the auditory sense.

Classical music can be perceived as being difficult to appreciate and enjoy precisely due to the absence of other senses to support the auditory sense. It is an accepted premise in neurological findings that the senses collect information and work together to offer a better understanding of the situation at hand. This collaboration of the senses enables one to better understand and enjoy music.

Visual Sense

With regard to the visual sense of sight, for example, some studies have shown that as much as two-thirds of the cerebral cortex is indirectly involved in vision. Several neurological and educational research, for example, indicate that the visual sense generally is stronger and used more often in humans than other senses. Since the visual sense can be more developed than other senses in some listeners 500, the teaching method 100 advantageously can incorporate one or more visual images for heightening the understanding of the contrary motion in music. These visual images can include use of one or more visual indicators, such as text, a symbol, a color, an icon and/or other suitable indicia, without limitation, for enabling the listener 500 to clearly see the general direction of the music without requiring the ability to read music. In other words, formal musical training is not required for understanding the music in accordance with the teaching method 100.

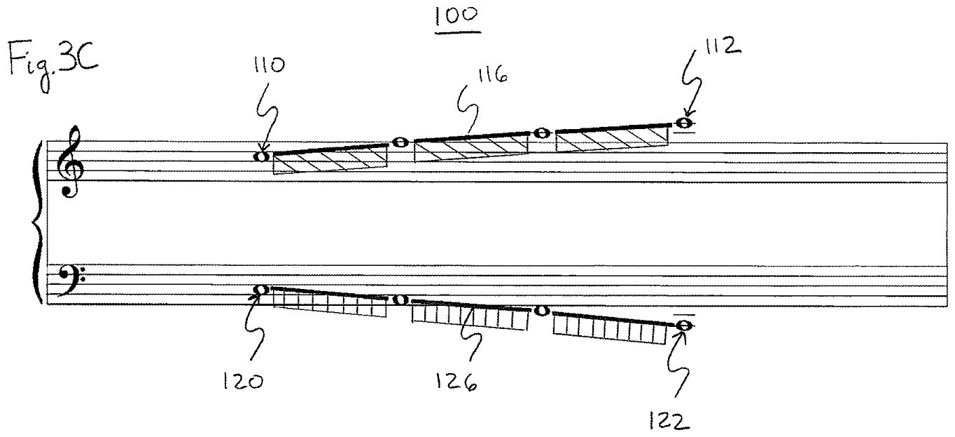

Exemplary visual images for heightening the understanding of the contrary motion in music are shown in FIGS. 3A-C. Turning to FIG. 3A, for example, the teaching method 100 can include a first visual image 116 for visually presenting the first line 110 of music. The first visual image 116, in selected embodiments, can be superimposed upon, disposed adjacent to, or otherwise incorporated into the first line 110 of music and/or can be used to indicate an ascending (or other) direction of the musical notes 112. Stated somewhat differently, the musical notes 112 comprising the first line 110 of music can be presented on a staff (or stave), which can be annotated to include the first visual image 116 as shown in FIG. 3A.

As illustrated in FIG. 3A, for instance, the first line 110 of music of FIG. 2A can be reproduced with the first visual image 116 being incorporated into the first line 110 of music and visually illustrating the ascension of the musical notes 112 via lines, such as green lines, disposed between adjacent musical notes 112. Although shown and described with reference to FIG. 3A as using solid dark lines between adjacent musical notes 112 for purposes of illustration only, the first visual image 116 can visually illustrate the ascension of the musical notes 112 via use of lines of any color, shape, size, format and/or style (such as solid, dotted or dashed) or any other type of suitable visual indicia.

Additionally and/or alternatively, the teaching method 100 can include a second visual image 126 for visually presenting the second line 120 of music as illustrated in FIG. 3B. The second visual image 126, in selected embodiments, can be superimposed upon, disposed adjacent to, or otherwise incorporated into the second line 120 of music and/or can be used to indicate a descending (or other) direction of the musical notes 122. Stated somewhat differently, the musical notes 122 comprising the second line 120 of music can be presented on a staff (or stave), which can be annotated to include the second visual image 126 as shown in FIG. 3B. The first visual image 116 (shown in FIG. 3A) and the second visual image 126 can be provided in an identical, similar and/or different manner. For example, the second line 120 of music of FIG. 2B can be reproduced with the second visual image 126 visually illustrating the descent of the musical notes 122 via lines, such as red lines, disposed between adjacent musical notes 122.

As illustrated in FIG. 3B, for example, the second line 120 of music of FIG. 2B can be reproduced with the second visual image 126 being incorporated into the second line 120 of music and visually illustrating the descent of the musical notes 122 via lines between adjacent musical notes 122. Although shown and described with reference to FIG. 3B as using solid red lines between adjacent musical notes 122 for purposes of illustration only, the second visual image 126 can visually illustrate the descent of the musical notes 122 via use of lines of any color, shape, size, format and/or style (such as solid, dotted or dashed) or any other type of suitable visual indicia. The indicia associated with the second visual image 126 preferably is visually distinguishable from the indicia associated with the first visual image 116.

In selected embodiments, the teaching method 100 can include presentation of the first line 110 of the music that ascends in pitch over time and the second line 120 of the music that descends in pitch over time in the manner set forth in more detail above with reference to the teaching method 100 of FIG. 2C. Turning to FIG. 3C, the teaching method 100 can include the first visual image 116 for visually presenting the first line 110 of music and the second visual image 126 for visually presenting the second line 120 of music. The first visual image 116 and the second visual image 126 thereby can be presented simultaneously.

In selected embodiments, the first visual image 116 can be provided in the manner discussed above with reference to the first visual image 116 of FIG. 3A; whereas, the second visual image 126 can be provided in the manner discussed above with regard to the second visual image 126 of FIG. 3B. The first visual image 116 and the second visual image 126, for example, can be presented in a visually distinguishable manner. The contrary motion in the music thereby can be illustrated via the first and second visual images 116, 126. The first visual image 116 and the second visual image 126 advantageously can help enable the listener 500 (shown in FIG. 4A) to visually see the contrary motion in the music.

As the first and second lines 110, 120 of the music are presented, the listener 500 can follow the first and second visual images 116, 126. The listener 500, for example, can be provided with a copy of the first and second lines 110, 120 of the music with the first and second visual images 116, 126, for example, in the interior of the programming notes of a “playbill” while attending a concert. The listener 500 thereby can visually follow the first and second visual images 116, 126 as the first and second lines 110, 120 of the basic music examples performed. The visual sense can be coordinated and/or confirmed while simultaneously using the tactile sense of tracing with a pencil or pen (or finger), the appropriate ascending or descending line(s) 110, 120 of music as located in the “Playbill” or other program notes.

Tactile Sense

The tactile sense of touch can comprise the sense of touch while moving or using smaller muscle groups. In selected embodiments, the listener 500 can utilize the digits 520 of using a dominant (or other) hand 510 for drawing a line with a pen or pencil (or with their finger) to trace the first and/or second visual images 116, 126, for example. The first and/or second visual images 116, 126, for example, can be traced during performance of the first and/or second lines 110, 120 of the music. Tracing first and/or second visual images 116, 126 advantageously can support and/or confirm the visual sense and can comprise an interactive activity that signifies participation of the listener 500. Stated somewhat differently, any piece of music that moves in contrary motion can be distilled and/or placed in a concert program (or other handout materials) for the audience member to participate by tracing the first and/or second lines 110, 120 of the music, two or more lines of actual classical music, a section of the music, a movement of the music and/or an entire Beethoven symphonic work, without limitation.

For example, the listener 500 might outline with a pen, pencil or even their finger, an existing line-drawing to indicate the direction of music. Tracing or “writing over” an observable figure or line is a familiar and on-going activity in human life, for example, persons applying facial cosmetics, such as lipstick (tracing lips) or using a shaving razor that “traces” outlines facial contours. A person brushing his/his teeth follows the contours of the teeth and can comprise another form of “tracing.”

Tracing can help ingrain the movement of the line 110, 120 of the music in an ascending or descending direction. This noticing of directions and tracing can be applied to any other type of music in contrary motion and is not limited to music in contrary motion.

Kinesthetic Sense

The kinesthetic sense often is considered to be a subset of the Tactile Sense and involves using or moving larger muscle groups also called, “gross muscle groups.” This movement typically involves movement of arms, legs, and torso. A kinesthetic sense (or “proprioception”—awareness of position of limbs), for example, can help the listener 500 further differentiate between the first and second lines 110, 120 of music.

To utilize the kinesthetic sense, the listener 500 can move a right arm (not shown), and/or step slightly forward with a right leg (not shown), as the first line 110 of music is being presented, at 210 (shown in FIG. 1). If the first line 110 comprises an ascending line of music, for instance, the right arm can be incrementally raised as the sequence of musical notes 112 increase in pitch. The listener 500 similarly can raise a left arm (not shown), and/or step slightly forward with a left leg (not shown), as the second line 120 of music is being presented, at 220 (shown in FIG. 1). If the second line 120 comprises a descending line of music, the left arm can be incrementally lowered as the sequence of musical notes 122 decrease in pitch. Additionally and/or alternatively, the listener 500 might employ a traditional crawl swimming stroke, noticing the arms (not shown) moving in opposite directions as another model that involves contrary motion. The listener 500 thereby can utilize the kinesthetic sense to appreciate the first and second lines 110, 120 of music and better understand the contrary motion.

The listener 500 might notice using multisensory cues in myriad of different ways. A non-musical example of contrary motion, the listener 500 could be riding in an elevator (not shown). The vestibular system, another sense located in the inner ear, allows us to know that the elevator is moving upwardly or downwardly, even with eyes closed. The listener 500 also can hear a sound of an elevator chime that indicates an approaching floor in a building (not shown). Additionally and/or alternatively, the listener 500 can feel a vibration of the elevator as the elevator moves between floors of the building. This movement adds depth to the sound of the chime. Furthermore, there is a visual indicator in the elevator for identifying the approaching floor of the building.

Distance

The ability to judge distance, or the ability to estimate the relative space between objects, is an innate part of the neurological makeup of human beings. Human beings use this well-honed skill continuously in virtually every human activity. The attribute of “distance” can be included in selected embodiments of the teaching system and method 100 to provide further clarification and additional distinction in noticing contrary motion in music. Contrary motion can include being able recognize expansion and contraction of musical tones. The listener 500 can notice direction through hearing, seeing, or touching.

For example, the visual and auditory senses, employed individually or in combination, can help human beings to judge distance. Similarly, noticing the visual distance of the printed music notes coupled with hearing the auditory distances between two or more tones in music may enhance the listener 500 to recognize contrary motion. When “seeing” dark storm clouds gathering, the listener 500 might be affected by the “feel,” the tactile sense, of the atmospheric pressure and/or the “smell,” the olfactory sense, of the moisture laden air while “listening” to the loud rumble and clapping of thunder, interspersed with flashes of lightning. During the storm, the listener 500 can hear, see and feel the rain.

Additionally and/or alternatively, the listener 500 can notice the difference between “loud” and “soft.” The listener 500, for instance, can “hear” if the loud or soft sound, whether continuous or syncopated, is approaching or receding. For example, footsteps approaching up the stairs can sound gradually louder as the footsteps approach and becoming more proximal to the listener 500. When leaving, the footsteps can sound gradually softer going down the stairs and otherwise becoming more distant from the listener 500.

Background of Distance, Spatial Awareness and its Relevance to the Teaching Method

The “sense” of distance, or spatial awareness, also known as “auditory spatial perception,” has developed over millions of years in mammals and is integral to the evolution of many biological species on this planet. The phenomenon of “hearing and seeing distance” is intrinsic mammals. Mammals have sharpened their spatial awareness skills throughout evolution, for 178 million years—judging the distance between near and far objects. Before descending from the trees and developing into Homo sapiens (human beings), our ancestors judged distances between branches of trees in order to jump, leap or swing from one to another. Over time the continuous practice of these instantaneous calculations, human beings developed an expert sense of special awareness.

Mammals saw and heard the sounds of their tribes and/or sounds of birds, animals, and insects that may have inhabited the same tree or nearby tree(s). In this way, a mammal could determine the location of a tribe member, prey or predator, relative to its position by sound, vision or both. The location could be determined, by using their auditory and visual senses to know whether the location was lower or higher, in back or in front, on the right or left side, etc. Evolutionary progress enabled later generations to move into caves or other forms of shelter; while, at the same time, visual and auditory faculties remained vigilantly intact.

The amygdala, the oldest part of the brain, governs the fight or flight response, in reaction to a threat or perceived danger. A basic survival skill, employing the spatial sense of judging distance, and the fight or flight response remains active in current day living.

Mammals became experts at visual and auditory senses that work in tandem as a measurement of distance.

The ability to utilize the sense of distance, or spatial awareness is innate and well developed in humans. The sense of distance can also be enhanced or further developed through the external influence of a teacher. This is common practice in learning to operate a vehicle, or playing recreational ball. When sitting next to someone, the speaking tone is different as when speaking to a person who is twenty feet away.

Distance in contemporary life is measured in inches/millimeters or miles/light years. Instruments observe the distance of a star; for example, Icarus, which is nine billion light years from planet Earth. Conversely, microchip technology stores information and powers cell phones and computers that are tiny in comparison. In typography, letters, numbers or symbols might be placed within a sixteenth of an inch of each other. Yet, people might drive five miles to work. This current teaching method makes use of the well-honed skill of distance/spatial awareness.

Additionally and/or alternatively, the teaching method 100 can enhance listener 500 comprehension of contrary motion in the music via the tactile sense of touch of the listener 500. FIG. 4A illustrates an exemplary embodiment of the teaching method 100, wherein a surface 300 can be utilized to present one or more of the lines 110, 120 of music via a tactile sense of touch and the “sense” of distance, or spatial awareness. In selected embodiments, the surface 300 can comprise a flat (or planar) surface, such as a table, a keyboard of a musical instrument (shown in FIG. 4B), such as a piano, keyboard or organ, and/or an image of the musical instrument keyboard, without limitation. The listener 500 can interact with the surface 300 via one or both hands 510 of the listener 500.

The listener 500, for example, can place both hands 510 on the surface 300. As shown in FIG. 4A, for instance, both of the hands 510 can be placed on the surface 300 with the left hand 510L being disposed at a predetermined distance, such as one inch, from the right hand 510R. When the hands 510 are placed on the surface 300, the digits 520 of each hand 510 can be rounded, curved and/or straight.

In selected embodiments, the digits 520 of each hand 510 can be respectively assigned or otherwise associated with a preselected number. A thumb 521 of each hand 510, more specifically, can be associated with a first preselected number, an index finger 522 of each hand 510 can be associated with a second preselected number, a middle finger 523 of each hand 510 can be associated with a third preselected number, a ring finger 524 of each hand 510 can be associated with a fourth preselected number, a little finger (or pinkie) 525 of each hand 510 can be associated with a fifth preselected number. For example, each thumb 521 can be associated with a number 1, each index finger 522 can be associated with a number 2, each middle finger 523 can be associated with a number 3, each ring finger 524 can be associated with a number 4 and/or each little finger 525 can be associated with a number 5.

Turning to FIG. 4B, the surface 300 is shown as including a musical keyboard 310 of a musical instrument, a typewriter 330 (shown in FIG. 4C) or any other conventional device. Exemplary musical instruments can include a piano, keyboard or organ, without limitation. The musical keyboard 310 can include a predetermined number of keys 320 in a preselected arrangement. In selected embodiments, the musical keyboard 310 can include any predetermined number of keys 310, such as twenty-five, thirty-seven, forty-four, forty-nine, sixty-one, seventy-two, traditional eighty-eight keys, other numbers of keys such as the fifty-note keyboard of 310. The arrangement of keys 320 can comprise twelve notes that are repeated over and over again within a specific pattern, without limitation. The musical keyboard 310 of FIG. 4B, for example, is illustrated as including seven white keys 322 and five black keys 423 in each keyboard octave. The white keys 322 can comprise the seven natural notes of a selected octave; whereas, the black keys 324 can comprise the five half-tone or “sharps and flats” notes of the selected C major scale.

The listener 500, for example, can place one or both hands 510 on the musical keyboard 310. As shown in FIG. 4B, for instance, the hands 510 of the listener 500 can be placed on the musical keyboard 310 with the left hand 510L being disposed at a predetermined distance, such as nine inches, from the right hand 510R, notice the “sense” of distance, or spatial awareness. When the hands 510 are placed on the musical keyboard 310, the digits 520 of each hand 510 can be rounded, curved and/or straight and/or can be placed upon respective keys 320 of the musical keyboard 310. Stated somewhat differently, one or more digits 520 of the left hand 510L of the listener 500 can be placed upon a first set of respective keys 320 of the musical keyboard 310, and/or one or more digits 520 of the right hand 510R of the listener 500 can be placed upon a second set of respective keys 320 of the musical keyboard 310 as illustrated in FIG. 4B. The listener 500 thereby can lower one or more selected digits 520 for activating the relevant key(s) 320 of the musical keyboard 310 to produce at least one audible note.

FIG. 5 shows an exemplary teaching method 400 for utilizing the sense of touch (or “fingering” in piano terms) to facilitate understanding of the music through expansion of contrary motion. The listener 500 can utilize the teaching method 400 on his own and/or at the instruction of a teacher, a musician, a conductor, a musicologist, or other individual (not shown). In selected embodiments, the listener 500 can begin (or can be instructed to begin) with the digits 520 of both hands 510 in a rest position in contact with the surface 300 in the manner illustrated in FIG. 4A.

The listener 500 can reposition (or can be instructed to reposition) each digit of 520 of both hands 510 relative to the surface 300. As shown in FIG. 5, for example, the listener 500 can lift (or can be instructed to lift) a first digit 520 of both hands 510 from (or above) the surface 300, at 410. The first digits 520, in other words, can be lifted from the rest position to a lifted position. The listener 500 preferably can lift both of the first digits 520 simultaneously to a first predetermined elevation (or distance) from the surface 300 with the unlifted other digits 520 remaining in the rest position and being in contact with the surface 300. For example, the thumbs 521 of both hands 510 can be lifted, at 410, to the first predetermined elevation, such as an elevation of one inch, from the surface 300. In selected embodiments, the lifted first digits 520 can be maintained in the lifted position for a first predetermined duration of time and, after the first predetermined time duration expires, can be lowered to the rest position and again contact the surface 300.

At 420, the listener 500 can lift (or can be instructed to lift) a second digit 520 of both hands 510 from (or above) the surface 300. The second digits 520, in other words, can be lifted from the rest position to a lifted position. The listener 500 preferably can lift both of the second digits 520 simultaneously to a second predetermined elevation (or distance) from the surface 300 with the unlifted other digits 520 remaining in the rest position and being in contact with the surface 300. For example, the index fingers 522 of both hands 510 can be lifted, at 420, to the second predetermined elevation, such as an elevation of one inch, from the surface 300. In selected embodiments, the lifted second digits 520 can be maintained in the lifted position for a second predetermined duration of time and, after the second predetermined time duration expires, can be lowered to the rest position and again contact the surface 300.

The listener 500 can lift (or can be instructed to lift) a third digit 520 of both hands 510 from (or above) the surface 300, at 430. The third digits 520, in other words, can be lifted from the rest position to a lifted position. The listener 500 preferably can lift both of the third digits 520 simultaneously to a third predetermined elevation (or distance) from the surface 300 with the unlifted other digits 520 remaining in the rest position and being in contact with the surface 300. For example, the middle fingers 523 of both hands 510 can be lifted, at 430, to the third predetermined elevation, such as an elevation of one inch, from the surface 300. In selected embodiments, the lifted third digits 520 can be maintained in the lifted position for a third predetermined duration of time and, after the third predetermined time duration expires, can be lowered to the rest position and again contact the surface 300.

At 440, the listener 500 can lift (or can be instructed to lift) a fourth digit 520 of both hands 510 from (or above) the surface 300. The fourth digits 520, in other words, can be lifted from the rest position to a lifted position. The listener 500 preferably can lift both of the fourth digits 520 simultaneously to a fourth predetermined elevation (or distance) from the surface 300 with the unlifted other digits 520 remaining in the rest position and being in contact with the surface 300. For example, the ring fingers 524 of both hands 510 can be lifted, at 440, to the fourth predetermined elevation, such as an elevation of one inch, from the surface 300. In selected embodiments, the lifted fourth digits 520 can be maintained in the lifted position for a fourth predetermined duration of time and, after the fourth predetermined time duration expires, can be lowered to the rest position and again contact the surface 300.

The listener 500 can lift (or can be instructed to lift) a fifth digit 520 of both hands 510 from (or above) the surface 300, at 450. The fifth digits 520, in other words, can be lifted from the rest position to a lifted position. The listener 500 preferably can lift both of the fifth digits 520 simultaneously to a fifth predetermined elevation (or distance) from the surface 300 with the unlifted other digits 520 remaining in the rest position and being in contact with the surface 300. For example, the little fingers 525 of both hands 510 can be lifted, at 450, to the fifth predetermined elevation, such as an elevation of one inch, from the surface 300. In selected embodiments, the lifted fifth digits 520 can be maintained in the lifted position for a fifth predetermined duration of time and, after the fifth predetermined time duration expires, can be lowered to the rest position and again contact the surface 300.

The teaching method 400, for example, can comprise a first sequence of the listener 500 lifting the thumbs 521 of both hands 510 from the surface 300 for the first predetermined duration, at 410, lifting the index fingers 522 of both hands 510 from the surface 300 for the second predetermined duration, at 420, lifting the middle fingers 523 of both hands 510 from the surface 300 for the third predetermined duration, at 430, lifting the ring fingers 524 of both hands 510 from the surface 300 for the fourth predetermined duration, at 440, and lifting the little fingers 525 of both hands 510 from the surface 300 for the second predetermined duration, at 450.

Additionally and/or alternatively, the teaching method 400 can comprise a second sequence of the listener 500 lifting the little fingers 525 of both hands 510 from the surface 300 for the first predetermined duration, at 410, lifting the ring fingers 524 of both hands 510 from the surface 300 for the second predetermined duration, at 420, lifting the middle fingers 523 of both hands 510 from the surface 300 for the third predetermined duration, at 430, lifting the index fingers 522 of both hands 510 from the surface 300 for the fourth predetermined duration, at 440, and lifting the thumbs 521 of both hands 510 from the surface 300 for the second predetermined duration, at 450. In selected embodiments, the teaching method 400 can include repeating the first exemplary sequence above, repeating the second exemplary sequence above, and/or the second exemplary sequence above can be performed between adjacent instances of the first exemplary sequence above.

The first predetermined elevation, the second predetermined elevation, the third predetermined elevation, the fourth predetermined elevation and the fifth predetermined elevation can be uniform and/or different among the digits 520. Some digits 520 of the listener 500, for example, can be more easily raised than other digits 520. Additionally and/or alternatively, the first predetermined duration, the second predetermined duration, the third predetermined duration, the fourth predetermined duration and the fifth predetermined duration can be uniform and/or different among the digits 520. In selected embodiments, a selected predetermined duration can be based at least in part on a duration of a corresponding musical note 112 (shown in FIG. 2A) and/or rest 114 (shown in FIG. 6A) associated with the relevant digit 520 of the hand 510.

Although described with reference to FIG. 5 as corresponding with the thumb 521, index finger 522, middle finger 523, ring finger 524 and little finger 525, respectively, for purposes of illustration only, the first, second, third, fourth and fifth digits 520 can be associated with any finger (or thumb) of the hand 510 of the listener 500 in any sequence. In some embodiments, for example, two or more of the first, second, third, fourth and fifth digits 520 can be associated with the same finger (or thumb) of the hand 510, and/or the first, second, third, fourth and fifth digits 520 optionally can be lifted in any predetermined sequence and/or preselected number of times.

Although shown and described with reference to FIGS. 4A and 5 as utilizing the surface 300 for purposes of illustration only, other musical instruments can be represented by the right and left hands 510. In other words, any combination of two or more instruments can be used to achieve the contrary motion. For example, in an orchestra, a violin (or a violin line) may be considered the equivalent of the right hand 510R; whereas, another instrument, such as a cello (or a cello line) may be considered as the equivalent of the left hand 510L.

Although shown and described with reference to FIGS. 4A and 5 as including lifting (or instruction to lift) a respective digit 520 for purposes of illustration only, the listener 500 can reposition (or can be instructed to reposition) each digit of 520 of both hands 510 relative to the surface 300 in any suitable manner. If the surface 300 includes the musical keyboard 310 as set forth herein with reference to FIG. 4B, for example, the listener 500 can lower (or can be instructed to lower) each digit of 520 of both hands 510 relative to the musical keyboard 310. The listener 500 thereby can lower one or more selected digits 520 for activating the relevant key(s) 320 of the musical keyboard 310 to produce at least one audible note.

The listener 500 can place (or can be instructed to place) one or both hands 510 on the musical keyboard 310. With reference to FIGS. 4B and 5, for example, the listener 500 can lower (or can be instructed to lower) a first digit 520, such as the thumb 521, of both hands 510 to depress or otherwise activate the relevant key(s) 320 of the musical keyboard 310 for producing at least one audible note. The listener 500 preferably can lower both of the first digits 520 simultaneously with the unlowered other digits 520 remaining in the rest position and being in contact with the musical keyboard 310.

In selected embodiments, the lowered first digits 520 can be maintained in the lowered position for a first predetermined duration of time and, after the first predetermined time duration expires, can be raised back to the rest position and again contact the surface of the musical keyboard 310. Stated somewhat differently, the listener 500 can lower (or can be instructed to lower) a first digit 520, such as the thumb 521, of both hands 510 to depress or otherwise activate the relevant key(s) 320 of the musical keyboard 310 for producing audible notes with both hands 510. For example, the thumb 521 of the right hand 510R can play the note C, corresponding to the musical keyboard 310 shown in FIG. 4B. The thumb 521 of the left hand 510L can play the note G, corresponding to the musical keyboard 310 shown in FIG. 4B.

Additionally and/or alternatively, the listener 500 can lower (or can be instructed to lower) a second digit 520, such as the index finger 522, of both hands 510 to depress or otherwise activate the relevant key(s) 320 of the musical keyboard 310 for producing at least one second audible note. The listener 500 preferably can lower both of the second digits 520 simultaneously with the unlowered other digits 520 remaining in the rest position and being in contact with the musical keyboard 310. In selected embodiments, the lowered second digits 520 can be maintained in the lowered position for a second predetermined duration of time and, after the second predetermined time duration expires, can be raised back to the rest position and again contact the surface of the musical keyboard 310.

Stated somewhat differently, the listener 500 can lower (or can be instructed to lower) a second digit 520, such as the index finger 522, of both hands 510 to depress or otherwise activate the relevant key(s) 320 of the musical keyboard 310 for producing audible notes with both hands 510. For example, the index finger 522 of the right hand 510R can play the note D, corresponding to the musical keyboard 310 shown in FIG. 4B; whereas, the index finger 521 of the left hand 510L can play the note F, corresponding to the musical keyboard 310 illustrated in FIG. 4B. In this particular example, the note played by the index finger 522 of the right hand 510R ascends in pitch from the previous note played by the thumb 521 of the right hand 510R. The note played by the index finger 522 of the left hand 510L, in contrast, descends in pitch from the previous note played by the thumb 521 of the left hand 510L.

The listener 500 can lower (or can be instructed to lower) a third digit 520, such as the middle finger 523, of both hands 510 to depress or otherwise activate the relevant key(s) 320 of the musical keyboard 310 for producing at least one third audible note. The listener 500 preferably can lower both of the third digits 520 simultaneously with the unlowered other digits 520 remaining in the rest position and being in contact with the musical keyboard 310. In selected embodiments, the lowered third digits 520 can be maintained in the lowered position for a third predetermined duration of time and, after the third predetermined time duration expires, can be raised back to the rest position and again contact the surface of musical keyboard 310. Stated somewhat differently, the listener 500 can lower (or can be instructed to lower) a third digit 520, such as the middle finger 523, of both hands 510 to depress or otherwise activate the relevant key(s) 320 of the musical keyboard 310 for producing audible notes with both hands 510.

For example, the middle finger 523 of the right hand 510R can play the note E, corresponding to the musical keyboard 310 shown in FIG. 4B. The middle finger 523 of the left hand 510L can play the note E, corresponding to the musical keyboard 310 shown in FIG. 4B. In this particular example, the note played by the middle finger 523 of the right hand 510R ascends in pitch from the previous note played by the index finger 522 of the right hand 510R. The note played by the middle finger 523 of the left hand 510L, in contrast, descends in pitch from the previous note played by the index finger 522 of the left hand 510L.

The listener 500 can lower (or can be instructed to lower) a fourth digit 520, such as the ring finger 524, of both hands 510 to depress or otherwise activate the relevant key(s) 320 of the musical keyboard 310 for producing at least one fourth audible note. The listener 500 preferably can lower both of the fourth digits 520 simultaneously with the unlowered other digits 520 remaining in the rest position and being in contact with the musical keyboard 310. In selected embodiments, the lowered fourth digits 520 can be maintained in the lowered position for a fourth predetermined duration of time and, after the fourth predetermined time duration expires, can be raised back to the rest position and again contact the surface of musical keyboard 310.

Stated somewhat differently, the listener 500 can lower (or can be instructed to lower) a fourth digit 520, such as the ring finger 524, of both hands 510 to depress or otherwise activate the relevant key(s) 320 of the musical keyboard 310 for producing audible notes with both hands 510. For example, the ring finger 524 of the right hand 510R can play the note F, corresponding to the musical keyboard 310 shown in FIG. 4B. The ring finger 524 of the left hand 510L can play the note D, corresponding to the musical keyboard 310 shown in FIG. 4B. In this particular example, the note played by the ring finger 524 of the right hand 510R ascends in pitch from the previous note played by the middle finger 523 of the right hand 510R. The note played by the ring finger 524 of the left hand 510L, in contrast, descends in pitch from the previous note played by the middle finger 523 of the left hand 510L.

The listener 500 can lower (or can be instructed to lower) a fifth digit 520, such as the little finger 525, of both hands 510 to depress or otherwise activate the relevant key(s) 320 of the musical keyboard 310 for producing at least one fifth audible note. The listener 500 preferably can lower both of the fifth digits 520 simultaneously with the unlowered other digits 520 remaining in the rest position and being in contact with the musical keyboard 310.

In selected embodiments, the lowered fifth digits 520 can be maintained in the lowered position for a fifth predetermined duration of time and, after the fifth predetermined time duration expires, can be raised back to the rest position and again contact the surface of musical keyboard 310. Stated somewhat differently, the listener 500 can lower (or can be instructed to lower) a fifth digit 520, such as the little finger 525, of both hands 510 to depress or otherwise activate the relevant key(s) 320 of the musical keyboard 310 for producing audible notes with both hands 510. For example, the little finger 525 of the right hand 510R can play the note G, corresponding to the musical keyboard 310 shown in FIG. 4B.

The little finger 525 of the left hand 510L can play the note C, corresponding to the musical keyboard 310 shown in FIG. 4B. In this particular example, the note played by the little finger 525 of the right hand 510R ascends in pitch from the previous note played by the ring finger 524 of the right hand 510R. The note played by the little finger 525 of the left hand 510L, in contrast, descends in pitch from the previous note played by the ring finger 524 of the left hand 510L.

The teaching method 400, for example, can comprise a first sequence of the listener 500 lowering the thumbs 521 of both hands 510 from the musical keyboard 310 for the first predetermined duration, lowering the index fingers 522 of both hands 510 from the musical keyboard 310 for the second predetermined duration, lowering the middle fingers 523 of both hands 510 from the musical keyboard 310 for the third predetermined duration, lowering the ring fingers 524 of both hands 510 from the musical keyboard 310 for the fourth predetermined duration and lowering the little fingers 525 of both hands 510 from the musical keyboard 310 for the second predetermined duration. In accordance with the first sequence, the relevant key(s) 320 of the musical keyboard 310 can be activated by the sequential lowering of the digits 520 of the hands 510 to produce the respective first, second, third, fourth and fifth audible notes.

Additionally and/or alternatively, the teaching method 400 can comprise a second sequence of the listener 500 lowering the little fingers 525 of both hands 510 from the musical keyboard 310 for the first predetermined duration, lowering the ring fingers 524 of both hands 510 from the musical keyboard 310 for the second predetermined duration, lowering the middle fingers 523 of both hands 510 from the musical keyboard 310 for the third predetermined duration, lowering the index fingers 522 of both hands 510 from the musical keyboard 310 for the fourth predetermined duration and lowering the thumbs 521 of both hands 510 from the musical keyboard 310 for the second predetermined duration. In accordance with the second sequence, the relevant key(s) 320 of the musical keyboard 310 can be activated by the sequential lowering of the digits 520 of the hands 510 to produce the respective first, second, third, fourth and fifth audible notes. In selected embodiments, the teaching method 400 can include repeating the first exemplary sequence above, repeating the second exemplary sequence above, and/or the second exemplary sequence above can be performed between adjacent instances of the first exemplary sequence above.

In the manner discussed in more detail above with reference to FIG. 1, the teaching method 100 can include presenting the first line 110 of music, at 210, to the listener 500 (shown in FIG. 4A). The first line 110 of music can be presented to the listener 500 in any conventional manner, such as in an audible manner, a visual manner, and/or a tactile manner, without limitation. Stated somewhat differently, the first line 110 of music can be audibly, visually and/or tactilely presented to the listener 500.

Additionally and/or alternatively, to further absorb contrary motion, the listener 500 can utilize a pattern where contrary motion is used in the fingers 520. In piano parlance, a selected “fingering” sequence of both hands 510 can use any sequence of the thumb 521, the index finger 522, the middle finger 523, the ring finger 524 and/or the little finger 525 in any predetermined progression, including predetermined progressions in which a selected first digit is included more than once and/or predetermined progressions in which a selected second digit is not included in the predetermined progression. For example, a selected “fingering” sequence of both hands 510 can comprise the thumb 521, the middle finger 523, the index finger 522, the ring finger 524, the middle finger 523 again, the little finger 525, etc. Variations of the fingering are not limited to the above example. As long as contrary motion is achieved, the same finger, such as the middle finger 523, for example, can be used in both hands 510L, 510R. Respective fingering sequences in both hands 510 preferably should match in selected embodiments.

FIG. 4C illustrates another alternative exemplary embodiment of the teaching method 100, wherein a typing keyboard 340 of a typewriter 330, computer or other conventional system with a “QWERTY” typing keyboard (designed in the 1870s, the name comes from the top left row of the keyboard) can be utilized to achieve a tactile touch of contrary motion with what is known as “fine motor skills” (the use of smaller muscle groups such as fingers and hands), often called, “muscle memory.” Stated somewhat differently, the typing keyboard 340 can be used to track or simulate the movement of one or more of the lines 110, 120 (shown in FIGS. 3A-C) of music via the tactile sense. The typing keyboard 340 can include a predetermined number of keys 350 in a preselected arrangement. In selected embodiments, the typing keyboard 340 can comprise an image of the typing keyboard 340, without limitation. The listener 500 can interact with the typing keyboard 340 via one or both hands 510 of the listener 500.

The listener 500, for example, can place (or can be instructed to place) one or both hands 510 on the typing keyboard 340. As shown in FIG. 4C, for instance, the hands 510 of the listener 500 can be placed on the typing keyboard 340 with the left hand 510L being disposed at a predetermined distance, such as approximately one inch, from the right hand 510R. When the hands 510 are placed on the typing keyboard 340, the digits 520 of each hand 510 can be rounded, curved and/or straight and/or can be placed upon respective keys 350 of the typing keyboard 340. Stated somewhat differently, one or more digits 520 of the left hand 510L of the listener 500 can be placed upon a first set of respective keys 350 of the typing keyboard 340, and/or one or more digits 520 of the right hand 510R of the listener 500 can be placed upon a second set of respective keys 350 of the typing keyboard 340 as illustrated in FIG. 4C. The listener 500 thereby can lower one or more selected digits 520 for activating the relevant key(s) 350 of the typing keyboard 340 to track or simulate the movement of one or more ascending and/or descending notes of the lines 110, 120 of music.

In the manner discussed in more detail above with reference to FIG. 1, the teaching method 100 can include presenting the first line 110 of music, at 210, presenting the second line 120 of music, at 220, and/or presenting the first and second lines 110, 120 of music, at 230, to the listener 500. The listener 500 can track or simulate the movement (or can be instructed to track/simulate) one or more ascending and/or descending notes of the lines 110, 120 of music by pressing and/or releasing one or more corresponding keys 350 of the typing keyboard 340.

With reference to FIG. 4C, for example, the listener 500 can lower (or can be instructed to lower) a first digit 520, such as the index finger 522, of both hands 510 to depress or otherwise activate the relevant key(s) 350 of the typing keyboard 340 corresponding with the first notes of the first line 110 and the second line 120. The listener 500 preferably can lower both of the first digits 520 simultaneously with the unlowered other digits 520 remaining in the rest position and being in contact with the typing keyboard 340.

In selected embodiments, the lowered first digits 520 can be maintained in the lowered position for a first predetermined duration of time and, after the first predetermined time duration expires, can be moved back to the traditional typing position and again contact the surface of the typing keyboard 340. In other words, the listener 500 can lower (or can be instructed to lower) a first digit 520, such as the index finger 522, of both hands 510 to depress or otherwise activate the relevant key(s) 350 of the typing keyboard 340. For example, the index finger 522 of the right hand 510R can depress the “J” key of the typing keyboard 340 shown in FIG. 4C while the index finger 522 of the left hand 510L can depress the “F” key of the typing keyboard 340 shown in FIG. 4C corresponding with the first notes of the first line 110 and the second line 120.

Additionally and/or alternatively, the listener 500 can lower (or can be instructed to lower) a second digit 520, such as the middle finger 523, of both hands 510 to depress or otherwise activate the relevant key(s) 350 of the typing keyboard 340 corresponding with the second notes of the first line 110 and the second line 120. The listener 500 preferably can lower both of the second digits 520 simultaneously with the unlowered other digits 520 remaining in the rest position and being in contact with the typing keyboard 340. In selected embodiments, the lowered second digits 520 can be maintained in the lowered position for a second predetermined duration of time and, after the second predetermined time duration expires, can be moved back to the traditional typing position and again contact the surface of the typing keyboard 340.

Stated somewhat differently, the listener 500 can lower (or can be instructed to lower) the second digit 520 of both hands 510 to depress or otherwise activate the relevant key(s) 350 of the typing keyboard 340. For example, the middle finger 523 of the right hand 510R can depress the “K” key of the typing keyboard 340 shown in FIG. 4C while the middle finger 523 of the left hand 510L can depress the “D” key of the typing keyboard 340 shown in FIG. 4C corresponding with the second note of 110 and 120. In this example, the “K” key tracked by the middle finger 523 of the right hand 510R moves to the right from the previous “J” key tracked by the index finger 522 of the right hand 510R. The D key tracked by the middle finger 523 of the left hand 510L, in contrast moves to the left from the previous F key tracked by the index finger 522 of the left hand 510L.

In addition to involving fine motor skills in the above example, the index finger 522 and the middle finger 523 of the right hand 510R by pressing in sequence the “J” and “K” key of the typing keyboard, move in an opposite direction, or in contrary motion, as the index finger 522 and the middle finger 523 of the left hand 510L press in sequence the “F” and “D” key of the typing keyboard.

The listener 500 optionally can lower (or can be instructed to lower) a third digit 520, such as the ring finger 524, of both hands 510 to depress or otherwise activate the relevant key(s) 350 of the typing keyboard 340 corresponding with the third notes of the first line 110 and the second line 120. The listener 500 preferably can lower both of the third digits 520 simultaneously with the unlowered other digits 520 remaining in the rest position and being in contact with the typing keyboard 340. In selected embodiments, the lowered third digits 520 can be maintained in the lowered position for a third predetermined duration of time and, after the third predetermined time duration expires, can be moved back to the traditional typing position and again contact the surface of typing keyboard 340. Stated somewhat differently, the listener 500 can lower (or can be instructed to lower) the third digit 520 of both hands 510 to depress or otherwise activate the relevant key(s) 350 of the typing keyboard 340.

For example, the ring finger 524 of the right hand 510R can depress the “L” key of the typing keyboard 340 shown in FIG. 4C; whereas, the ring finger 524 of the left hand 510L can depress the “S” key of the typing keyboard 340 shown in FIG. 4C corresponding with the third notes of 110 and 120. In this example, the “;” key tracked by the ring finger 524 of the right hand 510R moves to the right from the previously pressed “L” key tracked by the middle finger 523 of the right hand 510R. The “S” key tracked by the ring finger 524 of the left hand 510L, in contrast, moves to the left from the previous “D” key tracked by the middle finger 523 of the left hand 510L.

In addition to involving fine motor skills in the above example, the middle finger 523 and the ring finger 524 of the right hand 510R by pressing in sequence the “K” and “L” key of the typing keyboard, move in an opposite direction, or in contrary motion, as the middle finger 523 and the ring finger 524 of the left hand 510L press in sequence the as the “D” and “S” key of the typing keyboard.

The listener 500 can lower (or can be instructed to lower) a fourth digit 520, such as the little finger 525, of both hands 510 to depress or otherwise activate the relevant key(s) 350 of the typing keyboard 340 corresponding with the fourth notes of the first line 110 and the second line 120. The listener 500 preferably can lower both of the fourth digits 520 simultaneously with the unlowered other digits 520 remaining in the rest position and being in contact with the typing keyboard 340. In selected embodiments, the lowered fourth digits 520 can be maintained in the lowered position for a fourth predetermined duration of time and, after the fourth predetermined time duration expires, can be moved back to the traditional typing position and again contact the surface of the typing keyboard 340.

Stated somewhat differently, the listener 500 can lower (or can be instructed to lower) the fourth digit 520 of both hands 510 to depress or otherwise activate the relevant key(s) 350 of the typing keyboard 340. For example, the little finger 525 of the right hand 510R can depress the semicolon “;” key of the typing keyboard 340 shown in FIG. 4C while the little finger 525 of the left hand 510L can depress the “A” key of the typing keyboard 340 shown in FIG. 4C.

In this example, the semicolon “;” key tracked by the little finger 525 of the right hand 510R moves to the right from the previous “L” key tracked by the ring finger 524 of the right hand 510R. The “A” key tracked by the little finger 525 of the left hand 510L, in contrast, moves to the left from the previous “S” key tracked by the ring finger 524 of the left hand 510L. In addition to involving fine motor skills in the above example, the ring finger 524 and the little finger 525 of the right hand 510R by pressing in sequence the “L” and “;” key of the typing keyboard, move in an opposite direction, or in contrary motion, as the ring finger 524 and the little finger 525 of the left hand 510L press in sequence the as the “S” and “A” key of the typing keyboard.

The teaching method 400, involving fine motor skills for example, can comprise a first sequence of the listener 500 lowering the index fingers 522 of both hands 510 from the typing keyboard 340 for the first predetermined duration, lowering the middle fingers 523 of both hands 510 from the typing keyboard 340 for the second predetermined duration, lowering the ring fingers 524 of both hands 510 from the typing keyboard 340 for the third predetermined duration and lowering the little fingers 525 of both hands 510 from the typing keyboard 340 for the fourth predetermined duration. In accordance with the first sequence, the relevant key(s) 350 of the typing keyboard 340 can be activated by the sequential lowering of the digits 520 of the hands 510, corresponding with the notes of the first line 110 and the second line 120.

Additionally and/or alternatively, for involving fine motor skills the listener 500 can track or simulate the oppositional movement of (or can be instructed to track) the one or more audible notes of the lines 110, 120 of music by pressing and/or releasing a sequence of one or more corresponding keys 350 of the typing keyboard 340 via a single selected digit 520, such as the index finger 522, of both hands 510 of the listener 500. The teaching method 100 can include presenting the first line 110 of music, at 210, presenting the second line 120 of music, at 220, and/or presenting the first and second lines 110, 120 of music, at 230, to the listener 500 in the manner discussed in more detail herein.

The listener 500, for example, can lower (or can be instructed to lower) the selected digit 520 of both hands 510 to depress or otherwise activate the relevant key(s) 350 of the typing keyboard 340 corresponding with at least one audible note of the first line 110 and the second line 120. The listener 500 preferably can lower both of the selected digits 520 simultaneously with the unlowered other digits 520 remaining in the rest position and/or above the typing keyboard 340. In selected embodiments, the lowered selected digit 520 can be maintained in the lowered position for a first predetermined duration of time and, after the first predetermined time duration expires, can be moved back to the rest position and again contact the surface of the typing keyboard 340.

Stated somewhat differently, the listener 500 can lower (or can be instructed to lower) the selected digit 520 of both hands 510 to depress or otherwise activate the relevant key(s) 350 of the typing keyboard 340 can track or simulate the oppositional movement of (or can be instructed to track) the one or more audible notes of the lines 110, 120. For example, the selected digit 520 of the right hand 510R can depress the “Y” key of the typing keyboard 340 shown in FIG. 4C. The selected digit 520 of the left hand 510L can depress the T key of the typing keyboard 340 shown in FIG. 4C. In traditional typing position, this movement is used by the index fingers 522 and move in contrary motion.

Additionally and/or alternatively, the listener 500 can lower (or can be instructed to lower) the selected digit 520 of both hands 510 to depress or otherwise activate the relevant key(s) 350 of the typing keyboard 340 track or simulate the movement of (or can be instructed to track) the one or more audible notes of the lines 110, 120. The listener 500 preferably can lower both of the selected digits 520 simultaneously with the unlowered other digits 520 remaining in the rest position and/or above the typing keyboard 340. In selected embodiments, the lowered selected digits 520 can be maintained in the lowered position for a second predetermined duration of time and, after the second predetermined time duration expires, can be moved back to the rest position and again contact the surface of the typing keyboard 340.

Stated somewhat differently, the listener 500 can lower (or can be instructed to lower) the selected digit 520 of both hands 510 to depress or otherwise activate the relevant key(s) 350 of the typing keyboard 340 track or simulate the movement of (or can be instructed to track) the one or more audible notes of the lines 110, 120. For example, the selected digit 520 of the right hand 510R can depress the “H” key of the typing keyboard 340 shown in FIG. 4C; whereas, the selected digit 520 of the left hand 510L can depress the “G” key of the typing keyboard 340. In this example, the note tracked by the selected digit 522 of the right hand 510R moves in contrary motion to the selected digit 522 of the left hand. The note tracked by the selected digit 520 of the left hand 510L, in contrast, moves in contrary motion etc.

The listener 500 optionally can lower (or can be instructed to lower) the selected digit 520 of both hands 510 to depress or otherwise activate the relevant key(s) 350 of the typing keyboard 340. The listener 500 preferably can lower both of the selected digits 520 simultaneously with the unlowered other digits 520 remaining in the rest position and/or above the typing keyboard 340. In selected embodiments, the lowered selected digits 520 can be maintained in the lowered position for a third predetermined duration of time and, after the third predetermined time duration expires, can be raised back to the rest position and again contact the surface of typing keyboard 340. Stated somewhat differently, the listener 500 can lower (or can be instructed to lower) the selected digit 520 of both hands 510 to depress or otherwise activate the relevant key(s) 350 of the typing keyboard 340.

For example, the selected digit 523 of the right hand 510R can depress the “I” key of the typing keyboard 340 shown in FIG. 4C, and the selected digit 523 of the left hand 510L can depress the C key of the typing keyboard 340. In this example, the “I” key tracked by the selected digit 523 of the right hand 510R moves in contrary motion to the C key tracked by the selected digit 523 of the left hand 510L. Accordingly, use of the typing keyboard 340, the musical keyboard 310 (shown in FIG. 4B) or any other surface 300 (shown in FIG. 4A) advantageously can help the listener 500 to exercise the tactile sense in combination with the auditory sense.

Auditory

Turning to FIG. 6A, the first line 110 of music can include a sequence of two or more musical notes 112. The two or more musical notes 112, in some embodiments, can be arranged in one or more ascending line portions 110_{A}, one or more descending line portions 110_{B} and/or one or more unchanging line portions (not shown) in the manner discussed in more detail above with reference to FIG. 2A. The first line 110 of music as illustrated in FIG. 6A, for example, includes an ascending line portion 110_{A} followed by a descending line portion 110_{B}. For instance, the teaching method 100, at 210 (shown in FIG. 1), can include audibly presenting the first line 110 of music to the listener 500. The listener 500 thereby can utilize the auditory sense to hear the first line 110 of music and better understand the contrary motion in music.

Visual

In selected embodiments, the teaching method 100, at 210, can include visually presenting the first line 110 of music to the listener 500 as illustrated in FIG. 6B. In the manner discussed above with reference to FIG. 3A, the teaching method 100 can include a first visual image 116 for visually presenting the first line 110 of music. The first visual image 116 can comprise one or more visual images based upon the nature of the first line 110 of music. As shown in FIG. 6B, for example, the first visual image 116 can include a first visual image portion 116_{A} that is associated with the ascending line portion 110_{A} and/or a second visual image portion 116_{B} that is associated with the descending line portion 110_{B}. Stated somewhat differently, one or more visual image portions 116_{A}, 116_{B} can be associated with the first line 110 of music. The listener 500 thereby can utilize the visual sense to see the first line 110 of music and better understand the contrary motion in music.

Tactile

Additionally and/or alternatively, the teaching method 100, at 210, can include tactilely presenting the first line 110 of music to the listener 500 as illustrated in FIG. 6C. In the manner discussed above with reference to FIGS. 4A and 5, the teaching method 100 can utilize the surface 300 (shown in FIG. 4A) to present the first line 110 of music via the tactile sense of touch of the listener 500. As shown in FIG. 6C, for example, the musical notes 112 of the first line 110 of music can be associated with the digits 520 of the hands 510 of the listener 500. In selected embodiments, a predetermined note 112 of the first line 110 of music can be associated with two or more selected digits 520 of a selected hand 510 of the listener 500, and/or two or more predetermined musical notes 112 of the first line 110 of music can be associated with a selected digit 520 of the selected hand 510 of the listener 500.

In selected embodiments, each note 112 of the first line 110 of music can be associated with a selected digit 520 of a selected hand 510 of the listener 500. A first note of the first line 110 of music can be associated with the thumb 521 of the right hand 510R of the listener 500. A second note of the first line 110 of music can be associated with the index finger 522 of the right hand 510R of the listener 500; whereas, a third note of the first line 110 of music can be associated with the middle finger 523 of the right hand 510R of the listener 500. Similarly, a fourth note of the first line 110 of music can be associated with the ring finger 524 of the right hand 510R of the listener 500, and/or a fifth note of the first line 110 of music can be associated with the little finger 525 of the right hand 510R of the listener 500.

As shown in FIG. 6C, each note 112 of the ascending line portion 110_{A} and/or the descending line portion 110_{B} can be associated with a selected digit 520 of the right hand 510R of the listener 500. Preferably, a selected note 112 in the ascending line portion 110_{A} is associated with the same note 112 in the descending line portion 110_{B}. Stated somewhat differently, if the progression of musical notes 112 in the ascending line portion 110_{A} is a mirror image of the progression of musical notes 112 in the descending line portion 110_{B}, the progression of selected digits 520 of the hand 510 associated with the ascending line portion 110_{A} can be a mirror image of the progression of selected digits 520 of the hand 510 associated with the descending line portion 110_{B}.

The listener 500 thereby can utilize the tactile sense to touch the first line 110 of music and better understand the contrary motion in music. Although shown and described with reference to FIG. 6C as being associated with selected digits 520 of the right hand 510R of the listener 500 for purposes of illustration only, the musical notes 112 of the first line 110 of music can be associated with any predetermined digits 520 of either hand 510 of the listener 500.

Auditory, Visual and Tactile

FIG. 6D illustrates yet another exemplary alternative embodiment of the teaching method 100, wherein the teaching method 100 includes audibly, visually and tactilely presenting the first line 110 of music. In other words, the teaching method 100, at 210, can include audibly presenting the first line 110 of music to the listener 500, visually presenting the first line 110 of music to the listener 500 and/or tactilely presenting the first line 110 of music to the listener 500.

As illustrated in FIG. 6D, for example, the first line 110 of music can be audibly presented to the listener 500 in the manner shown and described above with reference to FIG. 6A. The first line 110 of music optionally can be visually presented to the listener 500 in the manner shown and described above with reference to FIG. 6B. Additionally and/or alternatively, the first line 110 of music can be tactilely presented to the listener 500 in the manner shown and described above with reference to FIG. 6C. The listener 500 thereby can utilize one or more senses to appreciate the first line 110 of music and better understand the contrary motion in music.

The teaching method 100 can include presenting the second line 120 of music, at 220, to the listener 500 (shown in FIG. 4A) in the manner discussed in more detail above with reference to FIG. 1. The second line 120 of music can be presented to the listener 500 in any conventional manner, such as in an audible manner, a visual manner, and/or a tactile manner, without limitation. Stated somewhat differently, the second line 120 of music can be audibly, visually and/or tactilely presented to the listener 500.

Auditory

Turning to FIG. 7A, the second line 120 of music can include a sequence of two or more musical notes 122. The two or more musical notes 122, in some embodiments, can be arranged in one or more descending line portions 120_{A}, one or more ascending line portions 120_{B} and/or one or more unchanging line portions (not shown) in the manner discussed in more detail above with reference to FIG. 2B. The second line 120 of music as illustrated in FIG. 7A, for example, includes a descending line portion 120_{A} followed by an ascending line portion 120_{B}. For instance, the teaching method 100, at 220 (shown in FIG. 1), can include audibly presenting the second line 120 of music to the listener 500. The listener 500 thereby can utilize the auditory sense to hear the second line 120 of music and better understand the contrary motion in music.

Visual

In selected embodiments, the teaching method 100, at 220, can include visually presenting the second line 120 of music to the listener 500 as illustrated in FIG. 7B. In the manner discussed above with reference to FIG. 3B, the teaching method 100 can include a second visual image 126 for visually presenting the second line 120 of music. The second visual image 126 can comprise one or more visual images based upon the nature of the second line 120 of music. As shown in FIG. 7B, for example, the second visual image 126 can include a second visual image portion 126_{A} that is associated with the descending line portion 120_{A} and/or a second visual image portion 126_{B} that is associated with the ascending line portion 120_{B}. Stated somewhat differently, one or more visual image portions 126_{A}, 126_{B} can be associated with the second line 120 of music. The listener 500 thereby can utilize the visual sense to see the second line 120 of music and better understand the contrary motion in music.

Tactile

Additionally and/or alternatively, the teaching method 100, at 220, can include tactilely presenting the second line 120 of music to the listener 500 as illustrated in FIG. 7C. In the manner discussed above with reference to FIGS. 4A and 5, the teaching method 100 can utilize the surface 300 (shown in FIG. 4A) to present the second line 120 of music via the tactile sense of touch of the listener 500. As shown in FIG. 7C, for example, the musical notes 122 of the second line 120 of music can be associated with the digits 520 of the hands 510 of the listener 500. In selected embodiments, a predetermined note 122 of the second line 120 of music can be associated with two or more selected digits 520 of a selected hand 510 of the listener 500, and/or two or more predetermined musical notes 122 of the second line 120 of music can be associated with a selected digit 520 of the selected hand 510 of the listener 500.

In selected embodiments, each note 122 of the second line 120 of music can be associated with a selected digit 520 of a selected hand 510 of the listener 500. A first note of the second line 120 of music can be associated with the thumb 521 of the left hand 510L of the listener 500. A second note of the second line 120 of music can be associated with the index finger 522 of the left hand 510L of the listener 500; whereas, a third note of the second line 120 of music can be associated with the middle finger 523 of the left hand 510L of the listener 500. Similarly, a fourth note of the second line 120 of music can be associated with the ring finger 524 of the left hand 510L of the listener 500, and/or a fifth note of the second line 120 of music can be associated with the little finger 525 of the left hand 510L of the listener 500.

As shown in FIG. 7C, each note 122 of the descending line portion 120_{A} and/or the ascending line portion 120_{B} can be associated with a selected digit 520 of the left hand 510L of the listener 500. Preferably, a selected note 122 in the descending line portion 120_{A} is associated with the same note 122 in the ascending line portion 120_{B}. Stated somewhat differently, if the progression of musical notes 122 in the descending line portion 120_{A} is a mirror image of the progression of musical notes 122 in the ascending line portion 120_{B}, the progression of selected digits 520 of the hand 510 associated with the descending line portion 120_{A} can be a mirror image of the progression of selected digits 520 of the hand 510 associated with the ascending line portion 120_{B}.

The listener 500 thereby can utilize the tactile sense to touch the second line 120 of music and better understand the contrary motion in music. Although shown and described with reference to FIG. 7C as being associated with selected digits 520 of the left hand 510L of the listener 500 for purposes of illustration only, the musical notes 122 of the second line 120 of music can be associated with any predetermined digits 520 of either hand 510 of the listener 500.

Auditory, Visual and Tactile

FIG. 7D illustrates yet another exemplary alternative embodiment of the teaching method 100, wherein the teaching method 100 includes audibly, visually and tactilely presenting the second line 120 of music. In other words, the teaching method 100, at 220, can include audibly presenting the second line 120 of music to the listener 500, visually presenting the second line 120 of music to the listener 500 and/or tactilely presenting the second line 120 of music to the listener 500.

As illustrated in FIG. 7D, for example, the second line 120 of music can be audibly presented to the listener 500 in the manner shown and described above with reference to FIG. 7A. The second line 120 of music optionally can be visually presented to the listener 500 in the manner shown and described above with reference to FIG. 7B. Additionally and/or alternatively, the second line 120 of music can be tactilely presented to the listener 500 in the manner shown and described above with reference to FIG. 7C. The listener 500 thereby can utilize one or more senses to appreciate the second line 120 of music and better understand the contrary motion in music.

The teaching method 100 can include presenting the first and second lines 110, 120 of music, at 230, to the listener 500 (shown in FIG. 4A) in the manner discussed in more detail above with reference to FIG. 1. The second line 120 of music can be presented to the listener 500 in any conventional manner, such as in an audible manner, a visual manner, and/or a tactile manner, without limitation. Stated somewhat differently, the second line 120 of music can be audibly, visually and/or tactilely presented to the listener 500. In selected embodiments, a teacher (not shown) may present the first line 110 of music to a student or other listener 500.

Contrary Motion in Music—Auditory

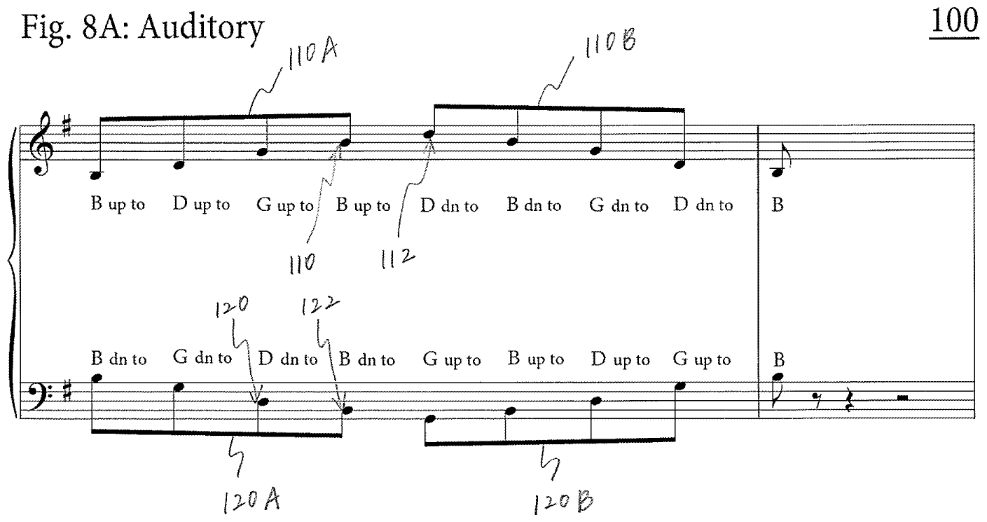

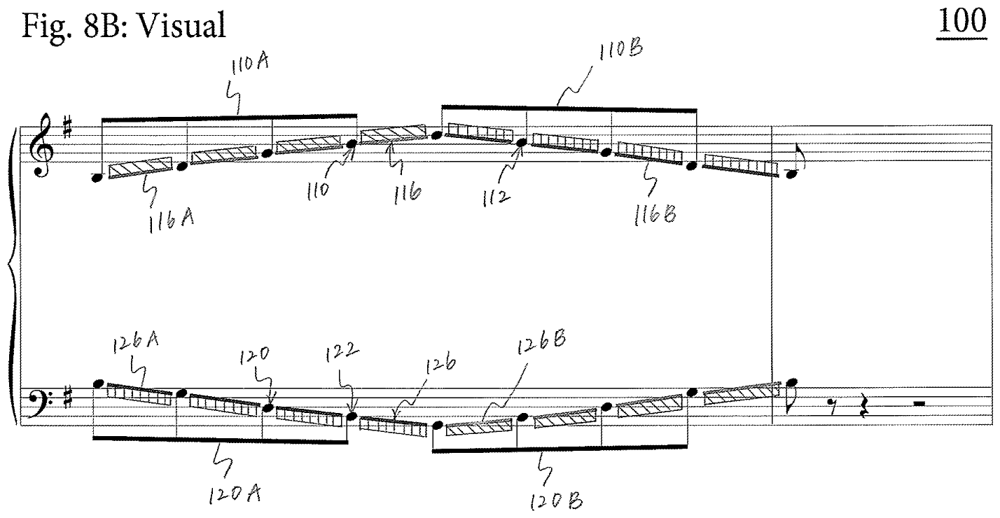

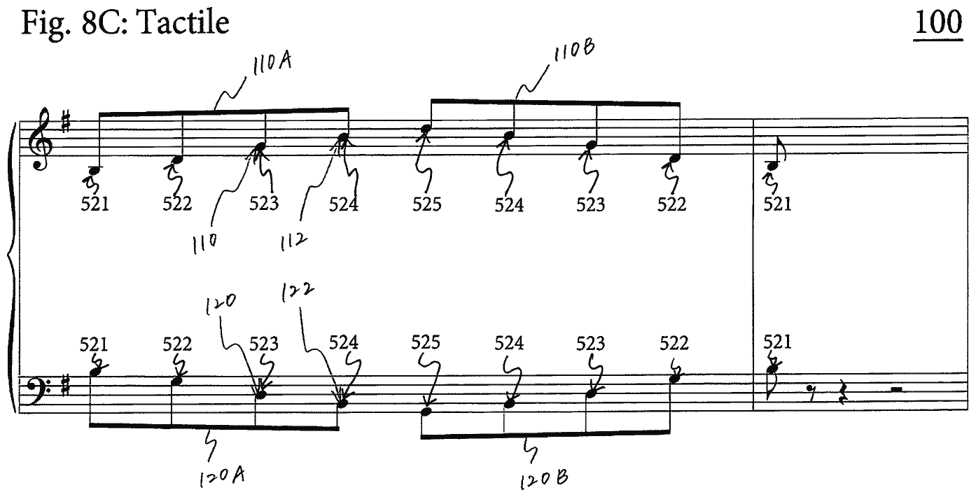

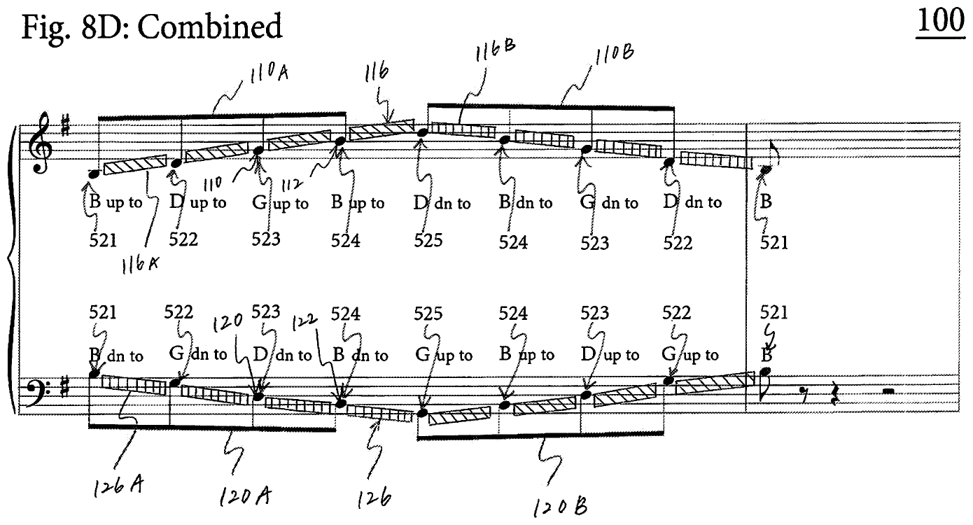

Turning to FIG. 8A, the first line 110 of music can include a sequence of two or more musical notes 112, and/or the second line 120 of music can include a sequence of two or more musical notes 122. The two or more musical notes 112 are illustrated as being provided in the manner of the two or more musical notes 112 as shown and described above with reference to FIG. 6A; whereas, the two or more musical notes 122 are illustrated as being provided in the manner of the two or more musical notes 122 as shown and described above with reference to FIG. 7A.

The first line 110 of music, for example, can include an ascending line portion 110_{A} followed by a descending line portion 110_{B}. Additionally and/or alternatively, the second line 120 of music can include a descending line portion 120_{A} followed by an ascending line portion 120_{B}. In selected embodiments, the teaching method 100, at 230 (shown in FIG. 1), can include audibly presenting the first and second lines 110, 120 of music together to the listener 500. The listener 500 thereby can utilize the auditory sense to hear the first and second lines 110, 120 of music and better understand the contrary motion in music.

Contrary Motion in Music—Visual

In selected embodiments, the teaching method 100, at 230, can include visually presenting the first and second lines 110, 120 of music to the listener 500 as illustrated in FIG. 8B. In the manner discussed above with reference to FIG. 3C, the teaching method 100 can include visual images 116, 126 for visually presenting the first and second lines 110, 120 of music. The visual images 116, 126 can comprise one or more visual images based upon the nature of the first and second lines 110, 120 of music, respectively. As shown in FIG. 8B, for example, the visual image 116 can include one or more visual image portions 116_{A}, 116_{B} that are associated with the first line 110 of music in the manner discussed in more detail above with reference to FIG. 6B, and/or the visual image 126 can include one or more visual image portions 126_{A}, 126_{B} that are associated with the second line 120 of music in the manner discussed in more detail above with reference to FIG. 7B. The listener 500 thereby can utilize the visual sense to see the first and second lines 110, 120 of music and better understand the contrary motion in music.

Contrary Motion in Music—Tactile

Additionally and/or alternatively, the teaching method 100, at 230, can include tactilely presenting the first and second lines 110, 120 of music to the listener 500 as illustrated in FIG. 8C. In the manner discussed above with reference to FIGS. 4A and 5, the teaching method 100 can utilize the surface 300 (shown in FIG. 4A) to present the first and second lines 110, 120 of music via the tactile sense of touch of the listener 500. The musical notes 112, 122 of the first and second lines 110, 120 of music can be associated with the digits 520 of the hands 510 of the listener 500.

As shown in FIG. 8C, the musical notes 112 of the first line 110 of music can be associated with the digits 520 of a first hand 510 of the listener 500 in the manner set forth in additional detail with reference to FIG. 6C; whereas, the musical notes 122 of the second line 120 of music can be associated with the digits 520 of a second hand 510 of the listener 500 in the manner set forth in additional detail with reference to FIG. 7C. Each note 112, 122, for example, can be associated with a selected digit 520 of a selected hand 510 of the listener 500. First musical notes 112, 122 can be associated with the thumbs 521 of first and second hands 510, respectively, of the listener 500. Second musical notes 112, 122 can be associated with the index fingers 522 of the first and second hands 510, respectively, of the listener 500; whereas, third musical notes 112, 122 can be associated with the middle fingers 523 of the respective first and second hands 510 of the listener 500. Similarly, fourth musical notes 112, 122 can be associated with the ring fingers 524 of the respective first and second hands 510 of the listener 500, and/or fifth musical notes 112, 122 can be associated with the little fingers 525 of the respective first and second hands 510 of the listener 500. This particular tactile exercise advantageously can make use of the mirror image of the natural hand.

The listener 500 thereby can utilize the tactile sense to touch the first and second lines 110, 120 of music and better understand the contrary motion in music. Although shown and described with reference to FIG. 8C as being associated with selected digits 520 of the respective hands 510 of the listener 500 for purposes of illustration only, the musical notes 112, 122 of the first and second lines 110, 120 of music can be associated with any predetermined digits 520 of either hand 510 of the listener 500.

Contrary Motion in Music—Auditory, Visual and Tactile

FIG. 8D illustrates yet another exemplary alternative embodiment of the teaching method 100, wherein the teaching method 100 includes audibly, visually and tactilely presenting the first and second lines 110, 120 of music. In other words, the teaching method 100, at 230, can include audibly presenting the first and second lines 110, 120 of music to the listener 500, visually presenting the first and second lines 110, 120 of music to the listener 500 and/or tactilely presenting the first and second lines 110, 120 of music to the listener 500.

As illustrated in FIG. 8D, for example, the first and second lines 110, 120 of music can be audibly presented to the listener 500 in the manner shown and described above with reference to FIG. 8A. The first and second lines 110, 120 of music optionally can be visually presented to the listener 500 in the manner shown and described above with reference to FIG. 8B. Additionally and/or alternatively, the first and second lines 110, 120 of music can be tactilely presented to the listener 500 in the manner shown and described above with reference to FIG. 8C. The listener 500 thereby can utilize one or more senses to appreciate the first and second lines 110, 120 of music and better understand the contrary motion in music.

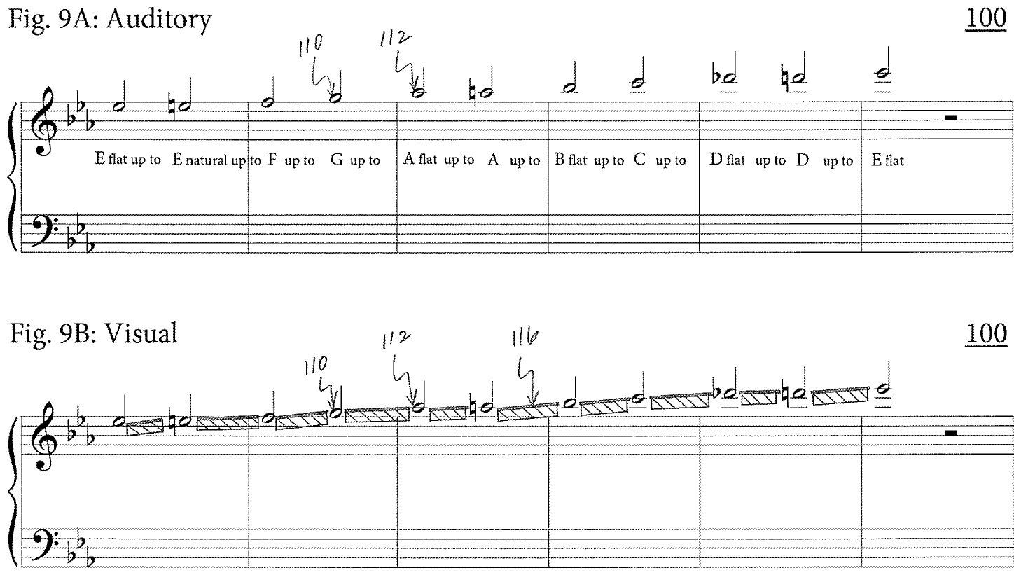

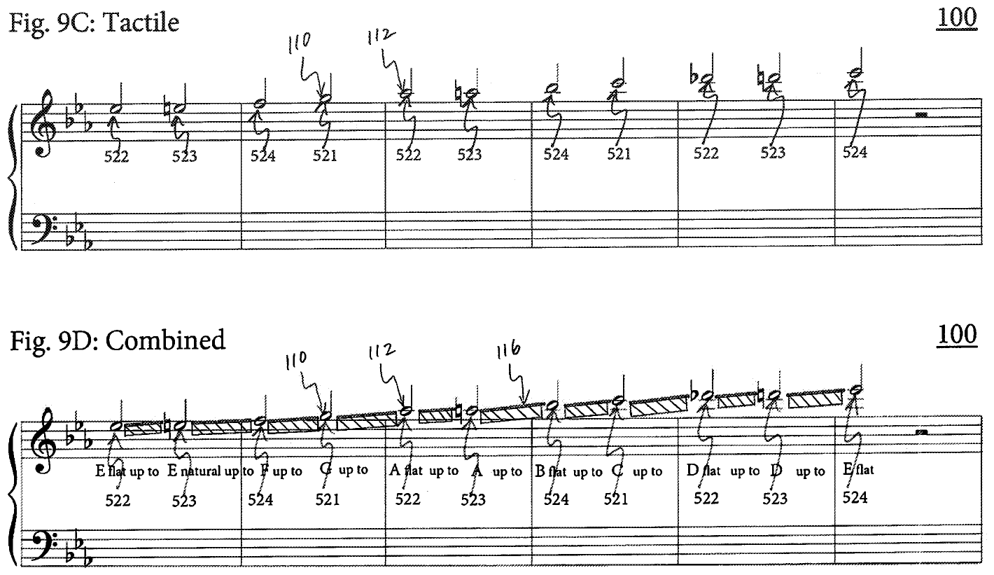

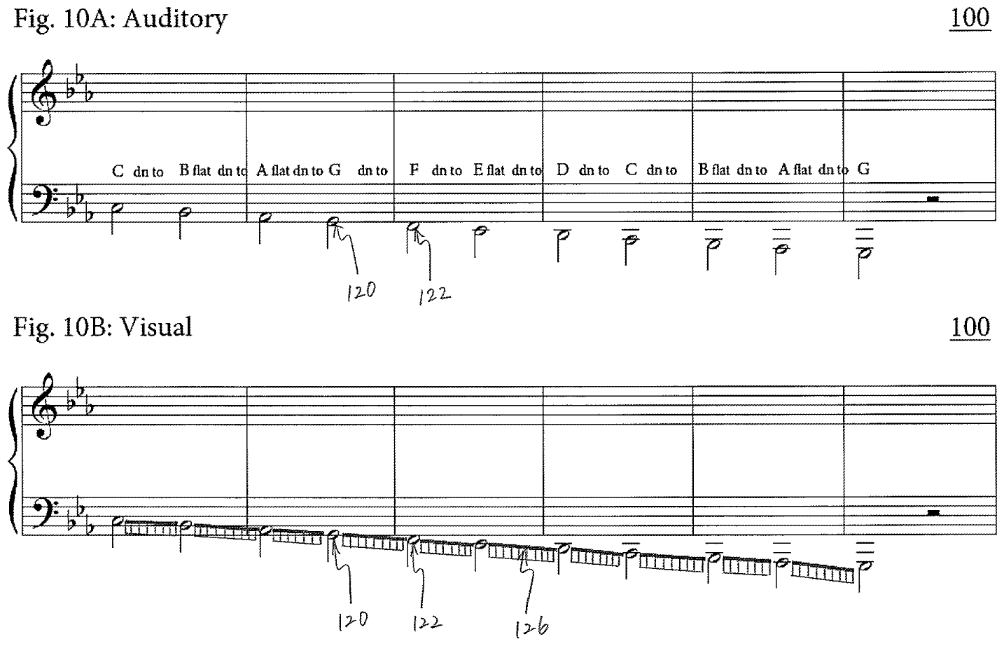

Classical music can be perceived as being difficult to appreciate and enjoy for the reasons set forth herein. Accordingly, the teaching method 100 advantageously can be configured to present classical music to the listener 500 in selected embodiments. FIGS. 9A-D, 11A-D and 12A-B therefore illustrate an exemplary embodiment of the teaching method 100, wherein music that is excerpted from a piece of classical music composed by Beethoven can be presented to the listener 500. The exemplary classical music piece shown in FIGS. 9A-D is from a Beethoven Sonata Number 8 Opus 13.

Auditory Sense in Classical Music

Turning to FIG. 9A, for example, the piece of classical music composed by Beethoven can include a first line 110 of music. The first line 110 of music can include a sequence of two or more musical notes 112 in the manner discussed in more detail above with reference to the first line 110 of music (shown in FIG. 6A). The two or more musical notes 112, as shown in FIG. 9A, can be arranged such that the musical notes 112 ascend in pitch. For instance, the teaching method 100, at 210 (shown in FIG. 1), can include audibly presenting the first line 110 of music to the listener 500. The listener 500 thereby can utilize the auditory sense to hear the first line 110 of music and better understand the contrary motion in music.

Visual Sense in Classical Music

In selected embodiments, the teaching method 100, at 210, can include visually presenting the first line 110 of music to the listener 500 as illustrated in FIG. 9B. In the manner discussed above with reference to FIG. 3A, the teaching method 100 can include a first visual image 116 for visually presenting the first line 110 of music. The first visual image 116 can comprise one or more visual images based upon the nature of the first line 110 of music. As shown in FIG. 9B, for example, the first visual image 116 can be associated with the ascending line portion 110 and disposed between adjacent musical notes 112. The listener 500 thereby can utilize the visual sense to see the first line 110 of music and better understand the contrary motion in music.

Tactile Sense in Classical Music

Additionally and/or alternatively, the teaching method 100, at 210, can include tactilely presenting the first line 110 of music to the listener 500 as illustrated in FIG. 9C. In the manner discussed above with reference to FIGS. 4A and 5, the teaching method 100 can utilize the surface 300 (shown in FIG. 4A) to present the first line 110 of music via the tactile sense of touch of the listener 500. As shown in FIG. 9C, for example, the musical notes 112 of the first line 110 of music can be associated with the digits 520 of the hands 510 of the listener 500. In selected embodiments, a predetermined note 112 of the first line 110 of music can be associated with two or more selected digits 520 of a selected hand 510 of the listener 500, and/or two or more predetermined musical notes 112 of the first line 110 of music can be associated with a selected digit 520 of the selected hand 510 of the listener 500.

In selected embodiments, each note 112 of the first line 110 of music can be associated with a selected digit 520 of a selected hand 510 of the listener 500. A first note of the first line 110 of music can be associated with the index finger 522 of the right hand 510R of the listener 500. A second note of the first line 110 of music can be associated with the middle finger 523 of the right hand 510R of the listener 500; whereas, a third note of the first line 110 of music can be associated with the ring finger 524 of the right hand 510R of the listener 500. Similarly, a fourth note of the first line 110 of music can be associated with the thumb 521 of the right hand 510R of the listener 500, and/or a fifth note of the first line 110 of music can be associated with the index finger 522 of the right hand 510R of the listener 500.

As shown in FIG. 9C, each note 112 in the first line 110 of music can be associated with a selected digit 520 of the right hand 510R of the listener 500. The listener 500 thereby can utilize the tactile sense to touch the first line 110 of music and better understand the contrary motion in music. Although shown and described with reference to FIG. 9C as being associated with selected digits 520 of the right hand 510R of the listener 500 for purposes of illustration only, the musical notes 112 of the first line 110 of music can be associated with any predetermined digits 520 of either hand 510 of the listener 500.

Auditory, Visual and Tactile Senses in Classical Music

FIG. 9D illustrates yet another exemplary alternative embodiment of the teaching method 100, wherein the teaching method 100 includes audibly, visually and tactilely presenting the first line 110 of music. In other words, the teaching method 100, at 210, can include audibly presenting the first line 110 of music to the listener 500, visually presenting the first line 110 of music to the listener 500 and/or tactilely presenting the first line 110 of music to the listener 500.

As illustrated in FIG. 9D, for example, the first line 110 of music can be audibly presented to the listener 500 in the manner shown and described above with reference to FIG. 9A. The first line 110 of music optionally can be visually presented to the listener 500 in the manner shown and described above with reference to FIG. 9B. Additionally and/or alternatively, the first line 110 of music can be tactilely presented to the listener 500 in the manner shown and described above with reference to FIG. 9C. The listener 500 thereby can utilize one or more senses to appreciate the first line 110 of music and better understand the contrary motion in music.

The piece of classical music composed by Beethoven optionally can include a second line 120 of music, and the teaching method 100 can include presenting the second line 120 of music, at 220 (shown in FIG. 1), to the listener 500 (shown in FIG. 4A) in the manner discussed in more detail above with reference to FIG. 1. The second line 120 of music can be presented to the listener 500 in any conventional manner, such as in an audible manner, a visual manner, and/or a tactile manner, without limitation. Stated somewhat differently, the second line 120 of music can be audibly, visually and/or tactilely presented to the listener 500.

Auditory Sense in Classical Music

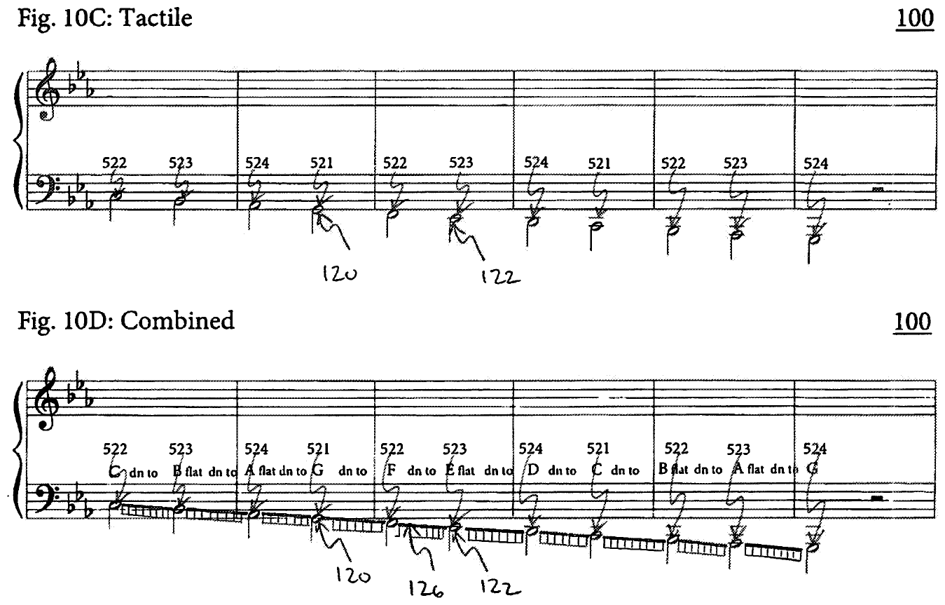

Turning to FIG. 10A, the second line 120 of music can include a sequence of two or more musical notes 122. The two or more musical notes 122, as shown in FIG. 10A, can be arranged such that the musical notes 122 descend in pitch. For instance, the teaching method 100, at 220, can include audibly presenting the second line 120 of music to the listener 500. The listener 500 thereby can utilize the auditory sense to hear the second line 120 of music and better understand the contrary motion in music.

Visual Sense in Classical Music

In selected embodiments, the teaching method 100, at 220, can include visually presenting the second line 120 of music to the listener 500 as illustrated in FIG. 10B. In the manner discussed above with reference to FIG. 3B, the teaching method 100 can include a second visual image 126 for visually presenting the second line 120 of music. The second visual image 126 can comprise one or more visual images based upon the nature of the second line 120 of music. The listener 500 thereby can utilize the visual sense to see the second line 120 of music and better understand the contrary motion in music.

Tactile Sense in Classical Music

Additionally and/or alternatively, the teaching method 100, at 220, can include tactilely presenting the second line 120 of music to the listener 500 as illustrated in FIG. 10C. In the manner discussed above with reference to FIGS. 4A and 5, the teaching method 100 can utilize the surface 300 (shown in FIG. 4A) to present the second line 120 of music via the tactile sense of touch of the listener 500. As shown in FIG. 10C, for example, the musical notes 122 of the second line 120 of music can be associated with the digits 520 of the hands 510 of the listener 500. In selected embodiments, a predetermined note 122 of the second line 120 of music can be associated with two or more selected digits 520 of a selected hand 510 of the listener 500, and/or two or more predetermined musical notes 122 of the second line 120 of music can be associated with a selected digit 520 of the selected hand 510 of the listener 500.

In selected embodiments, each note 122 of the second line 120 of music can be associated with a selected digit 520 of a selected hand 510 of the listener 500. A first note of the second line 120 of music can be associated with the index finger 522 of the left hand 510L of the listener 500. A second note of the second line 120 of music can be associated with the middle finger 523 of the left hand 510L of the listener 500; whereas, a third note of the second line 120 of music can be associated with the ring finger 524 of the left hand 510L of the listener 500. Similarly, a fourth note of the second line 120 of music can be associated with the thumb 521 of the left hand 510L of the listener 500, and/or a fifth note of the second line 120 of music can be associated with the index finger 522 of the left hand 510L of the listener 500.

The listener 500 thereby can utilize the tactile sense to touch the second line 120 of music and better understand the contrary motion in music. Although shown and described with reference to FIG. 10C as being associated with selected digits 520 of the left hand 510L of the listener 500 for purposes of illustration only, the musical notes 122 of the second line 120 of music can be associated with any predetermined digits 520 of either hand 510 of the listener 500.

Auditory, Visual and Tactile Senses in Classical Music

FIG. 10D illustrates yet another exemplary alternative embodiment of the teaching method 100, wherein the teaching method 100 includes audibly, visually and tactilely presenting the second line 120 of music. In other words, the teaching method 100, at 220, can include audibly presenting the second line 120 of music to the listener 500, visually presenting the second line 120 of music to the listener 500 and/or tactilely presenting the second line 120 of music to the listener 500.

As illustrated in FIG. 10D, for example, the second line 120 of music can be audibly presented to the listener 500 in the manner shown and described above with reference to FIG. 10A. The second line 120 of music optionally can be visually presented to the listener 500 in the manner shown and described above with reference to FIG. 10B. Additionally and/or alternatively, the second line 120 of music can be tactilely presented to the listener 500 in the manner shown and described above with reference to FIG. 10C. The listener 500 thereby can utilize one or more senses to appreciate the second line 120 of music and better understand the contrary motion in music.

Additionally and/or alternatively, the teaching method 100 can include presenting the first and second lines 110, 120 of music, at 230 (shown in FIG. 1), to the listener 500 (shown in FIG. 4A) in the manner discussed in more detail above with reference to FIG. 1. The first and second lines 110, 120 of music can be presented to the listener 500 in any conventional manner, such as in an audible manner, a visual manner, and/or a tactile manner, without limitation. Stated somewhat differently, the first and second lines 110, 120 of music can be audibly, visually and/or tactilely presented to the listener 500. In selected embodiments, a teacher (not shown) may present the first line 110 of music to a student or other listener 500.

Contrary Motion in Classical Music—Auditory

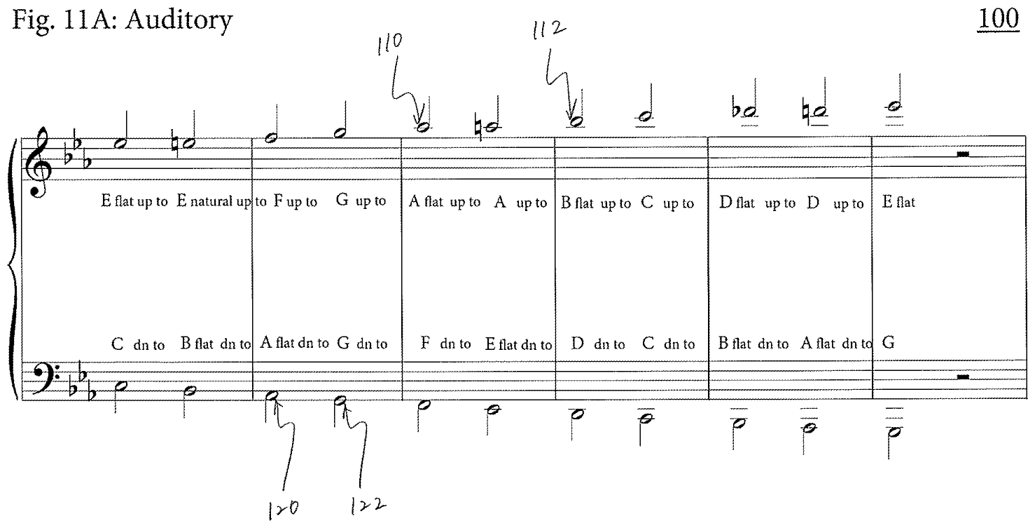

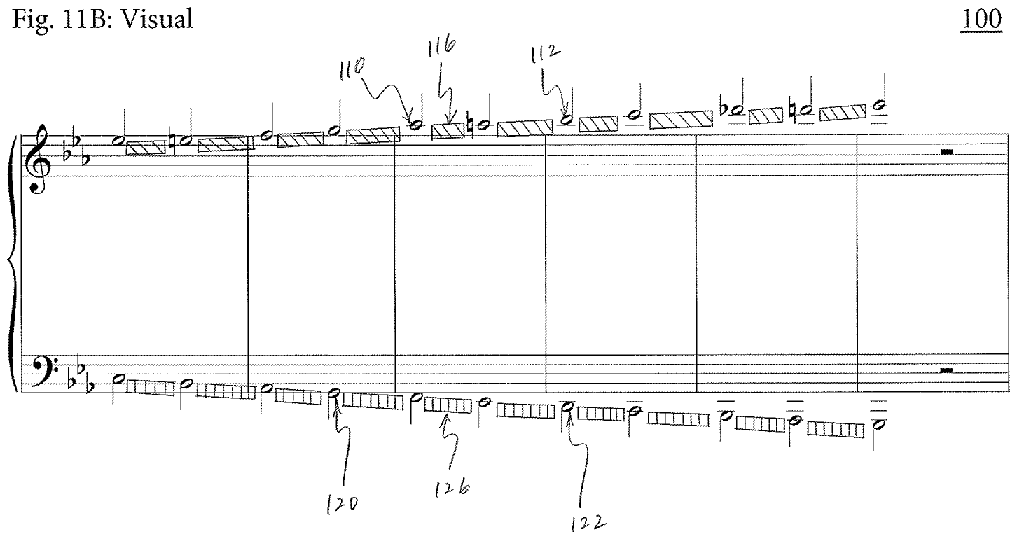

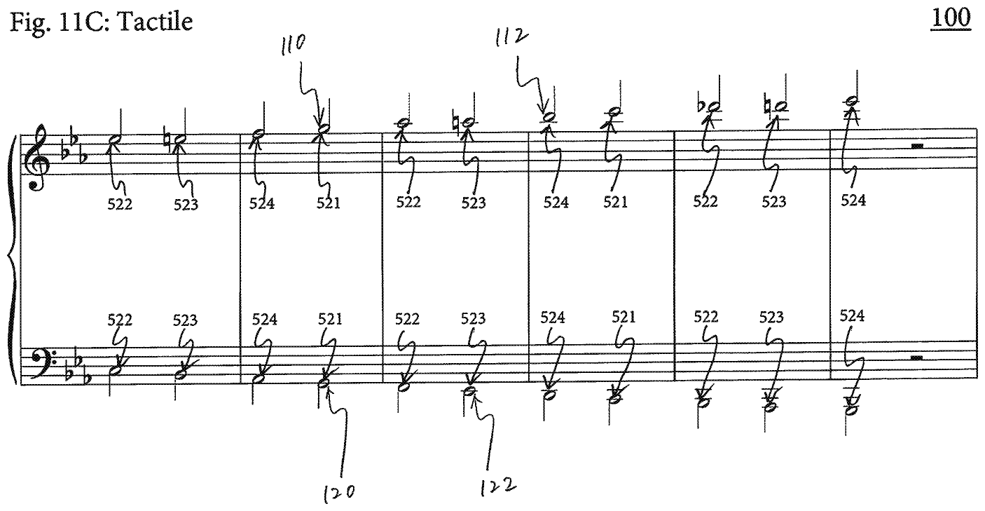

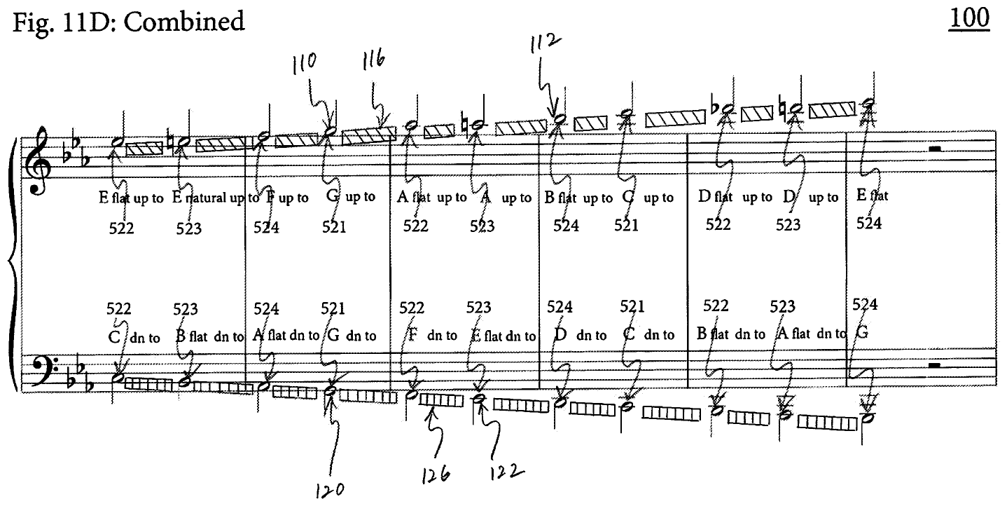

Turning to FIG. 11A, the first line 110 of music can include a sequence of two or more musical notes 112, and/or the second line 120 of music can include a sequence of two or more musical notes 122. The two or more musical notes 112 are illustrated as being provided in the manner of the two or more musical notes 112 as shown and described above with reference to FIG. 9A; whereas, the two or more musical notes 122 are illustrated as being provided in the manner of the two or more musical notes 122 as shown and described above with reference to FIG. 10A.

The first line 110 of music, for example, can be arranged such that the musical notes 112 ascend in pitch. Additionally and/or alternatively, the second line 120 of music can be arranged such that the musical notes 122 descend in pitch. In selected embodiments, the teaching method 100, at 230, can include audibly presenting the first and second lines 110, 120 of music together to the listener 500. The listener 500 thereby can utilize the auditory sense to hear the first and second lines 110, 120 of music and better understand the contrary motion in music.

Contrary Motion in Classical Music—Visual

In selected embodiments, the teaching method 100, at 230, can include visually presenting the first and second lines 110, 120 of music to the listener 500 as illustrated in FIG. 11B. In the manner discussed above with reference to FIG. 3C, the teaching method 100 can include visual images 116, 126 for visually presenting the first and second lines 110, 120 of music. The visual images 116, 126 can comprise one or more visual images based upon the nature of the first and second lines 110, 120 of music, respectively. The listener 500 thereby can utilize the visual sense to see the first and second lines 110, 120 of music and better understand the contrary motion in music.

Contrary Motion in Classical Music—Tactile

Additionally and/or alternatively, the teaching method 100, at 230, can include tactilely presenting the first and second lines 110, 120 of music to the listener 500 as illustrated in FIG. 11C. In the manner discussed above with reference to FIGS. 4A and 5, the teaching method 100 can utilize the surface 300 (shown in FIG. 4A) to present the first and second lines 110, 120 of music via the tactile sense of touch of the listener 500. The musical notes 112, 122 of the first and second lines 110, 120 of music can be associated with the digits 520 of the hands 510 of the listener 500.

As shown in FIG. 11C, the musical notes 112 of the first line 110 of music can be associated with the digits 520 of a first hand 510 of the listener 500 in the manner set forth in additional detail with reference to FIG. 9C; whereas, the musical notes 122 of the second line 120 of music can be associated with the digits 520 of a second hand 510 of the listener 500 in the manner set forth in additional detail with reference to FIG. 10C. Each note 112, 122, for example, can be associated with a selected digit 520 of a selected hand 510 of the listener 500. First musical notes 112, 122 can be associated with the index fingers 522 of first and second hands 510, respectively, of the listener 500. Second musical notes 112, 122 can be associated with the middle fingers 523 of the first and second hands 510, respectively, of the listener 500; whereas, third musical notes 112, 122 can be associated with the ring fingers 524 of the respective first and second hands 510 of the listener 500. Similarly, fourth musical notes 112, 122 can be associated with the thumbs 521 of the respective first and second hands 510 of the listener 500, and/or fifth musical notes 112, 122 can be associated with the index fingers 522 of the respective first and second hands 510 of the listener 500.

In this particular teaching example, the digits of the right hand 510R and left hand 510L are mirror images of each other. As shown in FIG. 11C, the musical notes 112 of the first line 110 of music can be associated with the digits 520 of a first hand 510 of the listener 500 in the manner set forth in additional detail with reference to FIG. 9C; whereas, the musical notes 122 of the second line 120 of music can be associated with the digits 520 of a second hand 510 of the listener 500 in the manner set forth in additional detail with reference to FIG. 10C. Stated somewhat differently, each note 112, 122 can be associated with a selected digit 520 of a selected hand 510 of the listener 500.

The listener 500 thereby can utilize the tactile sense to touch the first and second lines 110, 120 of music and better understand the contrary motion in music. Although shown and described with reference to FIG. 11C as being associated with selected digits 520 of the respective hands 510 of the listener 500 for purposes of illustration only, the musical notes 112, 122 of the first and second lines 110, 120 of music can be associated with any predetermined digits 520 of either hand 510 of the listener 500.

Contrary Motion in Classical Music—Auditory, Visual and Tactile

FIG. 11D illustrates yet another exemplary alternative embodiment of the teaching method 100, wherein the teaching method 100 includes audibly, visually and tactilely presenting the first and second lines 110, 120 of music. In other words, the teaching method 100, at 230, can include audibly presenting the first and second lines 110, 120 of music to the listener 500, visually presenting the first and second lines 110, 120 of music to the listener 500 and/or tactilely presenting the first and second lines 110, 120 of music to the listener 500.

As illustrated in FIG. 11D, for example, the first and second lines 110, 120 of music can be audibly presented to the listener 500 in the manner shown and described above with reference to FIG. 11A. The first and second lines 110, 120 of music optionally can be visually presented to the listener 500 in the manner shown and described above with reference to FIG. 11B. Additionally and/or alternatively, the first and second lines 110, 120 of music can be tactilely presented to the listener 500 in the manner shown and described above with reference to FIG. 11C. The listener 500 thereby can utilize one or more senses to appreciate the first and second lines 110, 120 of music and better understand the contrary motion in music.

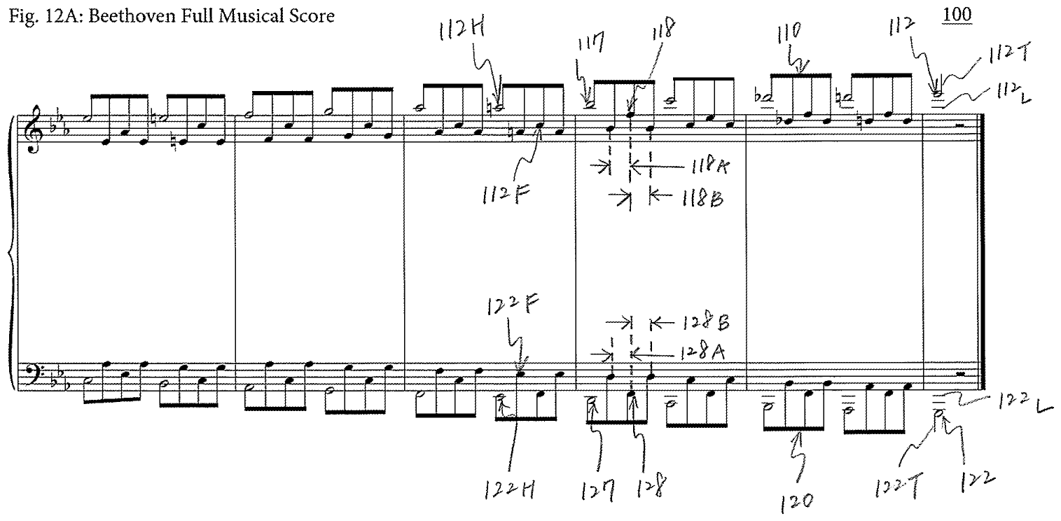

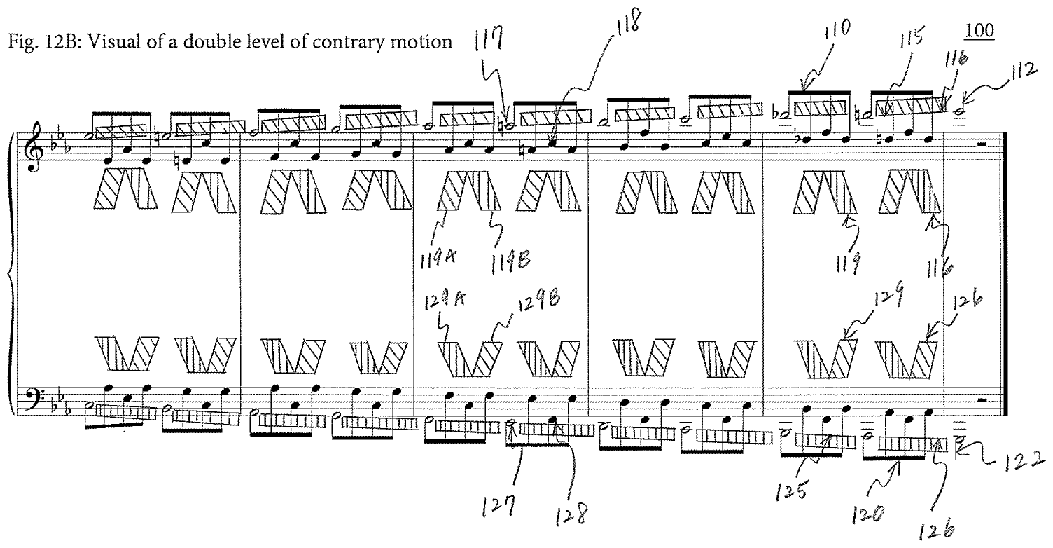

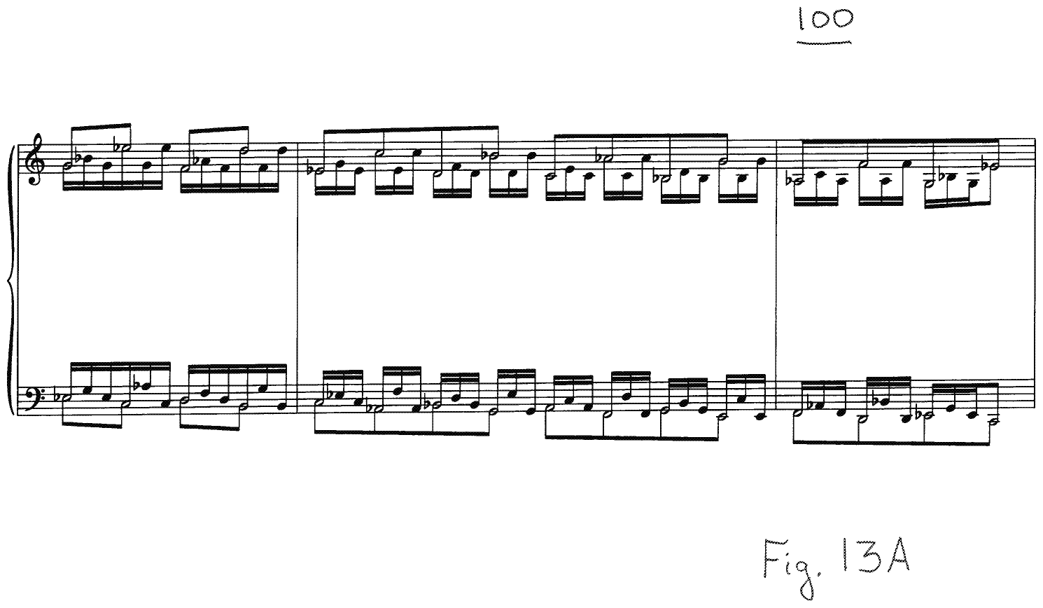

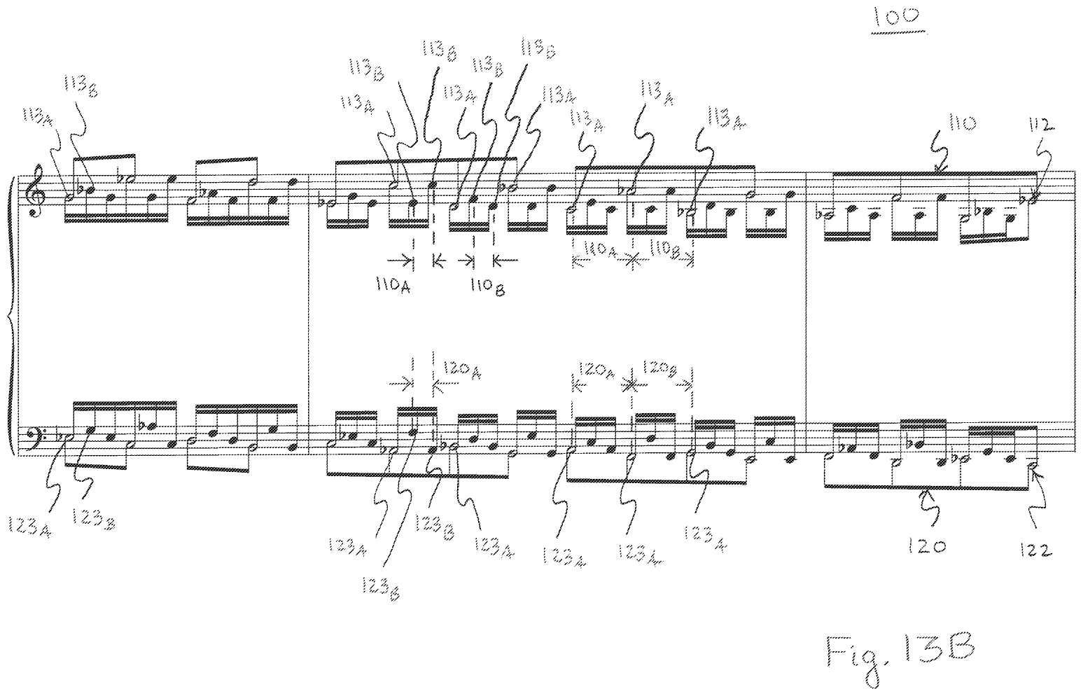

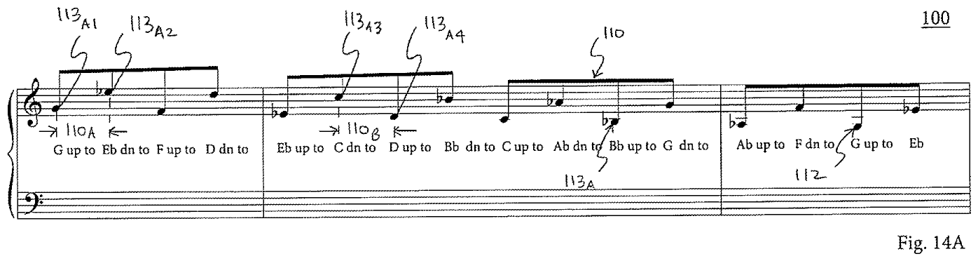

In selected embodiments, the teaching method 100 can present a first line 110 of music that comprises one or more hierarchical (or nested/double level of contrary motion) ascending line portions 110_{A} and/or descending line portions 110_{B}. Stated somewhat differently, a selected ascending line portion 110_{A} and/or a selected descending line portions 110_{B} can be disposed within another first line 110 of music. Each ascending line portion 110_{A} and/or descending line portion 110_{B} can be provided in the manner set forth in more detail above by reference to the ascending line portion 110_{A} and/or descending line portion 110_{B} of FIGS. 6A-D. In selected embodiments, at least one note 112 of the ascending line portion 110_{A} and/or at least one note 112 of the descending line portion 110_{B} can include a stem 112_{T}. and/or be associated with one or more ledger lines 112_{L} as illustrated in FIG. 12A.

As shown in FIG. 12A, for example, the teaching method 100 is shown as presenting a first line 110 of music excerpted from a Beethoven sonata. The first line 110 of music is illustrated as including a first line portion 117 and a second line portion 118. The first line portion 117 can comprise an ascending line portion that comprises a sequence of hollow musical notes 112_{H} with increasing pitch. Although shown and described with reference to FIG. 12A as comprising a single ascending line portion for purposes of illustration only, the first line portion 117 can include one or more ascending line portions 110_{A} (shown in FIG. 6A), wherein a selected ascending line portion 110_{A} can be adjacent to an intermediate line (also known as second level or “second voice” as it is said in music), the filled-in notes shown with reference to a second ascending line portion 118_{A} and/or a second descending line portion 118_{B}, such as a descending line portion 110_{B} (shown in FIG. 6A) or an unchanging (or steady) line portion (not shown). Additionally and/or alternatively, a selected pair of adjacent ascending line portions 110_{A} can be separated by an intermediate line portion, such as a descending line portion 110_{B} or an unchanging line portion.

The second line portion 118 is illustrated as including a plurality of groups of filled-in musical notes 112_{F}. Each respective group of filled-in musical notes 112_{F} is shown as being disposed between adjacent hollow musical notes 112_{H} in the first line portion 117. Stated somewhat differently, the groups of filled-in musical notes 112_{F} are illustrated as being nested within the first line portion 117. Advantageously, each group of filled-in musical notes 112_{F} can include a second ascending line portion 118_{A} and/or a second descending line portion 118_{B}. The second ascending line portion 118_{A} can comprise a sequence of filled-in musical notes 112_{F} that increase in pitch; whereas, the second descending line portion 118_{B} can comprise a sequence of filled-in musical notes 112_{F} that decrease in pitch. Stated somewhat differently, the second ascending line portion 118_{A} can include a note progression from a first filled-in note 112_{F} upwardly to a second filled-in note 112_{F}, wherein the note progression goes up in pitch. The second descending line portion 118_{B} similarly can include a note progression from a first filled-in note 112_{F} downwardly to a second filled-in note 112_{F}, wherein the note progression goes down in pitch.

It will be appreciated that the second line portion 118 can include one or more ascending line portions 118_{A} and/or one or more descending line portions 118_{B}. For example, a selected ascending line portion 118_{A} can be adjacent to an intermediate line portion, such as a descending line portion 118_{B} or an unchanging (or steady) line portion (not shown). Additionally and/or alternatively, a selected descending line portion 118_{B} can be adjacent to an intermediate line portion, such as an ascending line portion 118_{A} or an unchanging (or steady) line portion (not shown). In selected embodiments, a selected pair of adjacent ascending line portions 118_{A} can be separated by an intermediate line portion, such as a descending line portion 118_{B} or an unchanging line portion, and/or a selected pair of adjacent descending line portion 118_{B} can be separated by an intermediate line portion, such as an ascending line portion 118_{A} or an unchanging line portion. In some embodiments, the first line 110 of music optionally can include further a third ascending line portion (not shown) and/or a third descending line portion (not shown) that is nested, for example, within the second ascending line portion 118_{A} and/or the second descending line portion 118_{B}, and so on.

Turning to FIG. 12B, the teaching method 100 can include a first visual image 116 for visually presenting the first line 110 of music in the manner described in more detail herein with reference to the first visual image 116 shown in FIG. 6B. As illustrated in FIG. 12B, for instance, the first visual image 116 can include a first visual image portion 115 that is associated with the first line portion 117 and/or a second visual image portion 119 that is associated with the second line portion 118.

The first visual image portion 115, in selected embodiments, can be superimposed upon, disposed adjacent to, or otherwise incorporated into the first line portion 117 and/or can be used to visually indicate an ascending (or other) direction of the musical notes 112. As illustrated in FIG. 12B, for instance, the first line portion 117 of FIG. 12A can be reproduced with the first visual image portion 115 being incorporated into the first line portion 117 and visually illustrating the ascension of the musical notes 112 via lines, such as green lines, disposed between adjacent musical notes 112. Although shown and described with reference to FIG. 12B as using solid green lines between adjacent musical notes 112 of the first line portion 117 for purposes of illustration only, the first visual image portion 115 can visually illustrate the ascension of the musical notes 112 via use of lines of any color, shape, size, format and/or style (such as solid, dotted or dashed) or any other type of suitable visual indicia in the manner set forth above with regard to the first visual image 116 of FIG. 6B.

The second visual image portion 119 can be associated with the second line portion 118 in a similar manner. As illustrated in FIG. 12B, the second visual image portion 119 can comprise a plurality of nested visual image portions each being respectively associated with the one or more ascending line portions 118_{A} (shown in FIG. 12A) and/or one or more descending line portions 118_{B} (shown in FIG. 12A). The second visual image portion 119, for example, can include a first nested visual image portion 119_{A} and/or a second nested visual image portion 119_{B} as shown in FIG. 12B.

The first nested visual image portion 119_{A} can be associated with the ascending line portion 118_{A}. In selected embodiments, the first nested visual image portion 119_{A} can be superimposed upon, disposed adjacent to, or otherwise incorporated into the ascending line portion 118_{A} and/or can be used to visually indicate an ascending (or other) direction of the musical notes 112. As illustrated in FIG. 12B, for instance, the ascending line portion 118_{A} of FIG. 12A can be reproduced with the first nested visual image portion 119_{A} being incorporated into the ascending line portion 118_{A} and visually illustrating the ascension of the musical notes 112 via lines, such as green lines, disposed between adjacent musical notes 112. Although shown and described with reference to FIG. 12B as using solid green lines between adjacent musical notes 112 of the ascending line portion 118_{A} for purposes of illustration only, the first nested visual image portion 119_{A} can visually illustrate the ascension of the musical notes 112 via use of lines of any color, shape, size, format and/or style (such as solid, dotted or dashed) or any other type of suitable visual indicia in the manner set forth above with regard to the first visual image 116 of FIG. 6B.

Similarly, the second nested visual image portion 119_{B} can be associated with the descending line portion 118_{B}. In selected embodiments, the second nested visual image portion 119_{B} can be superimposed upon, disposed adjacent to, or otherwise incorporated into the descending line portion 118_{B} and/or can be used to visually indicate a descending (or other) direction of the musical notes 112. As illustrated in FIG. 12B, for instance, the descending line portion 118_{B} of FIG. 12A can be reproduced with the second nested visual image portion 119_{B} being incorporated into the descending line portion 118_{B} and visually illustrating the descending of the musical notes 112 via lines, such as red lines, disposed between adjacent musical notes 112. Although shown and described with reference to FIG. 12B as using solid red lines between adjacent musical notes 112 of the descending line portion 118_{B} for purposes of illustration only, the second nested visual image portion 119_{B} can visually illustrate the descending of the musical notes 112 via use of lines of any color, shape, size, format and/or style (such as solid, dotted or dashed) or any other type of suitable visual indicia in the manner set forth above with regard to the first visual image 116 of FIG. 6B.

Additionally and/or alternatively, the teaching method 100 of FIG. 12A can present a second line 120 of music that comprises one or more hierarchical (or nested) descending line portions 120_{A} and/or ascending line portions 120_{B}. Stated somewhat differently, a selected descending line portion 120_{A} and/or a selected ascending line portion 120_{B} can be disposed within another second line 120 of music. Each descending line portion 120_{A} and/or ascending line portion 120_{B} can be provided in the manner set forth in more detail above by reference to the descending line portion 120_{A} and/or ascending line portion 120_{B} of FIGS. 7A-D. In selected embodiments, at least one note 122 of the descending line portion 120_{A} and/or at least one note 122 of the ascending line portion 120_{B} can include a stem 122_{T} and/or be associated with one or more ledger lines 122_{L} as illustrated in FIG. 12A.

As shown in FIG. 12A, for example, the teaching method 100 is shown as presenting a second line 120 of music excerpted from a Beethoven sonata. The second line 120 of music is illustrated as including a first line portion 127 and a second line portion 128. The first line portion 127 can comprise a descending line portion that comprises a sequence of hollow musical notes 122_{H} with decreasing pitch. Although shown and described with reference to FIG. 12A as comprising a single descending line portion for purposes of illustration only, the first line portion 127 can include one or more descending line portions 120_{A} (shown in FIG. 7A), wherein a selected descending line portion 120_{A} can be adjacent to an intermediate line portion, such as an ascending line portion 120_{B} (shown in FIG. 7A) or an unchanging (or steady) line portion (not shown). Additionally and/or alternatively, a selected pair of adjacent descending line portions 120_{A} can be separated by an intermediate line portion, such as an ascending line portion 120_{B} or an unchanging line portion.

The second line portion 128 is illustrated as including a plurality of groups of filled-in musical notes 122_{F}. Each respective group of filled-in musical notes 122_{F} is shown as being disposed between adjacent hollow musical notes 122_{H} in the first line portion 127. Stated somewhat differently, the groups of filled-in musical notes 122_{F} are illustrated as being nested within the first line portion 127. Advantageously, each group of filled-in musical notes 122_{F} can include a second descending line portion 128_{A} and/or a second ascending line portion 128_{B}. The second descending line portion 128_{A} can comprise a sequence of filled-in musical notes 122_{F} that decrease in pitch; whereas, the second ascending line portion 128_{B} can comprise a sequence of filled-in musical notes 122_{F} that increase in pitch.

It will be appreciated that the second line portion 128 can include one or more descending line portions 128_{A} and/or one or more ascending line portions 128_{B}. For example, a selected descending line portion 128_{A} can be adjacent to an intermediate line portion, such as an ascending line portion 128_{B} or an unchanging (or steady) line portion (not shown). Additionally and/or alternatively, a selected ascending line portion 128_{B} can be adjacent to an intermediate line portion, such as a descending line portion 128_{A} or an unchanging (or steady) line portion (not shown). In selected embodiments, a selected pair of adjacent descending line portions 128_{A} can be separated by an intermediate line portion, such as an ascending line portion 128_{B} or an unchanging line portion, and/or a selected pair of adjacent ascending line portion 128_{B} can be separated by an intermediate line portion, such as a descending line portion 128_{A} or an unchanging line portion. In some embodiments, the second line 120 of music optionally can include further a third descending line portion (not shown) and/or a third ascending line portion (not shown) that is nested, for example, within the second descending line portion 128_{A} and/or the second ascending line portion 128_{B}, and so on.

Returning again to FIG. 12B, the teaching method 100 can include a second visual image 126 for visually presenting the second line 120 of music in the manner described in more detail herein with reference to the second visual image 126 shown in FIG. 7B. As illustrated in FIG. 12B, for instance, the second visual image 126 can include a first visual image portion 125 that is associated with the first line portion 127 and/or a second visual image portion 129 that is associated with the second line portion 128.

The first visual image portion 125, in selected embodiments, can be superimposed upon, disposed adjacent to, or otherwise incorporated into the first line portion 127 and/or can be used to visually indicate a descending (or other) direction of the musical notes 122. As illustrated in FIG. 12B, for instance, the first line portion 127 of FIG. 12A can be reproduced with the first visual image portion 125 being incorporated into the first line portion 127 and visually illustrating the descent of the musical notes 122 via lines, such as red lines, disposed between adjacent musical notes 122. Although shown and described with reference to FIG. 12B as using solid red lines between adjacent musical notes 122 of the first line portion 127 for purposes of illustration only, the first visual image portion 125 can visually illustrate the ascension of the musical notes 122 via use of lines of any color, shape, size, format and/or style (such as solid, dotted or dashed) or any other type of suitable visual indicia in the manner set forth above with regard to the second visual image 126 of FIG. 7B.

The second visual image portion 129 can be associated with the second line portion 128 in a similar manner. As illustrated in FIG. 12B, the second visual image portion 129 can comprise a plurality of nested visual image portions each being respectively associated with the one or more descending line portions 128_{A} (shown in FIG. 12A) and/or one or more ascending line portions 128_{B} (shown in FIG. 12A). The second visual image portion 129, for example, can include a first nested visual image portion 129_{A} and/or a second nested visual image portion 129_{B} as shown in FIG. 12B.

The first nested visual image portion 129_{A} can be associated with the descending line portion 128_{A}. In selected embodiments, the first nested visual image portion 129_{A} can be superimposed upon, disposed adjacent to, or otherwise incorporated into the descending line portion 128_{A} and/or can be used to visually indicate a descending (or other) direction of the musical notes 122. As illustrated in FIG. 12B, for instance, the descending line portion 128_{A} of FIG. 12A can be reproduced with the first nested visual image portion 129_{A} being incorporated into the descending line portion 128_{A} and visually illustrating the descent of the musical notes 122 via lines, such as red lines, disposed between adjacent musical notes 122. Although shown and described with reference to FIG. 12B as using solid red lines between adjacent musical notes 122 of the descending line portion 128_{A} for purposes of illustration only, the first nested visual image portion 129_{A} can visually illustrate the ascension of the musical notes 122 via use of lines of any color, shape, size, format and/or style (such as solid, dotted or dashed) or any other type of suitable visual indicia in the manner set forth above with regard to the second visual image 126 of FIG. 7B.

Similarly, the second nested visual image portion 129_{B} can be associated with the ascending line portion 128_{B}. In selected embodiments, the second nested visual image portion 129_{B} can be superimposed upon, disposed adjacent to, or otherwise incorporated into the ascending line portion 128_{B} and/or can be used to visually indicate an ascending (or other) direction of the musical notes 122. As illustrated in FIG. 12B, for instance, the ascending line portion 128_{B} of FIG. 12A can be reproduced with the second nested visual image portion 129_{B} being incorporated into the ascending line portion 128_{B} and visually illustrating the ascending of the musical notes 122 via lines, such as green lines, disposed between adjacent musical notes 122. Although shown and described with reference to FIG. 12B as using solid green lines between adjacent musical notes 122 of the ascending line portion 128_{B} for purposes of illustration only, the second nested visual image portion 129_{B} can visually illustrate the descending of the musical notes 122 via use of lines of any color, shape, size, format and/or style (such as solid, dotted or dashed) or any other type of suitable visual indicia in the manner set forth above with regard to the second visual image 126 of FIG. 7B.

Advantageously, the hierarchical (or nested) ascending line portions 110_{A} and the hierarchical (or nested) descending line portions 110_{B} can provide multiple levels of contrary motion. In selected embodiments, the teaching method 100 can include presentation of the first ascending line portion 117 of the music that ascends in pitch over time with the first descending line portion 127 that descends in pitch over time. Any descending line portion 110_{B} can be presented with any corresponding descending line portions 120_{B}. The teaching method 100 likewise can present the second ascending line portion 118_{A} with the second descending line portion 128_{A} and/or present the second descending line portion 118_{B} with the second ascending line portion 128_{B}. Stated somewhat differently, the teaching method 100 can simultaneously present the nested line portions 110_{A}, 110_{B}, 117, 118_{A}, 118_{B} of the first line 110 of the music and the nested line portions 120_{A}, 120_{B}, 127, 128_{A}, 128_{B} of second line 120 of the music in a manner that advantageously can facilitate understanding of the music through expansion of a compositional technique referred to herein as contrary motion.

Thereby, if played on a keyboard of a musical instrument, for example, the left hand 510L and the right hand 510R of the listener 500 (collectively shown in FIG. 4B) can move in contrary motion. In other words, the listener 500 can start by playing a selected hollow note 112_{H} of the first line portion 117 with the right hand 510R. The listener 500 then can sequentially play the group of filled-in musical notes 112_{F} of the second line portion 118 that follows the selected hollow note 112_{H}. The right hand 510R can move downwardly from the selected hollow note 112_{H} to the first filled-in note 112_{F} of the group, upwardly from the first filled-in note 112_{F} of the group to the second filled-in note 112_{F} of the group and downwardly from the second filled-in note 112_{F} of the group to the third filled-in note 112_{F} of the group. The listener 500 can proceed by playing the subsequent hollow musical notes 112_{H} and associated groups of filled-in musical notes 112_{F} of the first line portion 117 with the right hand 510R.

The left hand 510L of the listener 500 can do the opposite of the right hand 510R. For example, the left hand 510L of the listener 500 can start by playing a selected hollow note 122_{H} of the first line portion 127 with the left hand 510L. The listener 500 then can sequentially play the group of filled-in musical notes 122_{F} of the second line portion 128 that follows the selected hollow note 122_{H}. The left hand 510L can move upwardly from the selected hollow note 122_{H} to the first filled-in note 122_{F} of the group, downwardly from the first filled-in note 122_{F} of the group to the second filled-in note 122_{F} of the group and upwardly from the second filled-in note 122_{F} of the group to the third filled-in note 122_{F} of the group. The listener 500 can proceed by playing the subsequent hollow musical notes 122_{H} and associated groups of filled-in musical notes 122_{F} of the first line portion 127 with the left hand 510L. The left hand 510L and the right hand 510R of the listener 500 thereby can move in contrary motion.

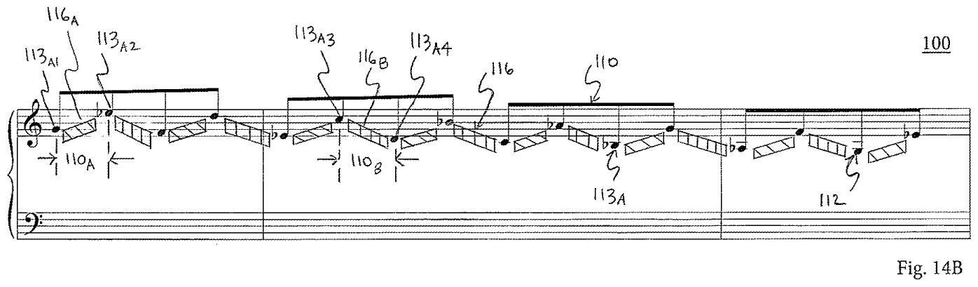

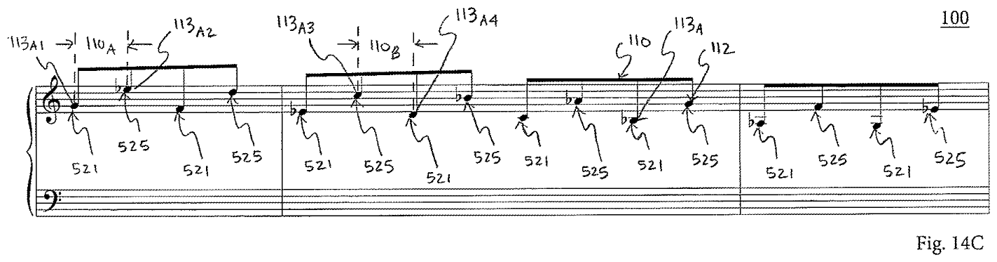

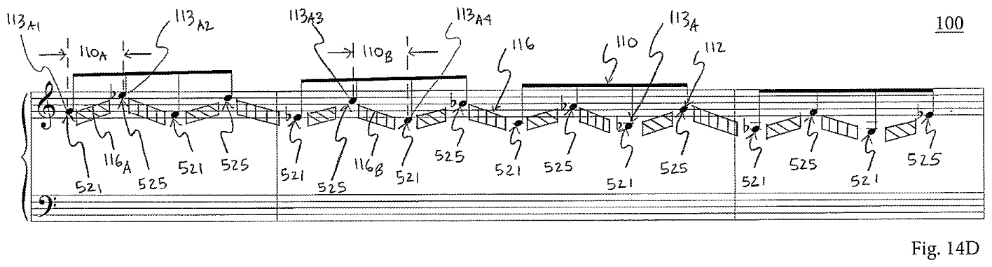

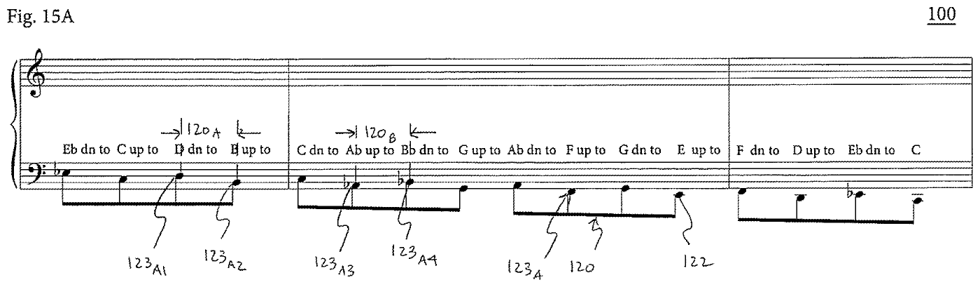

The teaching method 100 advantageously can be utilized with regard to any type, style or genre of music. Turning to FIG. 13A, for example, the teaching method 100 is shown as presenting a selected section of the musical score from Mozart Fantasia Number 1 Kochel 394. FIG. 13A illustrates how the selected section of the Mozart Fantasia looks in full form. FIGS. 13B, 14A-D, 15A-D, 16A-D illustrate the contrary motion that occurs on the main beats as well as the “ands” (or “secondary beats”) of the music. In other words, the contrary motion is shown in FIG. 13B via every third note beginning with the fourth note (there is no contrary motion on the first note) and continuing with the seventh note, tenth note, thirteenth note, sixteenth note, etc. of the Mozart Fantasia. FIGS. 14A-D, 15A-D, 16A-D illustrate auditory/visual/tactual use of the contrary motion, which is shown via the main beat notes and the secondary beat notes.

Turning to FIG. 13B, for example, the teaching method 100 is shown as presenting the section of the Mozart Fantasia of FIG. 13A. The Mozart Fantasia can include a first line 110 of music that comprises a first sequence with a first predetermined number of the musical notes 112. As illustrated in FIG. 13B, the musical notes 112 can include one or more hollow notes occurring on main beat notes or hollow secondary beat notes 113_{A} and at least one filled-in intermediate note 113_{B} disposed between adjacent hollow main and secondary beat notes 113_{A}. The hollow main and secondary beat notes 113_{A}, in some embodiments, can form one or more ascending line portions 110_{A} and/or one or more descending line portions 110_{B}. Additionally and/or alternatively, the filled-in intermediate notes 113_{B} can form one or more ascending line portions 110_{A} and/or one or more descending line portions 110_{B} in selected embodiments. In the manner discussed in more detail above with reference to FIG. 12, the hollow notes which constitute the main and secondary beat notes 113_{A} and the filled-in intermediate notes 113_{B} can comprise one or more hierarchical (or nested) ascending line portions 110_{A} and/or descending line portions 110_{B}.

As shown in FIG. 13B, the Mozart Fantasia can include a second line 120 of music that comprises a second sequence with a second predetermined number of the musical notes 122. The musical notes 122 is illustrated as including one or more main beat notes and secondary beat notes 123_{A} and at least one filled-in intermediate note 123_{B} disposed between adjacent main beat notes and secondary beat notes 123_{A}. The main and secondary beat notes 123_{A}, in some embodiments, can form one or more descending line portions 120_{A} and/or one or more ascending line portions 120_{B}. Additionally and/or alternatively, the filled-in intermediate notes 123_{B} can form one or more descending line portions 120_{A} and/or one or more ascending line portions 120_{B} in selected embodiments. In the manner discussed in more detail above with reference to FIG. 12, the main and secondary beat notes 123_{A} and the filled-in intermediate notes 123_{B} can comprise one or more hierarchical (or nested) descending line portions 120_{A} and/or ascending line portions 120_{B}.

Auditory

The teaching method 100 of FIG. 14A is shown as presenting the main beat notes 113_{A} from the Mozart Fantasia. A first set of main and secondary beat notes 113_{A}, such as a first main beat note (or a primary main beat note) 113_{A1} and a secondary beat note 113_{A2}, are illustrated as being arranged in one or more ascending line portions 110_{A}; whereas, a second set of main and secondary beat notes 113_{A}, such as a secondary beat note 113_{A3} and a main beat note 113_{A4}, are shown as being arranged in one or more descending line portions 110_{B}. Other main beat and secondary beat notes 113_{A} can be arranged in one or more unchanging line portions (not shown) in the manner discussed in more detail above with reference to FIG. 2A. The first line 110 of music as illustrated in FIG. 14A, for example, includes an ascending line portion 110_{A} followed by a descending line portion 110_{B}. For instance, the teaching method 100, at 210 (shown in FIG. 1), can include audibly presenting the first line 110 of music to the listener 500. The listener 500 thereby can utilize the auditory sense to hear the first line 110 of music and better understand the contrary motion in music.

Visual

In selected embodiments, the teaching method 100, at 210, can include visually presenting the first line 110 of music to the listener 500 as illustrated in FIG. 14B. In the manner discussed above with reference to FIG. 3A, the teaching method 100 can include a first visual image 116 for visually presenting the main and secondary beat notes 113_{A} of the first line 110 of music. The first visual image 116 can comprise one or more visual images based upon the nature of the first line 110 of music. As shown in FIG. 14B, for example, the first visual image 116 can include a first visual image portion 116_{A} that is associated with the first set of main and secondary beat notes 113_{A}, such as the primary main beat note 113_{A1} and the secondary beat note 113_{A2}, that form the ascending line portion 110_{A} and/or a second visual image portion 116_{B} that is associated with the second set of main and secondary beat notes 113_{A}, such as the secondary beat note 113_{A3} and the main beat note 113_{A4} that form the descending line portion 110_{B}. Stated somewhat differently, one or more visual image portions 116_{A}, 116_{B} can be associated with the first line 110 of music. The listener 500 thereby can utilize the visual sense to see the main and secondary beat notes 113_{A} of the first line 110 of music and better understand the contrary motion in music.

Tactile

Additionally and/or alternatively, the teaching method 100, at 210, can include tactilely presenting the first line 110 of music to the listener 500 as illustrated in FIG. 14C. In the manner discussed above with reference to FIGS. 4A and 5, the teaching method 100 can utilize the surface 300 (shown in FIG. 4A) to present the main and secondary beat notes 113_{A} of the first line 110 of music via the tactile sense of touch of the listener 500. As shown in FIG. 14C, for example, the main and secondary beat notes 113_{A} of the first line 110 of music can be associated with the digits 520 of the hands 510 of the listener 500. In selected embodiments, a predetermined main and secondary beat note 113_{A} of the first line 110 of music can be associated with two or more selected digits 520 of a selected hand 510 of the listener 500, and/or two or more predetermined main and secondary beat notes 113_{A} of the first line 110 of music can be associated with a selected digit 520 of the selected hand 510 of the listener 500.

In selected embodiments, each main and secondary beat note 113_{A} of the first line 110 of music can be associated with a selected digit 520 of a selected hand 510 of the listener 500. A first main beat note 113_{A} of the first line 110 of music can be associated with the thumb 521 of the right hand 510R of the listener 500. A secondary beat note 113_{A} of the first line 110 of music can be associated with the little finger 525 of the right hand 510R of the listener 500. The pattern of thumb 521 on main beat, and little finger 525 on the secondary beats, is repeated.

As shown in FIG. 14C, each main and secondary beat note 113_{A} of the ascending line portion 110_{A} and/or the descending line portion 110_{B} can be associated with a selected digit 520 of the right hand 510R of the listener 500. The listener 500 thereby can utilize the tactile sense to touch the first line 110 of music and better understand the contrary motion in music. Although shown and described with reference to FIG. 14C as being associated with selected digits 520 of the right hand 510R of the listener 500 for purposes of illustration only, the main and secondary beat notes 113_{A} of the first line 110 of music can be associated with any predetermined digits 520 of either hand 510 of the listener 500.

Auditory, Visual and Tactile

FIG. 14D illustrates yet another exemplary alternative embodiment of the teaching method 100, wherein the teaching method 100 includes audibly, visually and tactilely presenting the first line 110 of music. In other words, the teaching method 100, at 210, can include audibly presenting the main and secondary beat notes 113_{A} of the first line 110 of music to the listener 500, visually presenting the main and secondary beat notes 113_{A} of the first line 110 of music to the listener 500 and/or tactilely presenting the main and secondary beat notes 113_{A} of the first line 110 of music to the listener 500.

As illustrated in FIG. 14D, for example, the main and secondary beat notes 113_{A} of the first line 110 of music can be audibly presented to the listener 500 in the manner shown and described above with reference to FIG. 14A. The main and secondary beat notes 113_{A} of the first line 110 of music optionally can be visually presented to the listener 500 in the manner shown and described above with reference to FIG. 14B. Additionally and/or alternatively, the main and secondary beat notes 113_{A} of the first line 110 of music can be tactilely presented to the listener 500 in the manner shown and described above with reference to FIG. 14C. The listener 500 thereby can utilize one or more senses to appreciate the main and secondary beat notes 113_{A} of the first line 110 of music and better understand the contrary motion in music.

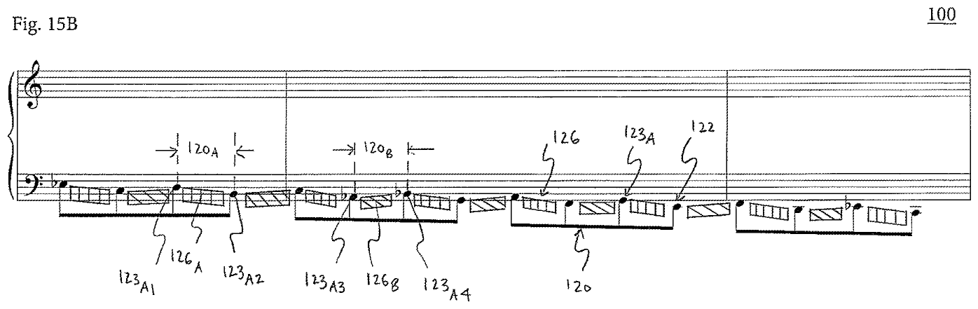

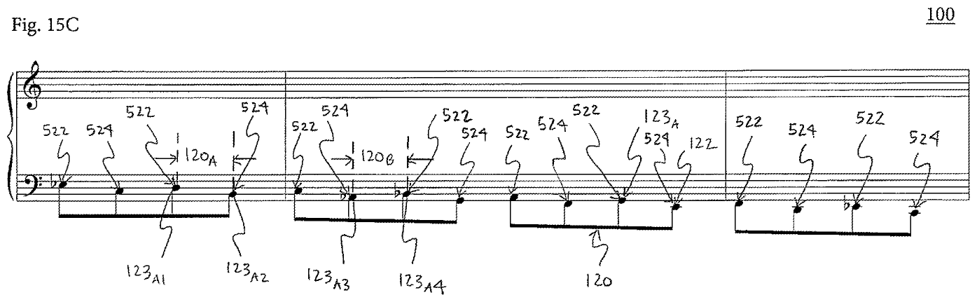

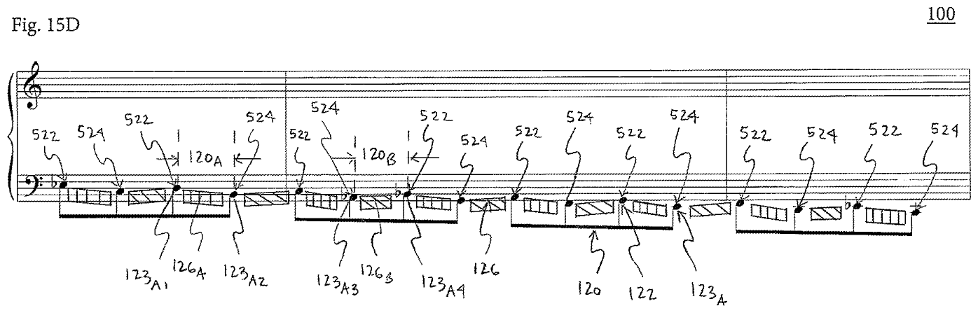

Additionally and/or alternatively, the teaching method 100 can include presenting the main and secondary beat notes 123_{A} from the Mozart Fantasia as the second line 120 of music, at 220, to the listener 500 (shown in FIG. 4A) in the manner discussed in more detail above with reference to FIG. 1. Turning to FIG. 15A, a first set of main and secondary beat notes 123_{A}, such as a first main beat note (or a primary main beat note) 123_{A1} and a secondary beat note 123_{A2}, are illustrated as being arranged in one or more descending line portions 120_{A}; whereas, a second set of main beat notes 123_{A}, such as a secondary beat note 123_{A3} and a main beat note 123_{A4}, are shown as being arranged in one or more ascending line portions 120_{B}. Other main and secondary beat notes 123_{A} can be arranged in one or more unchanging line portions (not shown) in the manner discussed in more detail above with reference to FIG. 2B.

The second line 120 of music as illustrated in FIG. 15A, for example, includes a descending line portion 120_{A} followed by an ascending line portion 120_{B}. For instance, the teaching method 100, at 220 (shown in FIG. 1), can include audibly presenting the second line 120 of music to the listener 500. The listener 500 thereby can utilize the auditory sense to hear the second line 120 of music and better understand the contrary motion in music. The second line 120 of music, for example, can be presented to the listener 500 in any conventional manner, such as in an audible manner, a visual manner, and/or a tactile manner, without limitation. Stated somewhat differently, the second line 120 of music can be audibly, visually and/or tactilely presented to the listener 500.

Auditory

Turning to FIG. 15A, the teaching method 100 is shown as presenting the main and secondary beat notes 123_{A} from the Mozart Fantasia. A first set of main and secondary beat notes 123_{A}, such as primary main beat note 123_{A1} and the secondary beat note 123_{A2}, are illustrated as being arranged in one or more descending line portions 120_{A}; whereas, a second set of main and secondary beat notes 123_{A}, such as the secondary beat note 123_{A3} and the main beat note 123_{A4}, are shown as being arranged in one or more ascending line portions 120_{B}. Other main beat notes and secondary 123_{A} can be arranged in one or more unchanging line portions (not shown) in the manner discussed in more detail above with reference to FIG. 2B. The second line 120 of music as illustrated in FIG. 15A, for example, includes a descending line portion 120_{A} followed by an ascending line portion 120_{B}. For instance, the teaching method 100, at 220 (shown in FIG. 1), can include audibly presenting the second line 120 of music to the listener 500. The listener 500 thereby can utilize the auditory sense to hear the second line 120 of music and better understand the contrary motion in music.

Visual

In selected embodiments, the teaching method 100, at 220, can include visually presenting the second line 120 of music to the listener 500 as illustrated in FIG. 15B. In the manner discussed above with reference to FIG. 3B, the teaching method 100 can include a second visual image 126 for visually presenting the main and secondary beat notes 123_{A} of the second line 120 of music. The second visual image 126 can comprise one or more visual images based upon the nature of the second line 120 of music. As shown in FIG. 15B, for example, the first visual image 126 can include a first visual image portion 126_{A} that is associated with the first set of main and secondary beat notes 123_{A}, such as the primary main beat note 123_{A1} and the secondary beat note 123_{A2}, that form the descending line portion 120_{A} and/or a second visual image portion 126_{B} that is associated with the second set of main and secondary beat notes 123_{A}, such as the secondary beat note 123_{A2} and the secondary beat note 123_{A3} and the main beat note 123_{A4} that form the ascending line portion 120_{B}. The listener 500 thereby can utilize the visual sense to see the second line 120 of music and better understand the contrary motion in music.

Tactile

Additionally and/or alternatively, the teaching method 100, at 220, can include tactilely presenting the second line 120 of music to the listener 500 as illustrated in FIG. 15C. In the manner discussed above with reference to FIGS. 4A and 5, the teaching method 100 can utilize the surface 300 (shown in FIG. 4A) to present the main and secondary beat notes 123_{A} of the second line 120 of music via the tactile sense of touch of the listener 500. As shown in FIG. 15C, for example, the main and secondary beat notes 123_{A} of the second line 120 of music can be associated with the digits 520 of the hands 510 of the listener 500. In selected embodiments, a predetermined main and secondary beat note 123_{A} of the second line 120 of music can be associated with two or more selected digits 520 of a selected hand 510 of the listener 500, and/or two or more predetermined main and secondary beat notes 123_{A} of the second line 120 of music can be associated with a selected digit 520 of the selected hand 510 of the listener 500.

In selected embodiments, each main and secondary beat note 123_{A} of the second line 120 of music can be associated with a selected digit 520 of a selected hand 510 of the listener 500. A first main beat note 123_{A} of the second line 120 of music can be associated with the index finger 522 of the left hand 510L of the listener 500. A secondary beat note 123_{A} of the second line 120 of music can be associated with the ring finger 524 of the left hand 510L of the listener 500; The pattern of index finger 522 of 510L on main beat, and ring finger 524 of 510L on the secondary beats is repeated throughout the example.

As shown in FIG. 15C, each main and secondary beat notes 123_{A} of the descending line portion 120_{A} and/or the ascending line portion 120_{B} can be associated with a selected digit 520 of the right hand 510R of the listener 500. The listener 500 thereby can utilize the tactile sense to touch the second line 120 of music and better understand the contrary motion in music. Although shown and described with reference to FIG. 15C as being associated with selected digits 520 of the right hand 510R of the listener 500 for purposes of illustration only, the main and secondary beat notes 123_{A} of the second line 120 of music can be associated with any predetermined digits 520 of either hand 510 of the listener 500.

Auditory, Visual and Tactile

FIG. 15D illustrates yet another exemplary alternative embodiment of the teaching method 100, wherein the teaching method 100 includes audibly, visually and tactilely presenting the second line 120 of music. In other words, the teaching method 100, at 220, can include audibly presenting the main and secondary beat notes 123_{A} of second line 120 of music to the listener 500, visually presenting the main and secondary beat notes 123_{A} of second line 120 of music to the listener 500 and/or tactilely presenting the main and secondary beat notes 123_{A} of second line 120 of music to the listener 500.

As illustrated in FIG. 15D, for example, the main and secondary beat notes 123_{A} of second line 120 of music can be audibly presented to the listener 500 in the manner shown and described above with reference to FIG. 15A. The main and secondary beat notes 123_{A} of second line 120 of music optionally can be visually presented to the listener 500 in the manner shown and described above with reference to FIG. 15B. Additionally and/or alternatively, the main and secondary beat notes 123_{A} of second line 120 of music can be tactilely presented to the listener 500 in the manner shown and described above with reference to FIG. 15C. The listener 500 thereby can utilize one or more senses to appreciate the second line 120 of music and better understand the contrary motion in music.

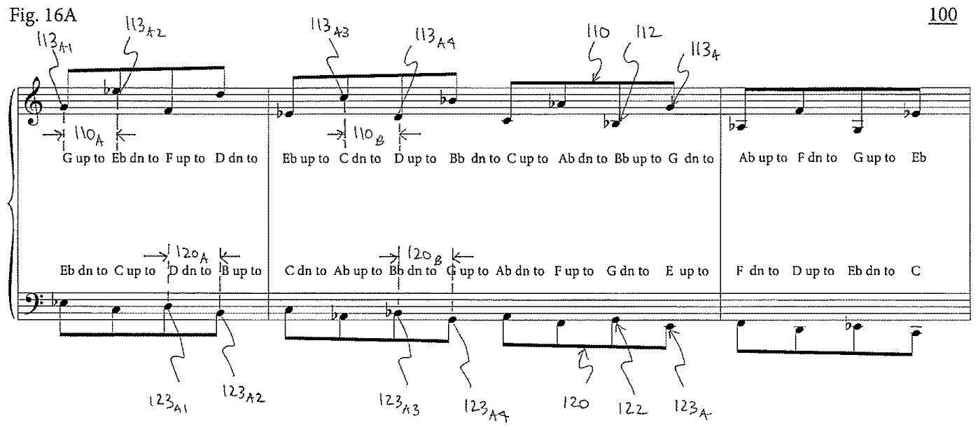

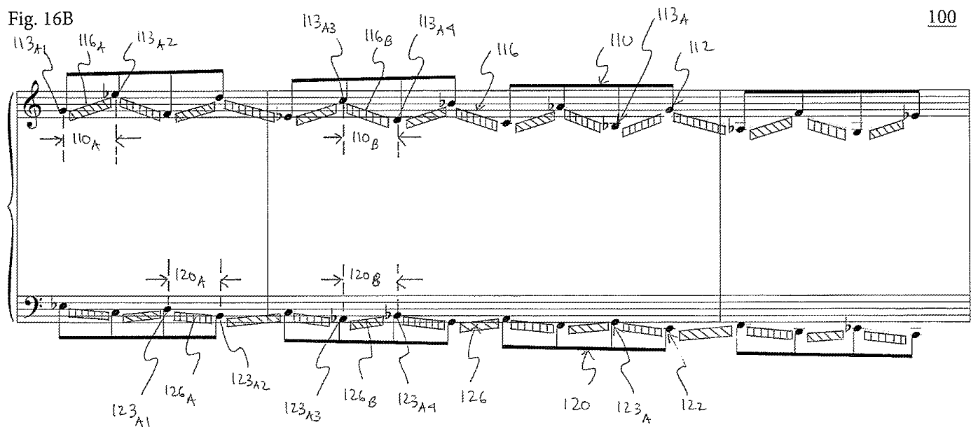

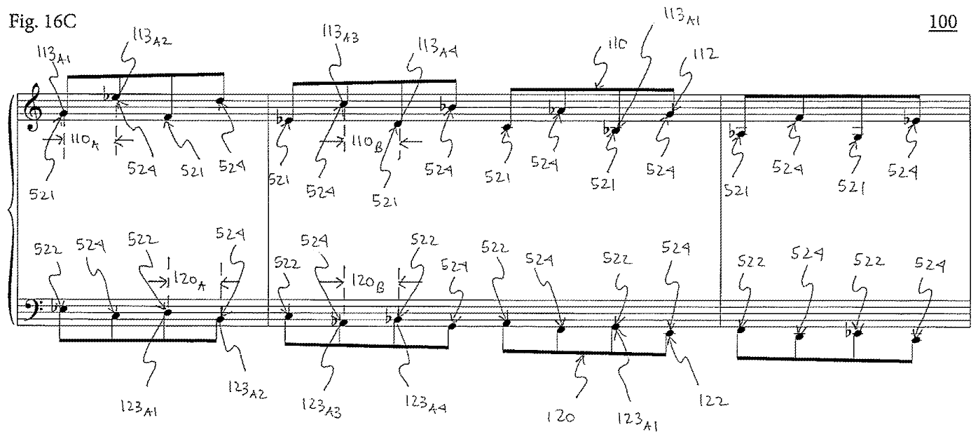

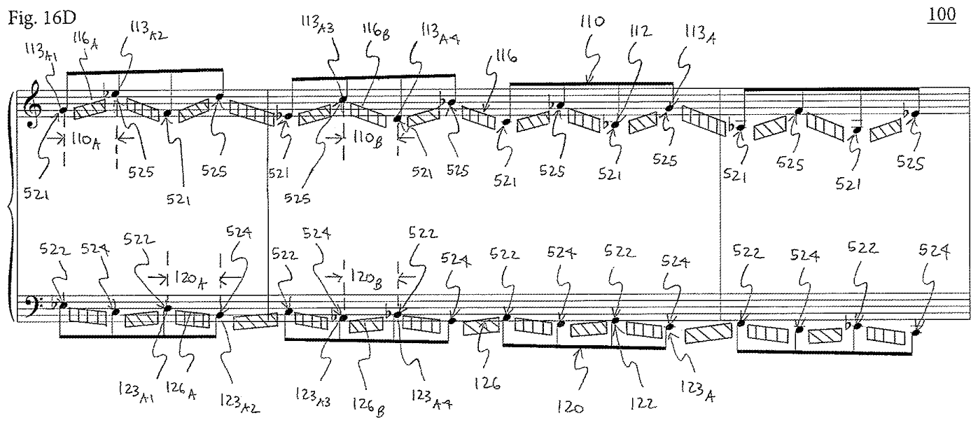

The teaching method 100 advantageously can include presenting the first and second lines 110, 120 of the Mozart Fantasia, at 230, to the listener 500 (shown in FIG. 4A) in the manner discussed in more detail above with reference to FIG. 1. The main and secondary beat notes 113_{A}, 123_{A} of the first and second lines 110, 120 of music as shown in FIG. 16A can be presented to the listener 500 in any conventional manner, such as in an audible manner, a visual manner, and/or a tactile manner, without limitation. Stated somewhat differently, the main and secondary beat notes 113_{A}, 123_{A} of the first and second lines 110, 120 of music can be audibly, visually and/or tactilely presented to the listener 500. In selected embodiments, a teacher (not shown) may present the first and second lines 110, 120 of music to a student or other listener 500.

Contrary Motion in Music—Auditory

Turning to FIG. 16A, the first line 110 of music is shown as including a sequence of two or more main and secondary beat notes 113_{A}; whereas, the second line 120 of music is illustrated as including a sequence of two or more main and secondary beat notes 123_{A}. The two or more main and secondary beat notes 113_{A} are illustrated as being provided in the manner of the two or more main and secondary beat notes 113_{A} as shown and described above with reference to FIG. 14A; whereas, the two or more main and secondary beat notes 123_{A} are illustrated as being provided in the manner of the two or more main and secondary beat notes 123_{A} as shown and described above with reference to FIG. 15A.

The main and secondary beat notes 113_{A} of the first line 110 of music, for example, can comprise an ascending line portion 110_{A} followed by a descending line portion 110_{B}. Additionally and/or alternatively, the main and secondary beat notes 123_{A} of the second line 120 of music can include a descending line portion 120_{A} followed by an ascending line portion 120_{B}. In selected embodiments, the teaching method 100, at 230 (shown in FIG. 1), can include audibly presenting the first and second lines 110, 120 of music together to the listener 500. The listener 500 thereby can utilize the auditory sense to hear the first and second lines 110, 120 of music and better understand the contrary motion in music.

Contrary Motion in Music—Visual

In selected embodiments, the teaching method 100, at 230, can include visually presenting the first and second lines 110, 120 of music to the listener 500 as illustrated in FIG. 16B. In the manner discussed above with reference to FIG. 3C, the teaching method 100 can include visual images 116, 126 for visually presenting the first and second lines 110, 120 of music. The visual images 116, 126 can comprise one or more visual images based upon the nature of the main and secondary beat notes 113_{A}, 123_{A} of the first and second lines 110, 120 of music, respectively. As shown in FIG. 16B, for example, the visual image 116 can include one or more visual image portions 116_{A}, 116_{B} that are associated with the main and secondary beat notes 113_{A} of the first line 110 of music in the manner discussed in more detail above with reference to FIG. 14B, and/or the visual image 126 can include one or more visual image portions 126_{A}, 126_{B} that are associated with the main beat and secondary notes 123_{A} of the second line 120 of music in the manner discussed in more detail above with reference to FIG. 15B. The listener 500 thereby can utilize the visual sense to see the main beat and secondary notes 113_{A} of the first line 110 of music and the main and secondary beat notes 123_{A} of the second line 120 of music and thereby better understand the contrary motion in music.

Contrary Motion in Music—Tactile

Additionally and/or alternatively, the teaching method 100, at 230, can include tactilely presenting the main beat and secondary notes 113_{A} of the first line 110 of music and the main and secondary beat notes 123_{A} of the second line 120 of music to the listener 500 as illustrated in FIG. 16C. In the manner discussed above with reference to FIGS. 4A and 5, the teaching method 100 can utilize the surface 300 (shown in FIG. 4A) to present the main and secondary beat notes 113_{A} of the first line 110 of music and the main and secondary beat notes 123_{A} of the second line 120 of music via the tactile sense of touch of the listener 500. The main and secondary beat notes 113_{A} of the first line 110 of music and the main and secondary beat notes 123_{A} of the second line 120 of music can be associated with the digits 520 of the hands 510 of the listener 500.

As shown in FIG. 16C, the main beat and secondary notes 113_{A} of the first line 110 of music can be associated with the digits 520 of a first hand 510 of the listener 500 in the manner set forth in additional detail with reference to FIG. 14C; whereas, the main beat and secondary notes 123_{A} of the second line 120 of music can be associated with the digits 520 of a second hand 510 of the listener 500 in the manner set forth in additional detail with reference to FIG. 15C. Each main beat and secondary note 113_{A}, 123_{A}, for example, can be associated with a selected digit 520 of a selected hand 510 of the listener 500. All first main beat notes 113_{A}, 123_{A} can be associated with the thumb 521 of the right hand 510R while the left hand 510L is associated with the index finger 522, of the listener 500. The secondary beat notes 113_{A} can be associated with the little finger 525 of the first hand 510R, of the listener 500; whereas, the secondary beat notes of 123_{A} can be associated with the ring finger 524 of left hand 510L. The pattern is in contrary motion, but not mirror image, providing the listener 500 with another tactual experience of opposition or contrary motion.

The listener 500 thereby can utilize the tactile sense to touch the main beat and secondary notes 113_{A} of the first line 110 of music and the main beat and secondary notes 123_{A} of the second line 120 of music and thereby better understand the contrary motion in music. Although shown and described with reference to FIG. 16C as being associated with selected digits 520 of the respective hands 510 of the listener 500 for purposes of illustration only, the main and secondary beat notes 113_{A} of the first line 110 of music and/or the main and secondary beat notes 123_{A} of the second line 120 of music can be associated with any predetermined digits 520 of either hand 510 of the listener 500.

Contrary Motion in Music—Auditory, Visual and Tactile

FIG. 16D illustrates yet another exemplary alternative embodiment of the teaching method 100, wherein the teaching method 100 includes audibly, visually and tactilely presenting the first and second lines 110, 120 of music. In other words, the teaching method 100, at 230, can include audibly presenting the main and secondary beat notes 113_{A} of the first line 110 of music and the main and secondary beat notes 123_{A} of the second line 120 of music to the listener 500, visually presenting the main and secondary beat notes 113_{A} of the first line 110 of music and the main and secondary beat notes 123_{A} of the second line 120 of music to the listener 500 and/or tactilely presenting the main and secondary beat notes 113_{A} of the first line 110 of music and the main beat and secondary notes 123_{A} of the second line 120 of music to the listener 500.

As illustrated in FIG. 16D, for example, the main beat and secondary notes 113_{A} of the first line 110 of music and the main and secondary beat notes 123_{A} of the second line 120 of music can be audibly presented to the listener 500 in the manner shown and described above with reference to FIG. 16A. The main beat and secondary notes 113_{A} of the first line 110 of music and the main and secondary beat notes 123_{A} of the second line 120 of music optionally can be visually presented to the listener 500 in the manner shown and described above with reference to FIG. 16B. Additionally and/or alternatively, the main and secondary beat notes 113_{A} of the first line 110 of music and the main and secondary beat notes 123_{A} of the second line 120 of music can be tactilely presented to the listener 500 in the manner shown and described above with reference to FIG. 16C. The listener 500 thereby can utilize one or more senses to appreciate the main and secondary beat notes 113_{A} of the first line 110 of music and the main beat and secondary notes 123_{A} of the second line 120 of music and thereby better understand the contrary motion in music.

Contrary motion can exist in a myriad of forms. Based upon the embodiments of the teaching method 100 as described above, lines of music in general, and music in contrary motion becomes much easier to identify in other music, as the ear becomes somewhat trained. The basic exercises of the teaching method 100 described herein can be repeated. The ability to hear this most important facet of classical music becomes stronger with practice. Part of the fabric of classical music is Contrary Motion; even modern and so-called atonal composers often display Contrary Motion throughout their compositions, while the tones of melody, and harmony, seem to be of lesser consequence. Rhythm can provide placement for all notes.

Contrary motion may hold the attention of the listener 500 engaged in a piece of classical music, enhanced by the visual and kinesthetic senses provided herein. Contrary Motion might be considered the rudder of the boat or airplane.

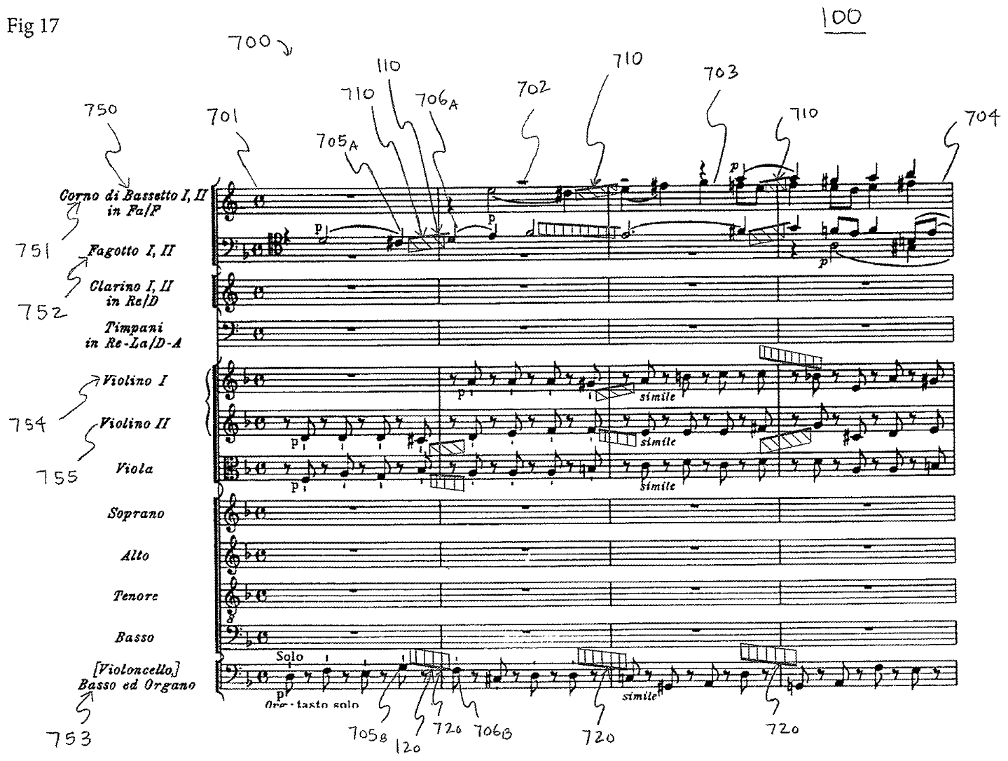

Before moving to the more in-depth assimilation of the visual and kinesthetic support of hearing Contrary Motion, the five examples in FIGS. 17-21 illustrate other Contrary Motion considerations.

In choral, solo or orchestral music the one or both of the two lines of music moving in contrary motion might switch to another instrument, line, or voice, in order to maintain the continuity of contrary motion. Contrary Motion can be shuffled between various instruments and is the sole component intrinsic to classical music, especially over the bar line as described earlier.

Turning to FIG. 17, the teaching method 100 is shown with reference to the opening four measures 701, 702, 703, 704 of the Mozart Requiem. These measures 701, 702, 703, 704 are played by several musical instruments 750 and exhibit an ascending line 710 of music that begun and discontinued by a bassoon 752 and later continued by a French horn 751. Metaphorically, the ascending line 710 of music being performed by two musical instruments 750 can be likened to a relay race where a baton is passed from one runner to another throughout the course.

One might notice that within an orchestra, the “wind section” might complete the contrary motion that may have started in the string section, for example. Switching to a different instrumentation allows the Contrary Motion to continue, and possibly offer more notice—as the sonority has changed.

First Measure 701 into Second Measure 702

The bassoon 752 can perform the ascending line 710 of music by playing a last note 705_{A} of the first measure 701 and ascending to a first note 706_{A} of the second measure 702. Meanwhile, a cello 753 on the lowest line, can perform a descending line 720 of music by playing a last note 705_{B} of the first measure 701 and descending to a first note 706_{B} of the second measure 702. The contrary motion is set up; the cello 753 provides the descending line 720 of music against the ascending line 710 of music performed by the bassoon 752.

Second Measure 702 into Third Measure 703

The contrary motion switches instruments; the French horn 751 in the top line picks up the ascending line 710 of music of contrary motion as the cello 753 continues to perform the descending line 720 of music. The bassoon 752 becomes a harmonic addition to the cello 753, instead of playing contrary motion to the cello 753. As “harmony,” the bassoon 752 blends in with the cello 753.

Third Measure 703 into Fourth Measure 704

Rhythmic variations also exist in establishing contrary motion. Off beats, such as beat “4&” often lead into beat one, such as the French horn 751 (with music note stem pointed down) on the top line can perform the ascending line 710 of music by ascending on the last eighth note of the third measure 703, beat “4&” moves to the first beat of the fourth measure 704 as the cello 753 performs the descending line 720 of music by descending from a “main beat” to another “main beat;” that is; from the fourth beat of the third measure 703 to the first beat of the fourth measure 704.

Syncopated rhythm, or rhythmic variety, offers another approach to Contrary Motion. First violin 754 and second violin 755 exhibit a slight rhythmic variety and syncopation of contrary motion from the first measure 701 to the second measure 702, again from the second measure 702 to the third measure 703 and again from the third measure 703 to the fourth measure 704. The rhythmic figure starts on beat “4&” but arrives on “1&,” as opposed to arriving directly on the main beat, beat one—which sets up a syncopation.

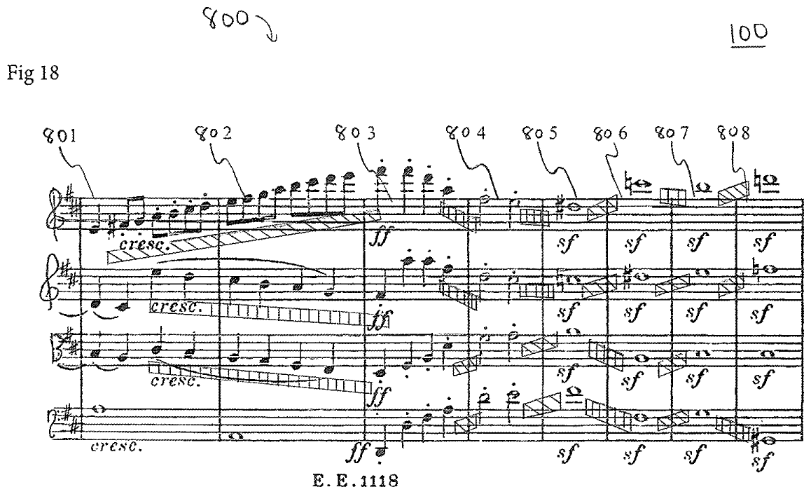

Rhythmic variety can be taken further without obscuring the contrary motion. Beethoven 800, for example, sometimes takes an opposite approach as illustrated in FIG. 18. Turning to FIG. 18, after a busy rhythmic passage of playing of measures 801, 802, 803, 804, Beethoven 800 abruptly presents whole notes, in a chorale style, while bringing attention to an important facet of Contrary Motion. It seems that Beethoven 800 was generous in showing Contrary Motion to the listener 500 (shown in FIG. 4A), making it as easy as possible for listener 500 to hear by slowing the action down with whole notes. Measures 801, 802, 803 with eighth notes and quarter notes arrives at a slowed down measure of whole notes in measures 804, 805, 806, 807, 808.

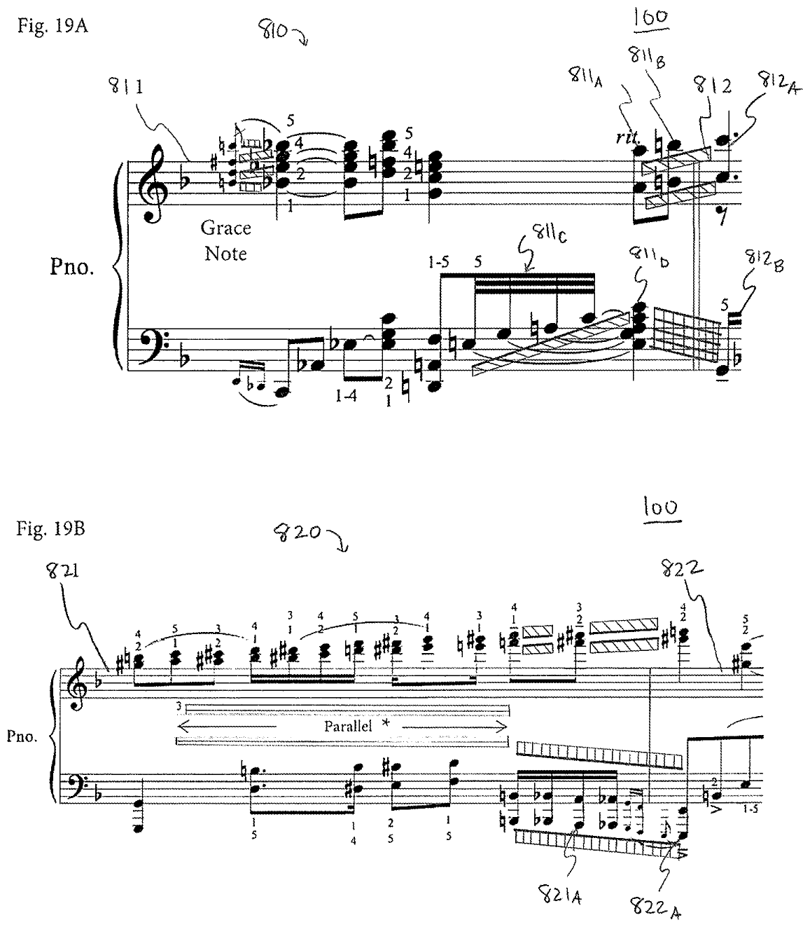

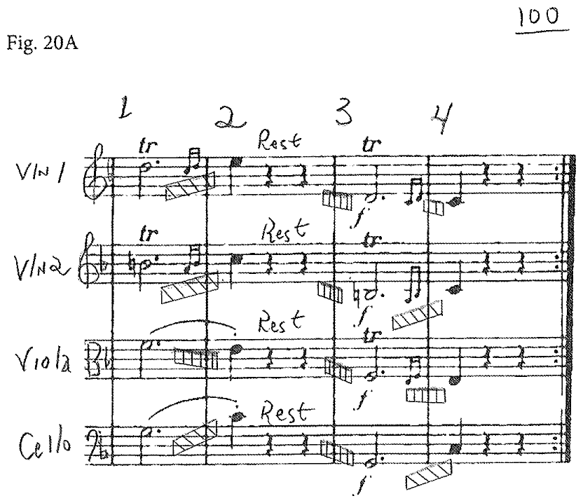

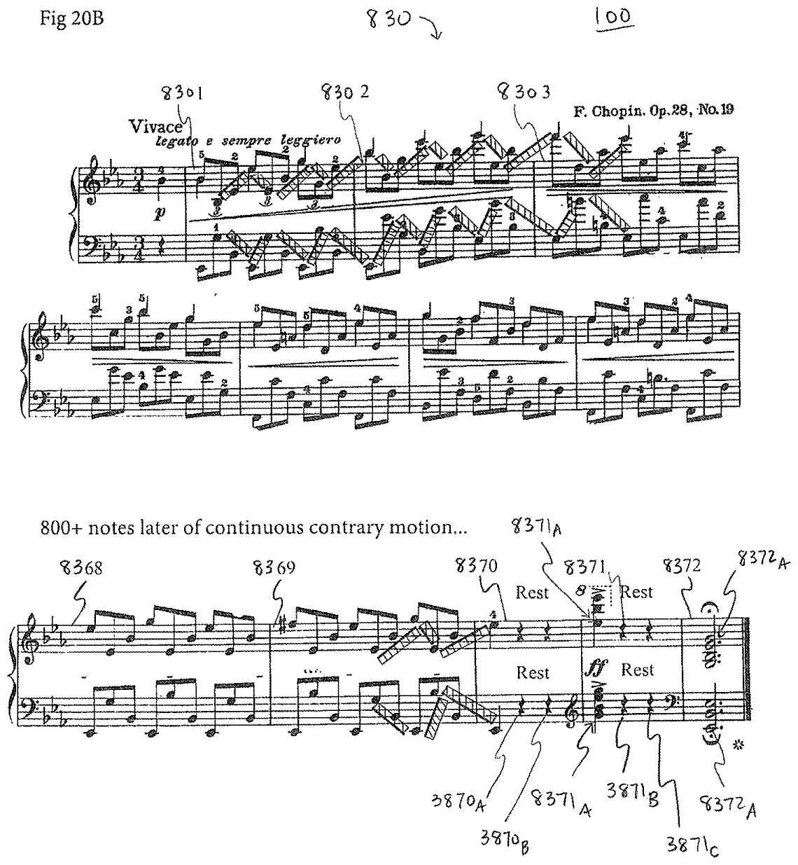

Various rhythmic schemes are shown and described with reference to FIGS. 19A-B. Turning first to FIG. 19A, contrary motion is shown as occurring between two adjacent chords going into beat one from a grace note. At first glance it looks like parallel motion, however the two middle notes (or voices) ascend, as the outer notes, B natural octaves, descends to B flat octaves.

FIG. 19A shows that, in a first measure 811, beat “3&” in the lower staff is an arpeggiated chord 811_{C} in green and has four notes tied over—into beat 4. One note 811D is played on beat 4 in the first measure 811, but the chord is not re-struck. The upper staff has ascending octaves in two eighth notes 811_{A}, 811_{B} from beat 4 of the first measure 811, into beat one of a second measure 812. Crossing into the bar line into second measure 812. The octave, at 812_{A}, in the top staff is in Contrary Motion to the held notes from 811D into the lower staff going into the second measure 812.

Lines that are partially in contrary motion or not in contrary motion but in parallel motion also exist in classical music, and other styles of music.

As illustrated in FIG. 19B, for example, parallel motion is shown in blue parallel lines on second and third beats of a first measure 821 and is marked with an asterisk *. The two lines of Contrary Motion may also have different note values such as quarter notes, eighth notes, sixteenth notes, or even whole notes before arriving at a second measure 822 in contrary motion.

As shown in FIG. 19B, the upper staff has ascending eighth notes 821_{A} at the end of the first measure 821 in green moving to the first beat 822_{A} of the second measure 822. The lower staff has descending sixteenth notes 821_{B} at the end of the first measure 821 in red moving to the first beat 822_{A} of the second measure 822.

Exceptions to contrary motion exist. Classical music makes the distinction of having contrary motion take place over the bar line, that is the last note(s) of the last beat of one measure to the first note(s) of the next measure and, often in the middle beats throughout the piece. In a few classical pieces the piece has contrary motion on every note.

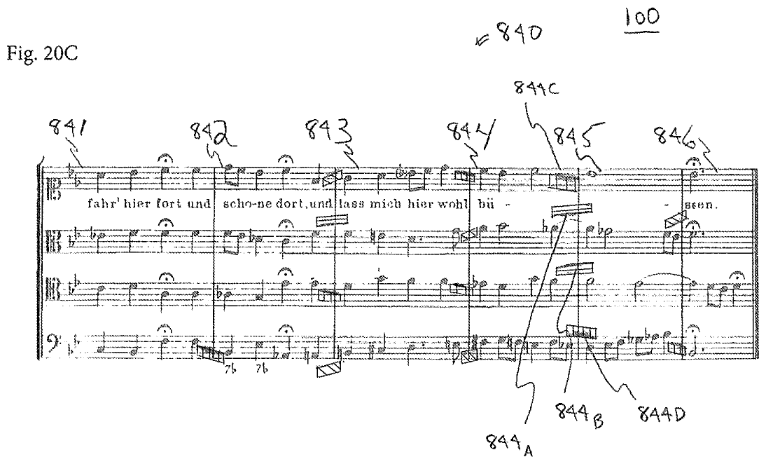

An exemplary exception to contrary motion is illustrated in FIG. 20A. As a rule, if there is a rest, (no notes played or sung), the music following the rest(s) may re-enter, without being in contrary motion from the previous notes—the music that precedes the rest(s). The idea being, that after a rest, the ear might start afresh.

A few pieces of classical music have the entire piece or movement in contrary motion. Chopin Op. 28 Prelude in E flat, for example, is shown in FIG. 20B. Turning to FIG. 20B, measures 8301, 8302, 8303, . . . , 8372 of Chopin Op. 28 Prelude in E flat are shown as containing two lines with over one thousand notes of consistent Contrary Motion. A penultimate measure 8371 includes a first chord 8371_{A}, preceded by one or more rests 8370_{A}, 8370_{B} and followed by one or more rests 8371_{B}, 8371_{C}.

Chopin in redeeming some kind of Contrary Motion, even when not required, invents a new breed of Contrary Motion, and ingeniously places the notes of the right hand of penultimate measure 8371, into the left hand of second measure 8372, and places the notes of the left hand of penultimate measure 8371 into the right hand of second measure 8372.

Another exception to Contrary Motion is “Oblique Motion” as shown in FIG. 20C. In “Oblique Motion,” one note (or voice) repeats a pitch or is tied into a next measure with the same pitch; while, other notes (or voices) move in one direction, up or down.

FIG. 20C shows measures 841-846 of the Bach Chorale from Cantata 48 840, composed in 1723, titled, “Ich elender Mensch.” The Bach Chorale from Cantata 48 840 demonstrates oblique motion. Oblique motion, for example, is demonstrated from beat 4 of measure 844 into beat 1 of measure 845. Blue straight lines 844_{A}, 844_{B} each extend from beat 4 of the measure 844, in the second and third staff to measure 845. In the second staff, an A flat note is tied into another A flat note, and in the third staff, a F note is tied into another F note. The outer two notes (or voices) 844_{C}, 844_{D} are shown descending, and there is no ascending line going into measure 845. Since the notes tied by the blue straight lines 844_{A}, 844_{B} are the same note, these tied knows demonstrate what is known as “oblique motion” and not contrary motion or parallel motion.

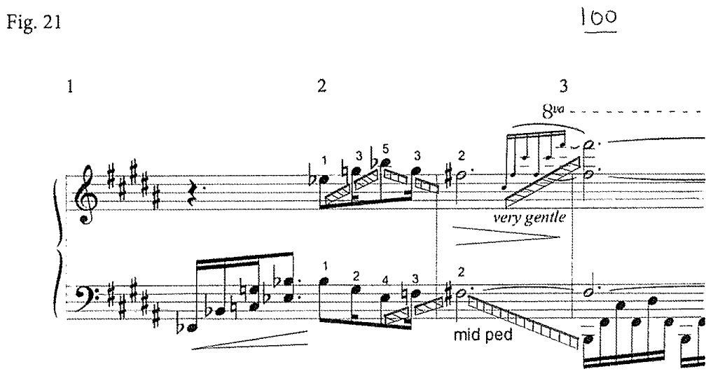

FIG. 21 demonstrates contrary motion ending on one note. A single note, or the same note in different octaves, played or sung by a group, can be followed by notes in Contrary Motion. Stated somewhat differently: two or more notes moving in Contrary Motion can be preceded immediately by a single note, or a different octave of the same note. The subsequent notes one higher and one lower than the single note creates contrary motion. The two notes can be played by different instruments, voices, or a single instrument such as a piano. A piano might use stem up and stem down on note to indicate the direction of the notes. For clarity, the single note might also be notated with both a stem up and a stem down. One of the main points for Contrary Motion is to hear individual lines enable expanded hearing.

Choir: Auditory, Visual and Kinesthetic Senses

Group singing, or singing in a choir, is an activity in which a large segment of the population participates. An estimated forty-million people or more currently in the United States have belonged at one time to choirs held in places of worship, schools, and independent or professional vocal groups and singing associations.

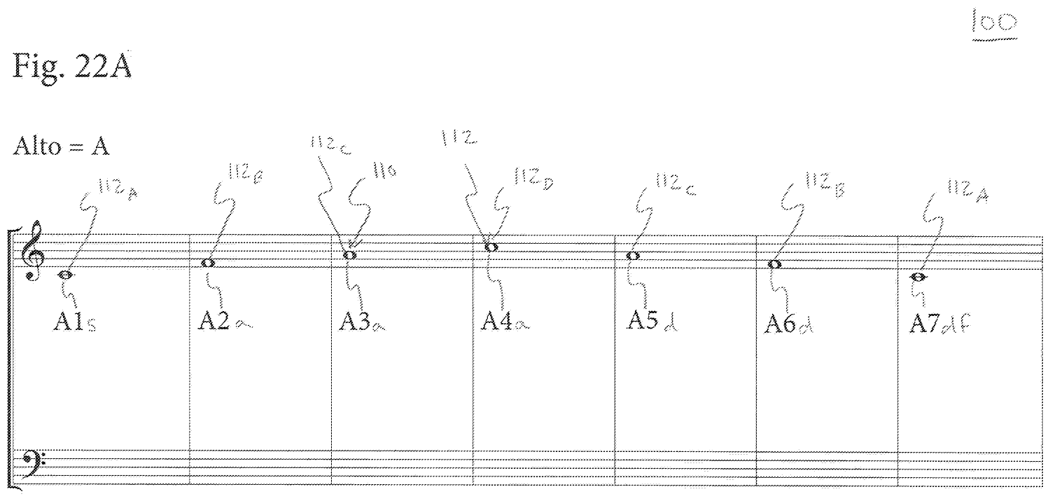

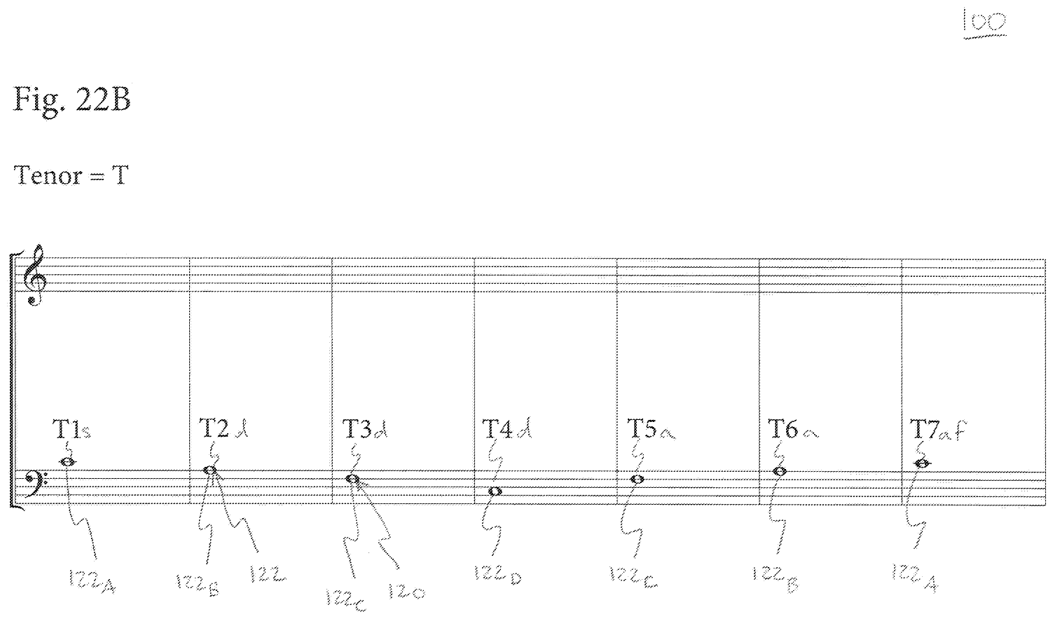

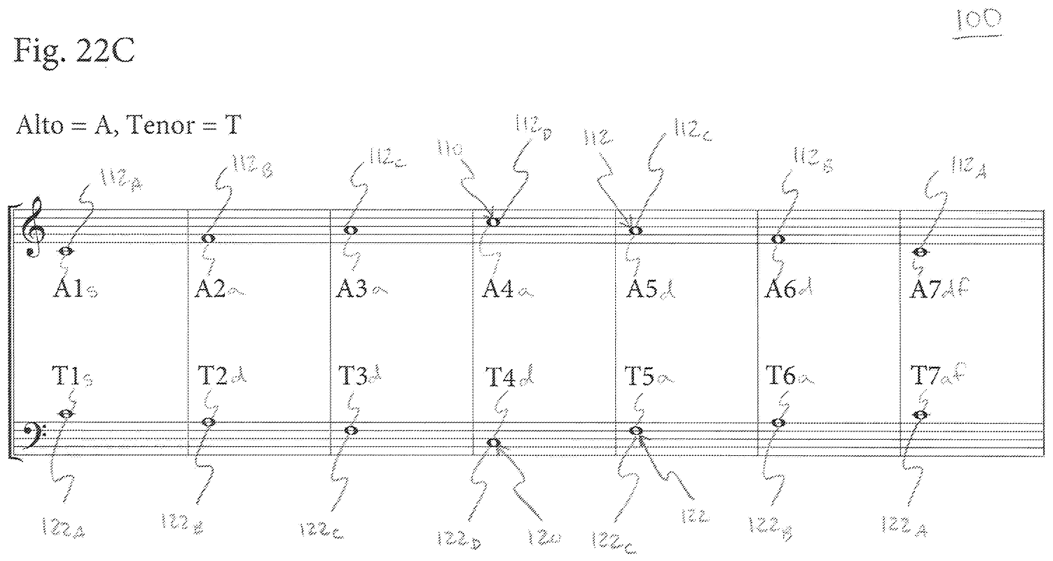

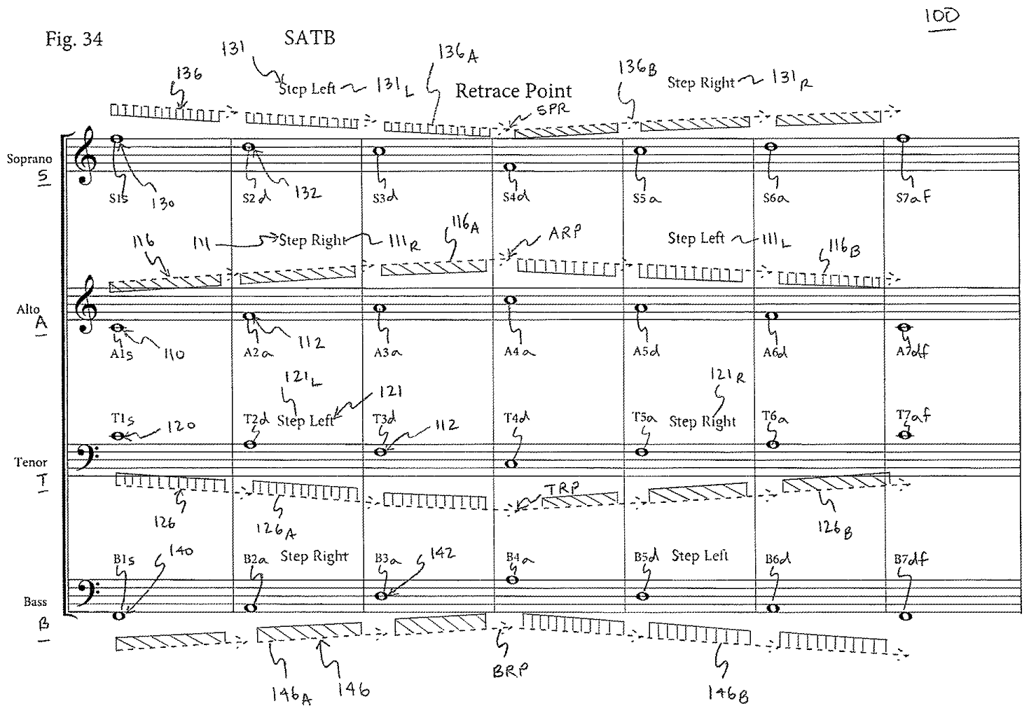

The teaching method 100 advantageously can utilize one or more auditory vocal music exercises performed in a contrary motion format that incorporates both the visual sense and tactual and/or kinesthetic experience to guide choir participants (or members) and other singers. These exercises can help enhance the “auditory spatial awareness” of the listener 500 (shown in FIG. 4A) and of the choir members. Although shown and described with reference to FIG. 22-37 with reference to a choir for purposes of illustration only, the teaching method 100 is not limited to choirs. For example, the teaching method 100 can be readily applied to two, four or more instrumentalists, such as a string quartet comprising a first violin, a second violin, a viola and a cello, without limitation. In selected embodiments, the musical notes 112, 122, as illustrated in FIGS. 22-27 and, as desired, FIG. 34, can be transposed to accommodate a suitable range for singing.

Auditory

FIGS. 22A-C illustrate the teaching method 100 with reference to two groups of singers, including a first group of alto singers A and a second group of tenor singers T who can sing a respective series (or sequences) of notes. In the embodiment shown in FIGS. 22A-C, each series of notes comprises a series of seven notes. For each group, one note is sung per measure (or bar), and thus seven measures (or bars) of music.

Turning to FIG. 22A, the teaching method 100 can include the first group of alto singers A singing a first line 110 of music that comprises a first series of musical notes 112. The first line 110 of music, in selected embodiments, can be provided in the manner discussed in more detail above with regard to the first line 110 of music shown in FIG. 2A. As shown in FIG. 22A, the first line 110 of music can begin with musical notes 112_{A}, 112_{B}, 112_{C}, 112_{D} that ascend in pitch as the first line 110 of the music proceeds. In other words, a first musical note 112_{A} can have a pitch that is lower than a pitch of a second musical note 112_{B}, the pitch of the second musical note 112_{B} can be lower than a pitch of a third musical note 112_{C} and the pitch of the third musical note 112_{C} can be lower than a pitch of a fourth musical note 112_{D}. Upon reaching the fourth musical note 112_{D}, the first line 110 of music can conclude by repeating the musical notes 112_{C}, 112_{B}, 112_{A} in reverse order as illustrated in FIG. 22A.

Turning to FIG. 22B, the teaching method 100 can include the second group of tenor singers T singing a second line 120 of music that comprises a second series of musical notes 122. The second line 120 of music, in selected embodiments, can be provided in the manner discussed in more detail above with regard to the second line 120 of music shown in FIG. 2B. As shown in FIG. 22B, the second line 120 of music can begin with musical notes 122_{A}, 122_{B}, 122_{C}, 122_{D} that descend in pitch as the second line 120 of the music proceeds. Stated somewhat differently, a first musical note 122_{A} can have a pitch that is higher than a pitch of a second musical note 122_{B}, the pitch of the second musical note 122_{B} can be higher than a pitch of a third musical note 122_{C} and the pitch of the third musical note 122_{C} can be higher than a pitch of a fourth musical note 122_{D}. Upon reaching the fourth musical note 122_{D}, the second line 120 of music can conclude by repeating the musical notes 122_{C}, 122_{B}, 122_{A} in reverse order as illustrated in FIG. 22B.

The teaching method 100 shown in FIG. 22C can include the first group of alto singers A singing the first line 110 of music of FIG. 22A and the second group of tenor singers T simultaneously singing the second line 120 of music of FIG. 22B. In other words, the teaching method 100 can simultaneously present the first line 110 of the music and the second line 120 of the music in a manner that advantageously can facilitate understanding of the music through expansion of a compositional technique referred to herein as contrary motion. Contrary motion refers to two or more lines of music that proceed in opposite directions from each other. As the first line 110 of the music moves up (or ascends) in pitch, the second line 120 of the music can move down (or descend) in pitch. Conversely, as the first line 110 of the music moves down (or descends) in pitch, the second line 120 of the music can move up (or ascend) in pitch.

In accordance with the teaching method 100, the musical notes 112 sung by the first group of alto singers A and the musical notes 122 sung by the second group of tenor singers T proceed in contrary motion. For purposes of illustration, the musical notes 112, 122 of FIGS. 22A-C can be designated with an “a” for ascending, a “d” for descending, a “s” for starting and/or a “f” for finishing. The first musical note 112_{A} sung by the first group of alto singers A, for example, can be designated as A1s; whereas, the third musical note 112_{C} sung by the first group of alto singers A can be designated as A3a as shown in FIGS. 22A, 22C. Similarly, the second musical note 122_{B} sung by the second group of tenor singers T can be designated as T2d; whereas, the seventh musical note 112_{A} sung by the second group of tenor singers T can be designated as T7af as shown in FIGS. 22B and 22C.

When the first group of alto singers A and the second group of tenor singers T simultaneously sing the respective musical notes 112, 122, the musical notes 112, 122 move in contrary motion to each other. As shown in FIG. 22A-C, the first (or starting) musical note 112_{A} for the first group of alto singers A and the first (or starting) musical note 122_{A} for the second group of tenor singers T comprise the same musical note and the same pitch known as C4 in the American Standard Pitch Notation (ASPN). This musical note is also known as “middle C,” which is notated on a musical staff as the first line below the staff in treble clef and the first line above the musical staff in the bass clef.

Hearing Retrace Point

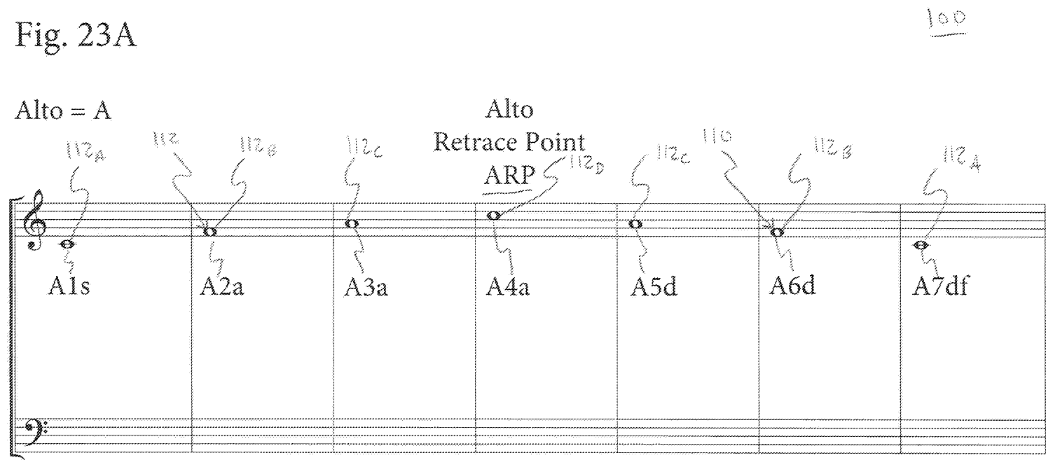

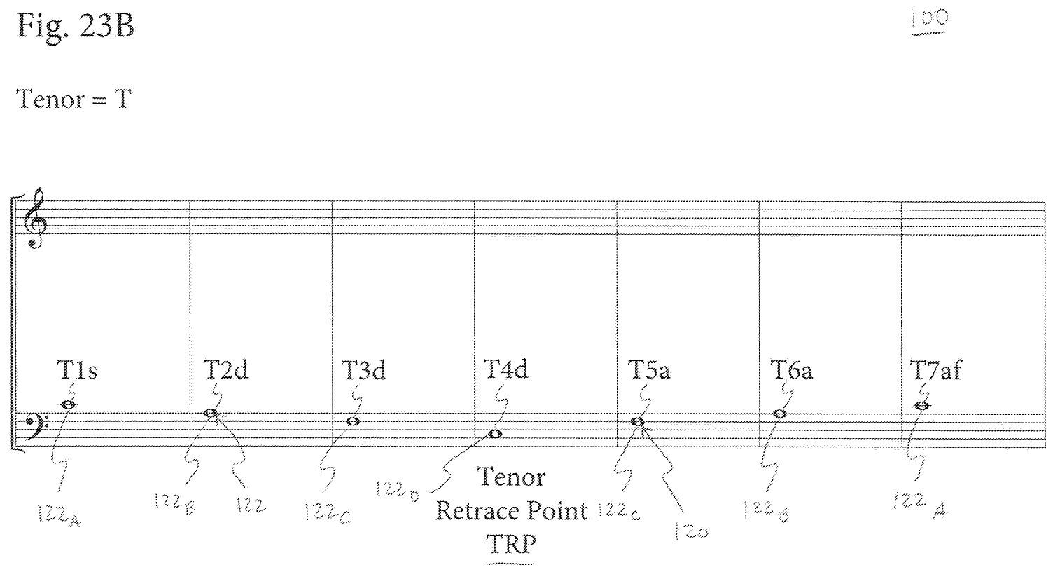

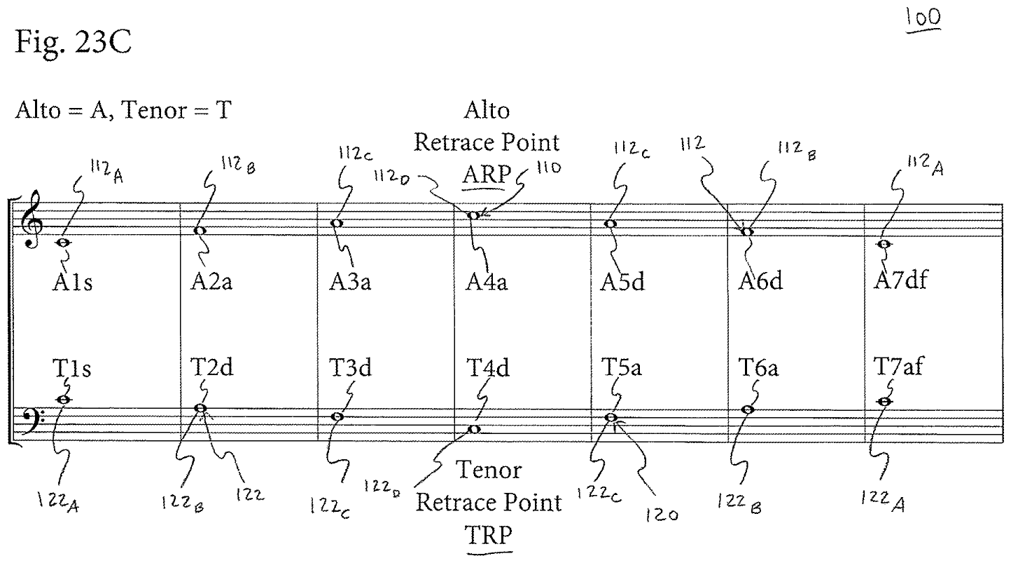

FIGS. 23A-C illustrate an alternative embodiment of the teaching method 100 shown in FIGS. 22A-C. The teaching method 100 of FIGS. 23A-C is illustrated with reference to two groups of singers, including a first group of alto singers A and a second group of tenor singers T who can sing a respective series (or sequences) of notes. In the embodiment shown in FIGS. 23A-C, each series of notes comprises a series of seven notes. For each group, one note is sung per measure (or bar), and thus seven measures (or bars) of music.

As illustrated in FIGS. 23A-C, six of the seven musical notes 112, 122 respectively sung by the first group of alto singers A and the second group of tenor singers T are repetitions of each other. In other words, the musical notes 112 sung by the first group of alto singers A are shown in FIG. 23A as beginning with a first sub-sequence of three musical notes 112_{A}, 112_{B}, 112_{C} and as ending with a second sub-sequence of three musical notes 112_{C}, 112_{B}, 112_{A}, wherein the first sub-sequence of three musical notes 112_{A}, 112_{B}, 112_{C} and the second sub-sequence of three musical notes 112_{C}, 112_{B}, 112_{A} are symmetrically centered about a fourth musical note 112_{D}.

The musical notes 122 sung by the second group of tenor singers T similarly are illustrated in FIG. 23B as beginning with a first sub-sequence of three musical notes 122_{A}, 122_{B}, 122_{C} and as ending with a second sub-sequence of three musical notes 122_{C}, 122_{B}, 122_{A}, wherein the first sub-sequence of three musical notes 122_{A}, 122_{B}, 122_{C} and the second sub-sequence of three musical notes 122_{C}, 122_{B}, 122_{A} are symmetrically centered about a fourth musical note 122_{D}.

The fourth musical note 112_{D} for the alto singers A and the fourth musical note 122_{D} for the tenor singers T are sung only once. In selected embodiments, the fourth musical note 112_{D} can serve as an alto retrace point ARP between ascending and descending directions of the three musical notes 112_{A}, 112_{B}, 112_{C}, and/or the fourth musical note 122_{D} can serve as a tenor retrace point TRP between descending and ascending directions of the three musical notes 122_{A}, 122_{B}, 122_{C}.

Turning to FIG. 23A, the teaching method 100 can include the first group of alto singers A singing a first line 110 of music that comprises a first series of musical notes 112. The first line 110 of music, in selected embodiments, can be provided in the manner discussed in more detail above with regard to the first line 110 of music shown in FIG. 2A. As shown in FIG. 23A, the first line 110 of music can begin with musical notes 112_{A}, 112_{B}, 112_{C}, 112_{D} that ascend in pitch as the first line 110 of the music proceeds. In other words, a first musical note 112_{A} can have a pitch that is lower than a pitch of a second musical note 112_{B}, the pitch of the second musical note 112_{B} can be lower than a pitch of a third musical note 112_{C} and the pitch of the third musical note 112_{C} can be lower than a pitch of a fourth musical note 112_{D}. Upon reaching the fourth musical note 112_{D} (or the alto retrace point ARP), the first line 110 of music can conclude by repeating the musical notes 112_{C}, 112_{B}, 112_{A} in reverse order as illustrated in FIG. 23A.

Turning to FIG. 23B, the teaching method 100 can include the second group of tenor singers T singing a second line 120 of music that comprises a second series of musical notes 122. The second line 120 of music, in selected embodiments, can be provided in the manner discussed in more detail above with regard to the second line 120 of music shown in FIG. 2B. As shown in FIG. 23B, the second line 120 of music can begin with musical notes 122_{A}, 122_{B}, 122_{C}, 122_{D} that descend in pitch as the second line 120 of the music proceeds. Stated somewhat differently, a first musical note 122_{A} can have a pitch that is higher than a pitch of a second musical note 122_{B}, the pitch of the second musical note 122_{B} can be higher than a pitch of a third musical note 122_{C} and the pitch of the third musical note 122_{C} can be higher than a pitch of a fourth musical note 122_{D}. Upon reaching the fourth musical note 122_{D} (or the tenor retrace point TRP), the second line 120 of music can conclude by repeating the musical notes 122_{C}, 122_{B}, 122_{A} in reverse order as illustrated in FIG. 23B.

The teaching method 100 shown in FIG. 23C can include the first group of alto singers A singing the first line 110 of music of FIG. 23A and the second group of tenor singers T simultaneously singing the second line 120 of music of FIG. 23B. In other words, the teaching method 100 can simultaneously present the first line 110 of the music and the second line 120 of the music in a manner that advantageously can facilitate understanding of the music through expansion of a compositional technique referred to herein as contrary motion. Contrary motion refers to two or more lines of music that proceed in opposite directions from each other. As the first line 110 of the music moves up (or ascends) in pitch, the second line 120 of the music can move down (or descend) in pitch. Conversely, as the first line 110 of the music moves down (or descends) in pitch, the second line 120 of the music can move up (or ascend) in pitch.

In accordance with the teaching method 100, the musical notes 112 sung by the first group of alto singers A and the musical notes 122 sung by the second group of tenor singers T proceed in contrary motion. For purposes of illustration, the musical notes 112, 122 of FIGS. 23A-C can be designated with an “a” for ascending, a “d” for descending, a “s” for starting and/or a “f” for finishing. The first musical note 112_{A} sung by the first group of alto singers A, for example, can be designated as A1s; whereas, the third musical note 112_{C} sung by the first group of alto singers A can be designated as A3a as shown in FIGS. 23A, 23C. The first line 110 of music can begin with musical notes 112_{A}, 112_{B}, 112_{C} that ascend in pitch as the first line 110 of the music proceeds and until the fourth musical note 112_{D} (or the alto retrace point ARP) is reached. Upon reaching the alto retrace point ARP, the first line 110 of music can conclude by repeating the musical notes 112_{C}, 112_{B}, 112_{A} in reverse order as illustrated in FIG. 23A.

Similarly, the first musical note 122_{A} sung by the second group of tenor singers T can be designated as T1s; whereas, the seventh musical note 112_{A} sung by the second group of tenor singers T can be designated as T7af as shown in FIGS. 23B, 23C. The second line 120 of music can begin with musical notes 122_{A}, 122_{B}, 122_{C} that descend in pitch as the second line 120 of the music proceeds and until the fourth musical note 122_{D} (or the tenor retrace point TRP) is reached. Upon reaching the tenor retrace point TRP, the second line 120 of music can conclude by repeating the musical notes 122_{C}, 122_{B}, 122_{A} in reverse order as illustrated in FIG. 23B.

When the first group of alto singers A and the second group of tenor singers T simultaneously sing the respective musical notes 112, 122, the musical notes 112, 122 move in contrary motion to each other. As shown in FIG. 23A-C, the first (or starting) musical note 112_{A} for the first group of alto singers A and the first (or starting) musical note 122_{A} for the second group of tenor singers T comprise the same musical note and the same pitch known as C4 in the American Standard Pitch Notation (ASPN). This musical note is also known as “middle C,” which is notated on a musical staff as the first line below the staff in treble clef and the first line above the musical staff in the bass clef.

Singing—Auditory and Visual Sense of Retrace Point Using Visual Diagonal Lines

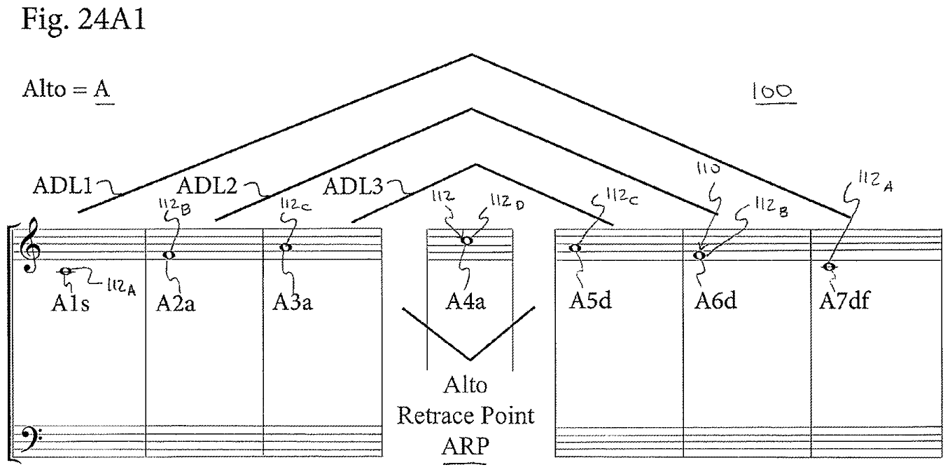

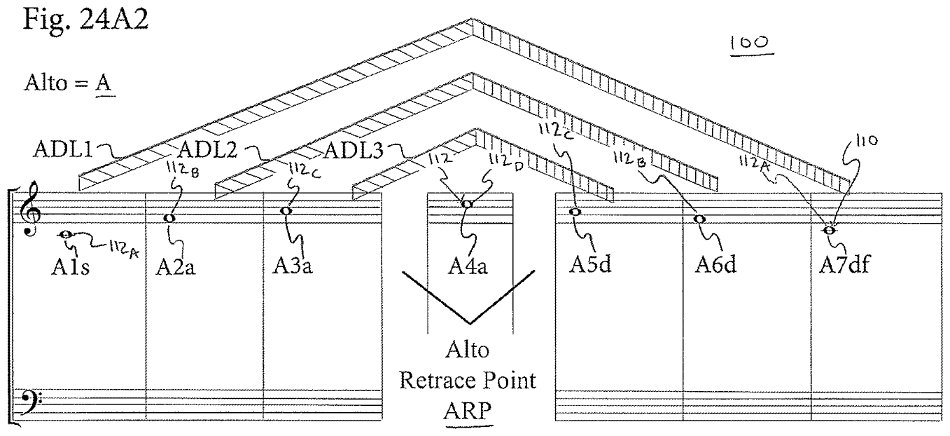

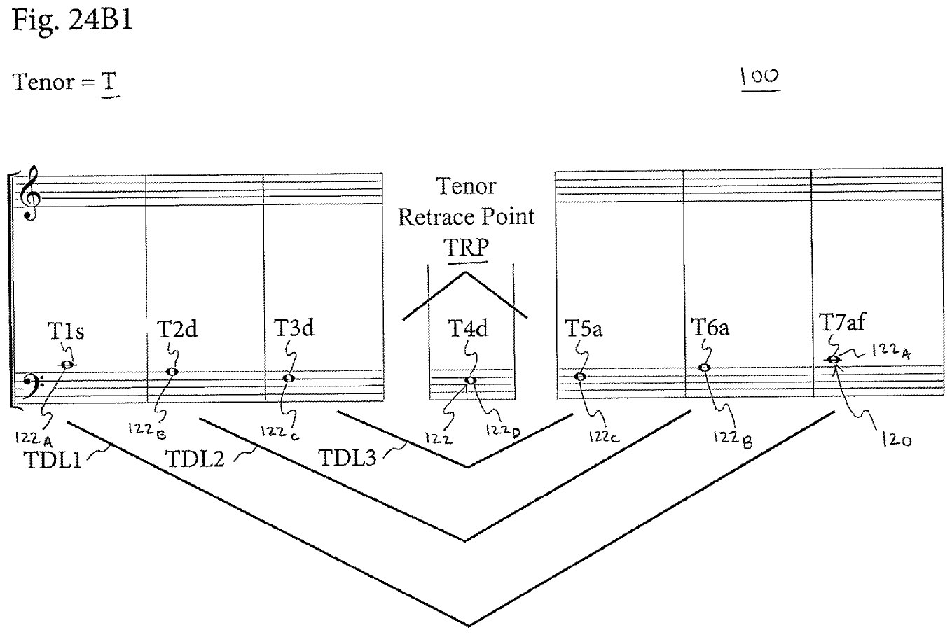

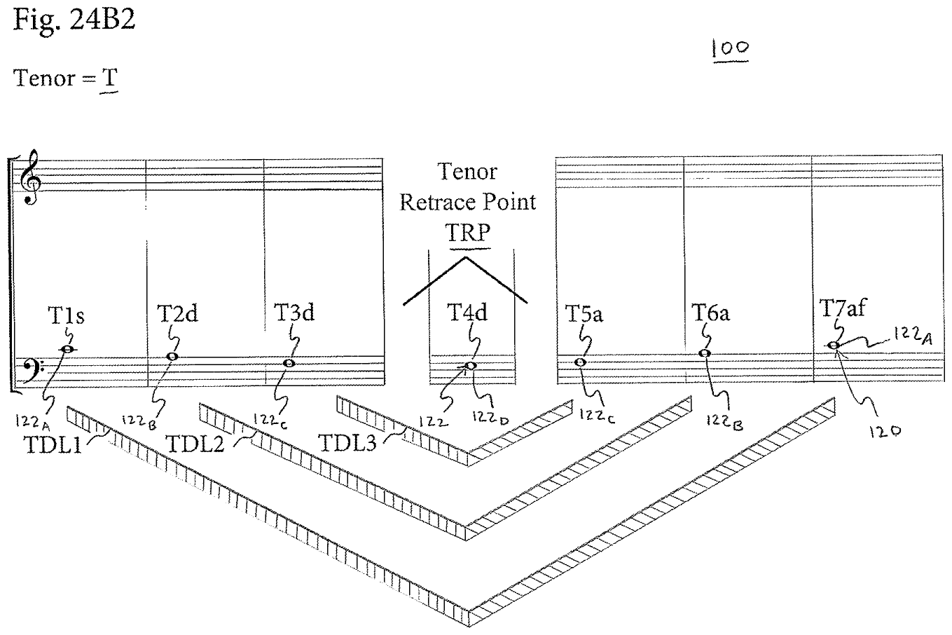

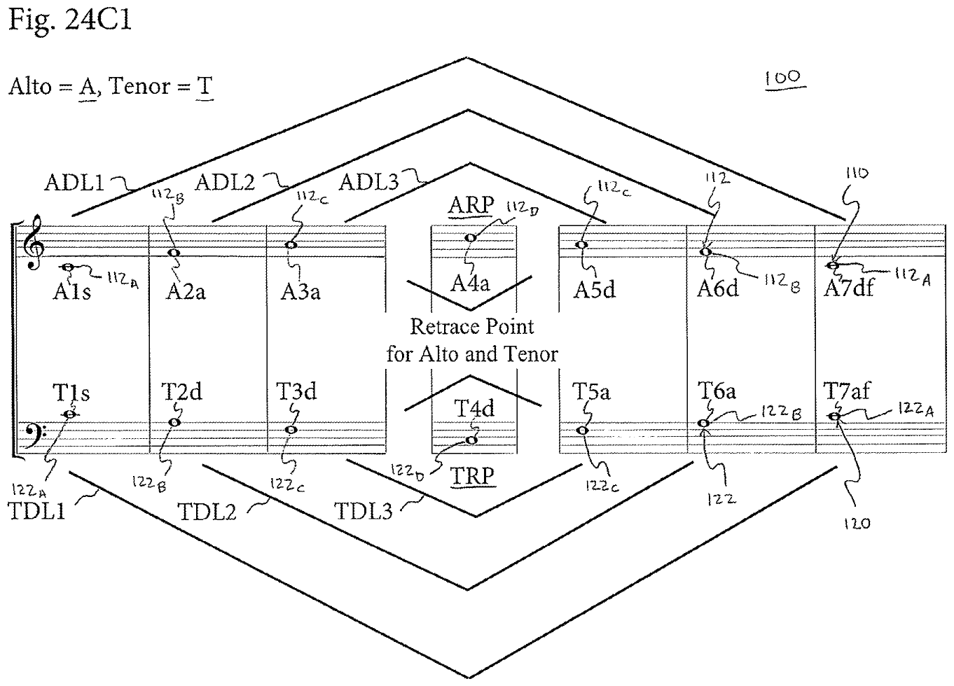

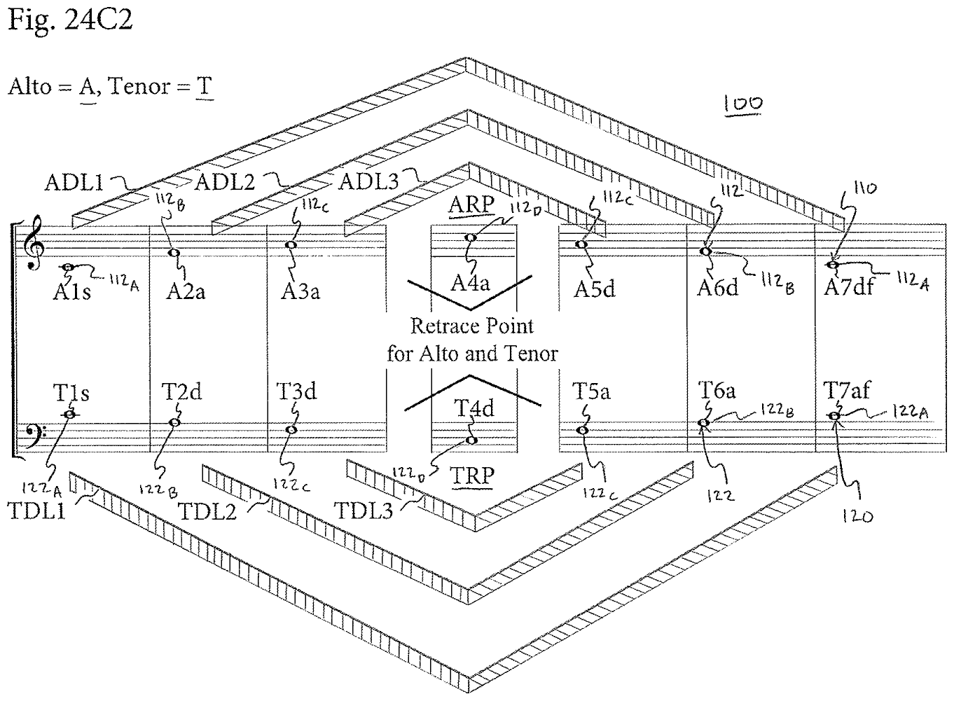

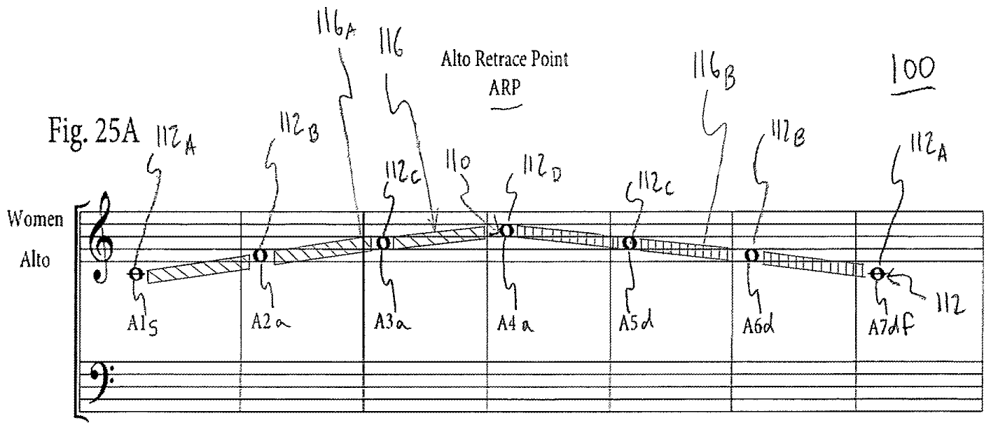

FIGS. 24A1, 24A2, 24B1, 24B2, 24C1 and 24C2 illustrate another alternative embodiment of the teaching method 100 shown in FIGS. 22A-C. The teaching method 100 of FIGS. 24A1, 24A2, 24B1, 24B2, 24C1 and 24C2 is illustrated with reference to two groups of singers, including a first group of alto singers A and a second group of tenor singers T who can sing a respective series (or sequences) of notes. In the embodiment shown in FIGS. 24A1, 24A2, 24B1, 24B2, 24C1 and 24C2, each series of notes comprises a series of seven notes. For each group, one note is sung per measure (or bar), and thus seven measures (or bars) of music.

As illustrated in FIGS. 24A1, 24A2, 24B1, 24B2, 24C1 and 24C2, six of the seven musical notes 112, 122 respectively sung by the first group of alto singers A and the second group of tenor singers T are repetitions of each other. In other words, the musical notes 112 sung by the first group of alto singers A are shown in FIG. 24A1 as beginning with a first ascending sub-sequence of three musical notes A2a, A3a, A4a and as ending with a second descending sub-sequence of three musical notes A5d, A6d, A7df, wherein the first ascending sub-sequence of three musical notes A2a, A3a, A4a and the second descending sub-sequence of three musical notes A5d, A6d, A7df are symmetrically centered about a fourth musical note A4a. Similarly, the musical notes 122 sung by the second group of tenor singers T are shown in FIG. 24B1 as beginning with a first descending sub-sequence of three musical notes T2d, T3d, T4d and as ending with a second ascending sub-sequence of three musical notes T5a, T6a, T7af, wherein the first descending sub-sequence of three musical notes T2d, T3d, T4d and the second ascending sub-sequence of three musical notes T5a, T6a, T7af are symmetrically centered about a fourth musical note T4d.

FIGS. 24A1, 24A2, 24B1, 24B2, 24C1 and 24C2 exemplify the duplication of the musical notes 112, 122 included in the seven-note series. The human ear does not automatically recognize or “hear” a duplication of a particular note, for example, in moving from one chord to another: a three-note chord of C, up to E and up to G, played next to A, up to C #, up to E, the common tone E, may be not heard as such, unless attention is drawn to it. In other words, duplication does not necessarily offer recognition, one has to be aware of, or “hear,” to audibly distinguish the notes. Without intentional hearing, it is similar to trying to identify an object in a dark room, until the lights are turned on. The teaching method 100 of FIGS. 24A1, 24A2, 24B1, 24B2, 24C1 and 24C2 can direct the attention of the listener 500 (shown in FIG. 4A) to audible recognition. Additionally and/or alternatively, FIGS. 24A1, 24A2, 24B1, 24B2, 24C1 and 24C2 can employ visual diagonal lines to assist in the recognition of audibly hearing and visually seeing the repeated or “retraced” notes that occur in the seven-note series. An exaggerated example of the being able to recognize the same tones is a Twelve Tone Row, which is a series of notes using all twelve tones before repeating the first note.

As set forth above, the seven musical notes 112, 122 of FIGS. 24A1, 24A2, 24B1, 24B2, 24C1 and 24C2 can be sung by the alto singers and the tenor singers. Three musical notes A1s, A2a, A3a of the musical notes 112 are repeated as musical notes A5d, A6d, A7df in reverse order; whereas, three musical notes T1s, T2d, T3d of the musical notes 122 are repeated as musical notes T5a, T6a, T7af in reverse order. In other words, the musical notes 112 sung by the alto singers A comprise three pairs of identical musical notes, leaving just one musical note A4a that is sung only once, and the musical notes 122 sung by the tenor singers T comprise three pairs of identical musical notes, leaving just one musical note T4d that is sung only once.

Alto diagonal lines ADL1, ADL2, ADL3 are shown in FIGS. 24A1 and 24A2 as connecting the same musical notes 112 sung by the alto singers A. The alto diagonal lines ADL1, ADL2, ADL3 may ascend or descend and always change their direction upon reaching the fourth musical note A4a that is sung only once. Similarly, tenor diagonal lines TDL1, TDL2, TDL3 are illustrated in FIGS. 24B1 and 24B2 as connecting the same musical notes 122 sung by the tenor singers T. The tenor diagonal lines TDL1, TDL2, TDL3 may ascend or descend and always change their direction upon reaching the fourth musical note T4d that is sung only once.

The fourth musical notes A4a, T4d can be associated with a retracing point of the musical notes and, as depicted in FIGS. 24A1, 24A2, 24B1, 24B2, 24C1 and 24C2, can be isolated from the other musical notes 112, 122. As discussed above, the fourth musical notes A4a, T4d can be sung only once. The fourth musical note A4a, for example, can be further distinguished by being top musical note sung by the alto singers A, and/or the fourth musical note T4d can be further distinguished by being the bottom note in the tenor singers T. The fourth musical note A4a can be associated with an alto retracing point ARP; whereas, the fourth musical note T4d can be associated with a tenor retracing point TRP as illustrated in FIGS. 24A1, 24A2, 24B1, 24B2, 24C1 and 24C2. That is, the first three ascending or descending notes are re-sung in reverse order for the ear to recognize the repeated notes. Diagonal lines can be used to connect two of the same notes in the sequence.

Turning to FIG. 24A1, the first alto diagonal line ADL1 can comprise a diagonal line that ascends from the first (or starting) musical note A1s sung by the alto singers A to the fourth musical note A4a sung by the alto singers A. The fourth musical note A4a is shown as being associated with the alto retracing point ARP. At the fourth musical note A4a, the first alto diagonal line ADL1 is shown as changing direction and descending to the seventh (or finishing) musical note A7df sung by the alto singers A. The seventh musical note A7df is shown as matching the first musical note A1s sung by the alto singers A. Stated somewhat differently, the first musical note A1s and the seventh musical note A7df can comprise the same note. The first alto diagonal line ADL1 can connect the two matching musical notes A1s, A7df.

The first alto diagonal line ADL1 can include one or more visual indicators, such as text, a symbol, a color, an icon and/or other suitable indicia, without limitation, for enabling the listener 500 to clearly see the general direction of the music without requiring the ability to read music. As shown in FIG. 24A2, for example, the first alto diagonal line ADL1 can comprise a green diagonal line that ascends from the first musical note A1s sung by the alto singers A to the fourth musical note A4a sung by the alto singers A. Additionally and/or alternatively, the first alto diagonal line ADL1 can comprise a red diagonal line that descends from the fourth musical note A4a sung by the alto singers A to the seventh musical note A7df sung by the alto singers A. The first alto diagonal line ADL1 thereby can help emphasize the ascension and descension of the musical notes 112 sung by the alto singers A.

Returning to FIG. 24A1, the second alto diagonal line ADL2 can comprise a diagonal line that ascends from the second musical note A2a sung by the alto singers A to the fourth musical note A4a sung by the alto singers A. As set forth above, the fourth musical note A4a is shown as being associated with the alto retracing point ARP. At the fourth musical note A4a, the second alto diagonal line ADL2 is shown as changing direction and descending to the sixth musical note A6d sung by the alto singers A. The sixth musical note A6d is shown as matching the second musical note A2a sung by the alto singers A. Stated somewhat differently, the second musical note A2a and the sixth musical note A6d can comprise the same note. The second alto diagonal line ADL2 can connect the two matching musical notes A2a, A6d.

The second alto diagonal line ADL2 can include one or more visual indicators, such as text, a symbol, a color, an icon and/or other suitable indicia, without limitation, for enabling the listener 500 to clearly see the general direction of the music without requiring the ability to read music. As shown in FIG. 24A2, for example, the second alto diagonal line ADL2 can comprise a green diagonal line that ascends from the second musical note A2a sung by the alto singers A to the fourth musical note A4a sung by the alto singers A. Additionally and/or alternatively, the second alto diagonal line ADL2 can comprise a red diagonal line that descends from the fourth musical note A4a sung by the alto singers A to the sixth musical note A6d sung by the alto singers A. The second alto diagonal line ADL2 thereby can help emphasize the ascension and descension of the musical notes 112 sung by the alto singers A.

Returning again to FIG. 24A1, the third alto diagonal line ADL3 can comprise a diagonal line that ascends from the third musical note A3a sung by the alto singers A to the fourth musical note A4a sung by the alto singers A. As set forth above, the fourth musical note A4a is shown as being associated with the alto retracing point ARP. At the fourth musical note A4a, the third alto diagonal line ADL3 is shown as changing direction and descending to the fifth musical note A5d sung by the alto singers A. The fifth musical note A5d is shown as matching the third musical note A3a sung by the alto singers A. Stated somewhat differently, the third musical note A3a and the fifth musical note A5d can comprise the same note. The third alto diagonal line ADL3 can connect the two matching musical notes A3a, A5d.

The third alto diagonal line ADL3 can include one or more visual indicators, such as text, a symbol, a color, an icon and/or other suitable indicia, without limitation, for enabling the listener 500 to clearly see the general direction of the music without requiring the ability to read music. As shown in FIG. 24A2, for example, the third alto diagonal line ADL3 can comprise a green diagonal line that ascends from the third musical note A3a sung by the alto singers A to the fourth musical note A4a sung by the alto singers A. Additionally and/or alternatively, the third alto diagonal line ADL3 can comprise a red diagonal line that descends from the fourth musical note A4a sung by the alto singers A to the fifth musical note A5d sung by the alto singers A. The third alto diagonal line ADL3 thereby can help emphasize the ascension and descension of the musical notes 112 sung by the alto singers A.

Turning to FIG. 24B1, the first tenor diagonal line TDL1 can comprise a diagonal line that descends from the first (or starting) musical note T1s sung by the tenor singers T to the fourth musical note A4a sung by the tenor singers T. The fourth musical note A4a is shown as being associated with the tenor retracing point TRP. At the fourth musical note A4a, the first tenor diagonal line TDL1 is shown as changing direction and ascending to the seventh (or finishing) musical note A7df sung by the tenor singers T. The seventh musical note A7df is shown as matching the first musical note T1s sung by the tenor singers T. Stated somewhat differently, the first musical note T1s and the seventh musical note T7af can comprise the same note. The first tenor diagonal line TDL1 can connect the two matching musical notes T1s, T7af.

The first tenor diagonal line TDL1 can include one or more visual indicators, such as text, a symbol, a color, an icon and/or other suitable indicia, without limitation, for enabling the listener 500 to clearly see the general direction of the music without requiring the ability to read music. As shown in FIG. 24B2, for example, the first tenor diagonal line TDL1 can comprise a red diagonal line that descends from the first musical note T1s sung by the tenor singers T to the fourth musical note T4d sung by the tenor singers T. Additionally and/or alternatively, the first tenor diagonal line TDL1 can comprise a green diagonal line that ascends from the fourth musical note T4d sung by the tenor singers T to the seventh musical note T7af sung by the tenor singers T. The first tenor diagonal line TDL1 thereby can help emphasize the descension and ascension of the musical notes 122 sung by the tenor singers T.

Returning to FIG. 24B1, the second tenor diagonal line TDL2 can comprise a diagonal line that descends from the second musical note T2d sung by the tenor singers T to the fourth musical note T4d sung by the tenor singers T. As set forth above, the fourth musical note T4d is shown as being associated with the tenor retracing point TRP. At the fourth musical note T4d, the second tenor diagonal line TDL2 is shown as changing direction and ascending to the sixth musical note T6a sung by the tenor singers T. The sixth musical note T6a is shown as matching the second musical note T2d sung by the tenor singers T. Stated somewhat differently, the second musical note T2d and the sixth musical note T6a can comprise the same note. The second tenor diagonal line TDL2 can connect the two matching musical notes T2d, T6a.

The second tenor diagonal line TDL2 can include one or more visual indicators, such as text, a symbol, a color, an icon and/or other suitable indicia, without limitation, for enabling the listener 500 to clearly see the general direction of the music without requiring the ability to read music. As shown in FIG. 24B2, for example, the second tenor diagonal line TDL2 can comprise a red diagonal line that descends from the second musical note T2d sung by the tenor singers T to the fourth musical note T4d sung by the tenor singers T. Additionally and/or alternatively, the second tenor diagonal line TDL2 can comprise a green diagonal line that ascends from the fourth musical note T4d sung by the tenor singers T to the sixth musical note T6a sung by the tenor singers T. The second tenor diagonal line TDL2 thereby can help emphasize the descension and ascension of the musical notes 122 sung by the tenor singers T.

Returning to FIG. 24B1, the third tenor diagonal line TDL3 can comprise a diagonal line that descends from the third musical note T3d sung by the tenor singers T to the fourth musical note T4d sung by the tenor singers T. As set forth above, the fourth musical note T4d is shown as being associated with the tenor retracing point TRP. At the fourth musical note T4d, the third tenor diagonal line TDL3 is shown as changing direction and ascending to the fifth musical note T5a sung by the tenor singers T. The fifth musical note T5a is shown as matching the third musical note T3d sung by the tenor singers T. Stated somewhat differently, the third musical note T3d and the fifth musical note T5a can comprise the same note. The third tenor diagonal line TDL3 can connect the two matching musical notes T3d, T5a.

The third tenor diagonal line TDL3 can include one or more visual indicators, such as text, a symbol, a color, an icon and/or other suitable indicia, without limitation, for enabling the listener 500 to clearly see the general direction of the music without requiring the ability to read music. As shown in FIG. 24B2, for example, the third tenor diagonal line TDL3 can comprise a red diagonal line that descends from the third musical note T3d sung by the tenor singers T to the fourth musical note T4d sung by the tenor singers T. Additionally and/or alternatively, the third tenor diagonal line TDL3 can comprise a green diagonal line that ascends from the fourth musical note T4d sung by the tenor singers T to the fifth musical note T5a sung by the tenor singers T. The third tenor diagonal line TDL3 thereby can help emphasize the descension and ascension of the musical notes 122 sung by the tenor singers T.

When the first group of alto singers A and the second group of tenor singers T simultaneously sing the respective musical notes 112, 122, the musical notes 112, 122 move in contrary motion to each other as shown in FIG. 24C1. Turning to FIG. 24C1, the musical notes 112 sung by the first group of alto singers A are shown as beginning with a first ascending sub-sequence of three musical notes A2a, A3a, A4a and as ending with a second descending sub-sequence of three musical notes A5d, A6d, A7df, wherein the first ascending sub-sequence of three musical notes A2a, A3a, A4a and the second descending sub-sequence of three musical notes A5d, A6d, A7df are symmetrically centered about a fourth musical note A4a. The musical notes 122 sung by the second group of tenor singers T are shown in FIG. 23B as beginning with a first descending sub-sequence of three musical notes T2d, T3d, T4d and as ending with a second ascending sub-sequence of three musical notes T5a, T6a, T7af, wherein the first descending sub-sequence of three musical notes T2d, T3d, T4d and the second ascending sub-sequence of three musical notes T5a, T6a, T7af are symmetrically centered about a fourth musical note T4d.

The alto diagonal lines ADL1, ADL2, ADL3 are shown as connecting the same musical notes 112 sung by the alto singers; whereas, the tenor diagonal lines TDL1, TDL2, TDL3 can connect the same musical notes 122 sung by the tenor singers in the manner discussed in more detail above. Advantageously, the alto diagonal lines ADL1, ADL2, ADL3 and the tenor diagonal lines TDL1, TDL2, TDL3 can include one or more visual indicators, such as text, a symbol, a color, an icon and/or other suitable indicia, without limitation, for enabling the listener 500 to clearly see the general direction of the music without requiring the ability to read music.

As shown in FIG. 24C2, for example, the alto diagonal lines ADL1, ADL2, ADL3 can comprise a green diagonal line that ascends as the musical notes 112 sung by the alto singers A ascend to the fourth musical note A4a and a red diagonal line that descends as the musical notes 112 sung by the alto singers A descend from the fourth musical note A4a. Additionally and/or alternatively, the tenor diagonal lines TDL1, TDL2, TDL3 can comprise a red diagonal line that descends as the musical notes 122 sung by the tenor singers T descend to the fourth musical note T4d and a green diagonal line that ascends as the musical notes 122 sung by the tenor singers T ascend from the fourth musical note T4d. The alto diagonal lines ADL1, ADL2, ADL3 and the tenor diagonal lines TDL1, TDL2, TDL3 thereby can help emphasize the ascension and descension of the musical notes 112 sung by the alto singers A and the tenor singers T.

Singing—Visual Sense

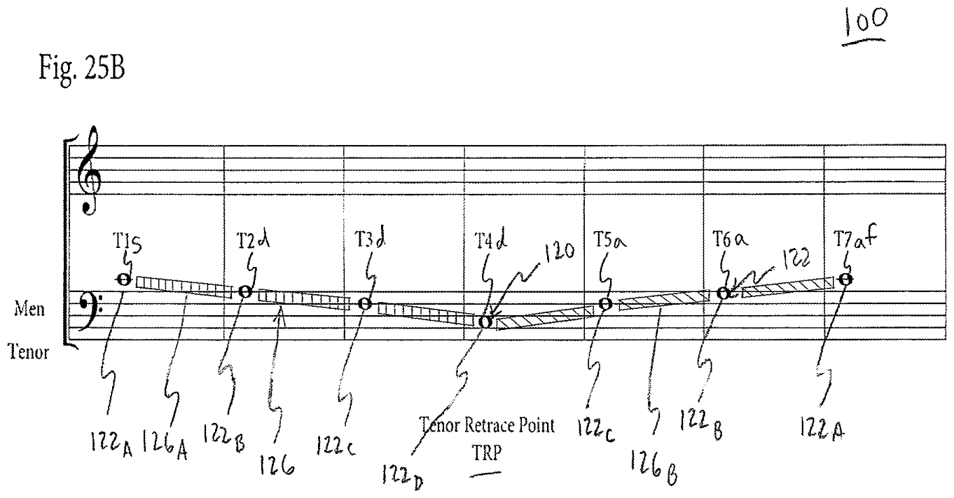

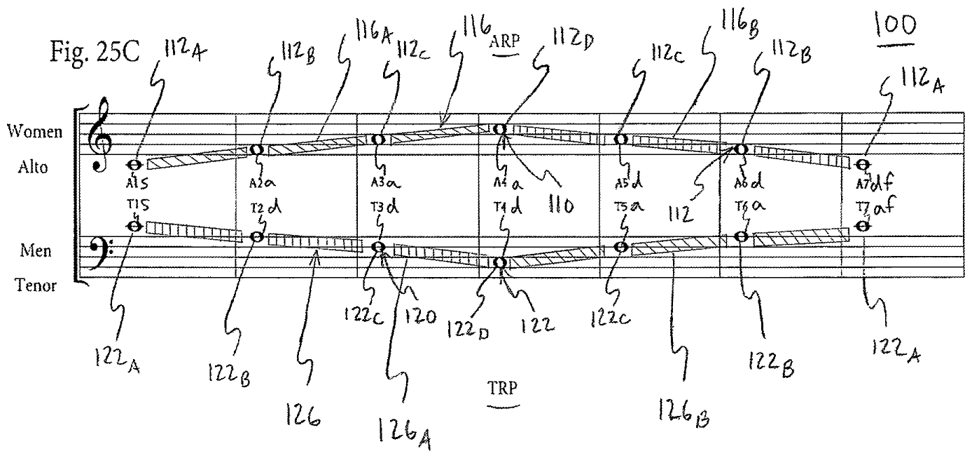

FIGS. 25A-C illustrate yet another alternative embodiment of the teaching method 100 of FIGS. 22A-C. In the manner set forth above, the teaching method 100 of FIGS. 25A-C is illustrated with reference to two groups of singers, including a first group of alto singers A and a second group of tenor singers T who can sing a respective series (or sequences) of notes. In the embodiment shown in FIGS. 25A-C, each series of notes comprises a series of seven notes. For each group, one note is sung per measure (or bar), and thus seven measures (or bars) of music.

As illustrated in FIGS. 25A-C, six of the seven musical notes 112, 122 respectively sung by the first group of alto singers A and the second group of tenor singers T are repetitions of each other. In other words, the musical notes 112 sung by the first group of alto singers A are shown in FIG. 25A as beginning with a first ascending sub-sequence of three musical notes A2a, A3a, A4a and as ending with a second descending sub-sequence of three musical notes A5d, A6d, A7df, wherein the first ascending sub-sequence of three musical notes A2a, A3a, A4a and the second descending sub-sequence of three musical notes A5d, A6d, A7df are symmetrically centered about a fourth musical note A4a. Similarly, the musical notes 122 sung by the second group of tenor singers T are shown in FIG. 25B as beginning with a first descending sub-sequence of three musical notes T2d, T3d, T4d and as ending with a second ascending sub-sequence of three musical notes T5a, T6a, T7af, wherein the first descending sub-sequence of three musical notes T2d, T3d, T4d and the second ascending sub-sequence of three musical notes T5a, T6a, T7af are symmetrically centered about a fourth musical note T4d.

As set forth above, the seven musical notes 112, 122 of FIGS. 25A-C can be sung by the alto singers A and the tenor singers T. Three musical notes A1 s, A2a, A3a of the musical notes 112 are repeated as musical notes A5d, A6d, A7df in reverse order; whereas, three musical notes T1s, T2d, T3d of the musical notes 122 are repeated as musical notes T5a, T6a, T7af in reverse order. In other words, the musical notes 112 sung by the alto singers A comprise three pairs of identical musical notes, leaving just one musical note A4a that is sung only once, and the musical notes 122 sung by the tenor singers T comprise three pairs of identical musical notes, leaving just one musical note T4d that is sung only once.

Turning to FIG. 25A, for instance, the teaching method 100 is shown as visually presenting the first line 110 of music as sung by the alto singers A to the listener 500 (shown in FIG. 4A). In the manner discussed above with reference to FIG. 3A, the teaching method 100 can include a first visual image 116 for visually presenting the first line 110 of music. The first visual image 116 can comprise one or more visual images based upon the nature of the first line 110 of music. The first visual image 116 can help enable the listener 500 to utilize the visual sense to see the first line 110 of music and better understand the contrary motion.

The first visual image 116 can include a first visual image portion 116_{A} that is associated with the first ascending sub-sequence of musical notes A2a, A3a, A4a and/or a second visual image portion 116_{B} that is associated with the descending sub-sequence of musical notes A5d, A6d, A7df as illustrated in FIG. 25A. Stated somewhat differently, one or more visual image portions 116_{A}, 116_{B} can be associated with the first line 110 of music. The alto retrace point ARP between the first ascending sub-sequence of musical notes A2a, A3a, A4a and the descending sub-sequence of musical notes A5d, A6d, A7df, for example, can define a boundary between the first visual image portion 116_{A} and the second visual image portion 116_{B}.

The visual image portion 116_{A} preferably is presented in a visually distinguishable manner from the visual image portion 116_{B}. Although shown and described with reference to FIG. 25A as comprising solid green and red lines for purposes of illustration only, the first visual image 116 can visually illustrate the ascent and/or descent of the musical notes 112 via use of lines of any color, shape, size, format and/or style (such as solid, dotted or dashed) or any other type of suitable visual indicia.

Turning to FIG. 25B, the teaching method 100 is shown as visually presenting the second line 120 of music as sung by the tenor singers T to the listener 500 (shown in FIG. 4A). In the manner discussed above with reference to FIG. 3B, the teaching method 100 can include a second visual image 126 for visually presenting the second line 120 of music. The second visual image 126 can comprise one or more visual images based upon the nature of the second line 120 of music. The second visual image 126 can help enable listener 500 to utilize the visual sense to see the second line 120 of music and better understand the contrary motion.

The second visual image 126 can include a first visual image portion 126_{A} that is associated with the first descending sub-sequence of musical notes T2d, T3d, T4d and/or a second visual image portion 126_{B} that is associated with the second ascending sub-sequence of musical notes T5a, T6a, T7af as illustrated in FIG. 25B. In other words, one or more visual image portions 126_{A}, 126_{B} can be associated with the second line 120 of music. The tenor retrace point TRP between the first descending sub-sequence of musical notes T2d, T3d, T4d and the second ascending sub-sequence of musical notes T4d, T5a, T6a, T7af, for example, can define a boundary between the first visual image portion 126_{A} and the second visual image portion 126_{B}.

The visual image portion 126_{A} preferably is presented in a visually distinguishable manner from the visual image portion 126_{B}. Although shown and described with reference to FIG. 25B as comprising dashed red and green lines for purposes of illustration only, the second visual image 126 can visually illustrate the descent and/or ascent of the musical notes 122 via use of lines of any color, shape, size, format and/or style (such as solid, dotted or dashed) or any other type of suitable visual indicia. The indicia associated with the second visual image 126 preferably is visually distinguishable from the indicia associated with the first visual image 116.

FIG. 25C illustrates the teaching method 100, wherein the first group of alto singers A sing the respective musical notes 112 of FIG. 25A simultaneously with the second group of tenor singers T singing the respective musical notes 122 of FIG. 25B. In the manner discussed with reference to FIG. 25A, the alto singers A can sing the first ascending sub-sequence of musical notes A2a, A3a, A4a and/or the second descending sub-sequence of musical notes A5d, A6d, A7df. The singing of the alto singers A can be visually enhanced via the first visual image portion 116_{A} that is associated with the first ascending sub-sequence of musical notes A2a, A3a, A4a and/or a second visual image portion 116_{B} that is associated with the second descending sub-sequence of musical notes A5d, A6d, A7df.

As the alto singers A sing the first ascending sub-sequence of musical notes A2a, A3a, A4a and/or the second descending sub-sequence of musical notes A5d, A6d, A7df, the tenor singers T can sing the first descending sub-sequence of musical notes T2d, T3d, T4d and/or the second ascending sub-sequence of musical notes T5a, T6a, T7af in the manner shown and described with reference to FIG. 25B. The singing of the tenor singers T can be visually enhanced via the first visual image portion 126_{A} that is associated with the first descending sub-sequence of musical notes T2d, T3d, T4d and/or a second visual image portion 126_{B} that is associated with the second ascending sub-sequence of musical notes T4d, T5a, T6a, T7af. A combination of the audible sense of hearing the alto singers A and the tenor singers T singing with the first and second visual images 116, 126 can help enable the listener 500 (shown in FIG. 4A) to utilize the audible and visual senses to better understand the contrary motion inherent in the lines 110, 120 of music.

In selected embodiments of the teaching method 100, the term “coupling” or “coupled” can be used to describe two or more voices or instruments, wherein two voices or instruments can move in contrary motion to each other. Coupling, in other words, can occur, in selected embodiments, when any two voices or instruments move in contrary motion to each other. Additionally and/or alternatively, coupling can be used as a term outside of the embodiments herein, when any two lines of music are playing together, with or without contrary motion.

Singing—Visual and Kinesthetic Senses

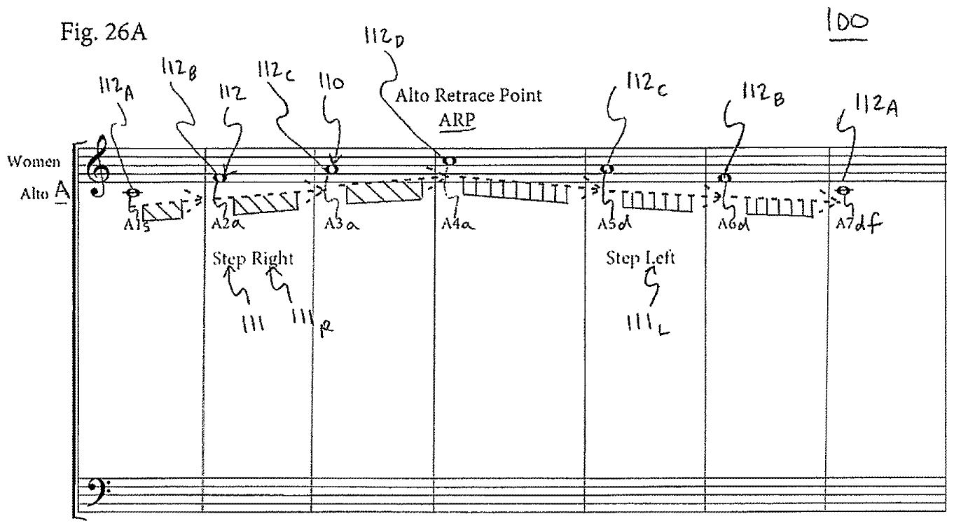

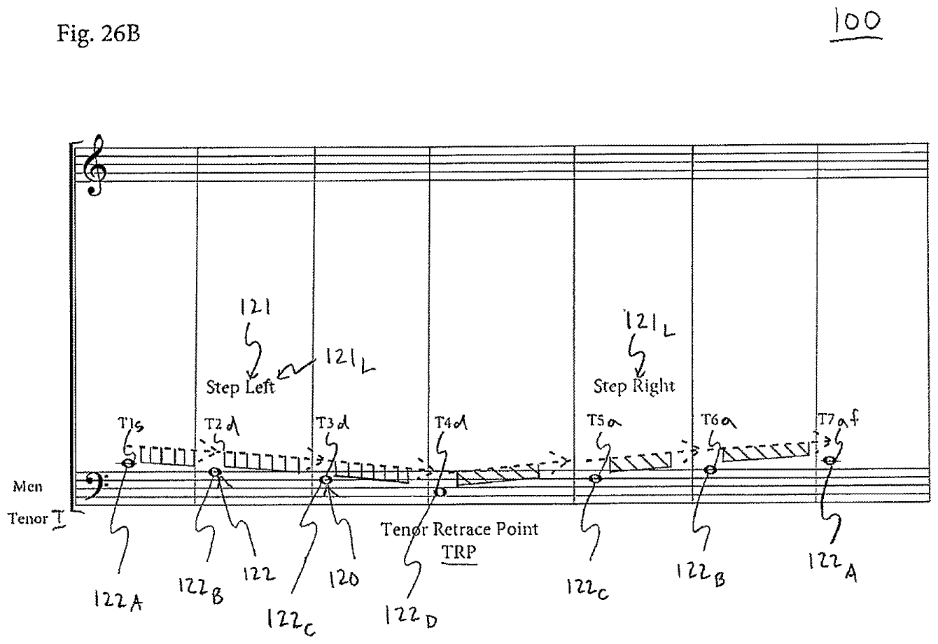

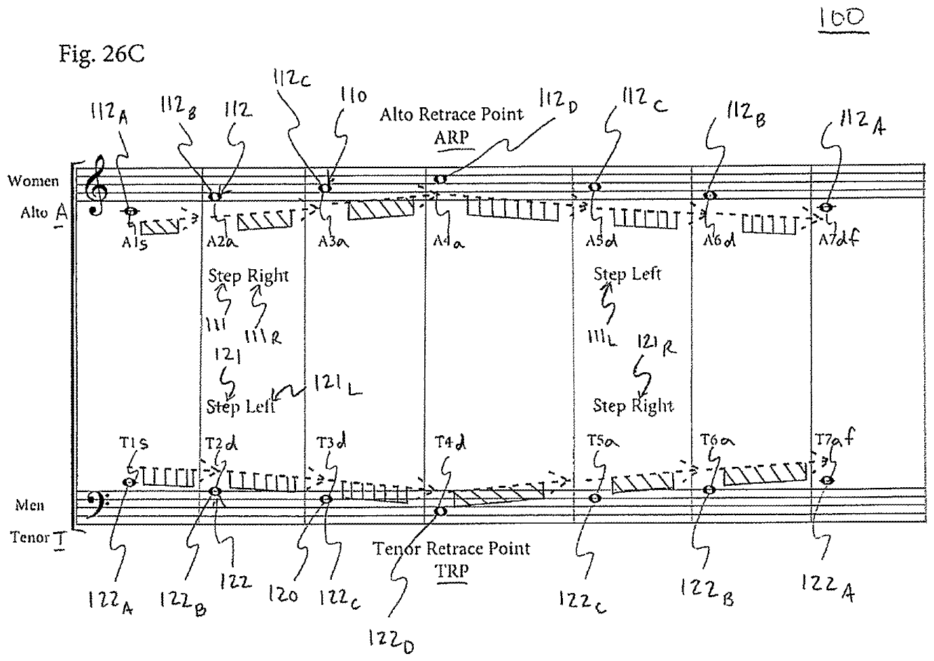

Still another alternative embodiment of the teaching method 100 of FIGS. 22A-C is shown and described with reference to FIGS. 26A-C. Turning to FIGS. 26A-C, the teaching method 100 is shown with reference to two groups of singers, including a first group of alto singers A and a second group of tenor singers T who can sing a respective series (or sequences) of notes in the manner set forth above. In the embodiment of FIGS. 26A-C, each series of notes comprises a series of seven notes.

As illustrated in FIGS. 26A-C, six of the seven musical notes 112, 122 respectively sung by the first group of alto singers A and the second group of tenor singers T are repetitions of each other. In other words, the musical notes 112 sung by the first group of alto singers A are shown in FIG. 26A as beginning with a first ascending sub-sequence of three musical notes A2a, A3a, A4a and as ending with a second descending sub-sequence of three musical notes A5d, A6d, A7df, wherein the first ascending sub-sequence of three musical notes A2a, A3a, A4a and the second descending sub-sequence of three musical notes A5d, A6d, A7df are symmetrically centered about a fourth musical note A4a. Similarly, the musical notes 122 sung by the second group of tenor singers T are shown in FIG. 26B as beginning with a first descending sub-sequence of three musical notes T2d, T3d, T4d and as ending with a second ascending sub-sequence of three musical notes T5a, T6a, T7af, wherein the first descending sub-sequence of three musical notes T2d, T3d, T4d and the second ascending sub-sequence of three musical notes T5a, T6a, T7af are symmetrically centered about a fourth musical note T4d.

In selected embodiments, hearing and recognizing the repeated tones of FIGS. 26A-C can be associated with one or more physical movements. The physical movements can comprise any suitable type of physical movement. Exemplary physical movements can include, but are not limited to, sidestepping movements, arm movements, leg movements, head movements, jumping, squatting, stepping forward, stepping backward, stepping diagonally, etc. These physical movements can be retraced or replicated and shown as dashed lines to differentiate the physical movements from the visual of ascending and descending notes.

The teaching method 100 can include at least one of the alto singers A physically moving 111 synchronously with the musical notes 112 sung by the first group of alto singers A. Turning to FIG. 26A, for example, one or more of the alto singers A are shown as sidestepping to the right 111_{R} while singing the first ascending sub-sequence of musical notes A2a, A3a, A4a and/or one or more of the alto singers A are shown as sidestepping to the left 111_{L} while singing the second descending sub-sequence of musical notes A5d, A6d, A7df.

In selected embodiments, the alto singers A can take a first predetermined number of sidesteps, such as one sidestep, approximately eighteen inches, to the right 111_{R} when each of the first ascending sub-sequence of musical notes A2a, A3a, A4a are sung and/or can take a second predetermined number of sidesteps, such as one sidestep, to left 111_{L} when each of the second descending sub-sequence of musical notes A5d, A6d, A7df are sung. Each sidestep to the right 111_{R} can comprise a movement of a right foot of the alto singer A to the right when the relevant musical note A2a, A3a, A4a is sung followed by a left foot of the alto singer A being moved to the right; whereas, each sidestep to the left 111_{L} can comprise a movement of the left foot of the alto singer A to the left when the relevant musical note A5d, A6d, A7df is sung followed by the right foot of the alto singer A being moved to the left.

The sidesteps to the left 111_{L} preferably retrace the previous sidesteps to the right 121_{R}. The alto retrace point ARP between the first ascending sub-sequence of musical notes A2a, A3a, A4a and the second descending sub-sequence of musical notes A5d, A6d, A7df can define a boundary between the sidestepping to the right 111_{R} and the sidestepping to the left 111_{L}. In other words, the alto singers A can reverse or otherwise change the physical movement 111 at the alto retrace point ARP. Although shown and described with reference to FIG. 26A as comprising right sidesteps and left sidesteps for purposes of illustration only, the physical movement 111 of the alto singers A can comprise any suitable type of physical movement, such as arm movements, leg movements, head movements, jumping, squatting, stepping forward, stepping backward, stepping diagonally, etc., without limitation.

By adding the physical movement 111 of the alto singers A, the teaching method 100 advantageously can add a kinesthetic sense to the visual exercise. The tactile and/or kinesthetic movement can include movement made via small muscle groups, known as fine motor skills, use of fingers and hands. Additionally and/or alternatively, the tactile and/or kinesthetic movement can involve the use of gross motor skills, which include taking sidesteps—or walking to the side, which involves moving the torso, balancing, and a number of other larger muscles.

The teaching method 100 optionally can include at least one of the tenor singers T physically moving 121 synchronously with the musical notes 122 sung by the second group of tenor singers T. Turning to FIG. 26B, for example, one or more of the tenor T singers are shown as sidestepping to the left 121_{L} while singing the first descending sub-sequence of musical notes T2d, T3d, T4d and/or sidestepping to the right 121_{R} while and/or additionally singing the second ascending sub-sequence of musical notes T5a, T6a, T7af.

In selected embodiments, the tenor singers T can take a first predetermined number of sidesteps, such as one sidestep, approximately eighteen inches, to the left 121_{L} when each of the first descending sub-sequence of musical notes T2d, T3d, T4d are sung and/or can take a second predetermined number of sidesteps, such as one sidestep, to right 121_{R} when each of the second ascending sub-sequence of musical notes T5a, T6a, T7af are sung. Each sidestep to the left 121_{L} can comprise a movement of a left foot of the tenor singer T to the left when the relevant musical note T2d, T3d, T4d is sung followed by a right foot of the tenor singer T being moved to the left; whereas, each sidestep to the right 111_{R} can comprise a movement of the right foot of the tenor singer T to the right when the relevant musical note T5a, T6a, T7af is sung followed by the left foot of the tenor singer T being moved to the right. The sidesteps to the right 121_{R} preferably retrace the previous sidesteps to the left 121_{L}.

The tenor retrace point TRP between the first descending sub-sequence of musical notes T2d, T3d, T4d and the second ascending sub-sequence of musical notes T5a, T6a, T7af can define a boundary between the sidestepping to the left 121_{L} and the sidestepping to the right 121_{R}. In other words, the tenor singers T can reverse or otherwise change the physical movement 121 at the tenor retrace point TRP. Although shown and described with reference to FIG. 26B as comprising left sidesteps and right sidesteps for purposes of illustration only, the physical movement 121 of the tenor singers T can comprise any suitable type of physical movement, such as arm movements, leg movements, head movements, jumping, squatting, stepping forward, stepping backward, stepping diagonally, etc., without limitation.

By adding the physical movement 121 of the tenor singers T, the teaching method 100 advantageously can add a kinesthetic sense to the visual exercise. The tactile and/or kinesthetic movement can include movement made via small muscle groups, known as fine motor skills, use of fingers and hands. Additionally and/or alternatively, the tactile and/or kinesthetic movement can involve the use of gross motor skills, which include taking sidesteps—or walking to the side, which involves moving the torso, balancing, and a number of other larger muscles.

FIG. 26C is a viewing of FIGS. 26A and 26B set next to each other, side by side, and illustrates the teaching method 100, wherein the first group of alto singers A sing the respective musical notes 112 of FIG. 26A simultaneously with the second group of tenor singers T singing the respective musical notes 122 of FIG. 26B. In the manner discussed with reference to FIG. 26A, the alto singers can sing the first ascending sub-sequence of musical notes A2a, A3a, A4a while sidestepping to the right 111_{R} and/or can sing the second descending sub-sequence of musical notes A5d, A6d, A7df while sidesteps to the left 111_{L}. The singing of the alto singers A can be kinesthetically enhanced via the sidesteps to the right 111_{R} that are associated with the first ascending sub-sequence of musical notes A2a, A3a, A4a and/or the sidesteps to the left 111_{L} that are associated with the second descending sub-sequence of musical notes A5d, A6d, A7df.

As the alto singers A sing the first ascending sub-sequence of musical notes A2a, A3a, A4a and/or the second descending sub-sequence of musical notes A5d, A6d, A7df, the tenor singers T can sing the first descending sub-sequence of musical notes T2d, T3d, T4d while sidestepping to the left 121_{L} and/or the second ascending sub-sequence of musical notes T5a, T6a, T7af while sidestepping to the right 121_{R} in the manner shown and described with reference to FIG. 26B. The singing of the tenor singers T can be kinesthetically enhanced via the sidesteps to the left 121_{L} that are associated with the first descending sub-sequence of musical notes T2d, T3d, T4d and/or the sidesteps to the right 121_{R} that are associated with the second ascending sub-sequence of musical notes T5a, T6a, T7af. A combination of the audible sense of hearing the alto singers A and the tenor singers T singing with the kinesthetic sense associated with the movement 111, 121 of the alto singers A and the tenor singers T can help enable the listener 500 (shown in FIG. 4A) to utilize the audible and kinesthetic senses to better understand the contrary motion inherent in the lines 110, 120 of music.

In this manner, the increasing and decreasing of physical distance between the group of alto singers A and the group of tenor singers T as shown in FIG. 26C can enhance the auditory distance of the increasing and decreasing of intervals sung between the two groups. As the two groups incremental move away from each other, at A4a and T4d, the group of alto singers A and the group of tenor singers T will be at the furthest distance and the furthest distance of singing two octaves apart. From the position of being furthest in sung tones and steps, the sung tones and groups of singers gradually move closer together, illustrating a composite of kinesthetic, visual and auditory senses with the noticing of contrary motion.

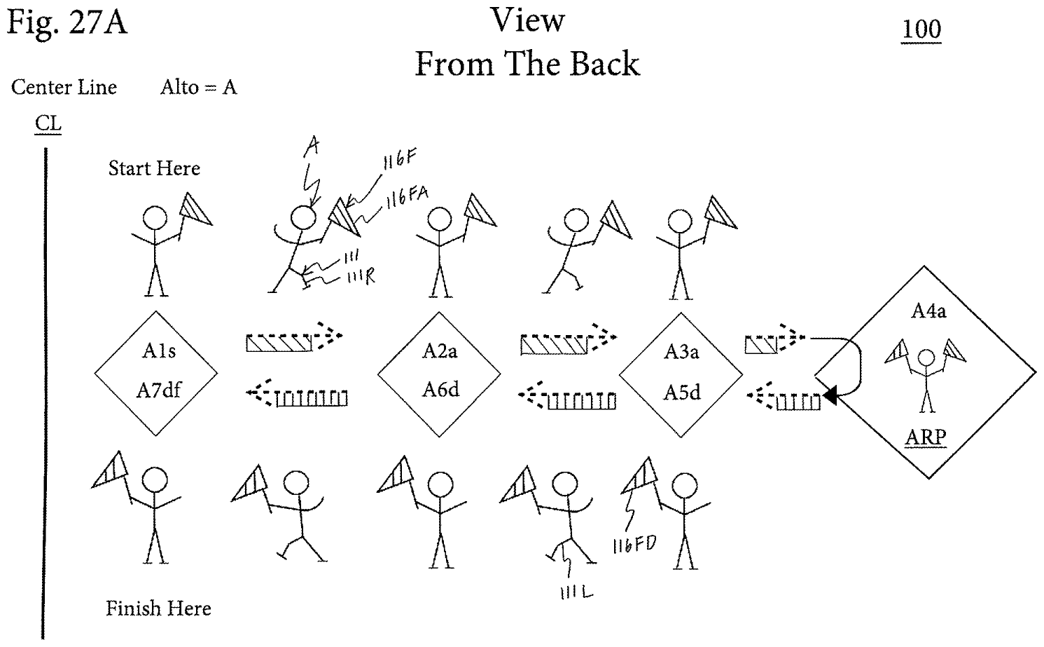

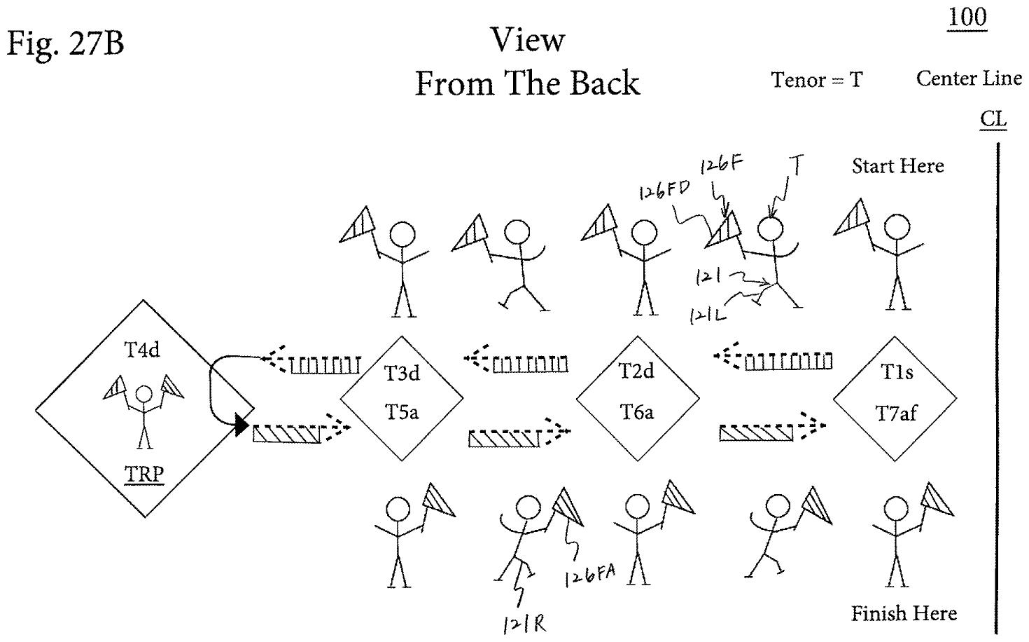

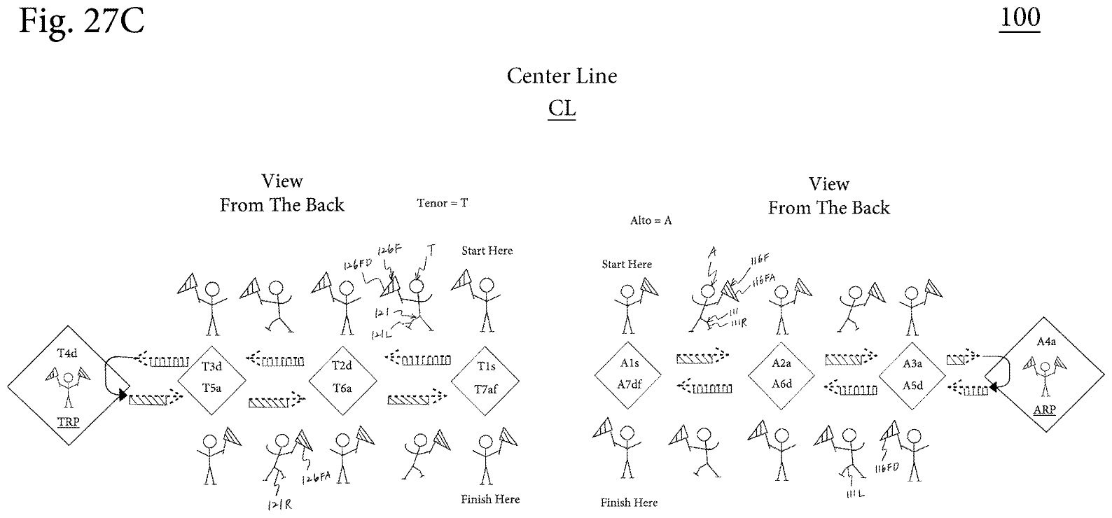

FIGS. 27A-C show an alternative embodiment of the teaching method 100 of FIGS. 26A-C, with an emphasis on the kinesthetic sense rather than singing. Turning to FIGS. 27A-C, the teaching method 100 is shown with reference to two groups of singers, including a first group of alto singers A and a second group of tenor singers T who can sing a respective series (or sequences) of notes in the manner shown and described in more detail above with reference to FIGS. 26A-C. As shown in FIGS. 27A-C, a center line CL can be disposed between the first group of alto singers A and the second group of tenor singers T. FIGS. 27A-C and 28 illustrate the stepping or other movement, and, as such, no musical staff is shown. The musical tones need not be sung and are mentioned as a guide or as synchronizing with the stepping. Both groups of singers may choose to sing or memorize the musical notes 112, 122 shown in FIGS. 26A-C.

Traditionally, in western cultures and other cultures, the reading of music and language proceeds in a left to right fashion. In selected embodiments of the teaching method 100, to appreciate the kinesthetic sense of actual left and right linear simultaneous movement in two opposite directions; the reading starts with the alto singers A and the tenor singers T and the music beginning on respective sides of the center line CL and expanding in opposite directions. FIG. 27A and FIG. 27B, for example, be viewed as alongside each other, viewed from the back and condensed to one page so that the center line CL appears in the between the two drawing sheets and separates the vocal lines of the alto singers A and the tenor singers T from each other in the manner illustrated in FIG. 27C.

The musical notes sung or otherwise indicated by the first group of alto singers A are shown in FIG. 27A as beginning with a first ascending sub-sequence of three musical notes A2a, A3a, A4a and as ending with a second descending sub-sequence of three musical notes A5d, A6d, A7df, wherein the first ascending sub-sequence of three musical notes A2a, A3a, A4a and the second descending sub-sequence of three musical notes A5d, A6d, A7df are symmetrically centered about a fourth musical note A4a. Similarly, the musical notes 122 sung or otherwise indicated by the second group of tenor singers T are shown in FIG. 27B as beginning with a first descending sub-sequen3ce of three musical notes T2d, T3d, T4d and as ending with a second ascending sub-sequence of three musical notes T5a, T6a, T7af, wherein the first descending sub-sequence of three musical notes T2d, T3d, T4d and the second ascending sub-sequence of three musical notes T5a, T6a, T7af are symmetrically centered about a fourth musical note T4d.

The teaching method 100 can include at least one of the alto singers A physically moving 111 synchronously with the musical notes 112 indicated by the first group of alto singers A in the manner shown and described in more detail above with reference to FIG. 26A. Turning to FIG. 27A, one of more of the alto singers A are shown as being positioned to the right of the center line CL and the view is from the back. One or more of the alto singers A can sidestep to the right 111_{R} and away from the center line while the first group of alto singers A may sing the first note A1s followed by the first ascending sub-sequence of musical notes A2a, A3a, A4a and/or sidestep to the left 111_{L} and toward the center line CL while the first group of alto singers A may sing the second descending sub-sequence of musical notes A5d, A6d, A7df.

Diamond-shaped indicia of FIG. 27A indicate the musical notes 112 that may be sung and the corresponding sidestep destinations for feet of the alto singers A. The diamond-shaped indicia also indicate that the sung musical notes 112 are the same, as the alto singers A retrace their steps. In other words, the musical note A1s and the musical note A7df occupy the same diamond-shaped indicia and comprise the same musical note, the musical note A2a and the musical note A6d occupy the same diamond-shaped indicia and comprise the same musical note, and the musical note A3a and the musical note A5d occupy the same diamond-shaped indicia and comprise the same musical note.

The alto singers A can sidestep to the left 111_{L} preferably retracing the previous sidesteps to the right 121_{R}. The alto retrace point ARP between the first ascending sub-sequence of musical notes A2a, A3a, A4a and the second descending sub-sequence of musical notes A5d, A6d, A7df can provide a transition between the sidestepping to the right 111_{R} and the sidestepping to the left 111_{L}. In other words, the alto singers A can reverse or otherwise change the physical movement 111 at the alto retrace point ARP.

The musical notes A1s, A2a, A3a are shown in an upper part of the diamond-shaped indicia. The diamond-shaped indicia A4a is drawn larger as it is the alto retracing point ARP for the alto singers A. The musical notes A5d, A6d, A7df are shown in a lower part of the diamond-shaped indicia on the lower part of the same diamond because musical notes A5d, A6d, A7df occupy the same space as the musical notes A1s, A2a, A3a. The inbound steps associated with the musical notes A5d, A6d, A7df are merely a retracing of outbound steps associated with musical notes A1s, A2a, A3a. In other words, the musical notes A5d, A6d, A7df use the same foot destinations as A1, A2, A3 as the musical notes A1s, A2a, A3a. Simply put, the steps associated with the musical notes A5d, A6d, A7df, retrace the steps associated with the musical notes A1s, A2a, A3a with the stepping being in opposite directions.

Additionally and/or alternatively, the teaching method 100 can include at least one of the tenor singers T physically moving 121 synchronously with the musical notes 122 indicated by the second group of tenor singers T. Turning to FIG. 27B, one of more of the tenor singers T are shown as being positioned to the left of the center line CL, and the view is from the back. One or more of the tenor singers T are shown as sidestepping to the left 121_{L} and away from the center line CL while the first group of tenor singers T may sing the first note T1s followed by the first descending sub-sequence of musical notes T2d, T3d, T4d and/or sidestepping to the right 121_{R} while the first group of tenor singers T may sing the second ascending sub-sequence of musical notes T5a, T6a, T7af.

Diamond squares are shown in FIG. 27B to indicate the musical notes being sung and the corresponding sidestep destinations for feet of the tenor singers T. The diamond-shaped indicia also indicate that the sung musical notes 122 are the same, as the tenor singers retrace their steps. In other words, the musical note T1s and the musical note T7af occupy the same diamond-shaped indicia and comprise the same musical note, the musical note T2d and the musical note T6a occupy the same diamond-shaped indicia and comprise the same musical note, and the musical note T3d and T5a occupy the same diamond-shaped indicia and comprise the same musical note.

The tenor retrace point TRP between the first descending sub-sequence of musical notes T2d, T3d, T4d and the second ascending sub-sequence of musical notes T5a, T6a, T7af can define a boundary between the sidestepping to the left 121_{L} and the sidestepping to the right 121_{R}. In other words, the tenor singers T can reverse or otherwise change the physical movement 121 at the tenor retrace point TRP.

The musical notes T1s, T2d, T3d are shown in an upper part of the diamond-shaped indicia. The diamond-shaped indicia T4d is drawn larger as it is the tenor retracing point TRP for the tenor singers T. The musical notes T5a, T6a, T7af are shown in a lower part of the diamond-shaped indicia on the lower part of the same diamond because musical notes T5a, T6a, T7af occupy the same space as the musical notes T1s, T2d, T3d. The inbound steps associated with the musical notes T5a, T6a, T7af are merely a retracing of outbound steps associated with musical notes T1s, T2d, T3d. In other words, the musical notes T5a, T6a, T7af use the same foot destinations as T1, T2, T3 as well as the musical notes T1s, T2d, T3d. Simply put, the steps associated with the musical notes T5a, T6a, T7af, retrace the steps associated with the musical notes T1s, T2d, T3d with the stepping being in opposite directions.

Although shown and described with reference to FIGS. 27A-B as comprising left sidesteps and right sidesteps for purposes of illustration only, the physical movement 111 of the alto singers A and the physical movement 121 of the tenor singers T can comprise any suitable type of physical movement, such as arm movements, leg movements, head movements, jumping, squatting, stepping forward, stepping backward, stepping diagonally, etc., without limitation.

For example, the visual impact of the teaching method 100 can be heightened by the alto singers A and the tenor singers T using flags 116_{F}, 126_{F} for pointing out their respective directions of movement. As shown in FIG. 27A, an alto-ascending (or green-colored) flag 116_{FA} can be used to emphasize the first ascending sub-sequence of musical notes A2a, A3a, A4a as sung by the alto singers A; whereas, an alto-descending (or red-colored) flag 116_{FD} can be used to emphasize the second descending sub-sequence of musical notes A5d, A6d, A7df. A right hand of a selected alto singer A can hold the alto-ascending flag 116_{FA}, and a left hand of the selected alto singer A can hold the alto-descending flag 116_{FD}. The selected alto singer A thereby can raise the alto-ascending flag 116_{FA} when the first ascending sub-sequence of musical notes A2a, A3a, A4a is sung and the alto-descending flag 116_{FD} when the second descending sub-sequence of musical notes A5d, A6d, A7df is sung.

Additionally and/or alternatively, a tenor-descending (or red-colored) flag 126_{FD} as illustrated in FIG. 27B can be used to emphasize the first descending sub-sequence of musical notes T2d, T3d, T4d as sung by the tenor singers T; whereas, a tenor-ascending (or green-colored) flag 126_{FA} can be used to emphasize the second ascending sub-sequence of musical notes T5a, T6a, T7af. A left hand of a selected tenor singer T can hold the tenor-descending flag 126_{FD}; whereas, a right hand of the selected tenor singer T can hold the tenor-ascending flag 126_{FA}. The selected tenor singer T thereby can raise the tenor-descending flag 126_{FD} when the first descending sub-sequence of musical notes T2d, T3d, T4d is sung and the tenor-ascending flag 126_{FA} when the second ascending sub-sequence of musical notes T5a, T6a, T7af is sung.

In the manner discussed above, FIG. 27C illustrates the sung musical notes 112 and the corresponding physical movement, at 111, of the alto singers A of FIG. 27A relative to the sung musical notes 122 and the corresponding physical movement, at 121, of the tenor singers T of FIG. 27B. Turning to FIG. 27C, the alto singers A and the tenor singers T are shown as starting on respective sides of the center line CL. The kinesthetic stepping feature, right and left, thereby can be accomplished as the listener 500 (shown in FIG. 4A) listens to the contrary motion in the music. Since the alto singers A step right as the tenor singers T step left, reading the exercise with an orientation from the center line CL, FIG. 27C can offer a true visual of the kinesthetic point of view. The listener 500 can be asked to read from the center line CL and proceed to the right for the alto singer A. Similarly, the listener 500 can be asked to read from the center line CL and proceed to the left for the tenor singer T.

Change of orientation is something with which humans are familiar. For example, clocks have several ways of expressing digital and analogue time: 10:45 is a quarter to eleven; while, in Europe, 10:45 pm would be 22:45.

In a stage performance, an audience might have a view of the entire stage. Likewise, looking at a painting, the viewer often starts from the focal point wherever that happens to be, and from there, expand outwards in different directions to take in the entire painting. Descriptions on paper intended to instruct, as with the teaching method 100, can include a different approach using a center line CL as the point of departure.

In selected embodiments, the teaching method 100 of FIGS. 27A-B advantageously can be built upon with other permutations as below.

A choir may explore different variations in the placement and positioning of the alto singers A and/or the tenor singers T.

In a situation where the singers are facing front with an audience viewing the exercise, for example, the alto singers A would be on the left side of the center line CL and the tenor singers T on the right side center line CL. Another position might engage the alto singers A and the tenor singers T standing back-to-back as the starting position, before each singer proceeding forward, resulting in hearing the contrary in addition to stepping away from each other.

Additional placement could include, as suggested in FIGS. 27A-B, starting a predetermined distance, such as eighteen inches apart with the alto singers A facing front and the tenor singers T facing back, instead of facing the same direction. This placement can include a one hundred and eighty degree turn-around in order to avoid stepping backwards and causing possible injury. Permutations of steps and different face directions are implemented with the idea of enhancing the auditory through movement in opposite or semi-opposite directions. Semi-opposite directions would include diagonal stepping. Another permutation could include one group of singers stepping backwards while the other group of singers is stepping forward. Yet, another possibility would be placing one or more alto singers A and one of more tenor singers T on a staircase, one group stepping up and another group stepping down.

To ensure greater attention to the exercise, one could add complexity as follows: have the alto singers A step down the stairs while singing an ascending line, and the tenor singers T stepping up the stairs while singing a descending line. This embodiment offers another dimension of contrary motion and necessitates that the singers to give close attention to the exercise.

One exemplary function of the permutations is to heighten the auditory experience by engaging the kinesthetic and visual senses.

### Example: Kinesthetic Sense with Stepping

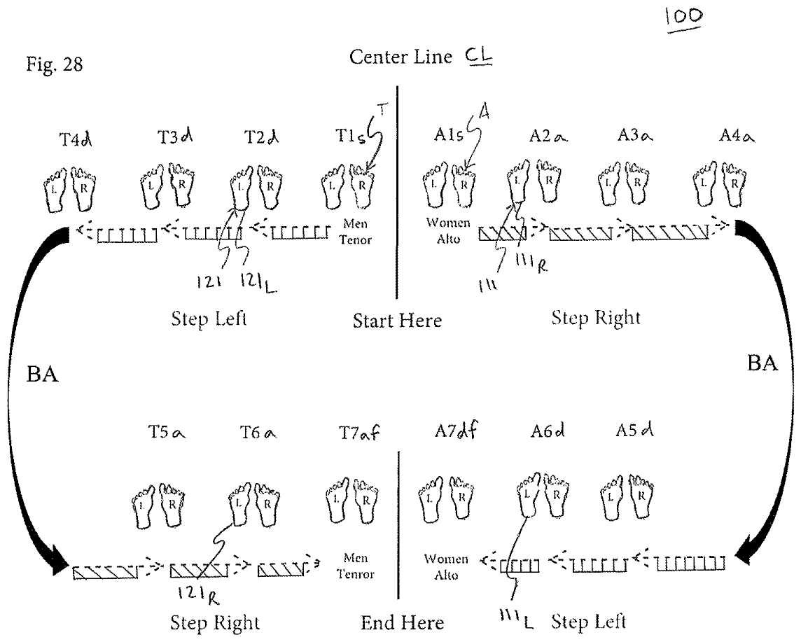

An alternative manner of depicting the kinesthetic foot stepping movement of the alto singers A and the tenor singers T from the perspective of the center line CL is illustrated in FIG. 28. This perspective includes drawings of feet and labeled, R for Right and L for Left. Turning to FIG. 28, the alto singers A can move to the right, and away from, the center line CL in synchronization with the first ascending sub-sequence of musical notes A2a, A3a, A4a as sung by the alto singers A. The tenor singers T, simultaneously, can move to the left, and away from, the center line CL with the second descending sub-sequence of three musical notes T2d, T3d, T4d as sung by the tenor singers T. Upon reaching the fourth musical note A4a, Td4, the alto singers A and the tenor singers T can retrace their steps back to the center line CL.

As shown in FIG. 28, a selected alto singer A can proceed from a starting alto position associated with musical note A1 s and to a second alto position associated with musical note A2a. The selected alto singer A can move from the starting alto position to the second alto position by leading with a right foot of the selected alto singer A, followed by a left foot of the selected alto singer A. When moving from the second alto position to a third alto position associated with the musical note A3a, the selected alto singer A can lead with the right foot followed by the left foot and then proceed on to a fourth alto position associated with the fourth musical note A4a by leading with the right foot followed by the left foot.

Upon reaching the fourth alto position, the selected alto singer A can retrace the same path back to the starting alto position as indicated by a first black arrow BA. The first black arrow BA is shown as connecting the fourth alto position associated with the fourth musical note A4a to a fifth alto position associated with the fifth musical note A5d, which is the same as the third alto position associated with the musical note A3a. The selected alto singer A, for example, can move from the fourth alto position to the fifth alto position by leading with the left foot of the selected alto singer A, followed by the right foot. When moving from the fifth alto position to a sixth alto position associated with the musical note A6d, the selected alto singer A can lead with the left foot followed by the right foot and then proceed on to a final alto position associated with the seventh musical note A7df by leading with the left foot followed by the right foot. The sixth alto position can be the same as the second alto position associated with the musical note A2a; whereas, the final alto position can be the same as the starting alto position associated with the musical note A1 s.

A selected tenor singer T similarly can proceed from a starting tenor position associated with musical note T1s and to a second tenor position associated with musical note T2d. The selected tenor singer T can move from the starting tenor position to the second tenor position by leading with a left foot of the selected tenor singer T, followed by a right foot of the selected tenor singer T. When moving from the second tenor position to a third tenor position associated with the musical note T3d, the selected tenor singer T can lead with the left foot followed by the right foot and then proceed on to a fourth tenor position associated with the fourth musical note T4d by leading with the left foot followed by the right foot.

Upon reaching the fourth tenor position, the selected tenor singer T can retrace the same path back to the starting tenor position as indicated by a second black arrow BA. The second black arrow BA is shown as connecting the fourth tenor position associated with the fourth musical note T4d to a fifth tenor position associated with the fifth musical note T5a, which is the same as the third tenor position associated with the musical note T3d. The selected tenor singer T, for example, can move from the fourth tenor position to the fifth tenor position by leading with the right foot of the selected tenor singer T, followed by the left foot. When moving from the fifth tenor position to a sixth tenor position associated with the musical note T6a, the selected tenor singer T can lead with the right foot followed by the left foot and then proceed on to a final tenor position associated with the seventh musical note T7af by leading with the right foot followed by the left foot. The sixth tenor position can be the same as the second tenor position associated with the musical note T2d; whereas, the final tenor position can be the same as the starting tenor position associated with the musical note T1s.

Orientation: Culmination of the Choir for Heightening the Auditory Sense Using Visual and Kinetic Senses

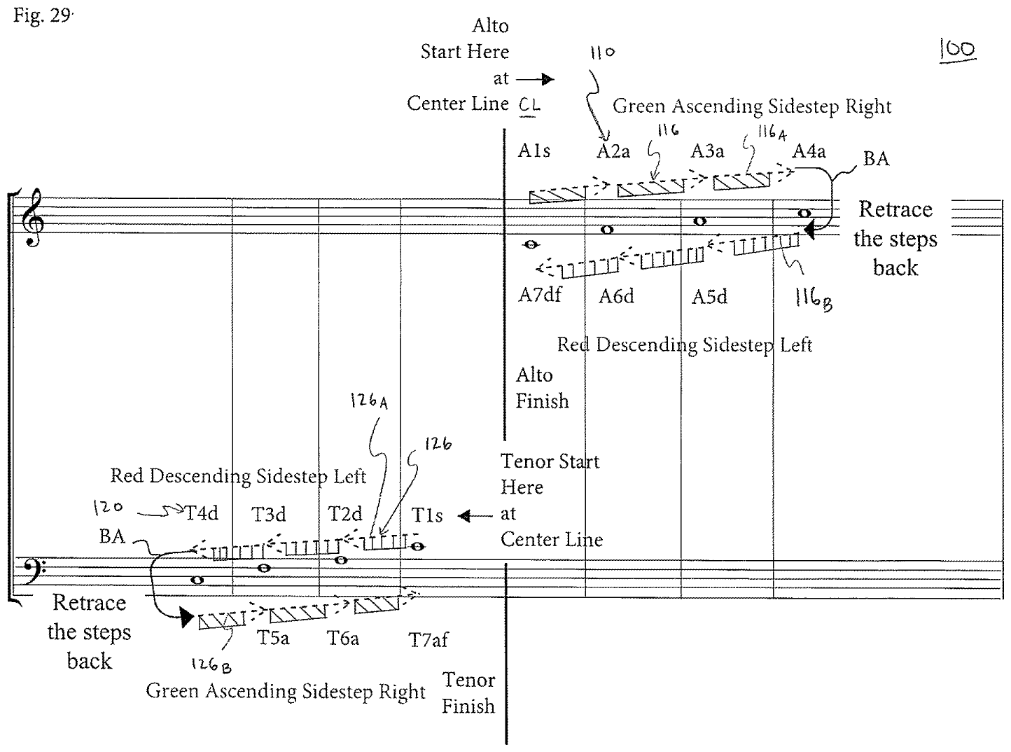

FIG. 29 exemplifies a succinct drawing using four musical notes for the alto singers A and four musical notes for the tenor singers T shown on each side of the center line CL. With the four musical notes, after singing the starting note, the singers sing the remaining three notes and then sing the musical notes, that they just sang in reverse order.

The listener 500 (shown in FIG. 4A) or other participant in the learning method 100 can start at a predetermined distance, such as eighteen inches, from another singer, is then asked to take sidesteps with their feet, as in FIG. 28, while simultaneously singing. The alto singers A begin by singing the musical note A1 s, and the tenor singers T begin by singing the musical note T1s. Each note of the four notes is sung while taking one step in increments, such as increments of eighteen inches. By the fourth note, each singer moves approximately five feet to the right or to the left. Thus, a distance of ten feet between the singers is achieved by the fourth musical note. The exercise highlights the distance between the steps taken and notes sung. As the intervals of the sung notes between the alto singers A and the tenor singers T increases, the physical incremental distance between each listener 500 or other participant stepping also increases. The physical distance supports and even magnifies the hearing of the opposition of the notes in contrary motion.

At the fourth note the exercise is retraced. As the sung notes and steps of the alto singers A and the tenor singers T return to the center or “finishing point”—the distance between the intervals of the notes and the steps diminishes incrementally. Thus, the sung notes can be heard as nearby, beginning with singing the same note, or as more distant intervals—reaching two octaves apart—simulating the kinesthetic movement with the auditory sense. The intervals of the music and distance of the steps work in tandem.

The Method for Both Alto Singer and Tenor Singer

At least one alto singer A and at least one tenor singer T are shown in FIG. 29 as being divided by a center line CL. The contrary motion can be observed by stepping away from and then back to the center line CL. Both the alto singer A and the tenor singer T start from the center of the page and proceed as follows.

The alto singer A and the tenor singer T respectively stepping to the right and to the left can be shown when starting simultaneously from the center line CL. The alto singer A and the tenor singer T start next to each other at a predetermined distance shoulder to shoulder such as about eighteen inches apart. Starting at the center line CL advantageously can be utilized to help distinguish between or otherwise illustrate the respective directions of the two singers A, T. From the center line CL, stepping moves to the right and to the left. A related music score shown in FIG. 29 also can be read from the middle and can continue to both the right and the left. In accordance with the selected embodiments of the teaching method 100, ascending notes can be marked with an ascending diagonal green line and descending notes are marked with a descending diagonal red line.

In other words, the teaching method 100 can include a first visual image 116 for visually presenting the first line 110 of music in the manner discussed above with reference to FIGS. 25A and 25C. The first visual image 116 can comprise one or more visual images based upon the nature of the first line 110 of music. The first visual image 116 can include a first visual image portion 116_{A} that is associated with the first ascending sub-sequence of musical notes A2a, A3a, A4a and/or a second visual image portion 116_{B} that is associated with the descending sub-sequence of musical notes A5d, A6d, A7df as illustrated in FIG. 29. Additionally and/or alternatively, the teaching method 100 can include a second visual image 126 for visually presenting the second line 120 of music in the manner discussed above with reference to FIGS. 25B and 25C. The second visual image 126 can comprise one or more visual images based upon the nature of the second line 120 of music. The second visual image 126 can include a first visual image portion 126_{A} that is associated with the first descending sub-sequence of musical notes T2d, T3d, T4d and/or a second visual image portion 126_{B} that is associated with the ascending sub-sequence of musical notes T5a, T6a, T7af as shown in FIG. 29.

Two groups of people, musicians or singers in a choir, such as the alto singer A and the tenor singer T, can stand next to each other. If there is more than one alto singer A and more than one tenor singer T, each alto singer A can stand behind another alto singer A, as in a queue at a comfortable distance. Each tenor singer T also can stand behind another tenor singer T, as in a queue. Each alto singer A can be partnered with a tenor singer T on the other side of a center line CL. A column of alto singers A can stand on the right side of the center line CL—while a column tenor singers T can stand on the left side of the center line CL, shoulder of a tenor singer T to shoulder of an alto singer A at a predetermined distance, such as about eighteen inches, apart.

The center line CL can be either physical or imaginary. Any equal number of alto singers A and tenor singers T may participate in order that each alto singer A can be partnered a tenor singer T. Both groups, the alto singers A and the tenor singers T, simultaneously sing one note at a time. The alto singers A and the tenor singers T hold each sung note for a predetermined period of time, such as two or three seconds. Each note is assigned a number as seen in FIG. 23 with a designation of “a” for ascending or “d” for descending and “s” for starting and “f” for finishing notes.

In selected embodiments, the alto singers A and the tenor singers T can remain stationary while singing the first musical notes A1 s and T1s. The first musical notes A1 s and T1s as shown in FIG. 29 is the same note for both alto singers A and tenor singers T. Feet are in a neutral or “starting position” with toes always facing forward.

All other musical notes sung and steps taken from this starting position will move in contrary motion between the alto singers A and the tenor singers T, that is; either ascending or descending. As the alto singers A sing an ascending note, the tenor singers T can simultaneously sing a descending note. And, vice versa as they retrace their steps back: As the alto singers A sing a descending note, the tenor singers T can sing an ascending note.

Stepping in General

While singing the series of musical notes, the alto singers A and the tenor singers T can demonstrate the workings of contrary motion in a tactual and/or kinesthetic sense by stepping to the side with their feet. One foot, followed by the other.

At A1 and T1, both feet of each singer A, T are in the starting position, the feet of each singer A, T are placed a predetermined distance, such as about six inches.

There are no one hundred and eighty degree turns and all steps can move a predetermined distance, such as approximately eighteen inches, in a straight line with one foot stepping to the right or left followed by the other foot stepping in the same direction. The alto singers A and the tenor singers T can continue to face front and preferably do not make a U-turn; the alto singers A and the tenor singers T merely reverse their steps.

Physically speaking both feet can move in a sidestepping manner, the feet and toes of the alto singers A and the tenor singers T preferably always face forward.

The alto singers A and the tenor singers T can begin at the center line CL and proceed away from the center line CL, one position at a time. At the fourth note, the alto singers A and the tenor singers T can retrace their steps back to center line CL where the exercise ends.

General: Ascending Notes with Sidestep to the Right

With each ascending sung note, the alto singer A can take a sidestep to the right at a predetermined distance, such as about eighteen inches. That is, the right foot of the alto singer A can take one step to the right; a sidestep; which can take approximately one or two seconds. The other foot—the left foot—of the alto singer A can follow by taking a sidestep the right at a predetermined distance, such as about eighteen inches. This second sidestep also can take about one or two seconds. Upon completing an ascending note both feet of the alto singer A can be aligned next to each other, and the feet of the alto singer A can hold that position for another second before proceeding to the next position.

This sequence of sidesteps can be mirrored by the tenor singer T who, with each ascending sung note, can take a sidestep to the right at a predetermined distance, such as about eighteen inches. That is, the right foot of the tenor singer T can take one step to the right; a sidestep; which can take approximately one or two seconds. The other foot—the left foot—of the tenor singer T can follow by taking a sidestep the right at a predetermined distance, such as about eighteen inches. This second sidestep also can take about one or two seconds. Upon completing an ascending note both feet of the tenor singer T can be aligned next to each other, and the feet of the tenor singer T can hold that position for another second before proceeding to the next position.

General: Descending Notes; Sidestep to the Left

With each descending sung note, the alto singer A can take a sidestep to the left at a predetermined distance, such as about eighteen inches. That is, the left foot of the alto singer A can take one step to the left; a sidestep; which takes about one or two seconds. The other foot the right foot—of the alto singer A can follow by also taking a sidestep to the left at a predetermined distance, such as about eighteen inches. The sidestep by the right foot also takes about one or two seconds. Upon completing a descending note both feet of the alto singer A can be aligned next to each other. That position can be held for another second or so before proceeding to the next position. Each sung note is held for approximately three seconds and can happen simultaneously with the stepping. The length of time for the entire exercise can comprise a reselected time interval such as between twenty-five seconds and thirty-five seconds.

This sequence of sidesteps can be mirrored by the tenor singer T who, with each descending sung note, can take a sidestep to the left at a predetermined distance, such as about eighteen inches. That is, the left foot of the tenor singer T can take one step to the left; a sidestep; which takes about one or two seconds. The other foot—the right foot—of the tenor singer T can follow by also taking a sidestep to the left at a predetermined distance, such as about eighteen inches. The sidestep by the right foot also takes about one or two seconds. Upon completing a descending note both feet of the tenor singer T can be aligned next to each other. That position can be held for another second or so before proceeding to the next position. Each sung note is held for approximately three seconds and can happen simultaneously with the stepping. The length of time for the entire exercise can comprise a reselected time interval such as between twenty seconds and thirty-five seconds.

General Clarification of Retracing Steps and Repeating Notes

After the starting note, the first three steps are taken to the right or left—and then the relevant singer(s) A, T can retrace the steps in the opposite direction returning to the starting and/or finishing position(s).

The singing of the music notes can match the direction of the sidestepping. Both the alto singers A and the tenor singers T can read and sing the four notes as they step, then or repeat the sung tones, back to the starting/finishing position.

The directions for the alto singer A and the tenor singer T are placed above the four notes. Upon reaching the fourth note, the directions for the alto singer A and the tenor singer T are placed below the four notes.

Alto Singers

When singing the starting or first musical note A1 s, the alto singers A can begin “in place” with both feet next to each other, the “starting position,” to the right of the center line CL. While the alto singers A sing their first note A1 s, their feet can remain in place.

While simultaneously singing the second musical note A2a in the series, an ascending note, the alto singers A can take a sidestep with their right feet, in a straight line, followed by their left feet. The alto singers A can complete the second musical note A2a with both feet placed next to each other, as in the starting position, before proceeding to the next musical note, the third musical note A3a.

While simultaneously singing the third musical note A3a in the series, an ascending note, the alto singers A can take a sidestep with their right feet, in a straight line, followed by their left feet. The alto singers A can complete the third musical note A3a with both feet next to each other, as in the starting position, before proceeding to the next musical note, the fourth musical note A4a.

While simultaneously singing the fourth musical note A4a in the series, an ascending note, the alto singers A can take a sidestep with their right feet, in a straight line, followed by their left feet. The alto singers A can complete the fourth musical note A4a with both feet next to each other, as in the starting position.

At the point of the fourth musical note A4a, the retracing of steps and repeating of sung notes begin with the next note, the fifth musical note A5d. A first black arrow BA curves around from the fourth sung note A4a and points to fifth musical note A5d. The alto singers A can prepare to retrace their steps while singing the fifth musical note A5d. The alto singers A can be asked to reverse or retrace their steps, moving now to the left while singing the descending notes of the exercise. The first black arrow BA shown connects the green ascending dotted line at T4d with the red descending dotted line 116_{B} associated with the fifth musical note A5d.

While simultaneously singing the fifth musical note A5d in the series, a descending note, the alto singers A can take a sidestep with their left foot, in a straight line, followed by their right foot. Stated somewhat differently, the alto singers A can retrace their steps. The alto singers A complete the fifth musical note A5d with both feet next to each other, as in the starting position, before proceeding to the next musical note, the sixth musical note A6d.

While simultaneously singing the sixth musical note A6d in the series, a descending note, the alto singers A can take a sidestep with their left feet, in a straight line, followed by their right feet. Stated somewhat differently, the alto singers A can retrace their steps. The alto singer A can complete the sixth musical note A6d with both feet next to each other as in the starting position, before proceeding to the next musical note, the seventh and final musical note A7df.

While simultaneously singing the seventh musical note A7df in the series, a descending note, the alto singers A can take a sidestep with their left feet, in a straight line, followed by their right feet. Stated somewhat differently, the alto singers A can retrace their steps, ending with both feet next to each other as in the starting position. The seventh musical note A7df is associated with the final step. The finishing position associated with the seventh musical note A7df can share the same position as the position associated with the starting musical note A1s.

Tenor Singers

When singing the starting or first musical note T1s, the tenor singers T can start “in place” with both feet next to each other, the “starting position” to the left of the center line CL. While singing the first musical note T1s, the tenor singers T can remain in place.

While simultaneously singing the second musical note T2d in the series, a descending note, the tenor singers T can take a step to the side with their left feet, in a straight line, followed by their right feet. The tenor singers T can complete the second musical note T2d with both feet next to each other as in the starting position, before proceeding to the next musical note, the third musical note T3d.

While simultaneously singing the third musical note T3d in the series, a descending note, the tenor singers T can take a sidestep with their left feet, followed by their right feet. The tenor singers T can complete the third musical note T3d with both feet next to each other, as in the starting position, before proceeding to the next musical note, the fourth musical note T4d.

While simultaneously singing the fourth musical note T4d in the series, a descending note, the tenor singers T can take a sidestep with their left feet, in a straight line, followed by their right feet. The tenor singers T can complete the fourth musical note T4d with both feet next to each other as in the starting position.

At the point of the fourth musical note T4d, the retracing of steps and repeating of sung notes can begin with the next musical note, the fifth musical note T5a. A second black arrow BA curves around from the fourth musical note T4d and points to the fifth musical note T5a. The tenor singers T can prepare to retrace their steps while the singing the fifth musical note T5a. The tenor singers T can be asked to reverse or retrace their, steps, moving now to the right while singing the ascending notes of the exercise. The second black arrow BA shown connects the red descending dotted line 126_{A} associated with the fourth musical note T4d to the green ascending dotted line 126_{B} associated with the fifth musical note T5a.

While simultaneously singing the fifth musical note T5a in the series, an ascending note, the tenor singers T can take a sidestep with their right feet, followed by their left feet. Stated somewhat differently, the tenor singers T can retrace their steps. The tenor singers T can complete the fifth musical note T5a with both feet next to each other as in the starting position, before proceeding to the next musical note, the sixth musical note T6a.

While simultaneously singing the sixth musical note T6a in the series, an ascending note, the tenor singers T can take a sidestep with their right feet in a straight line, followed by their left feet. Stated somewhat differently, the tenor singers T can retrace their steps. The tenor singers T can complete the sixth musical note T6a with both feet next to each other, as in the starting position, before proceeding to the next musical note, the seventh and final musical note T7af.

While simultaneously singing the seventh musical note T7af in the series, an ascending note, the tenor singers T can take a sidestep with their right feet, in a straight line, followed by their left feet. Stated somewhat differently, the tenor singers T can retrace their steps, ending with both feet next to each other as in the starting position. The seventh musical note T7af can be associated with the final step. The finishing position associated with the seventh musical note T7af can share the same position as the position associated with the starting musical note T1s.

For both the alto singers A and the tenor singers T, after the starting position, the stepping movement in the present embodiment can simply comprise three steps in one direction, followed by retracing the steps, that is, three steps back to the starting position in selected embodiments.

For both the alto singers A and the tenor singers T, after the first note is sung, the singing of the notes is simply three notes sung in direction, followed by three repeating the notes back to the starting note.

Metaphorically, like climbing a tree: the climber can go up and then retrace the steps down. In a simpler explanation, after the starting position, the singers A, T can sing three notes and then sing the same notes while they retrace the steps back to starting position.

It will be appreciated that the foregoing embodiments set forth various circumstances for understanding of the basic relationship between any two vocal parts of a choir whose lines are written in contrary motion, where the two lines extend away from each other and return. This basic relationship can provide a basis for incorporating the visual and kinesthetic senses. Other variations of these embodiments are contemplated. For example, adjacent musical notes 112, 122 of FIG. 16A are shown as alternating between comprising ascending musical notes and descending musical notes. While singing the musical notes 112 with larger intervals of sixths and sevenths, the alto singers A may need to span larger distances between steps, or possibly two steps, for each of the musical notes 112. The tenor singers T, in contrast, can sing the musical notes 122 with intervals of seconds and thirds. In other words, music can call specific attention to many different forms of contrary motion.

The teaching method 100 advantageously can be applied to a band, a choir or any other musical ensemble with any predetermined number of two or more musical note ranges. A choir, for example, need not be limited to alto singers A and tenor singers T as set forth in the preceding embodiments. The choir optionally can include one or more soprano singers, one or more mezzo-soprano singers, one or more baritone singers and/or one or more bass singers, without limitation. It will be appreciated that the embodiments shown and described with reference to FIGS. 22-29 and that the teaching method 100 can be applied to other pieces of music. The teaching method 100, as needed, can be adjusted or otherwise adapted to conform with the other pieces of music.

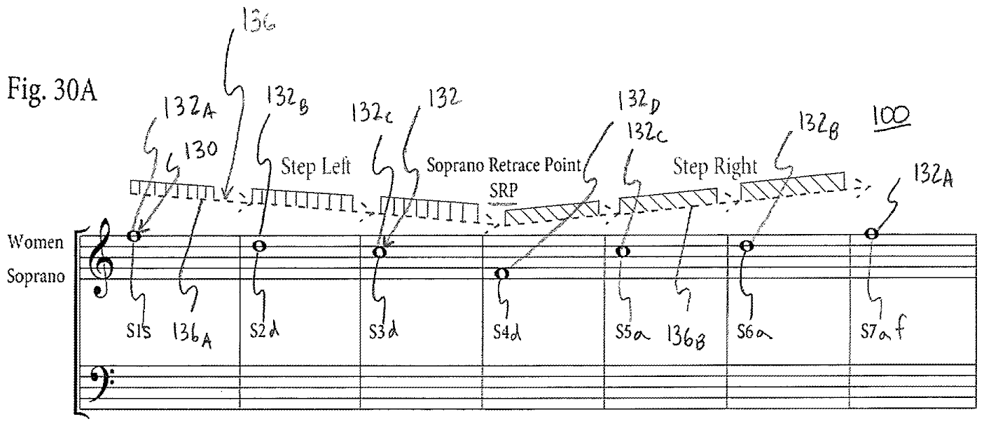

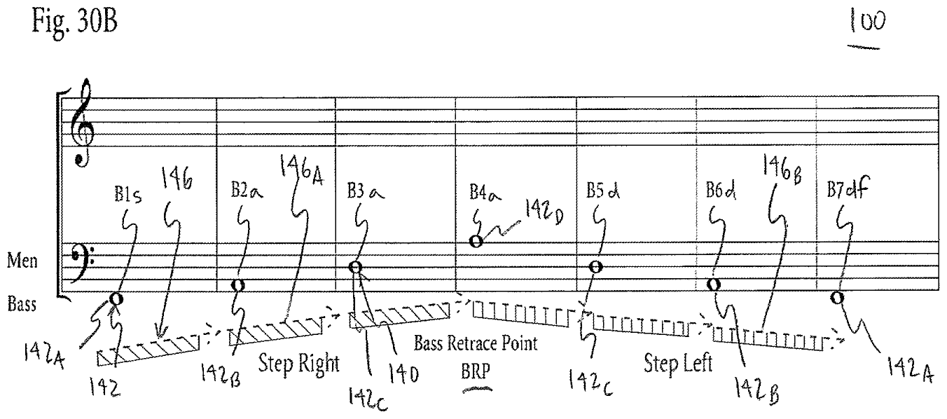

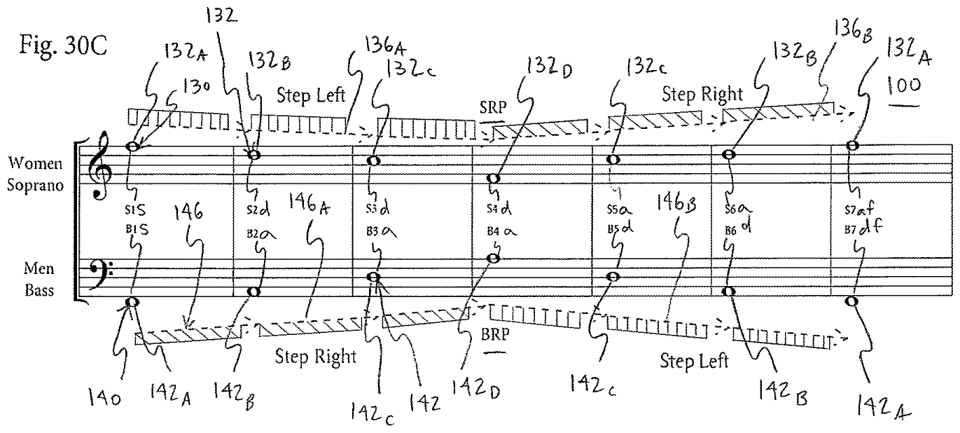

FIGS. 30A-C illustrate an alternative embodiment of the teaching method 100. Turning to FIGS. 30A-C, the teaching method 100 is illustrated with reference to two groups of singers, including a third group of soprano singers S and a fourth group of bass singers B who can sing a respective series (or sequences) of notes. The teaching method 100 of FIGS. 30A-C optionally can comprise only the third group of soprano singers S and the fourth group of bass singers B or can be combined with one or more other singers, such as the first group of alto singers A and the second group of tenor singers T as shown and described with reference to FIGS. 25A-C. The voices of the soprano singers S and the bass singers B can supply a fuller embodiment of the teaching method 100. In selected embodiments, the soprano singers S and the bass singers B can join the alto singers A and the tenor singers T shown in FIGS. 22-29 to form an expanded choral group. The soprano singers S and the bass singers B optionally can condense the material shown and described with reference to FIGS. 22-29 for the alto singers A and the tenor singers T. For example, the soprano singers S and the bass singers B may not make use (and/or may choose to not make use) the corresponding FIGS. 22, 23 and/or 24, which are used in the alto singers A and the tenor singers T. Additionally and/or alternatively, FIG. 30 illustrates an exemplary combination of the third visual images 136, 146 with the physical movement 131, 141 into one exercise the soprano singers S and the bass singers B.

In the embodiment shown in FIGS. 30A-C, the soprano singers S can sing a third line 130 of the music that can include a third series (or sequence) of musical notes 132. In the manner set forth above with reference the second line 120 of music (shown in FIG. 25B), the musical notes 132 can include a third predetermined number of musical notes 132_{A}, 132_{B}, 132_{C}, 132_{D}. The third line 130 of the music can begin with musical notes 132_{A}, 132_{B}, 132_{C} that descend in pitch as the third line 130 of the music proceeds and until the fourth musical note 132_{D} (or the soprano retrace point SRP) is reached. Upon reaching the soprano retrace point SRP, the third line 130 of music can conclude by repeating the musical notes 132_{C}, 132_{B}, 132_{A} in reverse order as illustrated in FIG. 30A.

The teaching method 100 optionally can include a fourth line 140 of the music that can include a fourth series (or sequence) of musical notes 142. In the manner set forth above with reference the first line 110 of music (shown in FIG. 25A), the musical notes 142 can include a fourth predetermined number of musical notes 142_{A}, 142_{B}, 142_{C}, 142_{D}. The fourth line 140 of the music can begin with musical notes 142_{A}, 142_{B}, 142_{C} that ascend in pitch as the fourth line 140 of the music proceeds and until the fourth musical note 142_{D} (or the bass retrace point BRP) is reached. Upon reaching the bass retrace point BRP, the fourth line 140 of music can conclude by repeating the musical notes 142_{C}, 142_{B}, 142_{A} in reverse order as illustrated in FIG. 30B.

For purposes of illustration, the musical notes 132 of FIGS. 30A-C can be designated with an “a” for ascending, a “d” for descending, a “s” for starting and/or a “f” for finishing. The resultant sequence of seven musical notes 132_{A}, 132_{B}, 132_{C}, 132_{D}, 132_{C}, 132_{B}, 132_{A} thus can be respectively designated as musical notes S1s, S2d, S3d, S4d, S5a, S5a, S7af as shown in FIG. 30A. Additionally and/or alternatively, the sequence of seven musical notes 142_{A}, 142_{B}, 142_{C}, 142_{D}, 142_{C}, 142_{B}, 142_{A} can be respectively designated as musical notes B1s, B2a, B3a, B4a, B5d, B6d, B7df as shown in FIG. 30B.

As illustrated in FIGS. 30A-C, six of the seven musical notes 132, 142 respectively sung by the third group of soprano singers S and the fourth group of bass singers B are repetitions of each other. In other words, the musical notes 132 sung by the third group of soprano singers S are shown in FIG. 30A as beginning with a first descending sub-sequence of three musical notes S2d, S3d, S4d and as ending with a second ascending sub-sequence of three musical notes S5a, S6a, S7af, wherein the first descending sub-sequence of three musical notes S2d, S3d, S4d and the second ascending sub-sequence of three musical notes S5a, S6a, S7af are symmetrically centered about a fourth musical note S4d. Similarly, the musical notes 142 sung by the fourth group of bass singers B are shown in FIG. 30B as beginning with a first ascending sub-sequence of three musical notes B2a, B3a, B4a and as ending with a second descending sub-sequence of three musical notes B5d, B6d, B7df, wherein the first ascending sub-sequence of three musical notes B2a, B3a, B4a and the second descending sub-sequence of three musical notes B5d, B6d, B7df are symmetrically centered about a fourth musical note B4a.

As set forth above, the seven musical notes 132, 142 of FIGS. 30A-C can be sung by the soprano singers S and the bass singers B. Three musical notes B1s, B2a, B3a of the musical notes 142 are repeated as musical notes B5d, B6d, B7df in reverse order; whereas, three musical notes S1s, S2d, S3d of the musical notes 132 are repeated as musical notes S5a, S6a, S7af in reverse order. In other words, the musical notes 142 sung by the bass singers B can comprise three pairs of identical musical notes, leaving just one musical note B4a that is sung only once, and the musical notes 132 sung by the soprano singers S can comprise three pairs of identical musical notes, leaving just one musical note S4d that is sung only once.

Turning to FIG. 30A, for instance, the teaching method 100 is shown as visually presenting the third line 130 of music as sung by the soprano singers S for the listener 500 (shown in FIG. 4A). In the manner discussed above with reference to FIG. 3B, the teaching method 100 can include a third visual image 136 for visually presenting the third line 130 of music. The second visual image 136 can comprise one or more visual images based upon the nature of the third line 130 of music. The third visual image 136 can help enable listener 500 to utilize the visual sense to see the third line 130 of music and better understand the contrary motion.

The third visual image 136 can include a first visual image portion 136_{A} that is associated with the first descending sub-sequence of musical notes S2d, S3d, S4d and/or a second visual image portion 136_{B} that is associated with the second ascending sub-sequence of musical notes S5a, S6a, S7af as illustrated in FIG. 30A. In other words, one or more visual image portions 136_{A}, 136_{B} can be associated with the third line 130 of music. The soprano retrace point SRP between the first descending sub-sequence of musical notes S2d, S3d, S4d and the second ascending sub-sequence of musical notes S4d, S5a, S6a, S7af, for example, can define a boundary between the first visual image portion 136_{A} and the second visual image portion 136_{B}.

The visual image portion 136_{A} preferably is presented in a visually distinguishable manner from the visual image portion 136_{B}. The use of color as well as dashed lines as shown in FIGS. 30A-C advantageously can provide a double function of indicating ascending and descending lines 130, 140 of music and the physical movement 131, 141. Exemplary physical movement 131, 141, for example, is illustrated via the dashed lines shown in FIGS. 30A-C. Although shown and described with reference to FIG. 30A as comprising dashed red and green lines for purposes of illustration only, the third visual image 136 can visually illustrate the descent and/or ascent of the musical notes 132 via use of lines of any color, shape, size, format and/or style (such as solid, dotted or dashed) or any other type of suitable visual indicia.

Turning to FIG. 30B, the teaching method 100 is shown as visually presenting the fourth line 140 of music as sung by the bass singers B to the listener 500 (shown in FIG. 4A). In the manner discussed above with reference to FIG. 3A, the teaching method 100 can include a fourth visual image 146 for visually presenting the fourth line 140 of music. The fourth visual image 146 can comprise one or more visual images based upon the nature of the fourth line 140 of music. The fourth visual image 146 can help enable the listener 500 to utilize the visual sense to see the fourth line 140 of music and better understand the contrary motion.

The fourth visual image 146 can include a first visual image portion 146_{A} that is associated with the first ascending sub-sequence of musical notes B2a, B3a, B4a and/or a second visual image portion 146_{B} that is associated with the descending sub-sequence of musical notes B5d, B6d, B7df as illustrated in FIG. 30B. Stated somewhat differently, one or more visual image portions 146_{A}, 146_{B} can be associated with the fourth line 140 of music. The bass retrace point BRP between the first ascending sub-sequence of musical notes B2a, B3a, B4a and the descending sub-sequence of musical notes B5d, B6d, B7df, for example, can define a boundary between the first visual image portion 146_{A} and the second visual image portion 146_{B}.

The visual image portion 146_{A} preferably is presented in a visually distinguishable manner from the visual image portion 146_{B}. Although shown and described with reference to FIG. 30B as comprising dashed green and red lines for purposes of illustration only, the fourth visual image 146 can visually illustrate the ascent and/or descent of the musical notes 142 via use of lines of any color, shape, size, format and/or style (such as solid, dotted or dashed) or any other type of suitable visual indicia. The indicia associated with the third visual image 136 preferably is visually distinguishable from the indicia associated with the fourth visual image 146.

FIG. 30C illustrates the teaching method 100, wherein the third group of soprano singers S can sing the respective musical notes 132 of FIG. 30A simultaneously with the fourth group of bass singers B singing the respective musical notes 142 of FIG. 30B. In the manner discussed with reference to FIG. 30B, the bass singers B can sing the first ascending sub-sequence of musical notes B2a, B3a, B4a and/or the second descending sub-sequence of musical notes B5d, B6d, B7df. The singing of the bass singers B can be visually enhanced via the first visual image portion 146_{A} that is associated with the first ascending sub-sequence of musical notes B2a, B3a, B4a and/or a second visual image portion 146_{B} that is associated with the second descending sub-sequence of musical notes B5d, B6d, B7df.

As the bass singers B sing the first ascending sub-sequence of musical notes B2a, B3a, B4a and/or the second descending sub-sequence of musical notes B5d, B6d, B7df, the soprano singers S can sing the first descending sub-sequence of musical notes S2d, S3d, S4d and/or the second ascending sub-sequence of musical notes S5a, S6a, S7af in the manner shown and described with reference to FIG. 30A. The singing of the soprano singers S can be visually enhanced via the first visual image portion 136_{A} that is associated with the first descending sub-sequence of musical notes S2d, S3d, S4d and/or a second visual image portion 136_{B} that is associated with the second ascending sub-sequence of musical notes S4d, S5a, S6a, S7af. A combination of the audible sense of hearing the soprano singers S and the bass singers B singing with the third and fourth visual images 136, 146 can help enable the listener 500 (shown in FIG. 4A) to utilize the audible and visual senses to better understand the contrary motion inherent in the third and fourth lines 130, 140 of music.

The teaching method 100 of FIGS. 30A-C can employ a process for the soprano singers S and the bass singers B that is used for the alto singers A and the tenor singers T described above with reference to FIGS. 22-29. In selected embodiments, the process for the soprano singers S and the bass singers B can differ from process for the alto singers A and the tenor singers T in one or more ways. For example, introducing the kinesthetic sense, the soprano and bass vocal parts, can begin at a preselected physical distance, such as a minimum of one hundred and twenty inches (ten feet), away from each other, and/or the two vocal lines begin at an interval of three octaves apart. For safety, as the soprano singer S and the bass singer B should not bump into each other as they sidestep toward the center line CL, but without crossing the center line CL, thus the preselected physical distance should help insure plenty of room.

The teaching method 100 of FIGS. 30A—otherwise can incorporate the use of auditory, visual and kinesthetic senses for the fuller understanding of the use of contrary motion. In the manner set forth above in FIGS. 22-29, and more specifically FIG. 25 and FIG. 26, the teaching method 100 can include ascending notes that are shown with green arrows the sidesteps to the right and descending notes that are shown with red arrows and sidesteps are taken to the left. While singing their lines, the soprano singer S and the bass singer B can gradually move toward each other to their respective retrace points SRP, BRP in the fourth measure of the music. From the respective retrace points SRP, BRP, the soprano singer S and the bass singer B can retrace their vocal lines and steps and moving further apart to their starting position of approximately one hundred and twenty inches apart.

Stepping Considerations for Vocal Lines of the Soprano Singer and the Bass Singer.

The treatment outlined in FIGS. 22-29 for the alto singer A and the tenor singer T can be applied to the soprano singer S and the bass singer B in the same progressive contrary motion, but starting the stepping from opposite end regions of the Horizontal Plane (HP) between the alto singer A and the tenor singer T. Stated somewhat differently, the soprano singer S and the bass singer B can begin the sidestepping about ten feet away from each other and move toward each other, rather than standing next to each other. The soprano singer S and the bass singer B, without crossing the center line CL, and can proceed away from each other, one step at a time.

FIG. 30A is a detail diagram of the soprano singers S who sing the musical notes S1s through S7af with a descending red line 136_{A} shown above the musical notes indicating that the musical notes descend and an ascending green diagonal line 136_{B} shown above the musical notes indicating that the musical notes ascend. The musical note S4 indicates the soprano retracing point SRP. The position of the starting musical note S1s for the soprano singers S is F5 of the American Standard Pitch Notation (ASPN) notated in a musical staff as the top of line of the treble clef.

FIG. 30B. is a detail diagram of the bass singers B who sing the musical notes B1s through B7df with an ascending green line 146_{A} shown below the musical notes indicating that the musical notes ascend and descending red diagonal line 146_{B} shown above the musical notes indicating that the musical notes descend. The musical note B4 indicates the bass retracing point BRP. The position of the starting musical note B1s for the bass singers B is F2 of the American Standard Pitch Notation (ASPN) notated in a musical staff just below the first line of the bass clef.

FIG. 30C is a detail diagram illustrating a combination of the musical notes sung by the soprano singers S of FIG. 30A with the musical notes sung by the bass singers B of FIG. 30B. When the soprano singers S and the bass singers B sing simultaneously, contrary motion between the sung notes can be demonstrated by the teaching method 100. In other words, the soprano singers S and the bass singers B can be coupled just as the alto singers A and the tenor singers T are set forth as being coupled with reference to FIGS. 25-29 The soprano singers S and the bass singers B preferably are practiced separately before coupled and singing together. It can be noticed that the starting pitch for the soprano singers S and the bass singers B are three octaves apart, unlike the alto singers A and the tenor singers T that begin and finish the exercise singing the same musical note and on the same pitch C4 of the American Standard Pitch Notation.

In this manner, the decreasing and increasing of physical distance between the third group of soprano singers S and the fourth group of bass singers B of FIG. 30C can help enhance the auditory distance of the decreasing and increasing of intervals sung between the third and fourth groups. As the third group of soprano singers S and the fourth group of bass singers B move in incremental steps toward from each other, at S4d and B4a, the soprano singers S and the bass singers B can be at the closest distance and the closest distance of singing a minor 6^{th} away from each other. From the position of being closest in sung tones and in steps, the sung tones and steps gradually move further away, resulting in a composite of kinesthetic, visual and auditory senses with the noticing of contrary motion.

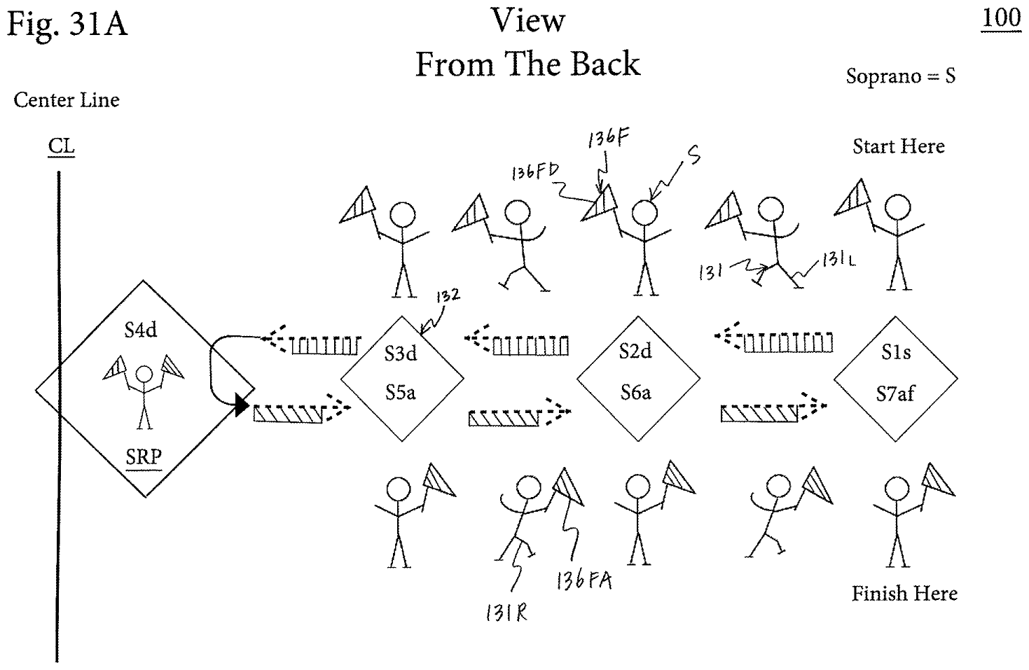

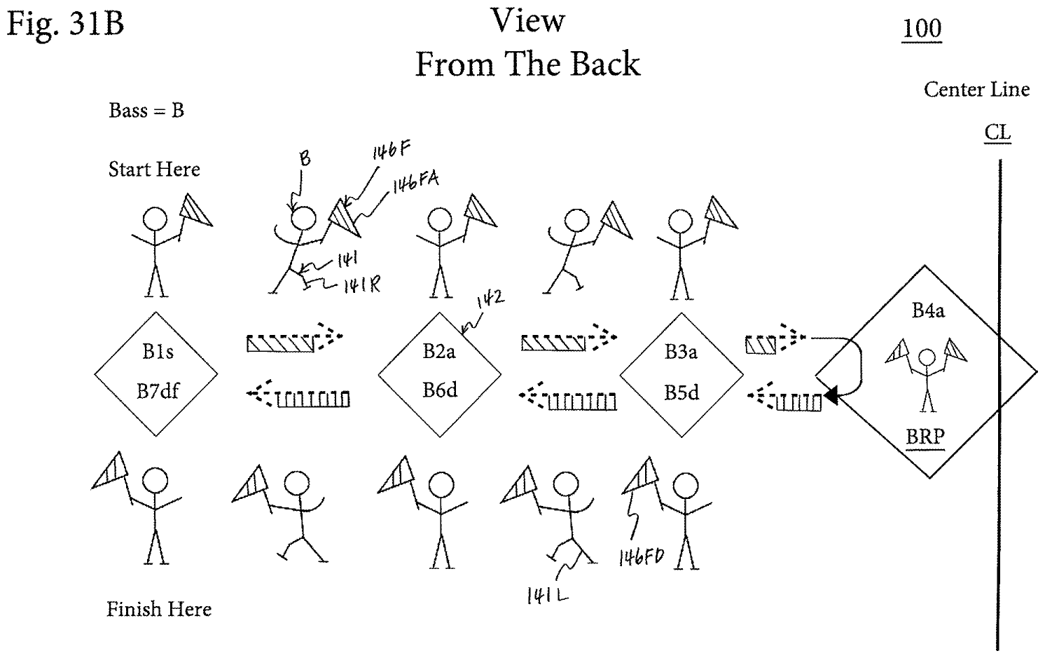

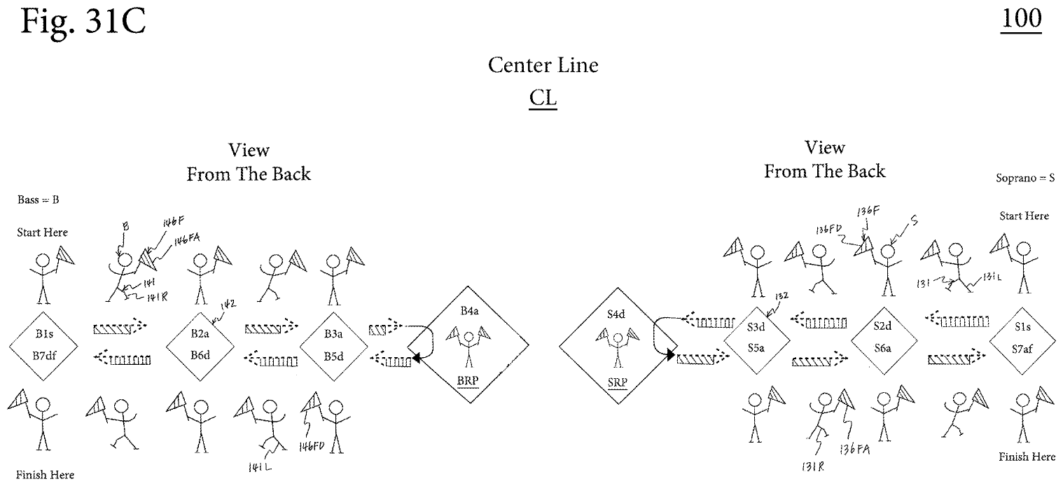

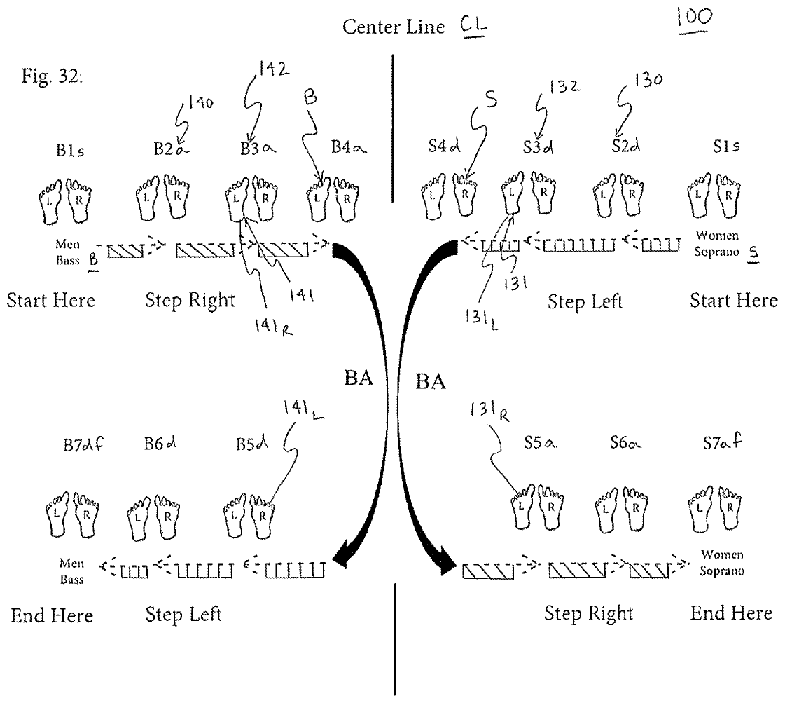

FIGS. 31A-B illustrate an alternative embodiment of the teaching method 100 of FIGS. 30A-C, showing the kinesthetic sense rather than singing. Turning to FIGS. 31A-B, the teaching method 100 is shown with reference to two groups of singers, including a third group of soprano singers S and a fourth group of bass singers B who can sing a respective series (or sequences) of notes in the manner shown and described in more detail above with reference to FIGS. 27A-C. As shown in FIGS. 31A-B, a center line CL can be disposed between the third group of soprano singers S and the fourth group of bass singers B. FIGS. 31 and 32 show the stepping, and, as such, no musical staff is illustrated. The musical notes 132, 142 need not be sung and are mentioned as a guide or as synchronizing with the stepping or other physical movement. The third and fourth groups may choose to sing or memorize the tones outlined in FIG. 30A-C.

Traditionally, in western cultures and other cultures, the reading of music and language proceeds in a left to right fashion. In selected embodiments of the teaching method 100, to appreciate the kinesthetic sense of actual left and right linear simultaneous movement in two opposite directions, reading can start with the soprano singers S and the bass singers B and the music beginning on respective sides of the center line CL and expanding in opposite directions. FIG. 31A-B, for example, be viewed as alongside each other, viewed from the back and condensed to one page so that the center line CL appears in the between the two drawing sheets and separates the vocal lines of the soprano singers S and the bass singers B from each other in the manner illustrated in FIG. 31C.

The musical notes 132 sung or otherwise indicated by the third group of soprano singers S are shown in FIG. 31A may sing the first note A1 s followed by a first descending sub-sequence of three musical notes S2d, S3d, S4d and as ending with a second ascending sub-sequence of three musical notes S5a, S6a, S7af, wherein the first descending sub-sequence of three musical notes S2d, S3d, S4d and the second ascending sub-sequence of three musical notes S5a, S6a, S7af are symmetrically centered about a fourth musical note S4d. Similarly, the musical notes 142 sung or otherwise indicated by the fourth group of bass singers B are shown in FIG. 31B as beginning with a first ascending sub-sequence of three musical notes B2a, B3a, B4a and as ending with a second descending sub-sequence of three musical notes B5d, B6d, B7df, wherein the first ascending sub-sequence of three musical notes B2a, B3a, B4a and the second descending sub-sequence of three musical notes B5d, B6d, B7df are symmetrically centered about a fourth musical note B4a.

The teaching method 100 can include at least one of the soprano singers S physically moving 131 synchronously with the musical notes 132 indicated by the third group of soprano singers S in the manner shown and described in more detail above with reference to FIG. 30A. Turning to FIG. 31A, for example, one or more of the soprano singers S is illustrated as being positioned to the far right of the center line CL. The view is from the back. One or more of the sopranos S are shown as sidestepping to the left 131_{L} while the third group of soprano singers S may sing the first descending sub-sequence of musical notes S2d, S3d, S4d and/or sidestepping to the right 1318 while the third group of soprano singers S sing the second ascending sub-sequence of musical notes S5a, S6a, S7af.

Diamond squares (or diamond-shaped indicia) are shown in FIG. 31A to indicate the musical notes that may be sung and the corresponding sidestep destinations for feet of the soprano singers S. The diamond-shaped indicia also can indicate that the sung musical notes 132 are the same, as the soprano singers S retrace their steps. In other words, the musical note S1s and the musical note S7af occupy the same diamond-shaped indicia and comprise the same musical note, the musical note S2d and the musical note S6a occupy the same diamond-shaped indicia and comprise the same musical note, and the musical note S3d and S5a occupy the same diamond-shaped indicia and comprise the same musical note.

The soprano retrace point SRP between the first descending sub-sequence of musical notes S2d, S3d, S4d and the second ascending sub-sequence of musical notes S5a, S6a, S7af can define a boundary between the sidestepping to the left 131_{L} and the sidestepping to the right 131_{R}. In other words, the soprano singers S can reverse or otherwise change the physical movement 131 at the soprano retrace point SRP.

The musical notes S1s, S2d, S3d are shown in an upper part of the diamond-shaped indicia. The diamond-shaped indicia associated with the musical note S4d is drawn larger as diamond-shaped indicia is the soprano retracing point SRP for the soprano singers S. The musical notes S5a, S6a, S7af are shown in a lower part of the diamond-shaped indicia on the lower part of the same diamond-shaped indicia because musical notes S5a, S6a, S7af occupy the same space as the musical notes S1s, S2d, S3d. The inbound steps associated with the musical notes S5a, S6a, S7af are merely a retracing of outbound steps associated with musical notes S1s, S2d, S3d. In other words, the musical notes S5a, S6a, S7af use the same foot destinations as S1, S2, S3 as well as the musical notes S1s, S2d, S3d. Simply put, the steps associated with the musical notes S5a, S6a, S7af retrace the steps associated with the musical notes S1s, S2d, S3d with the stepping being in opposite directions.

Additionally and/or alternatively, the teaching method 100 can include at least one of the bass singers B physically moving 141 synchronously with the musical notes 142 indicated by the fourth group of bass singers B in the manner shown and described in more detail above with reference to FIG. 27A, in that the alto singers A (shown in FIG. 27A) and the bass singers B both are illustrated as initially moving to the right. Turning to FIG. 31B, the bass singers B are shown as being positioned to the far left of the center line CL. One or more of the bass singers B can sidestep to the right 141_{R} and toward the center line while the fourth group of bass singers B sing the first note T1s followed by the first ascending sub-sequence of musical notes B2a, B3a, B4a and/or sidestep to the left 141_{L} and away from the center line CL while the fourth group of bass singers B sing the second descending sub-sequence of musical notes B5d, B6d, B7df.

Diamond-shaped indicia of FIG. 31B indicate the musical notes 142 being sung and the corresponding sidestep destinations for feet of the bass singers B. The diamond-shaped indicia also can indicate that the sung musical notes 142 are the same, as the bass singers B retrace their steps. In other words, the musical note B1s and the musical note B7df occupy the same diamond-shaped indicia and comprise the same musical note, the musical note B2a and the musical note B6d occupy the same diamond-shaped indicia and comprise the same musical note, and the musical note B3a and the musical note B5d occupy the same diamond-shaped indicia and comprise the same musical note.

The sidesteps to the left 141_{L} by the bass singers B preferably retrace the previous sidesteps to the right 131_{R}. The bass retrace point BRP between the first ascending sub-sequence of musical notes B2a, B3a, B4a and the second descending sub-sequence of musical notes B5d, B6d, B7df can provide a transition between the sidestepping to the right 141_{R} and the sidestepping to the left 141_{L}. In other words, the bass singers B can reverse or otherwise change the physical movement 141 at the bass retrace point BRP.

The musical notes B1s, B2a, B3a are shown in an upper part of the diamond-shaped indicia. The diamond-shaped indicia associated with the musical note B4a is drawn larger as the diamond-shaped indicia is the bass retracing point BRP for the bass singers B. The musical notes B5d, B6d, B7df are shown in a lower part of the diamond-shaped indicia on the lower part of the same diamond-shaped indicia because musical notes B5d, B6d, B7df occupy the same space as the musical notes B1s, B2a, B3a. The inbound steps associated with the musical notes B5d, B6d, B7df are merely a retracing of outbound steps associated with musical notes B1s, B2a, B3a. In other words, the musical notes B5d, B6d, B7df use the same foot destinations as B1, B2, B3 as well as the musical notes B1s, B2a, B3a. Simply put, the steps associated with the musical notes B5d, B6d, B7df, retrace the steps associated with the musical notes B1s, B2a, B3a with the stepping being in opposite directions.

Although shown and described with reference to FIGS. 31A-B as comprising left sidesteps and right sidesteps for purposes of illustration only, the physical movement 131 of the soprano singers S and the physical movement 141 of the bass singers B can comprise any suitable type of physical movement, such as arm movements, leg movements, head movements, jumping, squatting, stepping forward, stepping backward, stepping diagonally, etc., without limitation.

For example, the visual impact of the teaching method 100 can be heightened by the bass singers B and the soprano singers S using flags 136_{F}, 146_{F} for pointing out their respective directions of movement. As shown in FIG. 31B, a bass-ascending (or green-colored) flag 146_{FA} can be used to emphasize the first ascending sub-sequence of musical notes B2a, B3a, B4a as sung by the bass singers B; whereas, a bass-descending (or red-colored) flag 146_{FD} can be used to emphasize the second descending sub-sequence of musical notes B5d, B6d, B7df. A right hand of a selected bass singer B can hold the bass-ascending flag 146_{FA}, and a left hand of the selected bass singer B can hold the bass-descending flag 146_{FD}. The selected bass singer B thereby can raise the bass-ascending flag 146_{FA} when the first ascending sub-sequence of musical notes B2a, B3a, B4a is sung and the bass-descending flag 146_{FD} when the second descending sub-sequence of musical notes B5d, B6d, B7df is sung.

Additionally and/or alternatively, a soprano-descending (or red-colored) flag 136_{FD} as illustrated in FIG. 31A can be used to emphasize the first descending sub-sequence of musical notes S2d, S3d, S4d as sung by the soprano singers S; whereas, a soprano-ascending (or green-colored) flag 136_{FA} can be used to emphasize the second ascending sub-sequence of musical notes S5a, S6a, S7af. A left hand of a selected soprano singer S can hold the soprano-descending flag 136_{FD}; whereas, a right hand of the selected soprano singer S can hold the soprano-ascending flag 136_{FA}. The selected soprano singer S thereby can raise the soprano-descending flag 136_{FD} when the first descending sub-sequence of musical notes S2d, S3d, S4d is sung and the soprano-ascending flag 136_{FA} when the second ascending sub-sequence of musical notes S5a, S6a, S7af is sung.

In the manner discussed above, FIG. 31C illustrates the sung musical notes 132 and the corresponding physical movement, at 131, of the soprano singers S of FIG. 31A relative to the sung musical notes 142 and the corresponding physical movement, at 141, of the bass singers B of FIG. 31B. Turning to FIG. 31C, the soprano singers S and the bass singers B are shown as starting on respective sides of the center line CL. The kinesthetic stepping feature, right and left, thereby can be accomplished as the listener 500 (shown in FIG. 4A) listens to the contrary motion in the music. Since the bass singers B step right as the soprano singers S step left, reading the exercise with an orientation from the center line CL offers a true visual of the kinesthetic point of view. The listener 500 can be asked to read from the center line CL and proceed to the right for the bass singer B. Similarly, the listener 500 can be asked to read from the center line CL and proceed to the left for the soprano singer S.

In selected embodiments, the musical notes 132 for the soprano singers S of FIG. 31A and the musical notes 142 for the bass singers B of FIG. 31B can correspond with the musical notes 122 for the tenor singers T of FIG. 27B and the musical notes 112 for the alto singers A of FIG. 27A. One difference between the musical notes 132 and the musical notes 142 of FIGS. 31A-B and the musical notes 112 and the musical notes 122 of FIGS. 27A-B is that the starting positions associated with the soprano singers S and the bass singers B are about sixty inches (or five feet) on respective sides of the center line CL. The sidesteps move toward each other, until the respective retrace points SRP, BRP, at which the soprano singers S and the bass singers B are about eighteen inches away from each other. The soprano singers S and the bass singers B can follow the black arrow, which points the way. Upon proceeding with the exercise, the soprano singers S and the bass singers B can move away from each other taking respective steps to the respective “finish here” positions of the soprano singers S and the bass singers B.

### Example: Kinesthetic Sense with Stepping

An alternative manner of depicting the kinesthetic foot stepping movement of the bass singers B and the soprano singers S from the perspective of the center line CL is illustrated in FIG. 32. This perspective includes drawings of feet, which are labeled R for Right and L for Left. The foot movements of the bass singers B and the soprano singers S can be compared with, and/or contrasted from, the foot movements of the alto singers A and the tenor singers T as illustrated in FIG. 28. Turning to FIG. 32, the bass singers B can move to the right, and toward, the center line CL in synchronization with the first ascending sub-sequence of musical notes B2a, B3a, B4a as sung by the bass singers B. The soprano singers S, simultaneously, can move to the left, and toward, the center line CL with the second descending sub-sequence of three musical notes S2d, S3d, S4d as sung by the soprano singers S. Upon reaching the fourth musical note B4a, Sd4, the bass singers B and the soprano singers S can retrace their steps away from the center line CL.

As shown in FIG. 32, a selected bass singer B can proceed from a starting bass position associated with musical note B1s and to a second bass position associated with musical note B2a. The selected bass singer B can move from the starting bass position to the second bass position by leading with a right foot of the selected bass singer B, followed by a left foot of the selected bass singer B. When moving from the second bass position to a third bass position associated with the musical note B3a, the selected bass singer B can lead with the right foot followed by the left foot and then proceed on to a fourth bass position associated with the fourth musical note B4a by leading with the right foot followed by the left foot.

Upon reaching the fourth bass position, the selected bass singer B can retrace the same path back to the starting bass position as indicated by a first black arrow BA. The first black arrow BA is shown as connecting the fourth bass position associated, with the fourth musical note B4a to a fifth bass position associated with the fifth musical note B5d, which fifth bass position is the same as the third bass position associated with the musical note B3a. The selected bass singer B, for example, can move from the fourth bass position, to the fifth bass position by leading with the left foot of the selected bass singer B, followed by the right foot. When moving from the fifth bass position to a sixth bass position associated with the musical note B6d, the selected bass singer B can lead with the left foot followed by the right foot and then proceed on to a final bass position associated with the seventh musical note B7df by leading with the left foot followed by the right foot. The sixth bass position can be the same as the second bass position associated with the musical note B2a; whereas, the final bass position can be the same as the starting bass position associated with the musical note B1s.

A selected soprano singer S similarly can proceed from a starting soprano position associated with musical note S1s and to a second soprano position associated with musical note S2d. The selected soprano singer S can move from the starting soprano position to the second soprano position by leading with a left foot of the selected soprano singer S, followed by a right foot of the selected soprano singer S. When moving from the second soprano position to a third soprano position associated with the musical note S3d, the selected soprano singer S can lead with the left foot followed by the right foot and then proceed on to a fourth soprano position associated with the fourth musical note S4d by leading with the left foot followed by the right foot.

Upon reaching the fourth soprano position, the selected soprano singer S can retrace the same path back to the starting soprano position as indicated by a second black arrow BA. The second black arrow BA is shown as connecting the fourth soprano position, associated with the fourth musical note S4d to a fifth soprano position associated with the fifth musical note S5a, which fifth soprano position is the same as the third soprano position associated with the musical note S3d. The selected soprano singer S, for example, can move from the fourth soprano position to the fifth soprano position by leading with the right foot of the selected soprano singer S, followed by the left foot. When moving from the fifth soprano position to a sixth soprano position associated with the musical note S6a, the selected soprano singer S can lead with the right foot followed by the left foot and then proceed on to a final soprano position associated with the seventh musical note S7af by leading with the right foot followed by the left foot. The sixth soprano position can be the same as the second soprano position associated with the musical note S2d; whereas, the final soprano position can be the same as the starting soprano position associated with the musical note S1s.

Orientation: Culmination of the Choir for Heightening the Auditory Sense

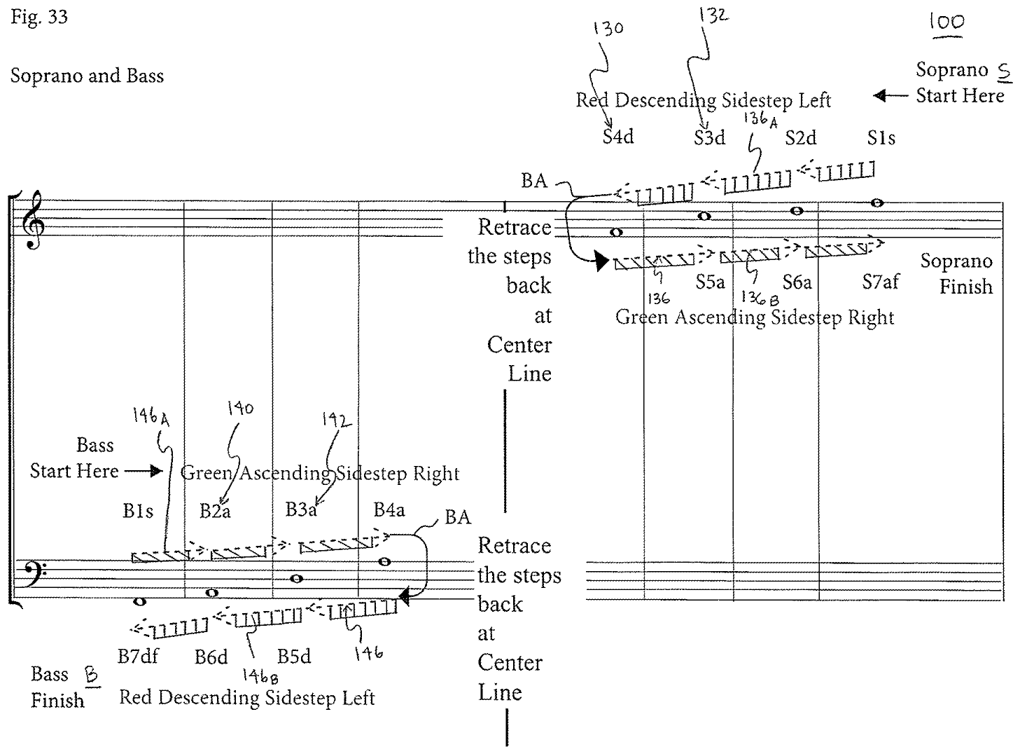

FIG. 33 exemplifies a succinct drawing using four musical notes for the bass singers B and four musical notes for the soprano singers S shown on each side of the center line CL. In FIG. 33, the bass singers B are shown as starting at the bottom left side of the page and the soprano singers S are illustrated as starting at the top right side of the page. After singing the starting note, the singers B, S can sing the next three notes, followed by singing the musical notes that the singers B, S just sang in reverse order.

The listener 500 (shown in FIG. 4A) or other participant in the teaching method 100 can start at a predetermined distance of at least ten feet (or one hundred and twenty inches) and can be asked to take sidesteps with their feet, as in FIG. 32, while simultaneously singing. The bass singers B can begin by singing the musical note B1s, and the soprano singers S can begin by singing the musical note S1s. Each note of the four notes can be sung while taking one step in increments, such as increments of eighteen inches toward each other. By the fourth note, each singer B, S moves about four and a half feet to the right or left. Thus, a combined distance of about nine feet is achieved by the fourth musical note, and the bass singers B and the soprano singers S can be about twelve inches away from each other. The exercise highlights the distance between the steps taken and notes sung. As the intervals of the sung notes between the bass singers B and the soprano singers S decreases as the singers B, S move toward the center line CL, the physical incremental distance between each listener 500 or other participant stepping also decreases. The physical distance supports and even magnifies the hearing of the opposition of the notes in contrary motion.

At the fourth note the exercise is retraced. As the sung notes and steps of the bass singers B and the soprano singers S return to the “finishing point”—the distance between the intervals of the notes, and the distance between singers steps increases incrementally. Thus, the intervals of the sung notes can be heard as further away, simulating the kinesthetic movement with the auditory sense. The intervals of the music and distance of the steps work in tandem. The expansion and contraction of contrary motion is experienced visually, kinesthetically and aurally.

The Method for Both Bass Singer and Soprano Singer

At least one bass singer B and at least one soprano singer S are shown in FIG. 33 as being divided by a center line CL. The contrary motion can be observed by stepping toward and then away from the center line CL. Both the bass singer B and the soprano singer S start from the periphery of the page and proceed as follows.

The bass singer B and the soprano singer S respectively stepping to the right and to the left can be shown when starting simultaneously distally from the center line CL. Stepping moves to the right for the bass singer B toward the center line CL and from the left for the soprano singer S toward the center line CL. In accordance with the selected embodiments of the teaching method 100, ascending notes 142 can be marked with an ascending diagonal green line 146_{A} and descending notes 132 are marked with a descending diagonal red line 136_{A}.

In other words, the teaching method 100 can include a fourth visual image 146 for visually presenting the fourth line 140 of music in the manner discussed above with reference to FIGS. 30B and 30C. The fourth visual image 146 can comprise one or more visual images based upon the nature of the fourth line 140 of music. The fourth visual image 146 can include a first visual image portion 146_{A} that is associated with the first ascending sub-sequence of musical notes B2a, B3a, B4a and/or a second visual image portion 146_{B} that is associated with the descending sub-sequence of musical notes B5d, B6d, B7df as illustrated in FIG. 33. Additionally and/or alternatively, the teaching method 100 can include a third visual image 136 for visually presenting the third line 130 of music in the manner discussed above with reference to FIGS. 30A and 30C. The third visual image 136 can comprise one or more visual images based upon the nature of the third line 130 of music. The third visual image 136 can include a first visual image portion 136_{A} that is associated with the first descending sub-sequence of musical notes S2d, S3d, S4d and/or a second visual image portion 136_{B} that is associated with the ascending sub-sequence of musical notes S5a, S6a, S7af as shown in FIG. 33.

Two groups of people, musicians or singers in a choir, such as the bass singer B and the soprano singer S, can stand at opposite ends of the center line CL, which is the opposite of the alto singer A and the tenor singer T who can stand next to each other as in FIG. 29. If there is more than one bass singer B and more than one soprano singer S, each bass singer B can stand behind another bass singer B, as in a queue. Each soprano singer S likewise can stand behind another soprano singer S, as in a queue. Each bass singer B can be partnered with a soprano singer S on the other side of a center line CL. A column of bass singers B can stand on a far left side of the center line CL—while a column of soprano singers S can stand on a far right side of the center line CL, at a predetermined distance, such as about one hundred and twenty inches or ten feet, apart.

The center line CL can be either physical or imaginary. Any equal number of bass singers B and soprano singers S may participate in order that each bass singer B can be partnered a soprano singer S. Both groups, the bass singers B and the soprano singers S, simultaneously sing one note at a time. The bass singers B and the soprano singers S can hold each sung note for a predetermined period of time, such as two or three seconds. Each note is assigned a number as seen in FIG. 33 with a designation of “a” for ascending or “d” for descending and “s” for starting and “f” for finishing notes.

In selected embodiments, the bass singers B and the soprano singers S can remain stationary while singing the first musical notes B1s and S1s. Feet of the bass singers B and the soprano singers S can be in a neutral or “starting position” with toes always facing forward. All other musical notes sung and steps taken from this starting position will move in contrary motion between the bass singers B and the soprano singers S, that is, either ascending or descending. As the bass singers B sing an ascending note, the soprano singers S can simultaneously sing a descending note. And, vice versa as they retrace their steps back. As the bass singers B sing a descending note, the soprano singers S can sing an ascending note.

FIG. 34 is a detail diagram illustrating an alternative embodiment of the teaching method 100. Turning to FIG. 34, the teaching method 100 is shown as demonstrating contrary motion by combining the musical notes 112 associated with the alto singer A and the musical notes 122 associated with the tenor singer T of FIG. 25C with the musical notes 132 associated with the soprano singer S and the musical notes 142 associated with the bass singer B of FIG. 30C. As shown in FIG. 34, the musical notes 112, 122, 132, 142 can be arranged as a four-part traditional score in selected embodiments.

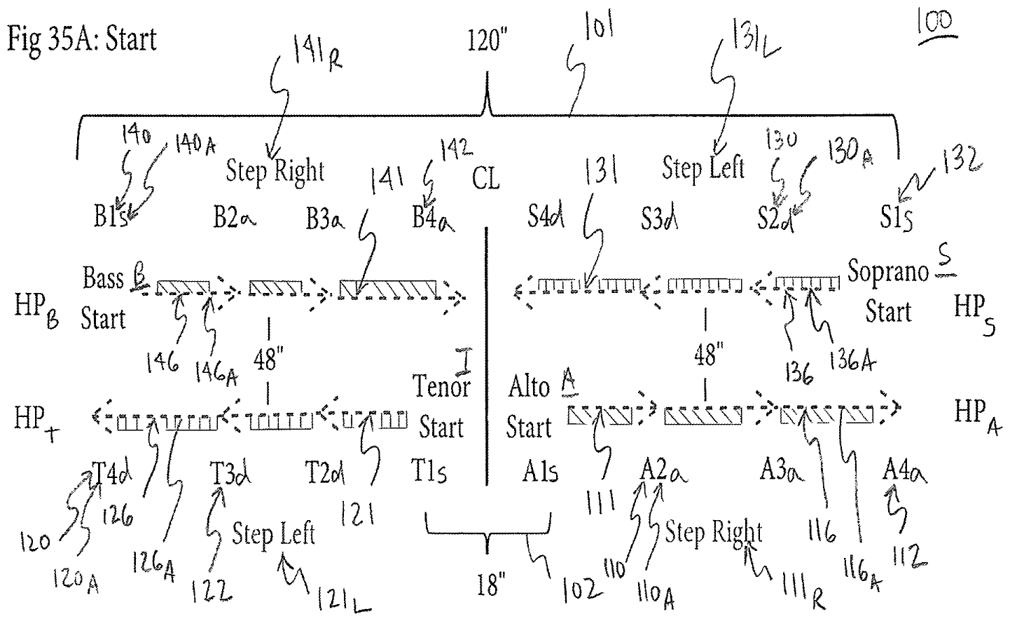

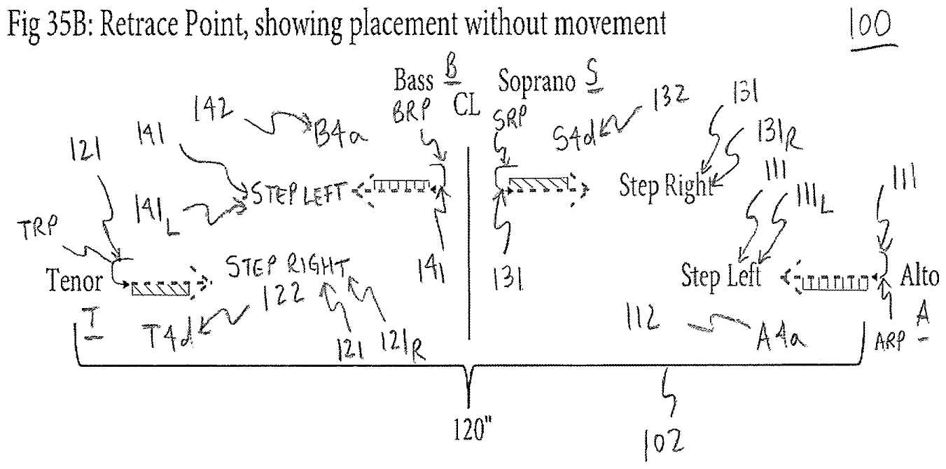

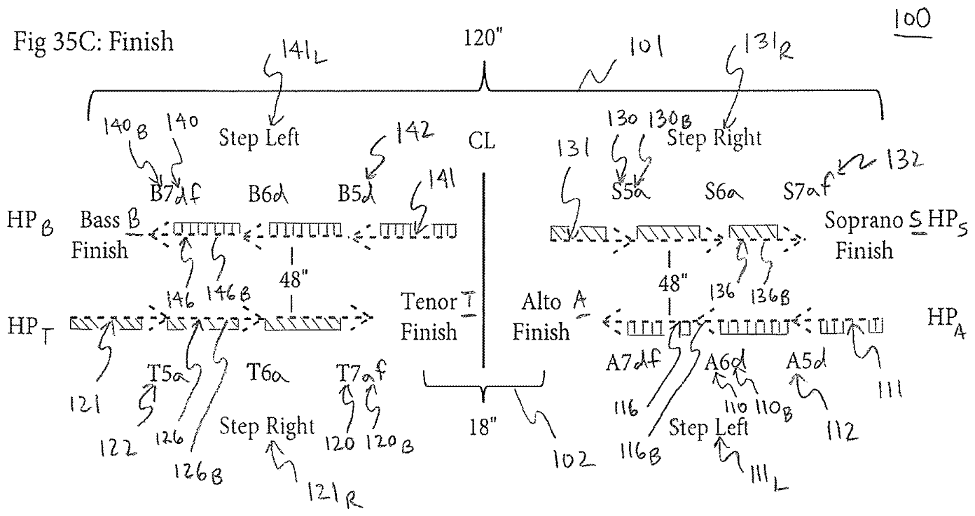

FIGS. 35A-C illustrate an alternative embodiment of the learning method 100 of FIG. 34. Turning to FIGS. 35A-C, an overall look at the learning method 100 for a quartet is shown. The quartet can include a soprano singer S, an alto singer A, a tenor singer T and a bass singer B. The grouping of the quartet of FIGS. 35A-C can have two coupled groups of singers. The first coupled group of singers can comprise a soprano/bass coupling that is associated with the soprano singer S and the bass singer B; whereas, the alto singer A and the tenor singer T can comprise an alto/tenor coupling, forming the second coupled group of singers.

The soprano singer S and the bass singer B can be disposed at a first predetermined starting distance, such as one hundred and twenty inches, from each other as illustrated in FIG. 35A. The predetermined starting distance between the soprano singer S and the bass singer B is illustrated via a long black bracket line 101, connecting sidesteps of the soprano singer S and the bass singer B. Similarly, the alto singer A and the tenor singer T can be disposed at a second predetermined starting distance, such as eighteen inches, from each other as illustrated in FIG. 35A. The second predetermined starting distance between the alto singer A and the tenor singer T is illustrated via a shorter black bracket line 102, connecting sidesteps of the alto singer A and the tenor singer T.

The first and second groups of coupled singers can move along parallel horizontal planes that are divided by a center line CL. An alto horizontal plane HPA can be associated with the alto singer A and can be disposed in a parallel configurate relative to a soprano horizontal plane HPs that can be associated with the soprano singer S. A bass horizontal plane HPB can be associated with the bass singer B and axially aligned with the soprano horizontal plane HPs; whereas, a tenor horizontal plane HPT can be associated with the tenor singer T and axially aligned with the alto horizontal plane HPA. The bass horizontal plane HPB and the soprano horizontal plane HPs can be separated via a center line CL between the soprano singer S and the bass singer B. The center line CL also can separate the tenor horizontal plane HPT from the alto horizontal plane HPA.

The center line CL can comprise a region in which the musical notes 132, 142 sung by the soprano singer S and the bass singer B are closest together. In other words, the soprano singer S can sing the musical note S4d, and the bass singer B can sing the musical note B4a when the soprano singer S and the bass singer B are proximal to the center line CL. Additionally and/or alternatively, the musical notes 112, 122 sung by the alto singer A and the tenor singer T can be furthest apart when the alto singer A and the tenor singer T are distal from the center line CL.

When the alto singer A and the tenor singer T are distal from the center line CL, the soprano singer S and the bass singer B can be proximal to the center line CL. While distal from the center line CL, the alto singer A and the tenor singer T can sing the musical note A4a and the musical note T4d, respectively, and the soprano singer S and the bass singer B being proximal to the center line CL can sing the musical note S4d and the musical note B4a, respectively, as illustrated in FIG. 35A. In selected embodiments, the soprano singer(s) S, the alto singer(s) A, the tenor singer(s) T and/or the bass singer(s) B are not inhibited from crossing the center line CL. For ease and clarity, it is preferable for the singers S, A, T, B to stay on their respective side of the center line CL. Should the singers S, A, T, B or director find it necessary to the cross the center line CL, the singers S, A, T, B might be mindful of not bumping into each other. Beginning the exercise slightly in front of or in back of the partnered singer would alleviate the potential of the proverbial “stepping on each other's feet.”

Turning to FIG. 35A, the soprano singer S and the bass singer B in the first group can physically move, at 131, 141, respectively, toward the center line CL between the soprano singer S and the bass singer B. The soprano singer S, for example, can take one or more step to the left 131_{L}; while, the bass singer B can take one or more step to the right 141_{R}. In the second group, the alto singer A and the tenor singer T can physically move, at 111, 121, respectively, away from the center line CL between the alto singer A and the tenor singer T. As shown in FIG. 35A, the center line CL between the soprano singer S and the bass singer B can comprise the same center line as the center line CL between the alto singer A and the tenor singer T. The alto singer A can take one or more steps to the right 111_{R}; whereas, the tenor singer T can take one or more steps to the left 121_{L} as illustrated in FIG. 35A.

In selected embodiments, the horizontal planes HPA, HPT, HPs, HPB can provide visual images 116, 126, 136, 146, respectively, for enabling the listener 500 (shown in FIG. 4A) to clearly see the general direction of the musical notes 112, 122, 132, 142. The horizontal plane HPA, for example, can include a first visual image portion 116_{A} that is associated with the ascending line portion 110_{A} as sung by the alto singer A and/or a second visual image portion 116_{B} that is associated with the descending line portion 110_{B} as sung by the alto singer A. The horizontal plane HPT can include a second visual image portion 126_{A} that is associated with the descending line portion 120_{A} as sung by the tenor singer T and/or a second visual image portion 116_{B} that is associated with the ascending line portion 110_{B} as sung by the tenor singer T.

As shown in FIG. 35A, the horizontal plane HPA can include a first visual image portion 116_{A} with alto-ascending (or green-colored) indica since the alto singer A is shown singing the first ascending sub-sequence of musical notes A2a, A3a, A4a; whereas, the horizontal plane HPT can include a first visual image portion 126_{A} with tenor-descending (or red-colored) indica since the tenor singer T is illustrated singing the first descending sub-sequence of musical notes T2d, T3d, T4d.

Similarly, the horizontal plane HPs can include a first visual image portion 136_{A} that is associated with the descending line portion 130_{A} as sung by the soprano singer S and/or a second visual image portion 136_{B} that is associated with the ascending line portion 130_{B} as sung by the soprano singer S. The horizontal plane HPB for example, can include a second visual image portion 146_{A} that is associated with the ascending line portion 140_{A} as sung by the bass singer B and/or a second visual image portion 146_{B} that is associated with the descending line portion 140_{B} as sung by the bass singer B.

The horizontal plane HPs of FIG. 35A is shown as including a first visual image portion 136_{A} with soprano-descending (or red-colored) indica since the soprano singer S is illustrated as singing the first descending sub-sequence of musical notes S2d, S3d, S4d. Additionally and/or alternatively, the horizontal plane HPB can include a first visual image portion 146_{A} with bass ascending (or green-colored) indica since the bass singer B is illustrated as singing the first ascending sub-sequence of musical notes B2a, B3a, B4a.

In the embodiment of the teaching method 100 shown in FIG. 35A, the soprano singer S is shown as sidestepping to the left 131_{L} along the horizontal plane HPs while singing the first descending sub-sequence of musical notes S2d, S3d, S4d, and the bass singer B is shown as sidestepping to the right 141_{R} along the horizontal plane HPB while singing the first ascending sub-sequence of musical notes B2a, B3a, B4a. The soprano singer S and the bass singer B can be separated by a first predetermined distance, such as one hundred and twenty inches, when the sidestepping 131_{L}, 141_{R} is begun. The alto singer A and the tenor singer T can be in front of, or behind, the soprano singer S and the bass singer B by a second predetermined distance, such as forty-eight inches. The tenor singer T is shown as sidestepping to the left 121_{L} along the horizontal plane HPT while singing the first descending sub-sequence of musical notes T2d, T3d, T4d, and the alto singer A is shown as sidestepping to the right 111_{R} along the horizontal plane HPA while singing the first ascending sub-sequence of musical notes A2a, A3a, A4a. The tenor singer T and the alto singer A can be separated by a third predetermined distance, such as eighteen inches, when the sidestepping 121_{L}, 111_{R} is begun.

To create a different perspective in sound, the alto singer A and the bass singer B can position themselves in front of the soprano singer S and the tenor singer T. Stated somewhat differently, the soprano singer S and the bass singer B can begin by standing at a distance of about one hundred and twenty inches from one another. Viewed from the back, the soprano singer S can stand on the right and moves to the left; whereas, the bass singer B can stand on the left and moves to the right. As set forth above, the soprano singer S and the bass singer B both can move towards to center line CL. In contrast, the alto singer A and the tenor singer T can start at the center line CL, at a distance of eighteen inches shoulder to shoulder, with the same starting note. The alto singer A and the tenor singer T can proceed to sing notes in contrary motion while sidestepping away from each other—moving away from their respective starting position proximal to the center line CL.

The alto singer A, the tenor singer T, the soprano singer S and the bass singer B can continue the sidestepping 111_{R}, 121_{L}, 131_{L}, 141_{R} until reaching the respective retrace points ARP, TRP, SRP, BRP as illustrated in FIG. 35B. FIG. 35B only shows the retrace point.

At the retrace points ARP, TRP, SRP, BRP, alto singer A, the tenor singer T, the soprano singer S and the bass singer B can reverse course. In preferred embodiments, the soprano singer S, the alto singer A, the tenor singer T and the bass singer B sing the respective fourth musical notes S4d, A4a, T4d, B4a only once at the retrace points SRP, ARP, TRP, BRP.

Turning to FIG. 35C, the soprano singer S is shown as sidestepping to the right 1318 along the horizontal plane HPs while singing the second ascending sub-sequence of musical notes S5a, S6a, S7af, and the bass singer B is shown as sidestepping to the left 141_{L} along the horizontal plane HPB while singing the second descending sub-sequence of musical notes B5d, B6d, B7df. The soprano singer S and the bass singer B thereby retrace their steps back to their respective starting positions. The tenor singer T is illustrated as sidestepping to the right 121_{R} along the horizontal plane HPT while singing the second ascending sub-sequence of musical notes T5a, T6a, T7af, and the alto singer A is shown as sidestepping to the left 111_{L} along the horizontal plane HPA while singing the second descending sub-sequence of musical notes A5d, A6d, A7df. The tenor singer T and the alto singer A thereby retrace their steps back to their respective starting positions.

The sidestepping and the musical notes sung are in contrary motion to those sung by their partner who is on the opposite side of the center line CL. Upon each singer S, A, T, B learning their own part well, the singer S, A, T, B might then sing their own part while also listening to their coupled partner. Then, for a further additional sense of contrary motion while singing their own part, the singer S, A, T, B may choose to listen to the other coupled singers. After performing and understanding the resultant contrary motion, the group of four singers S, A, T, B might take their usual stationary choir positions and sing the exercises but with no sidestepping. The singers S, A, T, B then can be asked to witness any difference in their hearing of contrary motion. In this regard, the exercises may be applied to other pieces of music.

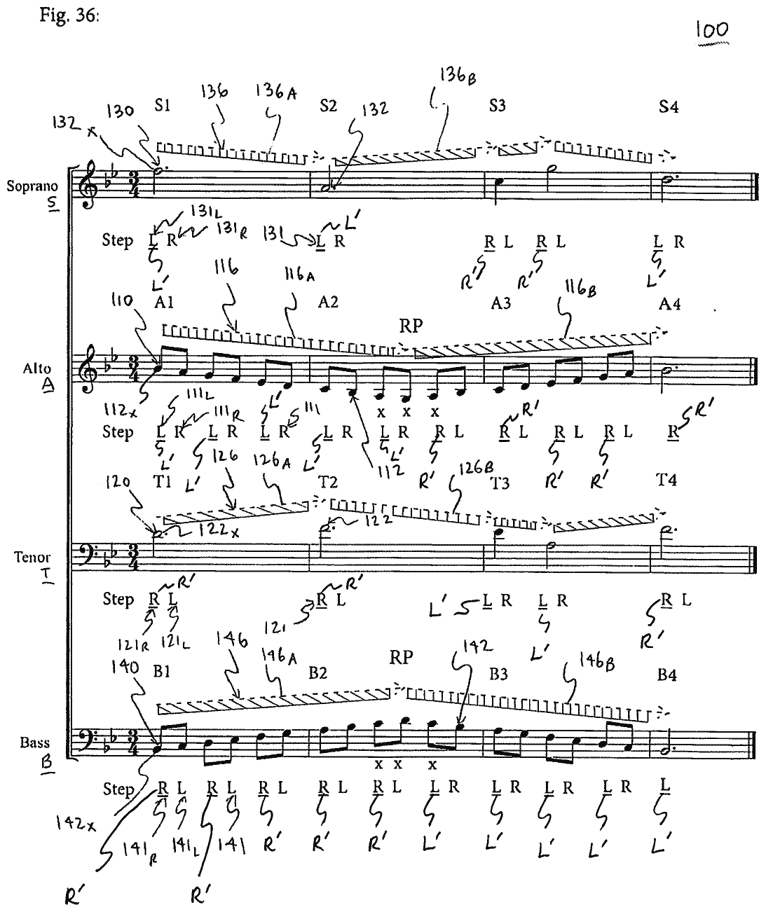

FIG. 36 is a detail diagram illustrating yet another exemplary alternative embodiment of the teaching method 100 into a four-measure, four-part score designed for a choir consisting of a soprano singer S, an alto singer A, a tenor singer T and a bass singer B. FIG. 36 can help illustrate different aspects of contrary motion that are not usually in a “mirror” or easy to follow form in the manner shown in FIG. 34.

In contrast to the coupling shown and described with reference to FIG. 34, the soprano singer S and the tenor singer T can be coupled into a first group of singers, and the alto singer A and bass singer B can be coupled into a second group of singers in the embodiment of the teaching method 100 of FIG. 36. Each individual part, or coupled part, such as the soprano singer S and the bass singer B, may proceed with the same various sequences as in FIGS. 25-35, that is, proceeding with the auditory contrary motion while employing visual red and green lines 116, 126, 136, 146 showing the simultaneously ascending and descending lines 110, 120, 130, 140 of the music and employing the kinesthetic sense of sidestepping to the right 111_{R}, 121_{R}, 131_{R}, 141_{R} for ascending lines and sidestepping to the left 111_{L}, 121_{L}, 131_{L}, 141_{L} for the descending lines of the music. The kinesthetic and visual aspects enable the listener 500 to sense the distance between the contrary motion lines in order to strengthen the ability of hearing contrary motion. Seeing the physical movement enhances the spatial awareness and magnifies the hearing of the opposition of the musical notes 112, 122, 132, 142 in contrary motion.

The musical notes 132 sung by the soprano singer S and the musical notes 122 sung by the tenor singer T are shown in FIG. 36 as having a different rhythmic scheme from the musical notes 112 sung by the alto singer A and the musical notes 142 sung by the bass singer B. Therefore, the timing of the sidesteps 111, 121, 131, 141 can be adjusted differently between the first group of the soprano singer S and the tenor singer T and the second group of the alto singer A and the bass singer B.

The first sung musical note Alto 112_{X}, Tenor 122_{X}, Soprano 132_{X}, Bass 142_{X} of all the vocal parts is shown in FIG. 36 begins with a sidestep to the left 111_{L}, 131_{L}, as shown with red lines 116_{A}, 136_{A}, or sidestep to the right 121_{R}, 141_{R} shown with green lines 126_{A}, 146_{A}, while simultaneously singing the first musical note 112_{X}, 122_{X}, 132_{X}, 142_{X}. The singing of the first musical note 112_{X}, 122_{X}, 132_{X}, 142_{X} of the embodiment of FIG. 36 is in contrast to the teaching method 100 as illustrated FIGS. 32-35, which includes each respective singer S, A, T, B singing a first musical note in a starting position.

In selected embodiments the soprano singer S and the tenor singer T in the first group of singers can form a horizontal plane HP (shown in FIGS. 35A-C) and can be positioned about thirty-six inches apart from each other. The horizontal plane HPs (shown in FIGS. 35A and 35C) associated with the soprano singer S and the horizontal plane HPT (shown in FIGS. 35A and 35C) associated with the tenor singer T in the first group of singers can be positioned in front of the horizontal plane HPA (shown in FIGS. 35A and 35C) associated with the alto singer A and the horizontal plane HPB (shown in FIGS. 35A and 35C) associated with the bass singer B in the second group of singers. The horizontal plane HPs and the horizontal plane HPT can be separated from the horizontal plane HPA and the horizontal plane HPB by a predetermined distance, such as approximately forty-eight inches. To create a different sound for the listener 500 (shown in FIG. 4A), the soprano singer S and the tenor singer T can stand in back of the alto singer A and the bass singer B by a preselected distance, such as approximately forty-eight inches.

The alto singer A and the bass singer B in the second group of singers can stand at a predetermined distance of approximately one hundred and eighty inches (or fifteen feet) from one another. In selected embodiments, the alto singer A can stand on the right since the first step 111_{L} of the alto singer A is to the left. Additionally and/or alternatively, the bass singer B can stand on the left because the first step 141_{R} of the bass singer B is to the right.

All the musical notes 112, 122, 132, 142 in the vocal parts are associated with green ascending dotted lines 116_{B}, 126_{B}, 136_{A}, 146_{A} or red descending dotted lines 116_{A}, 126_{A}, 136_{B}, 146_{B} for visually demonstrating the contrary motion. All the vocal parts contain an “R” or “L” to indicate a sidestepping 111, 121, 131, 141 to the right or left. Leftward sidestepping can be initiated via a lead-stepping left foot L′; whereas, rightward sidestepping can be initiated via a lead-stepping right foot R′.

As shown in FIG. 36, the alto singer A and the bass singer B can be mirror images to one other; whereas, the soprano singer S and the tenor singer T are not in mirror image to one another but nevertheless proceed in contrary motion to each other. Intervals of the soprano singer S and the tenor singer T can vary. The soprano singer S, for example, can open with a descending minor sixth interval, and the tenor singer T can open with an ascending minor third interval. The soprano singer S and tenor singer T are not shown in FIG. 36 as having retrace points.

Before the first musical note 112_{X}, 122_{X}, 132_{X}, 142_{X} is sung in FIG. 36, the starting pitch should be given to each singer S, A, T, B before beginning the exercise. Each vocal part begins on a different pitch. The pitch for each part can be given by a conductor or a designated leader of the group before beginning the exercise.

Upon singing the first musical note 112_{X}, 122_{X}, 132_{X}, 142_{X}, all the voices simultaneously take their first respective designated sidesteps. The tempo should be slow since the alto singer A and the bass singer B have more notes to sing and sidesteps to take than the soprano singer S and the tenor singer T.

A lead stepping foot R′, L′ of each singer S, A, T, B as illustrated in FIG. 36 is immediately followed in the same direction by a non-leading foot of the respective singers S, A, T, B. For example, the left foot sidesteps to the left while singing descending notes can be immediately followed in the same direction by the non-leading foot; whereas the right foot sidesteps to the right while singing ascending notes immediately followed in the same direction by the non-leading foot. The feet of each singer S, A, T, B thereby can be placed next to one another after the step is complete.

In selected embodiments, the sidestepping moves in predetermined increments, such as about eighteen inches or a shorter distance if it is more comfortable for the singers S, A, T, B. The feet of the singers S, A, T, B preferably do not cross over each other.

Soprano Singer S/Tenor Singer T

As shown in FIG. 36, the soprano singer S and the tenor singer T can sing long held musical notes 122, 132. The sung notes 122, 132 are illustrated as including a dotted half note in the first and second bars and a quarter note and a half note in the third bar with dotted half note to finish the phrase in the fourth bar. The rhythmic scheme of the soprano singer S and the tenor singer T are matched making the contrary motion visible in written score. In contrast to the sung musical notes 122, 132 of the soprano singer S and the tenor singer T, the alto singer A and the bass singer B are shown as being associated with consistent eighth notes, which are mirror images of each other.

Soprano Singer S

At S1, the soprano singer S can take one sidestep 131_{L} to the left with the lead-stepping left foot L′ of the soprano singer S. The sidestep 131_{L} to the left can comprise a predetermined distance, such as approximately eighteen inches, and can be immediately followed by a right foot R of the soprano singer S. The feet of the soprano singer S thereby can meet in position with both feet placed next to each other. The position of the feet of the soprano singer S can be held for the duration of the sung dotted half note.

At S2, a second sung dotted half note is shown as decreased in pitch relative to the first sung dotted half note. Due to the decrease in pitch in the sung musical notes, the soprano singer S can take a second sidestep 131_{L} to the left with the lead-stepping left foot L′ being immediately followed by a sidestep to the left with the right foot R to meet in position with both feet placed next to each other. The position of the feet of the soprano singer S can be held for the duration of the sung dotted half note.

At S3, a first musical quarter note is shown as ascending pitch relative to the second sung dotted half note of S2. Due to the ascending pitch in the sung musical notes, the soprano singer S can take one sidestep 1318 to the right with the lead-stepping right foot R′ immediately followed by a sidestep to the right with the left foot L. The feet of the soprano singer S thereby can meet in position with both feet placed next to each other. The position of the feet of the soprano singer S can be held for the duration of the sung quarter note.

A second musical half note, at S3, is shown as ascending pitch relative to the sung first musical quarter note. Due to the ascending pitch in the sung musical notes, the soprano singer S can take another sidestep 1318 to the right with the lead-stepping right foot R′ immediately followed by a sidestep to the right with the left foot L. The feet of the soprano singer S thereby can meet in position with both feet placed next to each other. The position of the feet of the soprano singer S can be held for the duration of the sung half note.

At S4, a third sung dotted half note is shown as descending in pitch relative to the first half note at S3. Due to the descending in pitch in the sung musical notes, the soprano singer S can take one sidestep 131_{L} to the left with the lead-stepping left foot L′ immediately followed by a sidestep to the left with the right foot R. The feet of the soprano singer S thereby can meet in position with both feet placed next to each other. The position of the feet of the soprano singer S can be held for the duration of the sung dotted half note.

Tenor Singer T

At T1, the tenor singer T can take one sidestep 121_{R} to the right with a lead-stepping right foot R′ of the tenor singer T. The sidestep 121_{R} to the right can comprise a predetermined distance, such as approximately eighteen inches, and can be immediately followed by left foot L of the tenor singer T. The feet of the tenor singer T thereby can meet in position with both feet placed next to each other. The position of the feet of the tenor singer T can be held for the duration of the sung dotted half note.

At T2, a second sung dotted half note is shown as ascending in pitch relative to the first sung dotted half note. Due to the ascending in pitch in the sung musical notes, the tenor singer T can take a second sidestep 121_{R} to the right with the lead-stepping right foot R′ being immediately followed by a sidestep to the right with the left foot L to meet in position with both feet placed next to each other. The position of the feet of the tenor singer T can be held for the duration of the sung dotted half note.

At T3, a first musical quarter note is shown as descending in pitch relative to the second sung dotted half note of T2. Due to the descending in pitch in the sung musical notes, the tenor singer T can take one sidestep 121_{L} to the left with the lead-stepping left foot L′ immediately followed by a sidestep to the left with the right foot R. The feet of the tenor singer T thereby can meet in position with both feet placed next to each other. The position of the feet of the tenor singer T can be held for the duration of the sung quarter note.

A second musical half note, at T3, is shown as descending in pitch relative to the sung first musical quarter note. Due to the descending in pitch in the sung musical notes, the tenor singer T can take another sidestep 121_{L} to the left with the lead-stepping left foot L′ immediately followed by a sidestep to the left with the right foot R. The feet of the tenor singer T thereby can meet in position with both feet placed next to each other. The position of the feet of the tenor singer T can be held for the duration of the sung half note.

At T4, a third sung dotted half note is shown as an ascending pitch relative to the first half note at T3. Due to the ascending in pitch in the sung musical notes, the tenor singer T can take one sidestep 121_{R} to the right with the lead-stepping right foot R′ immediately followed by a sidestep to the right with the left foot L. The feet of the tenor singer T thereby can meet in position with both feet placed next to each other. The position of the feet of the tenor singer T can be held for the duration of the sung dotted half note.

The intervallic relationship between the soprano singer S and the tenor singer T can begin at a predetermined distance of the interval of a minor 10^{th}. This is followed by their respective second notes which is a major 3^{rd}, a much closer interval. This larger interval is included to highlight the physical stepping distance towards each other. The present embodiment comprises a musical exaggeration to make a point.

Alto Singer A/Bass Singer B

Additionally and/or alternatively, the sung notes and sidestepping for the alto singer A and the bass singer B can mirror each other. The sidestepping of the alto singer A and the bass singer B can occur on the first, second, and third beats, which are the main beats in ¾ time signature. A first (or leading) foot of the alto singer A or the bass singer B can move synchronously with singing of a first eighth note on the main beats immediately followed by the second (or non-leading foot) of the singer A, B while singing the associated second eighth note to briefly meet in starting position. Eighth notes, even in slow tempo, move without delay. Both feet merely touch position and proceed to the next eighth note by the leading sidestepping note. As illustrated in FIG. 36, the musical notes 112, 142 sung by the alto singer A and the bass singer B can comprise of eighth notes that end with a dotted half note. The rhythmic scheme of the alto singer A and the bass singer B are matched which makes contrary motion easily visible.

On the third beat in the second measure, the non-leading foot of each of the alto singer A and the bass singer B can become the leading foot at a retrace point RP. Stated somewhat differently, the eighth note patterns as sung by the alto singer A and the bass singer B can reverse at the retrace point RP. At the retrace point RP in the second measure on the “and” of beat two, going into the third beat, the same foot (R, R′ or L, L′) can make two consecutive sidesteps.

While singing eighth notes, the alto singer A and the bass singer B, each take one sidestep per eighth note, first with a lead-stepping left foot L′ or a lead-stepping right foot R′, depending on whether the sung note is ascending or descending. The lead-stepping left foot L′ or a lead-stepping right foot R′ can be associated the lead stepping foot of the singer A, B and can move to the right or to the left. Considering that a sidestep is taken on the first musical note 112_{X}, 142_{X} as shown in FIG. 36, each foot, right and left, of the alto singer A and the bass singer B can each move five times to the right and five times to the left.

As illustrated in FIG. 36, the alto singer A and the bass singer B can have an additional feature of vocally “crossing each” other for three notes marked “X.” This crossing can happen regularly in choral and any kind of music. Yet, as stated earlier, the feet of the singers A, B preferably do not cross each other, and the singers A, B preferably do not cross each other. Thus, one reason for starting at a distance of one hundred and eighty inches (or fifteen feet) apart thereby avoiding a collision. For the sake of clarity, or to strengthen the concept of contrary motion, the singers A, B or the director may choose that the two singers A, B can cross each other in selected embodiments. Since, in this case, the music of the alto singer A and the bass singer B do cross. That is, the alto singer A sings pitches lower than pitches sung by the bass singer B, and the bass singer B sings pitches that are higher than pitches sung by the alto singer A. It might be determined which singer A, B would be in front or in back of the other singer A, B to avoid bumping into each other.

The rhythmic scheme of the soprano singer S and the tenor singer T have long held notes, and the rhythmic scheme of the alto singer A and the bass singer B has consistent eighth notes. This rhythmic scheme advantageously can make the contrary motion visibly accessible, for each coupling the soprano singer S with the tenor singer T and coupling the alto singer A with the bass singer B. Both groups of singers can demonstrate contrary motion, moving at different speeds, which when noticed by the listener 500 (shown in FIG. 4A), can add another layer to the contrary motion: fast and slow.

Other Configurations

The two groups of singers, may face each other at a predetermined distance of about forty-eight inches, stepping right on ascending notes and stepping left on descending notes, while simultaneously singing the examples. Different permutations such as facing each other would allow for a different recognition of the ascending and descending lines. The idea being, to be able to hear more of the inner workings of the music, one can never hear too much.

Once the exercise is familiarized, another permutation could place all the singers S, A, T, B on their own respective horizontal planes, creating four separate lines. Any exercise or permutation of the four parts would provide a contrary motion pattern, while stepping in directions as detailed by the ascending and descending lines.

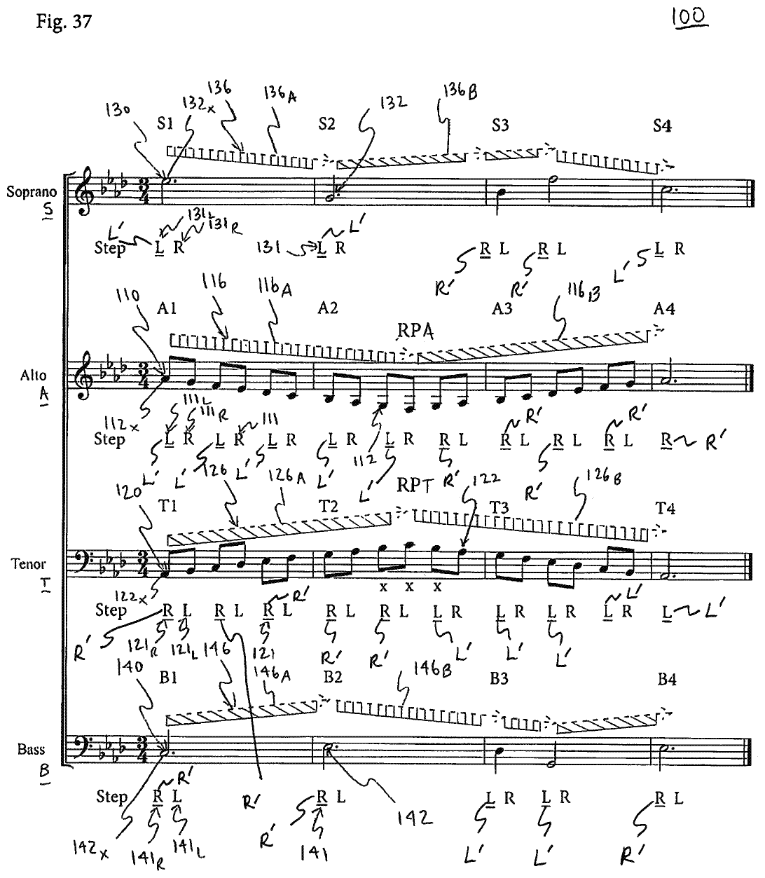

FIG. 37 illustrates an alternative embodiment of the teaching method 100 shown in FIG. 36. Turning to FIG. 37, the musical notes 122 sung by the tenor singer T can be switched with the musical notes 142 sung by the bass singer B. This technique; switching of parts, is formally known as Invertible Counterpoint, which is used most famously in the Two-Part Invention in E major of J. S. Bach, BWV 777 (not shown). The musical notes 122, 142 of FIG. 37 are shown as being in a lower key (Ab) in order to make the vocal range singable for both parts. The musical notes 112, 122, 132, 142 sung by any two singers S, A, T, B, such as the tenor singer T and the alto singer A, optionally can be switched. Additional permutations strengthen the perception of contrary motion between musical lines.

Parallel motion exercises are envisioned by the present disclosure and can be tried for comparison. Two or more groups of singers S, A, T, B might sing a major scale up or down in the interval a third or any interval. In the case of an oblique motion exercise, for example, one group of singers S, A, T, B might sing a major scale up or down, while a second or third group of singers S, A, T, B can sing the pedal tone of the tonic (or dominant) of the key.

For parallel motion, a group of two or more singers S, A, T, B might sing any one part, in unison on the same pitch or one or more octaves apart, such as the alto singer A part of FIG. 36 in B flat.

Additionally and/or alternatively, the singers S, A, T, B might arrange to sing the example in 3rds, keeping to the key. That is, one singer S, A, T, B can sing the part of the alto singer A as written, and another singer S, A, T, B can sing the B flat scale starting on the note D, and proceed in the same direction as the alto singer A. By showing the difference in parallel motion and contrary motion. Contrary Motion becomes much easier to hear when the contrary motion is pointed out; playing one line at a time, before putting the two lines together.

Comparison of Sidestepping Creating Distance with Stationary

A comparison between oppositional sidestepping as shown and described above with reference to FIGS. 22-37, as opposed to remaining in one place (or stationary), can involve the other senses with assisting in the demonstration of audible contrary motion. Sidestepping in opposite directions provides the added benefit of a sense of spatial distance. The use of distance heightens the experience of hearing the opposition of the notes in contrary motion.

As a further exploration of choir couplings in FIGS. 22-37, couplings between singers S, A, T, B may occur within any one vocal part. For instance, couplings can occur between a first tenor singer T1 and a second tenor singer T2, between a first alto singer A1 and a second alto singer A2, between a first soprano singer S1 and a second soprano singer S2 and/or between a first bass singer B1 and a second bass singer B2. While rare, one part may be divided into more than two lines, such as a first tenor singer T1, a second tenor singer T2 and a third tenor singer T3. The third tenor singer T3, for example, might be in contrary motion to another tenor singer T and/or another part, such as a part sung by the bass singer B.

The teaching method 100, including the most basic of exercises, the sidestepping, observing the coupled parts and switching of parts, as disclosed herein, can provide excellent training for understanding fugue, invertible counterpoint and double fugues. The listener 500 (shown in FIG. 4A), laymen and musicians thereby might enter the realm of the musical composition, especially that of classical, and possibly spur an interest in science.

In selected embodiments, one or more senses other than the auditory sense of hearing, visual sense of sight and/or tactile sense of touch of the listener 500 can be utilized to appreciate the first and second lines 110, 120 of music and understand the contrary motion. These other senses can be used independently from, and/or in conjunction with, the auditory sense of hearing, visual sense of sight and/or tactile sense of touch.

### Further Alternative Exemplary Embodiments of the Teaching Method

In selected embodiments, listening to music in contrary motion can be considered a natural activity. Contrary motion exists throughout science, in the form of positive protons and negative electrons in atomic structure and/or as electromagnetic poles, such as north and south magnetic poles. Human DNA is arranged in a guanine (G), cytosine (C), adenine (A) and thymine (T) (or collectively GCAT) pattern.

The human body likewise is a complex of contrary motion activity. Within the human body, the circulatory system of veins carry blood to the heart for reoxygenation, and arteries carry oxygen-rich blood to various parts of body and away from the heart. In the human eye, the retina sees the world upside down, which is then reversed by the brain. The respiratory/pulmonary system also exhibits contrary motion, such as with regard to inhaling and exhaling.

As another example, the listener 500 might easily observe and/or trace a light-green back part of a leaf (not shown). The listener 500 can follow, or be instructed to follow, a midrib (or center) of the leaf and/or notice one or more veins extending from the midrib as being arranged in contrary motion.

Additionally and/or alternatively, engineering feats often include myriad oppositional patterns. These oppositional patterns can arise in cross beams in a bridge, alternating current in electricity, pistons in an engine, a crankshaft in an automobile, a turbine and/or a jet engine, without limitation.

Simultaneous and Multiple Levels of Contrary Motion

In science, protons, which are of a positive charge, are the opposite of negative electrons. Protons also contain subatomic particles known as “quarks.” Quarks are known to have six “flavors” that have oppositional properties: up-down; strange-charm and top-bottom. Quarks in current science help to define a part of the four forces of the universe: electromagnetism; gravitation; strong nuclear force and weak nuclear force. The strong and weak nuclear forces are in opposition. While the proton and the electron are opposites, subatomic particles within the protons also contain oppositional components.

Electrons also exhibit oppositional properties. The Pauli Exclusion Principle states that essentially electrons have opposing spins.

In classical music multiple levels of opposition or contrary motion exist. The contrary motion of the Beethoven in FIGS. 9, 10 and 11 contain the basic outline or the contrary motion. FIG. 12A is the original Beethoven containing all of the notes between the outlined contrary motion, in FIG. 12B, exhibit two levels of contrary motion.

In the Bach Goldberg Variations, two lines of music play in contrary motion, while the right and left hand of the pianist crisscross each other (not shown), thus at least two levels of contrary motion are used. Bach's use of contrary motion is exemplary. One of his compositions from the Musical Offering known as the Crab Canon, consists of only one line of music. However, that line is to be played forward, and backward at the same time. That is, as one line starts from the beginning of the piece, simultaneously another line begins on the last note of the piece, and proceeds in a backwards sequence to the first note.

Contrary Motion Indigenous to Activities

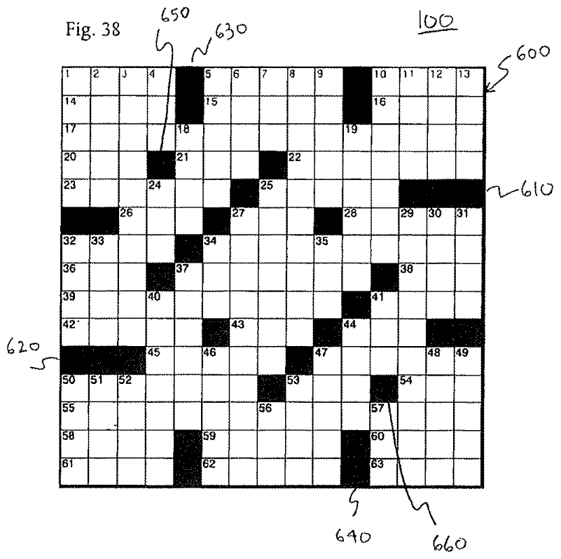

Contrary motion exists in human recreational activities such as, but not limited to, tennis, ping pong, chess and checkers. Most crossword puzzles are arranged in a contrary motion pattern. An exemplary crossword puzzle grid 600 is illustrated in FIG. 38. Turning to FIG. 38, the crossword puzzle grid 600 is shown as including a first group of three black squares 610 above squares 29, 30 and 31. The three black squares 610 can correspond with a second group of three black squares 620 above squares 50, 51 and 52. Additionally and/or alternatively, a first group of two black squares 630 that descend downwardly between squares 4 and 5 and the single black square 650 above square 24 can correspond, respectively, to a second group of two black squares 640 that ascend up between squares 62 and 63 and the single black square 660 above square 57.

A golf ball's surface contains dimples which reduce aerodynamic drag and create lift thus furthering the distance of the golf ball's flight after it has been hit.

Such oppositional patterns can work in oppositional motion. Newton's Third Law states that, for every action (force) in nature, there is an equal and opposite reaction. Classical music may provide us with insight into other fields besides music as well as the mechanics of the universe.

Selected Features

Selected features of the teaching system and method 100 can include, but are not limited to, one or more of the following features.
1. Teaching of classical music or other types of music through its inherent oppositional structure. The classical music genre, for example, contains an oppositional property similar to that which is found in daily activities (walking, for example). Audible, visual, tactile and/or kinesthetic senses used in everyday activities help in the understanding of classical music.
2. Teaching of classical music or other types of music whereby an inherent oppositional structure of the music is enhanced by using visual, tactile, and/or kinesthetic senses. Observation of the oppositional design in classical music can connect to the workings of multi-sensory cues.
The multi-sensory cues (visual, tactile and/or kinesthetic) can be incorporated to enhance the auditory experience of music, heightening the contrary motion.
3. Teaching an understanding of classical music or other types of music, using multi-sensory cues as set forth herein.
4. Separating lines of music from a score of a chamber or a symphony orchestra piece and assigning the two lines that move in contrary motion to respective musicians playing different instruments. The instruments can comprise two instrumental sections, such as a cello and a flute and/or a violin and a clarinet, without limitation. When the music moves in contrary motion, two or more sections of the orchestra can play their respective parts of a symphonic composition separately and/or together for an audience to hear. To that end, a concert program can consist of one of piece of music. In selected embodiments, an entire first half of the concert program can be devoted to displaying and hearing the contrary motion between instrument sections using the teaching methods described herein; whereas, the musicians can play the piece in its entirety in the second half of the concert program.
5. Providing a surface 300 (shown in FIG. 4A) for enabling an audience to have a tactile experience using their hands during a musical performance and/or for their own amusement, for example, at home. The surface 300, for example, can be provided as a keyboard visual via a performance program. In selected embodiments, the keyboard visual can be spread across front and back cover of the performance program or spanning across any two or more adjacent pages in the booklet of program notes.
6. Utilizing a typing keyboard 340 (shown in FIG. 4C) to achieve a tactile touch of contrary motion with what is known as “fine motor skills.” The typing keyboard 340 advantageously can be used to track or simulate the movement of one or more of the lines 110, 120 of music via the tactile sense.
7. Making use of the kinesthetic sense to teach and/or understand classical music or other types of music via everyday physical movement. If the physical movement includes walking, for example, the listener 500 (shown in FIG. 4A) can notice that, as the right leg steps forward, the left arm swings forward. The listener 500 likewise can notice that, as the left leg steps forward, the right arm swings forward.

In selected embodiments, one or more of the features disclosed herein can be provided as a computer program product being encoded on one or more non-transitory machine-readable storage media. As used herein, a phrase in the form of at least one of A, B, C and D herein is to be construed as meaning one or more of A, one or more of B, one or more of C and/or one or more of D. Likewise, a phrase in the form of A, B, C or D as used herein is to be construed as meaning A or B or C or D. For example, a phrase in the form of A, B, C or a combination thereof is to be construed as meaning A or B or C or any combination of A, B and/or C. It also will be appreciated that the inclusion of various headings within the detailed description are intended to facilitate the readability of the present specification and not for purposes of limitation. Furthermore, the subject matter of the present disclosure is not limited to contrary motion in music.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A method for teaching music appreciation through use of multi-sensory cues to highlight a musical technique known as contrary motion, comprising:
instructing a student to place each digit of a right hand on a keyboard, the right-hand digits being respectively positioned on a first group of keys of the keyboard associated with a first line of music with a first sequence of musical notes that ascend in pitch;
instructing the student to place each digit of a left hand on the keyboard, the left-hand digits being respectively positioned on a second group of keys of the keyboard associated with a second line of music with a second sequence of musical notes that descend in pitch, the first and second lines of music moving in the contrary motion; and
interactively presenting the first and second lines of music to the student with instruction to the student to use the right hand to press a relevant key in the first group as each corresponding musical note in the first line of music is presented and instruction to the student to use the left hand to press a relevant key in the second group as each corresponding musical note in the second line of music is presented.

2. The method of claim 1, wherein said interactively presenting the first and second lines of music to the student includes audibly presenting the first and second lines of music to the student in a sequential manner.

3. The method of claim 1, wherein said interactively presenting the first and second lines of music to the student includes interactively presenting the first and second lines of music simultaneously to the student.

4. The method of claim 3, wherein said interactively presenting the first and second lines of music to the student includes instruction to the student to use the right hand and left hand to tactually press the relevant keys in the first and second groups simultaneously as each corresponding musical note in the first and second lines of music is presented.

5. A method for teaching music understanding through use of multi-sensory cues, comprising:
annotating a first staff with a first line of music having a first sequence of musical notes that ascend in pitch with first indicia for visually illustrating the ascension of the musical notes;
annotating a second staff with a second line of music having a second sequence of musical notes that descend in pitch with second indicia for visually illustrating the descent of the musical notes, the first and second lines of music moving in contrary motion; and
interactively presenting the first and second lines of music to a student with instruction to the student to visually observe the first indicia as each musical note in the first line of music is presented and instruction to the student to visually observe the second indicia as each musical note in the second line of music is presented.

6. The method of claim 5, wherein said annotating the first staff includes annotating the first staff with the first line of music being visually presented during a concert attended by the student, wherein said annotating the second staff includes annotating the second staff with the second line of music being visually presented during the concert, and wherein said interactively presenting the first and second lines of music includes instructing the student to trace the annotated first and second staffs.

7. The method of claim 6, wherein the first and second lines of music are visually presented via printed literature, via a computer display circuit or via an interior of a concert program for the concert.

8. The method of claim 6, wherein said instructing the student to trace the annotated first and second staffs includes instructing the student to trace the annotated first and second staffs with an implement.

9. The method of claim 8, wherein the implement includes a pen.

10. The method of claim 6, wherein the first and second lines of music comprise first and second lines from a selected passage of classical music.

11. The method of claim 10, wherein the first and second lines of music are configured for performance by an orchestra, chamber or music group to demonstrate contrary motion.

12. The method of claim 10, wherein the first and second lines of music are configured to demonstrate contrary motion to musicians or to an audience.

13. The method of claim 5, wherein said interactively presenting the first and second lines of music further comprises interactively presenting the first and second lines of music to the student with instruction to the student to visually observe a first movement of a first singer who audibly sings the first line of music and a second movement of a second singer who audibly sings the second line of music, wherein the first movement and the second movement demonstrate the contrary motion in the first and second lines of music.

14. The method of claim 13, wherein the first movement of the first singer includes a first physical movement in a first direction, and wherein the second movement of the second singer includes a second physical movement in a second direction.

15. The method of claim 14, wherein the first direction comprises an opposite direction relative to the second direction, and wherein the first physical movement of the first singer comprises the first singer sidestepping in a leftward direction relative to the first singer, and wherein the second physical movement of the second singer comprises the second singer sidestepping in a rightward direction relative to the second singer.

16. The method of claim 5, further comprising extracting the first and second lines of music from a written music score.

17. The method of claim 16, wherein said extracting includes extracting the first and second lines of music while singers and musicians are performing the first and second lines of music.

18. The method of claim 5, further comprising distilling the first and second lines of music from a written music score.

19. The method of claim 18, wherein said distilling includes distilling the first and second lines of music while singers and musicians are performing the first and second lines of music.

20. A method for teaching music understanding through use of multi-sensory cues, comprising:
annotating a first staff with a first line of music having a first sequence of musical notes that ascend in pitch with first indicia for kinesthetically illustrating the ascension of the musical notes;
annotating a second staff with a second line of music having a second sequence of musical notes that descend in pitch with second indicia for kinesthetically illustrating the descent of the musical notes, the first and second lines of music moving in contrary motion; and
interactively presenting the first and second lines of music to a student with instruction to the student to kinesthetically observe the first indicia as each musical note in the first line of music is presented and instruction to the student to kinesthetically observe the second indicia as each musical note in the second line of music is presented.
